(19) United States
(12) Patent Application Publication
(10) Pub. No.: US 2011/0145293 A1
(43) Pub. Date: Jun. 16, 2011

(54) Methods, Systems, and Products for Creating Sharable Objects

(76) Inventor: Samantha Stewart, Elgin, IL (US)

(21) Appl. No.: 12/635,836

(22) Filed: Dec. 11, 2009

(51) Int. Cl. G06F 17/30

(52) U.S. Cl. 707/792; 707/E17.127

(57) ABSTRACT

Methods, systems, and products are disclosed for producing SCORM-conformant training materials. Exemplary embodiments create extensible mark-up language (or “XML”) content required by the SCORM specification, and exemplary embodiments appropriately name graphics and resources as the SCORM specification requires. Exemplary embodiments may also output metadata in the SCORM format. These features are automatically generated without requiring a software designer to rigidly adhere to the SCORM specification's complex requirements.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

Exemplary embodiments generally relate to electrical computers and, more particularly, to graphing data.

The Sharable Content Object Reference Model (or “SCORM”) is a collection of complicated standards and specifications for web-based learning (or “e-learning”). Many organizations wish to develop SCORM-conformant training materials, but the SCORM standards and specifications require complex programming skills.

### BRIEF DESCRIPTION OF THE SEVERAL VIEWS OF THE DRAWINGS

The features, aspects, and advantages of the exemplary embodiments are better understood when the following Detailed Description is read with reference to the accompanying drawings, wherein:

FIGS. 1-3 are schematics illustrating an environment in which exemplary embodiments may be implemented;

FIG. 4 is a schematic illustrating software componentry of a SCOBi application, according to exemplary embodiments;

FIG. 5 is a schematic illustrating diagramming symbols that are used in the drawings;

FIGS. 6-10 are schematics illustrating a SCOBi core application, according to exemplary embodiments;

FIGS. 11-42 are schematics illustrating sub-systems, according to exemplary embodiments;

FIGS. 43-187 are schematics illustrating screenshots of user interfaces and memory tables of software components, according to exemplary embodiments;

FIG. 188 is a schematic illustrating a processor-controlled device, according to exemplary embodiments; and

FIG. 189 depicts other possible operating environments for additional aspects of the exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

Exemplary embodiments create SCORM-conformant training materials. Exemplary embodiments describe methods, systems, and products that create a SCORM-conformant shareable content object (or “SCO”). Exemplary embodiments may comply with any version of the SCORM specification, which is produced from the Advanced Distributed Learning (or “ADL”) Initiative in the Office of the United States Secretary of Defense. Exemplary embodiments, for example, may rapidly and easily create SCORM-2004 conformant content, which is the latest version of the specification. Exemplary embodiments, however, are applicable to any past and/or future version of the SCORM specification. Exemplary embodiments create extensible mark-up language (or “XML”) content required by the SCORM specification, and exemplary embodiments appropriately name graphics and resources. Exemplary embodiments may also output XML and metadata in the SCORM format. Exemplary embodiments achieve these features without requiring a software designer to rigidly adhere to complex technical, design, template, and metadata requirements.

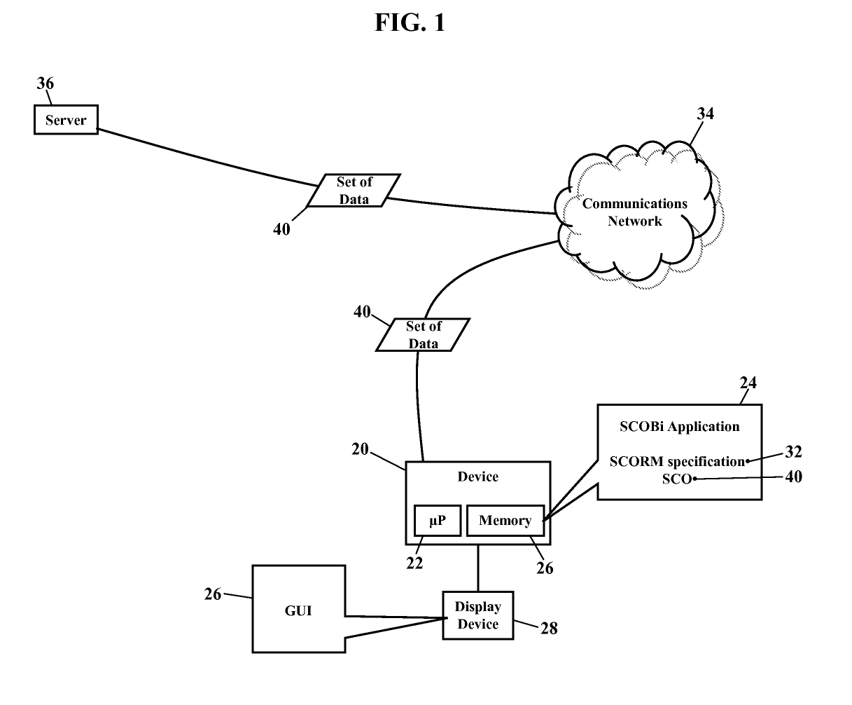

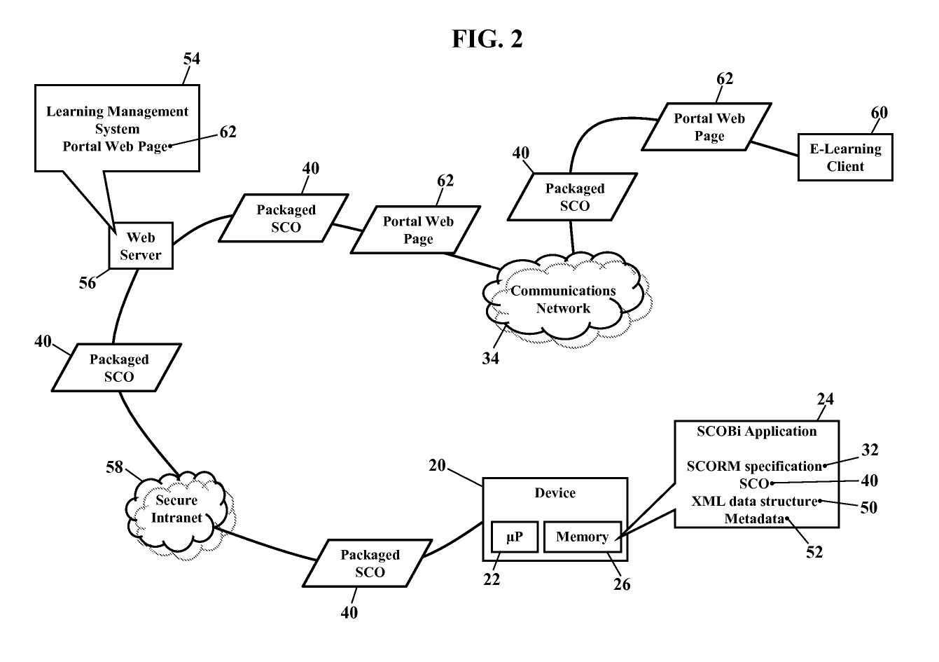

FIGS. 1-3 are simplified schematics illustrating an environment in which exemplary embodiments may be implemented. FIG. 1 illustrates a client-server network architecture, and FIG. 2 illustrates an e-learning training environment. Starting with FIG. 1, a device 20 has a processor 22 (e.g., “μP”), application specific integrated circuit (ASIC), or other component that executes a SCOBi application 24 stored in a memory 26. The acronym “SCOBi” is a word formed from “Shareable Content Object Builder.” The SCOBi application 24 may cause the processor 22 to produce a graphical user interface 26. The graphical user interface 26 is illustrated as being visually produced on a display device 28, yet the graphical user interface 26 may also have audible features. Although the device 20 is generically shown, the device 20, as later paragraphs will explain, may be a server, workstation, communications device, or any processor-controlled device.

The SCOBi application 24 creates SCORM-conformant content. The SCOBi application 24 retrieves a set 30 of data and conforms the set 30 of data to the SCORM specification 32. The set 30 of data is illustrated as being remotely retrieved via a communications network 34 from a server 36. The set 30 of data, however, may be locally retrieved from the memory 26 of the device 20. Regardless, because the SCOBi application 24 conforms the set 30 of data to the SCORM specification 32, the SCOBi application 24 creates or outputs a sharable content object (or “SCO”) 40. The sharable content object 40 conforms to the SCORM specification 32. The SCOBi application 24 is thus a rapid software authoring tool that automates the creation of extensible mark-up language (or “XML”), file structures, and UNIX/LINUX file naming conventions required by the SCORM specification 32. The SCOBi application 24 automates the complex technical, design, template, and metadata requirements of the SCORM specification 32, thus allowing designers to focus on developing quality content, rather than on the complexities of coding to the SCORM specification 32. While UNIX/LINUX file naming conventions are primarily discussed, the SCOBi application 24 may output any naming convention of any operating system or specification.

The set 30 of data may include multimedia. The set 30 of data is entered or retrieved at run time by the designer. Entry is done through initializing a project type and then accessing appropriate screen types to include relevant data. The graphical user interface 26 guides the user with step-by-step support in selecting, entering, and importing text and media into the SCOBi application 24. The designer may include text, images (.png, .jpg, .gif), as well as audio files (.mp3) and/or video (.flv). The SCOBi application 24 ensures that the included graphics and resources are named appropriately to meet the case sensitivity requirements for correct functioning on a UNIX-based platform or any other operating system.

FIGS. 1-3 may now be read in conjunction. The SCOBi application 24 creates and outputs the sharable content object 40. The SCOBi application 24 outputs an XML data structure 50 and metadata 52 in the SCORM format that is needed for a learning management system 54 operated by a web server 56. The sharable content object 40 may be packaged in a .zip file format with files from a content data engine so that the lesson is complete and operable as a deliverable. The .zip file format is well-known as a data compression format. The .zip file format is supported by many software applications, such as MICROSOFT® WNDOWS® and APPLE® MAC® operating systems. Within the packaged sharable content object 40 structure there may be three primary files that the SCOBi application 24 creates and renders from the specific content entered by the designer. A first file (“sco_content.xml”) contains the XML structure of the sharable content object 40 with associated text, graphics and audio on a screen by screen basis. A second file (“imsmanifest.xml”) holds the listing of the files and the path structure to be read by the learning management system 54. A third file (“S001.xml”) documents metadata information that holds the author, vendor and searchable keywords.

The packaged sharable content object 40 may be accessed from a web-based portal. After the packaged sharable content object 40 has been created, the packaged sharable content object 40 may be communicated to the web server 56. FIG. 2 illustrates the packaged sharable content object 40 communicating via a secure intranet 58 to the web server 56. The web server 56 stores the sharable content object 40 in memory for distribution to an e-learning client 60. The web server 56, for example, may store a portal web page 62 that is accessed and downloaded from the communications network 34. The e-learning client 60 communicates with the web server 56 and downloads the portal web page 62. The portal web page 62 may require authentication credentials (such as a secure username and password). When the e-learning client 60 successfully authenticates, the web server 56 and/or the portal web page 62 allows the e-learning client 60 to download packaged sharable content object 40. The portal web page 62 may rely upon an additional learning management system to initially call the sharable content object 40 (and/or other content) to action. Once the appropriate content is requested to be opened, the packaged sharable content object 40 then begins to render (such as HTML, javascript, and other content).

The device 20, the web server 56, and the e-learning client 60 are only simply illustrated. Because the architecture and operating principles of processor-controlled devices are well known, their hardware and software components are not further shown and described. If the reader desires more details, the reader is invited to consult the following sources: ANDREW TANENBAUM, COMPUTER NETWORKS (4^{th} edition 2003); WILLIAM STALLINGS, COMPUTER ORGANIZATION AND ARCHITECTURE: DESIGNING FOR PERFORMANCE (7^{th} Ed., 2005); and DAVID A. PATTERSON & JOHN L. HENNESSY, COMPUTER ORGANIZATION AND DESIGN: THE HARDWARE/SOFTWARE INTERFACE (3^{rd}. Edition 2004).

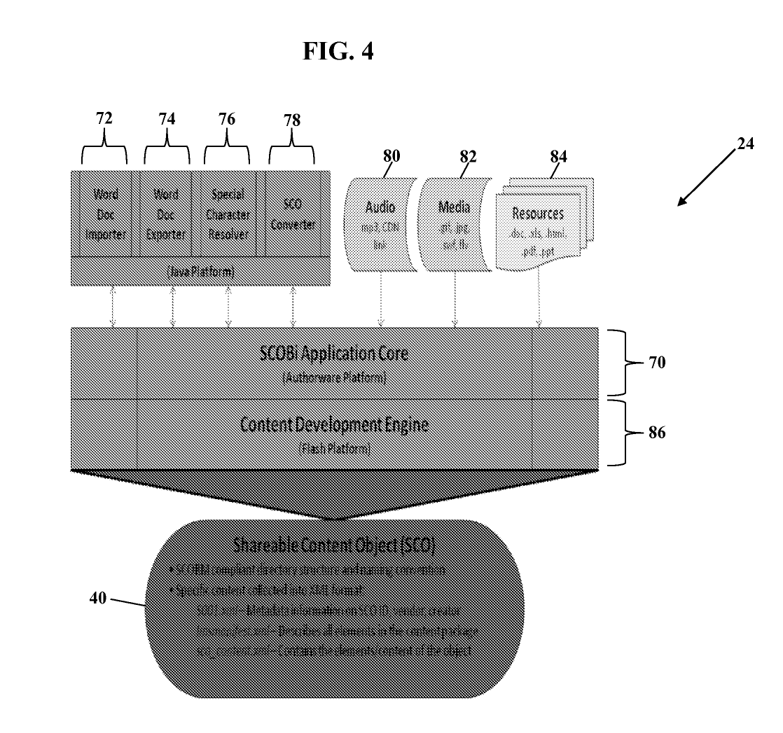

FIG. 4 is a schematic illustrating the software componentry of the SCOBi application 24, according to exemplary embodiments. The software structure of the SCOBi application 24 includes a SCOBi core application 70 that interfaces with multiple software subsystems. The SCOBi core application 70, for example, interfaces with a WORD® document importer 72, a WORD® document exporter 74, a Special Character Resolver 76, and an SCO Converter 78. Each of these subsystems will be described in later paragraphs. The SCOBi core application 70 may also receive or interface with audio files 80, media files 82, and any other resource 84. The SCOBi core application 70 may also interface with a Content Development Engine 86 that creates and/or generates the packaged sharable content object 40.

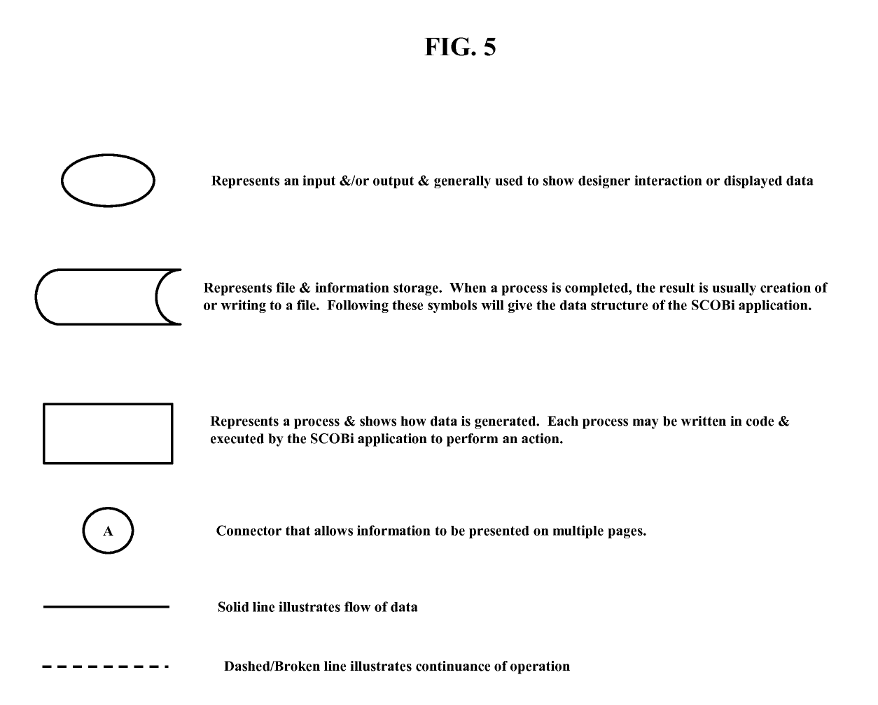

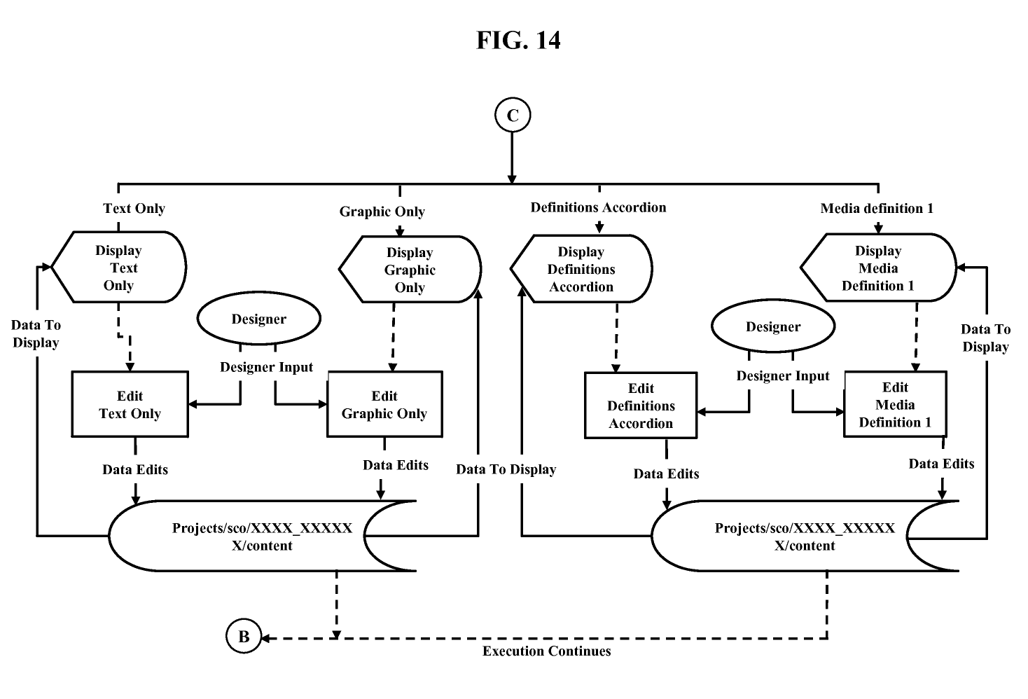

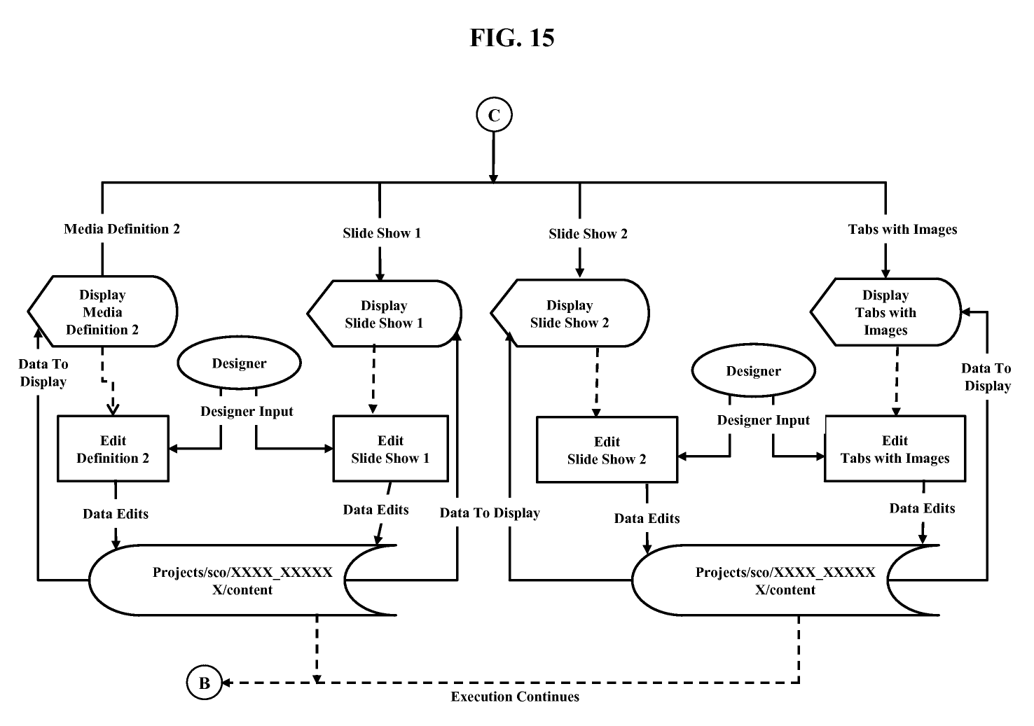

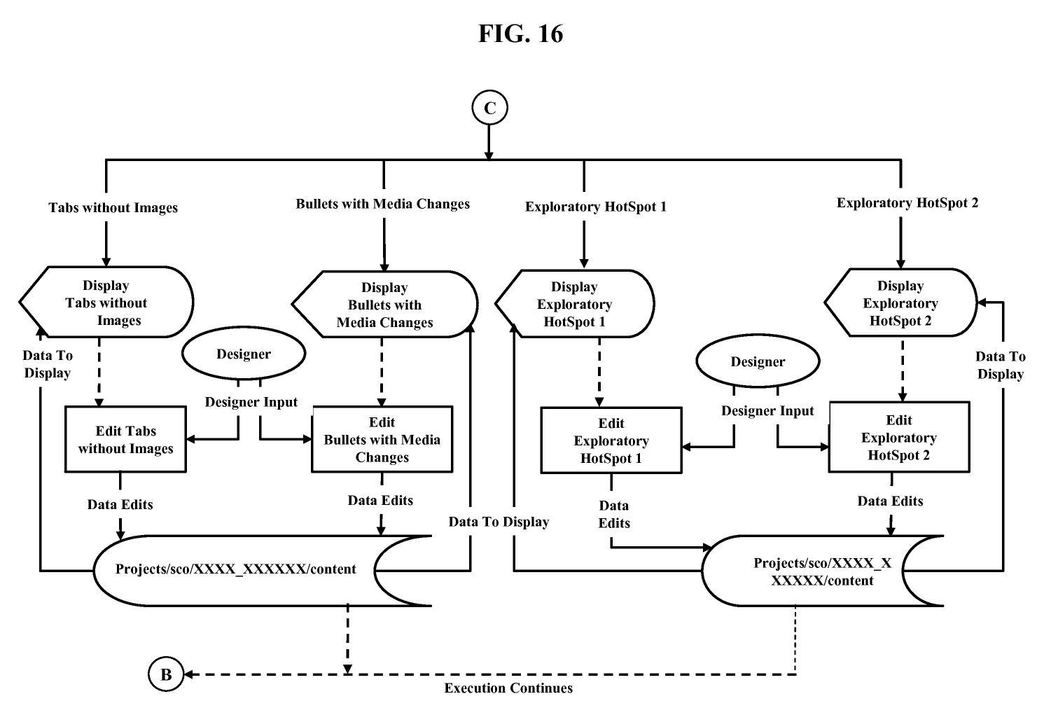

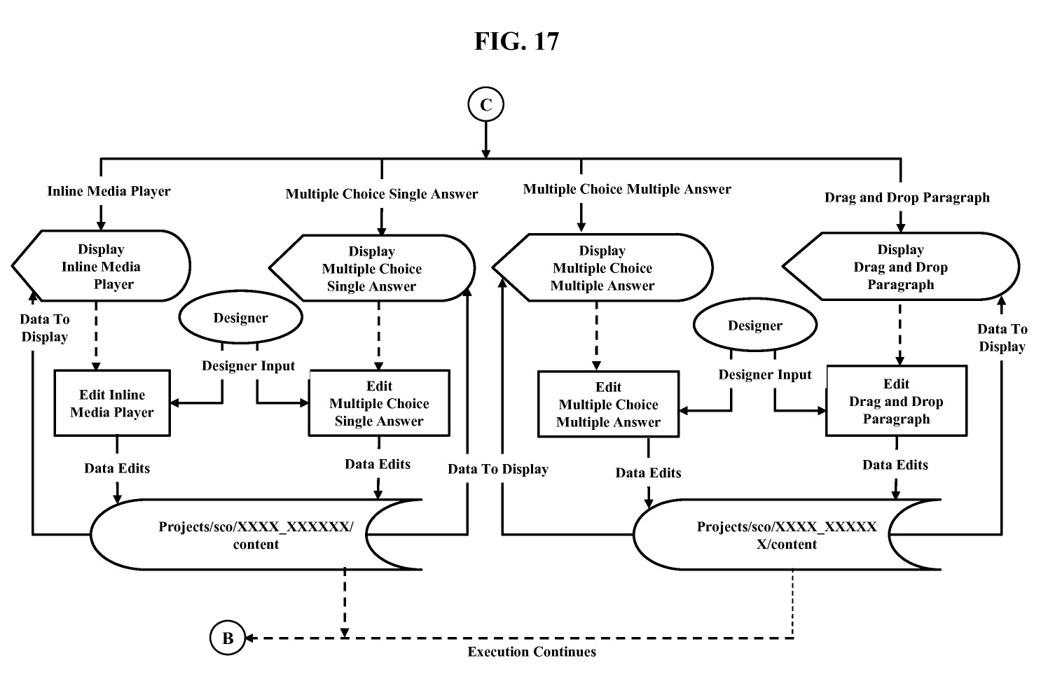

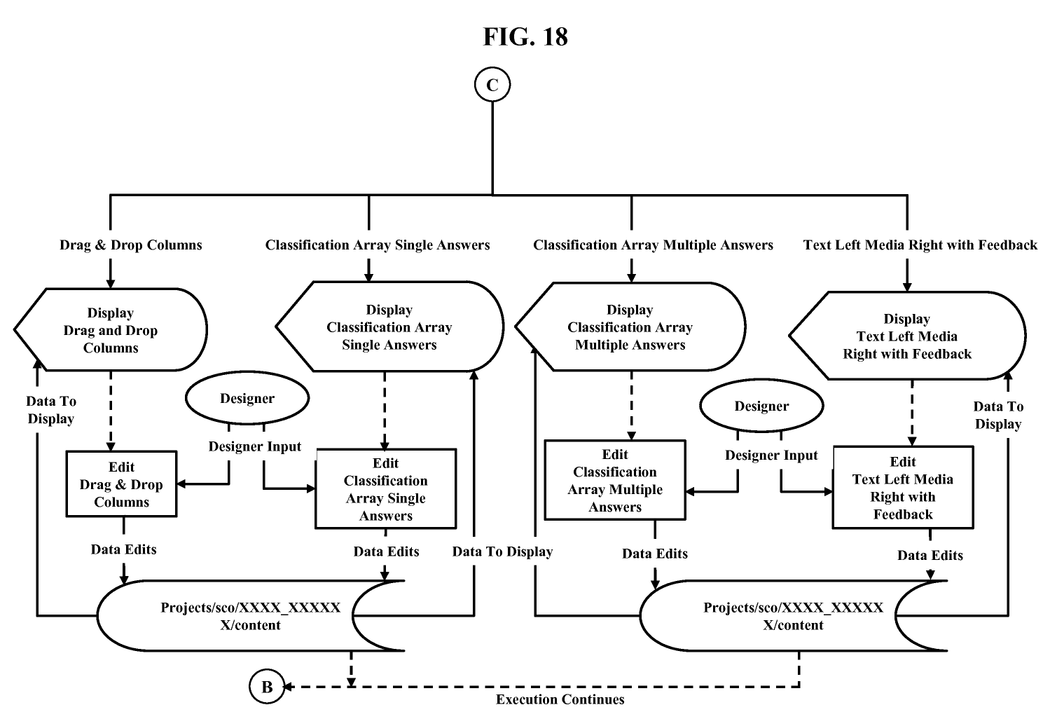

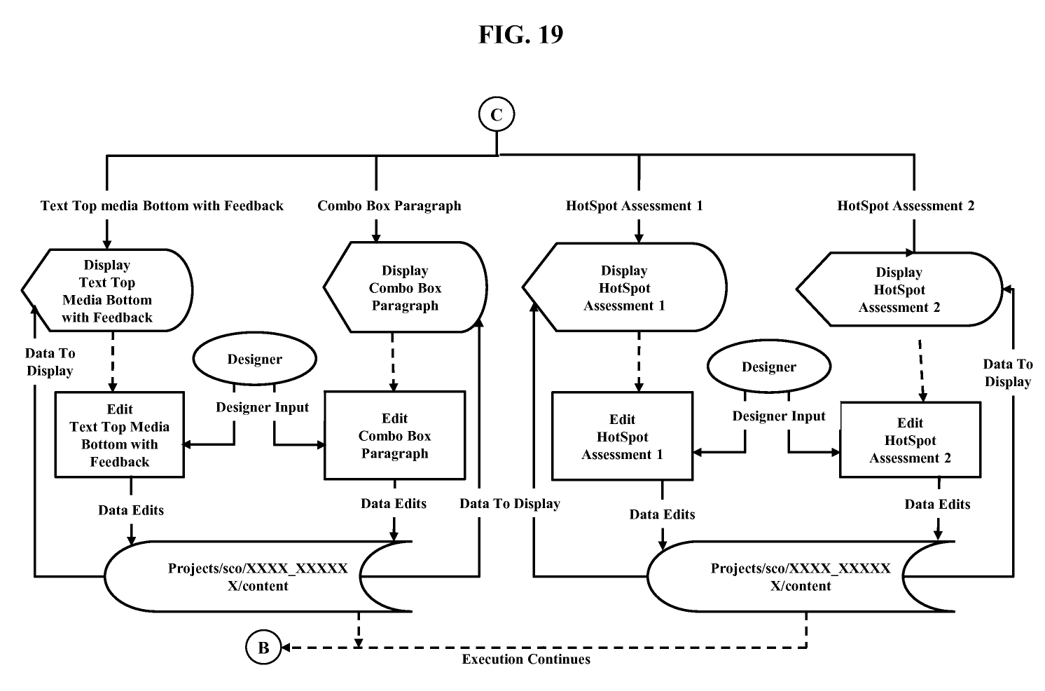

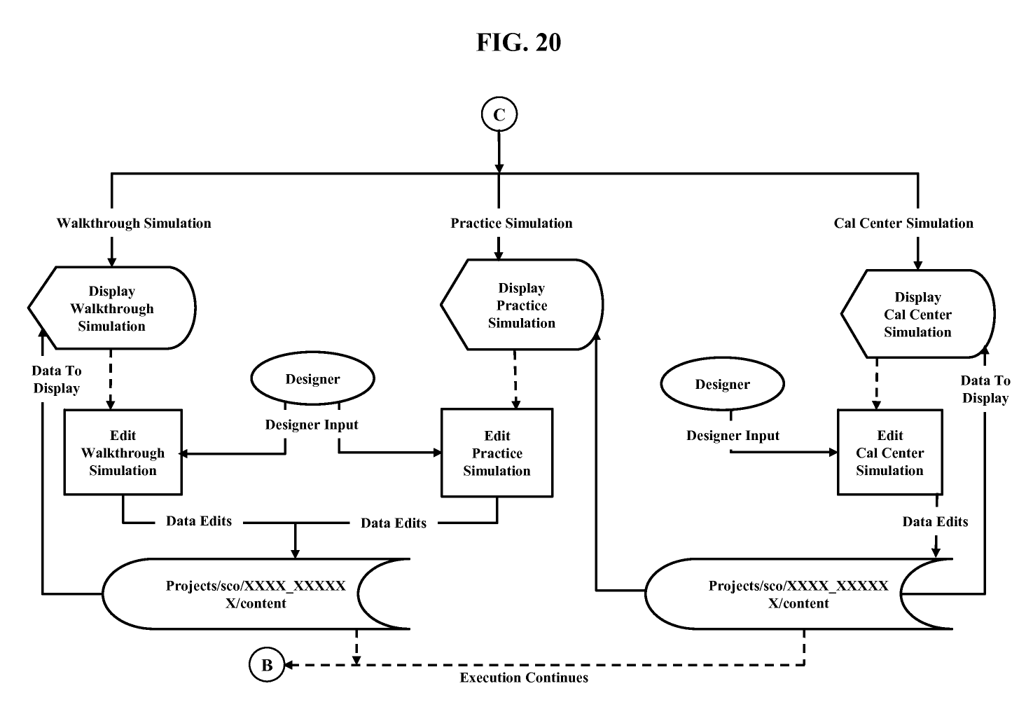

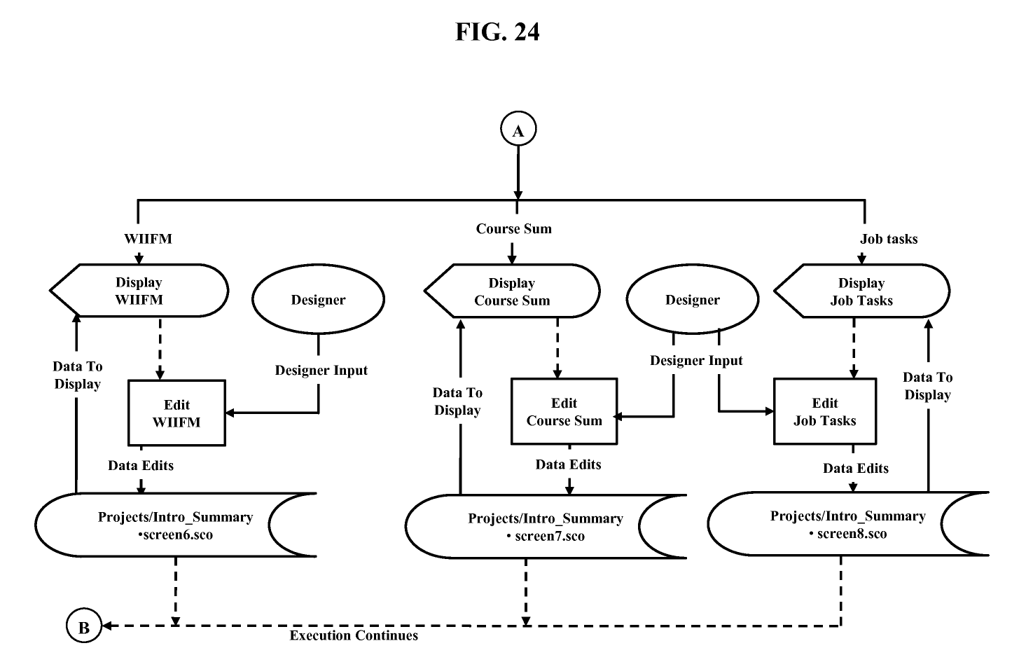

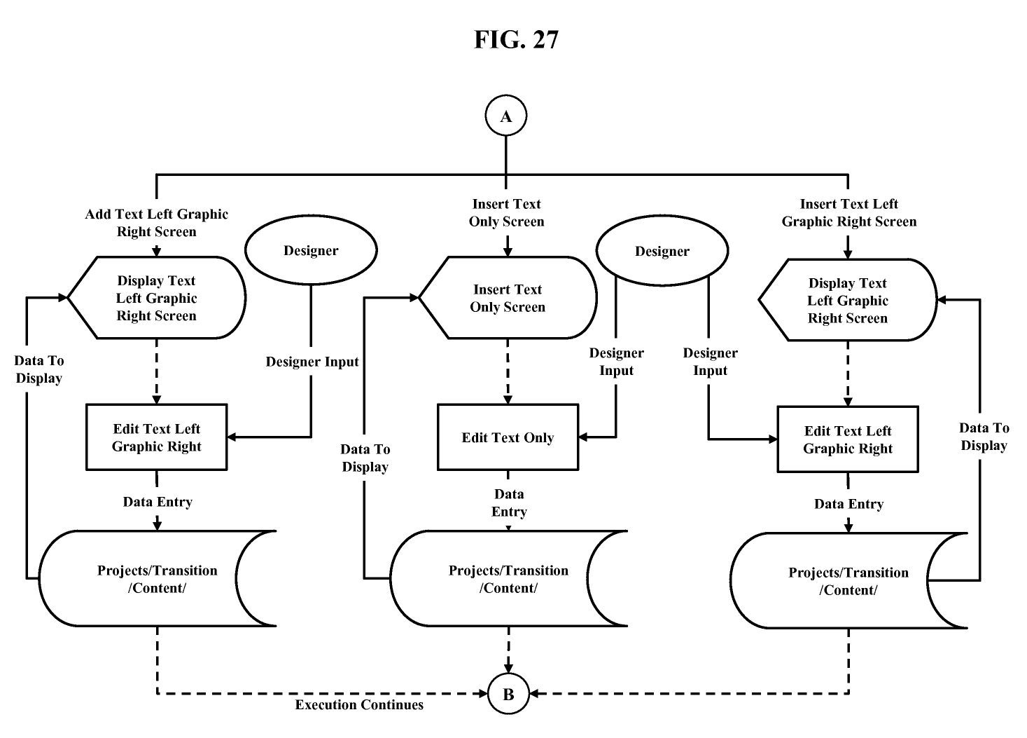

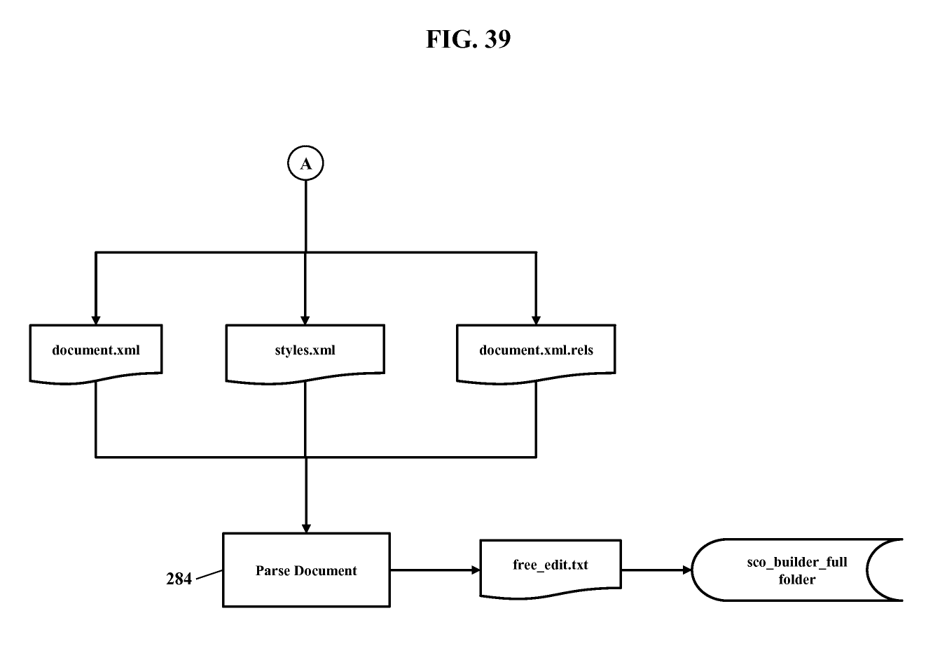

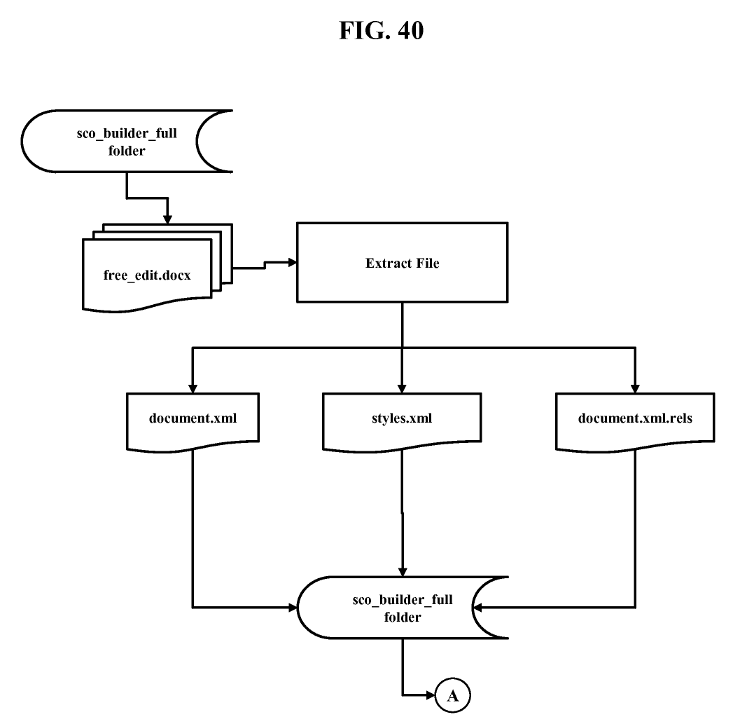

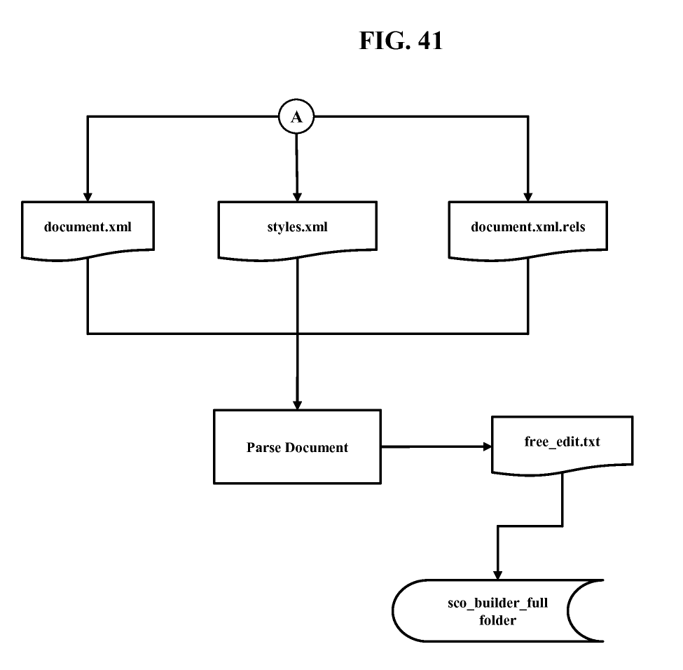

Before the software componentry of the SCOBi application 24 is explained, FIG. 5 is a schematic illustrating diagramming symbols that are used in the drawings. The software structure of the SCOBi application 24 may be illustrated as a hybrid of both a data flow diagram and a process flow diagram. The majority of the representation is typical data flow structure, documenting the inflow of data, the processes that generate or handle data, and the resulting output. Typically a data flow structure does not show order of operation, but because the SCOBi application 24 may be written in AUTHORWARE®, the SCOBi application 24 was organized and written in a tree structure (AUTHORWARE® is a registered trademark of Adobe Systems Incorporated). FIGS. 5-42 may be organized by general run time order, with initialization of the overall system, initialization of a project type and ultimately the data structures of the input screens. Future plans are to rebuild all AUTHORWARE® components in JAVA°.

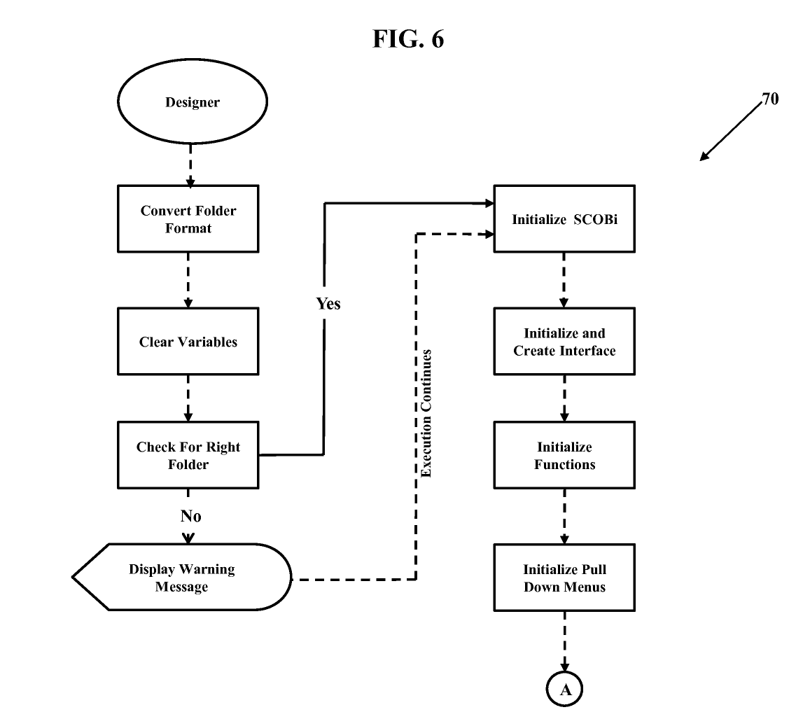

FIGS. 6-10 are schematics illustrating the SCOBi core application 70, according to exemplary embodiments. The SCOBi core application 70 is the main program that ties all of the SCOBi sub-systems together into the wholly functional SCOBi application 24. The SCOBi core application 70 provides the main user interface that the designer sees and interacts with upon first starting the SCOBi application 24. This main interface serves as a gateway to all of the software features provided by the SCOBi sub-systems. The SCOBi core application 70 may present a main menu bar that contains graphical menus that pertain to each of the project types SCOBi can be used to produce and edit. At this level of execution, each menu allows the user to create or edit an existing project of the type the menu pertains to. The SCOBi core application 70 allows the designer to create or edit the following types of projects:
Content SCO,
Intro/Summary SCO,
Transition SCO, and/or
Call Center Simulation.
   The SCOBi core application 70 may also allow the designer to create or edit additional project types.

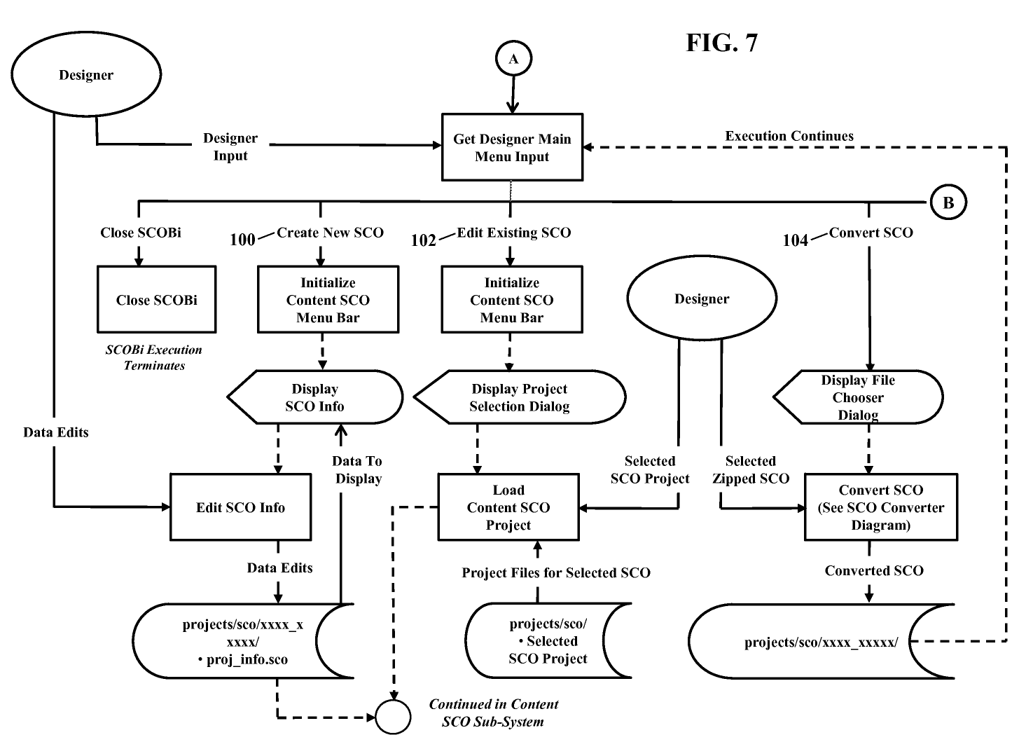

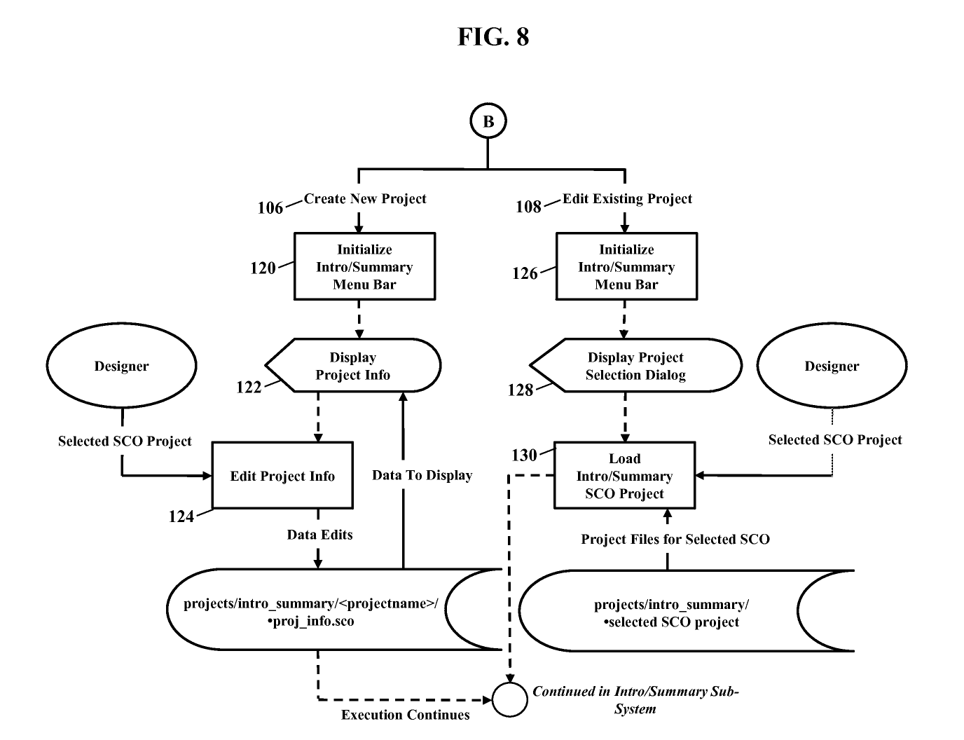

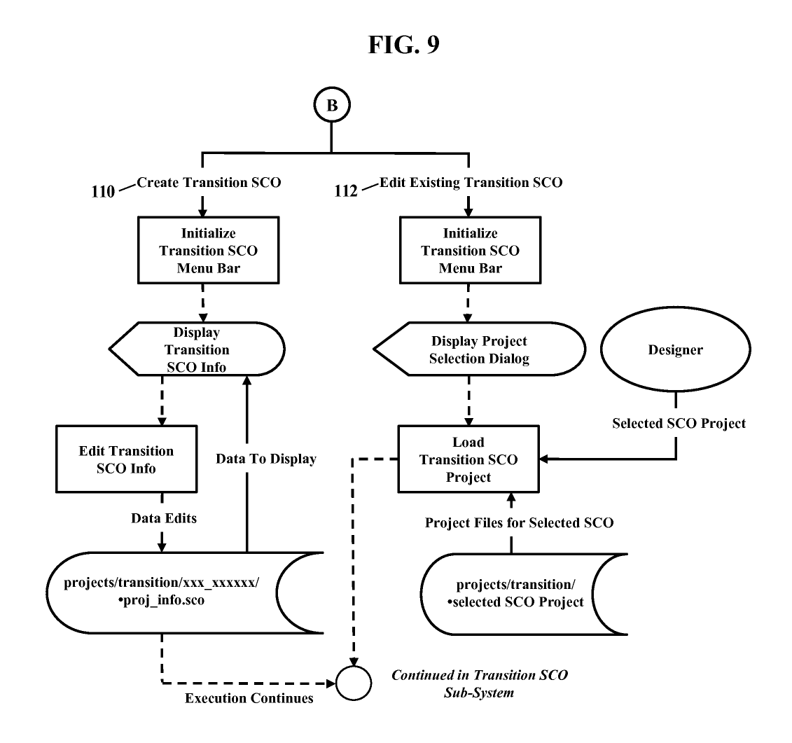

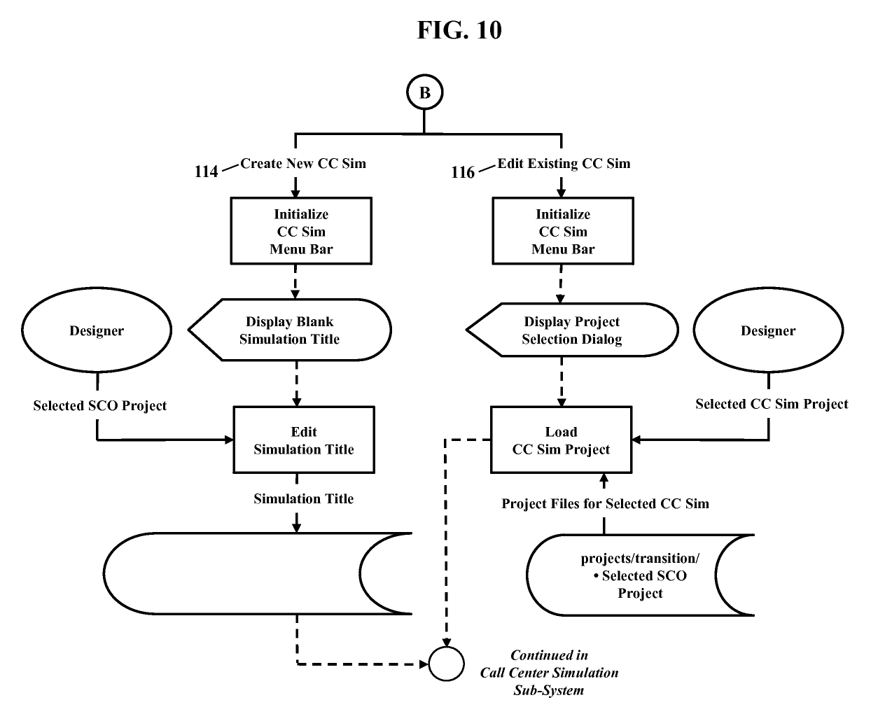

The ideas of execution are the same regardless of project type, and are outlined in FIGS. 7-10. As FIG. 7 illustrates, the designer may choose to create a new SCO (Block 100), edit an existing SCO (Block 102), or convert an existing SCO (Block 104). The main menu continues with FIG. 8, which illustrates options for creating a new project (Block 106) or editing an existing project (Block 108). The main menu continues with FIGS. 9 and 10, which respectively illustrate options for creating a transition SCO (Block 110), editing an existing transition SCO (Block 112), creating a new CC simulation (Block 114), or editing an existing CC simulation (Block 116).

FIG. 8 provides an exemplary menu selection process. When the designer chooses Create New <project type> from a menu, the designer accesses or initializes a <project type> submenu (Block 120) and displays the project info for <project type> (Block 122). An Edit Project Info process (Block 124) takes in new data from the designer, and the Edit Project Info process stores new data to the memory 26 (such as the designer's hard drive). Execution continues onward to the sub system pertaining to <project type>. When the designer chooses to edit an existing project, the designer chooses the Edit Existing <project type> from a menu (Block 108). A <project type> submenu is initialized (Block 126), and a Project Selection Dialog is displayed (Block 128), which allows the designer to choose an existing type of project (e.g., “<project type>”). The selected project is loaded or retrieved from the memory 26 (Block 130), and execution continues onward to the sub system pertaining to <project type>.

The type of projected entitled “Call Center Simulations” may not have project info like the other project types. The “Call Center Simulations” may, instead, have “Simulation Titles.” These are in place of “project info” in the illustrated steps. Additionally, the SCOBi core application 70 may give the designer a way to convert the sharable content object 40 in the SWRI format into a Content SCO project that can then be packaged as a formatted SCOBi SCO (such as in a corporate training format), thus converting the sharable content object 40. Lastly, the SCOBi core application 70 may provide means for the designer to close the software when he/she is finished using it.

Inputs are accepted and outputs are generated. The designer inputs commands and/or data during runtime. The SCOBi core application 70 may then produce outputs depending on what the designer chooses to do during runtime. The SCOBi core application 70, for example, may out a packaged SCO (in both zipped and unzipped forms), a newly created SCO and CC Sim Project File Structures (which get populated with .sco text files by the SCOBi sub-systems), and/or a converted SCO project. The SCOBi core application 70 may interface with the designer, the host environment (such as the designer's computer), a Content SCO Sub-System, an Intro/Summary SCO Sub-System, a Transition SCO Sub-System, a Call Center Simulation Sub-System, and/or a SCO Converter.

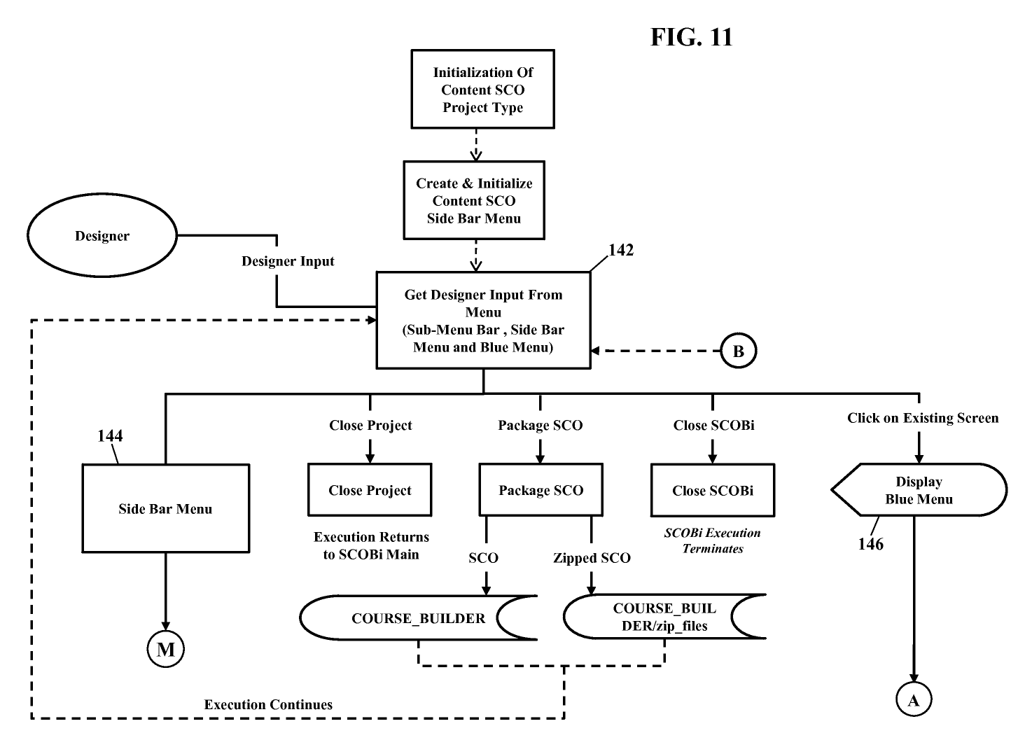

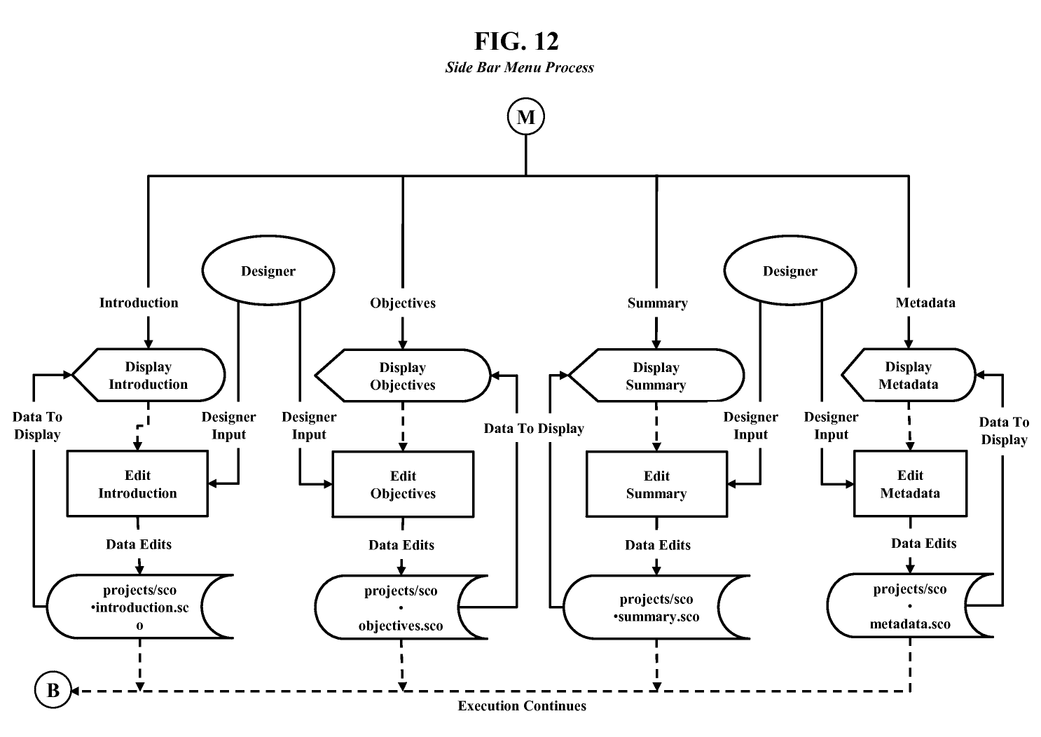

FIGS. 11-20 are schematics illustrating the Content SCO Sub-System 140, according to exemplary embodiments. This process will take designer inputs at runtime to the requisite text files that collectively represent an SCO project. The SCOBi application 24 can then be used to package (export) the SCO in the SCOBi SCO format. The designer's menu selection is received (Block 142). When the designer selects a side bar menu process (Block 144), the process continues with FIG. 12. After the process of FIG. 12 is logically performed, the process returns to FIG. 11 and receives another input from the menu (Block 142).

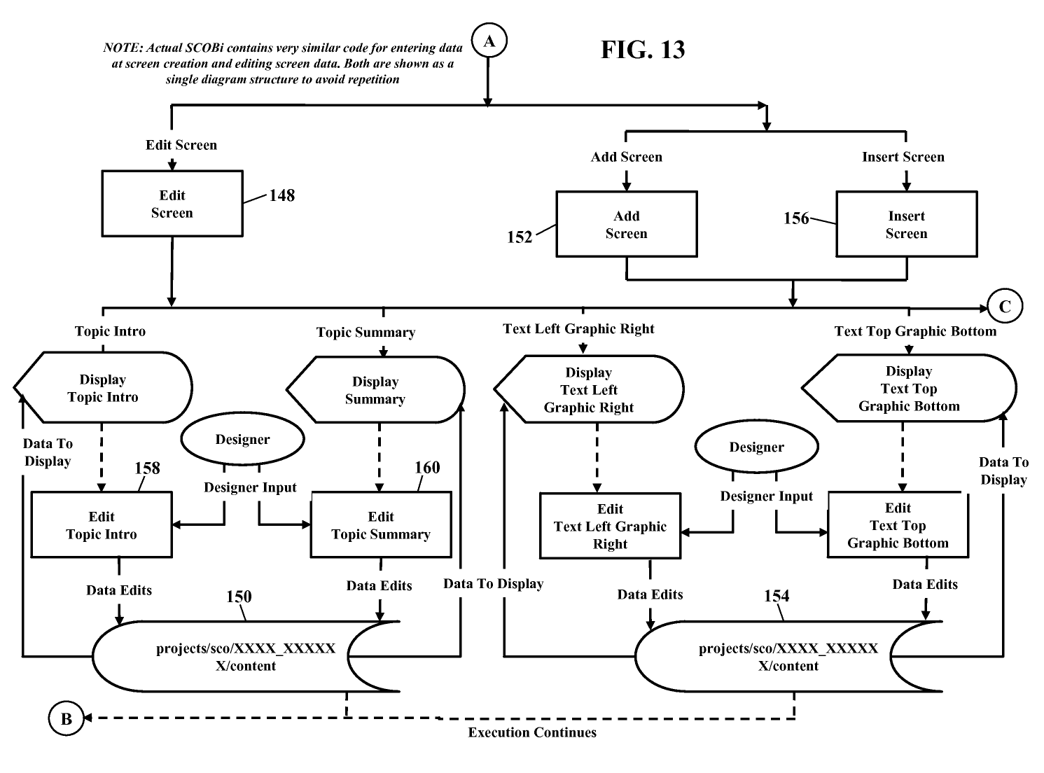

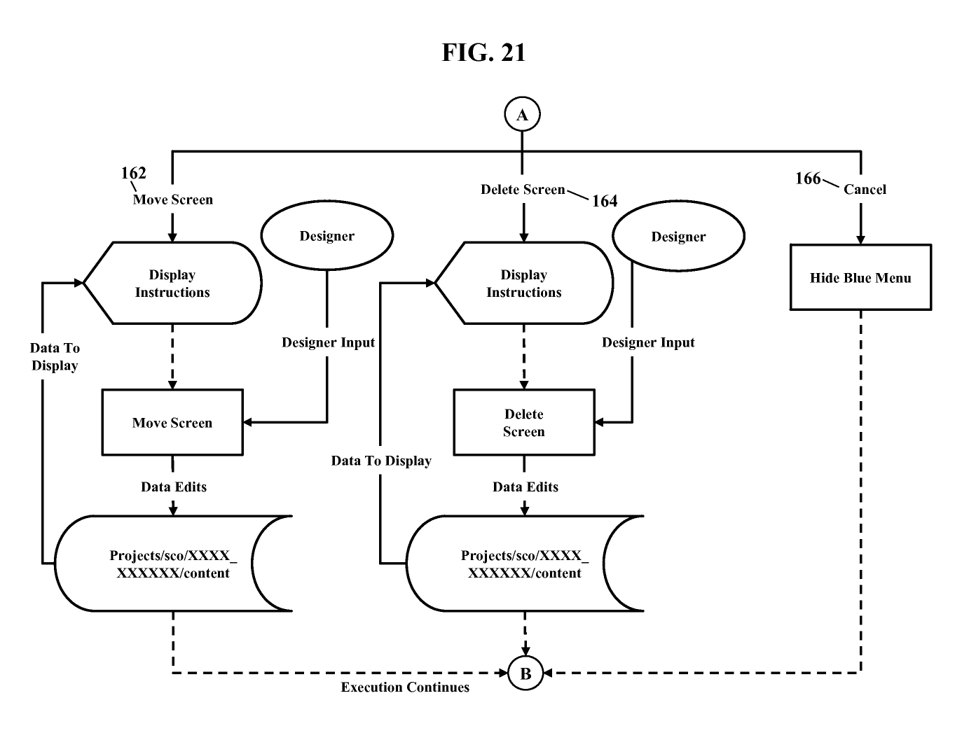

When the designer chooses to display a “blue” menu (Block 146), the process continues with FIGS. 13-21. FIGS. 13-20 illustrate several different menu options that may be selected by the designer. The designer's selection is logically completed and execution returns to Block 142 of FIG. 11. An Edit Screen option (Block 148 of FIG. 13), for example, populates current screen data to the Designer, and when the Designer saves the screen, the screen data will be saved in a text file at projects/sco/xxxx-xxxxxx/content (Block 150). An Add Screen option (Block 152) populates a screen data to the Designer, and when the Designer saves the screen, the screen data will be saved in a text file at projects/sco/xxxx-xxxxxx/content (Block 154). An Insert Screen option (Block 156) will populate a screen to the Designer, and when the Designer saves the screen, the screen data will be saved in a text file at projects/sco/xxxx-xxxxxx/content (Block 154). An Edit Topic Intro (Block 158) uses the Designer's edited data to generate a t010-screen010.sco file. This file is stored at projects/sco/xxxx-xxxxxx/content (Block 154). An Edit Topic Summary (Block 160) uses the Designer's edited data to generate a t0xx-screen0xx.sco file. This file is stored at projects/sco/xxxx-xxxxxx/content (Block 154). An Edit Screen Types uses the Designer's edited data to generate the necessary number and type of screen type text files. All such files are named with the proper naming convention and have the .sco file extension. All of these files are stored at projects/sco/xxxx-xxxxxx/content/. A Move Screen option (Block 162 of FIG. 21) populates some instructions to the designer which allows the designer to move the screen. A Delete Screen option (Block 164 of FIG. 21) populates a popup box to the designer in order to delete a screen. A Cancel process (Block 166 of FIG. 21) hides the Blue Menu bar.

The Content SCO sub-system 140 may also receive inputs and generate outputs. The inputs may be the designer's inputs, while the output may be a packaged SCO (in both zipped and unzipped forms). The output may include a series of text files that represent an entire SCO Project (SCO) to the SCOBi core application 70. These text files may have an extension of .sco, and may be stored at sco_builder_full/projects/sco/content/. This folder can contain anywhere from 2 to n content files, depending on the number and type of screens chosen by the designer (where n is any integer value). Each output text file corresponds to a screen chosen by the designer, and each output text file may contain the screen type and the data to populate the screen. The data contents of these files may be marked up with SCOBi markup. These files may also be named with the proper SCOBi naming convention and the .sco file extension. Consider, for example, the filename “t010-screen230.sco,” where “t010” indicates topic 1 of the SCO, and “screen230” indicates screen 23 of topic 1. The filename “t020-screen040.sco” has “t020” as topic 2 of the SCO, and “screen040” indicates screen 40 of topic 2.

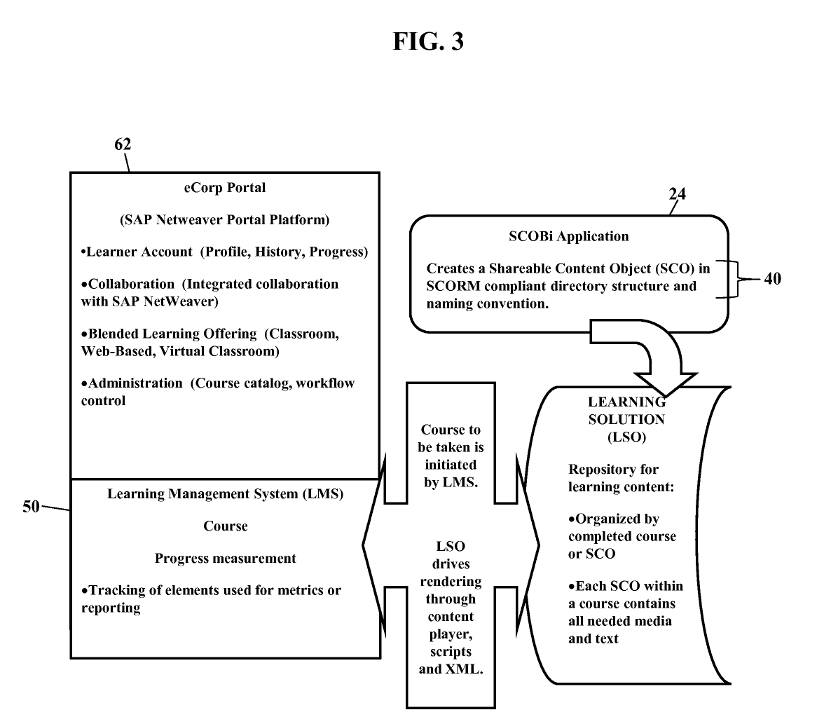

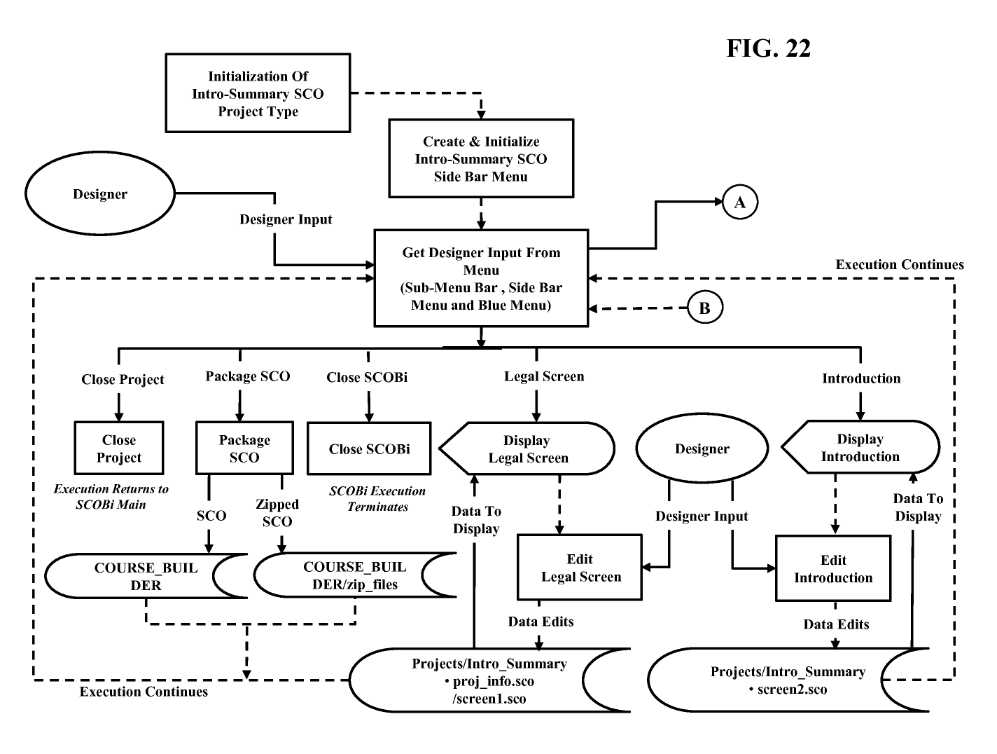

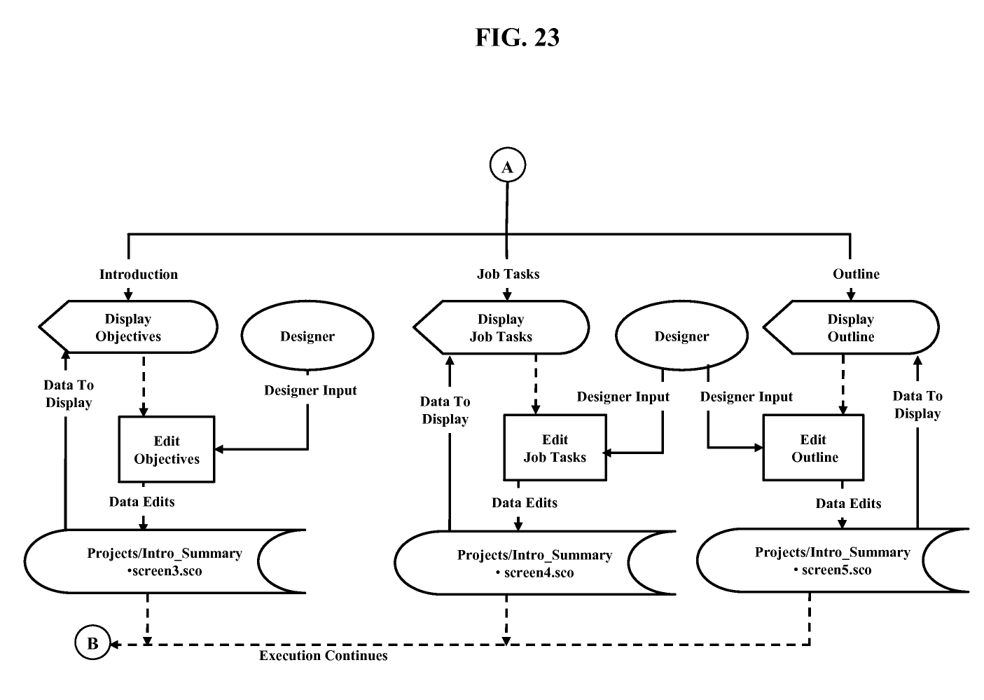

FIGS. 22-24 are schematics illustrating an Introduction/Summary subsystem 180, according to exemplary embodiments. The Introduction/Summary subsystem 180 provides the user interface 26 and functionality that give the designer the ability to enter original data and/or edit existing data for a SCOBi Intro/Summary Project. This data is stored in .sco text files that collectively make up an Intro/Summary project. Additionally, the Introduction/Summary subsystem 180 gives the designer the ability to package an Intro/Summary project into valid Introduction and Summary SCOs, which can then be hosted on the learning solution (illustrated in FIG. 3) and used in educational courseware.

The Introduction/Summary subsystem 180 produces .sco text files. The files may be, for example, “screen1.sco,” “screen2.sco,” “screen3.sco,” “screen4.sco,” “screen5.sco,” “screen6.sco,” and “screen7.sco.” These files are stored at sco_builder_full/ intro_summary /<project name>/. Intro/Summary SCO Projects differ from the other SCO project types in that they have a pre-determined number and type of screens that they can contain. The ideas of execution are the same regardless of the specific screen being edited. The execution steps for both editing a screen and packaging a SCO are outlined below.
Edit Screen
1. Designer selects screen <screen name> to edit
2. Display <screen name> process reads in data for specific screen from designer's hard drive
3. Designer Edits <screen name> Screen data
4. Designer Edits are saved to the designer's hard drive
Package SCO
1. Designer Chooses Package SCO from submenu
2. Package SCO process packages the SCO
3. Unzipped and zipped SCOs are stored on the users hard drive at COURSE BUILDER and COURSE BUILDER/zip_files/respectively.
   The packaged sharable content object 40 may rely on WINZIP® software. The inputs are again designer data and commands, and the outputs may be Introduction and Summary SCOs (in both zipped and unzipped forms). The Introduction/Summary subsystem 180 may interface with the designer, the SCOBi core application 70, and WINZIP® software.

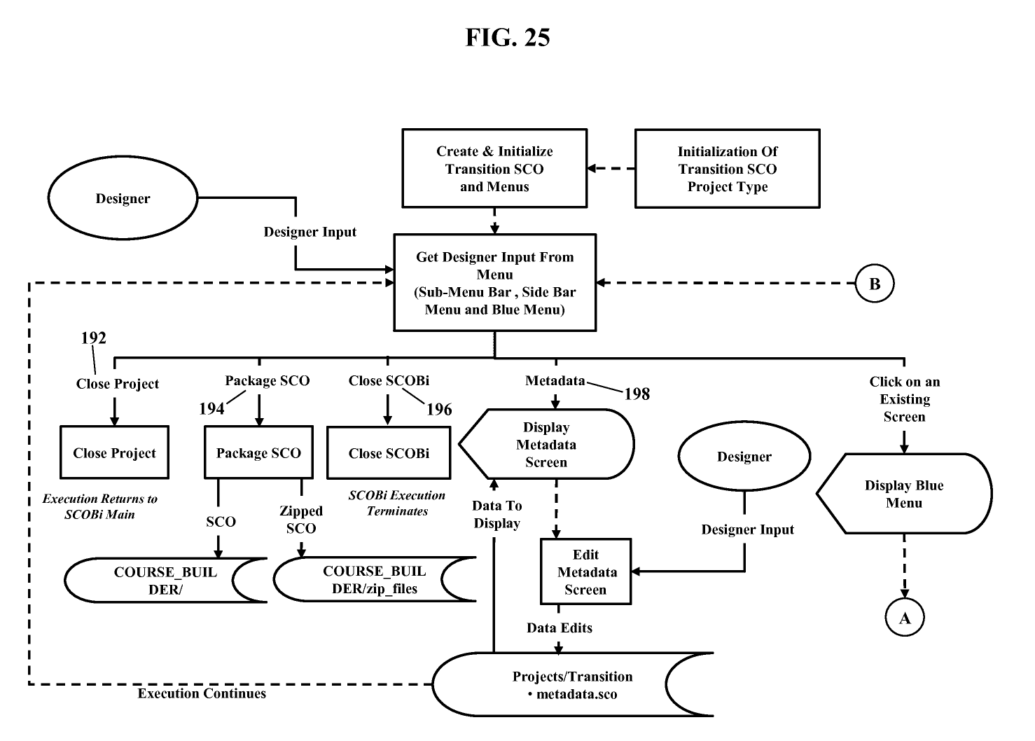

FIGS. 25-28 are schematics illustrating a transition SCO subsystem 182, according to exemplary embodiments. The transition SCO subsystem 182 accepts designer inputs at runtime to the requisite text files that collectively represent an SCO project. The SCOBi application 24 may then package or export the SCO in the SCOBi SCO format. This project type allows the designer to choose from three (3) menus, termed the “Blue Menu Bar,” the “Menu Bar,” and the “Side Menu Bar.”

Blue Menu Bar

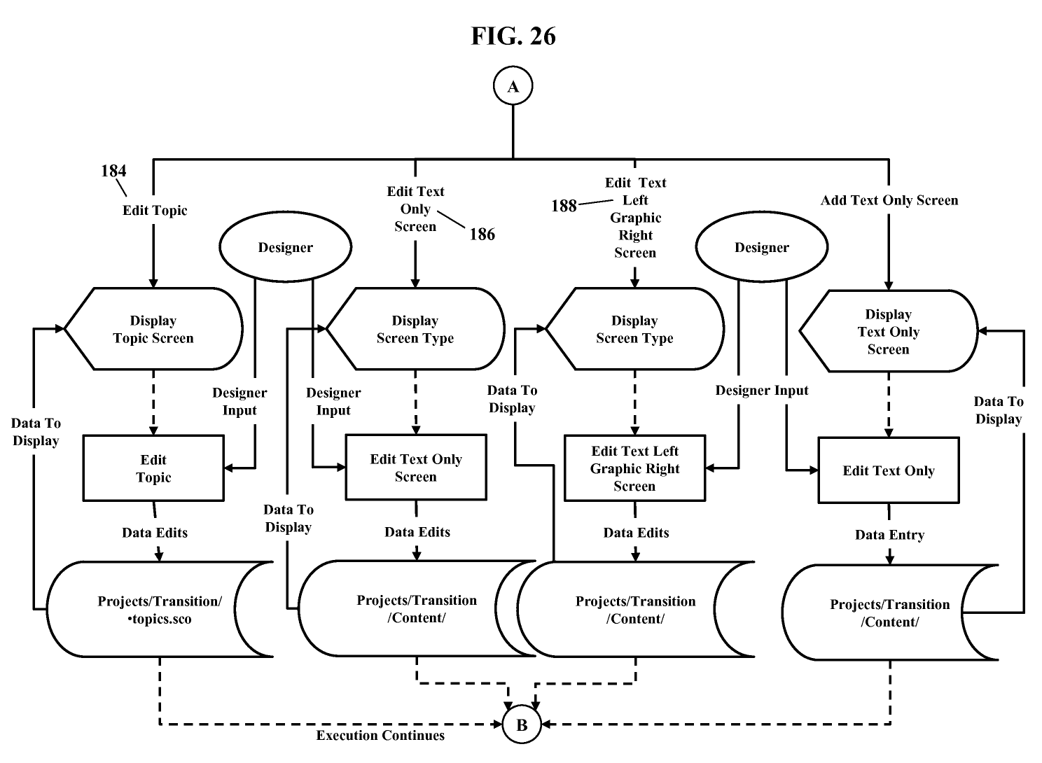

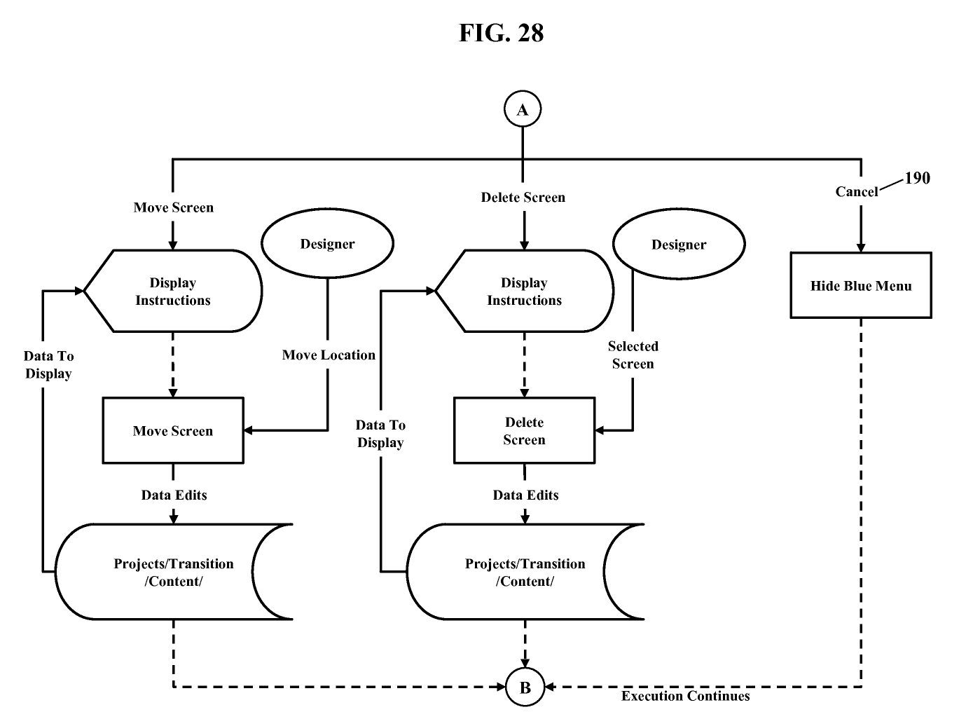

The Blue Bar Menu permits the designer to “Edit/Add/Insert/Move/Delete” the following two different screen types that can be included in a Transition SCO.
Text Left Graphic Right
Text Only
   Edit Topic (Block 184 of FIG. 26) displays Topic screen data to the Designer, and when the Designer saves the screen, the screen data will be saved in a t0xx-screen0xx.sco text file at sco_builder_full/projects/transition/xxxx-xxxxxx/content. Edit Screen displays current screen data to the Designer, and when the Designer saves the screen, the screen data will be saved in a .sco text file at sco_builder_full/projects/transition/xxxx-xxxxxx/content. Edit Text Only (Block 186) displays a Text Only screen data to the Designer, and when the Designer saves the screen, the screen data will be saved in a .sco text file at sco_builder_full/projects/transition/xxxx-xxxxxx/content. Edit Text Left Graphic Right (Block 188) displays a Text Left Graphic Right screen data to the Designer, and when the Designer saves the screen, the screen data will be saved in a .sco text file at sco_builder_full/projects/transition/xxxx-xxxxxx/content. A Cancel (Block 190 of FIG. 28) process hides the Blue Menu bar.

Menu Bar

Using Menu Bar the designer can “close Project /package/close SCOBi.” Close Project (Block 192 of FIG. 25) allows the designer to close the current project type and the execution returns to the SCOBi main application. Package SCO (Block 194) allows the designer to package an SCO in both zipped and unzipped forms. The zipped SCO is stored at COURSE_BUILDER/zip_files/ and the unzipped SCO is stored at COURSE_BUILDER/. Close SCOBi (Block 196) allows the designer to terminate the execution of the SCOBi application 24.

Side Menu Bar

Using the Side Bar Menu the designer can add/edit Metadata screens. Edit Metadata (Block 198) displays Metadata screen data to the designer. When the Designer saves the screen, the screen data will be saved in a metadata.sco text file at sco_builder_full/projects/transition/xxxx-xxxxxx.

The transition SCO subsystem 182 also has inputs and outputs. The inputs are designer commands during runtime. The output is a packaged SCO (in both zipped and unzipped forms). The packaged SCO may include a series of text files that represent an entire SCO Project (SCO) to the SCOBi core application 70. These text files have an extension of .sco, and are stored at sco_builder_full/projects/ transition/xxxx-xxxxxx/ and sco_builder_full/projects/transition/xxxx-xxxxxx/content/ . Any text files that are stored at sco_builder_full/projects/transition/xxxx-xxxxxx/ contain metadata.sco. Any text files that are stored at sco_builder_full/projects/transition/xxxx-xxxxxx/content/ contain anywhere from 2 to n content files, depending on the number and type of screens chosen by the designer, where n is an integer. Each output text file corresponds to a screen chosen by the designer and contains the screen type and the data to populate the screen. The data contents of these files are marked up with SCOBi markup. These files are named with the proper SCOBi naming convention and the .sco file extension. For example, t010-screen230.sco may be used, where “t010” indicates topic 1 of the SCO, and “screen230” indicates screen 23 of topic 1. The filename t020-screen040.sco similarly indicates “t020” as topic 2 of the SCO and “screen040” indicates screen 40 of topic 2. The transition SCO subsystem 182 may interface with the designer, the SCOBi core application 70, and WINZIP® Software.

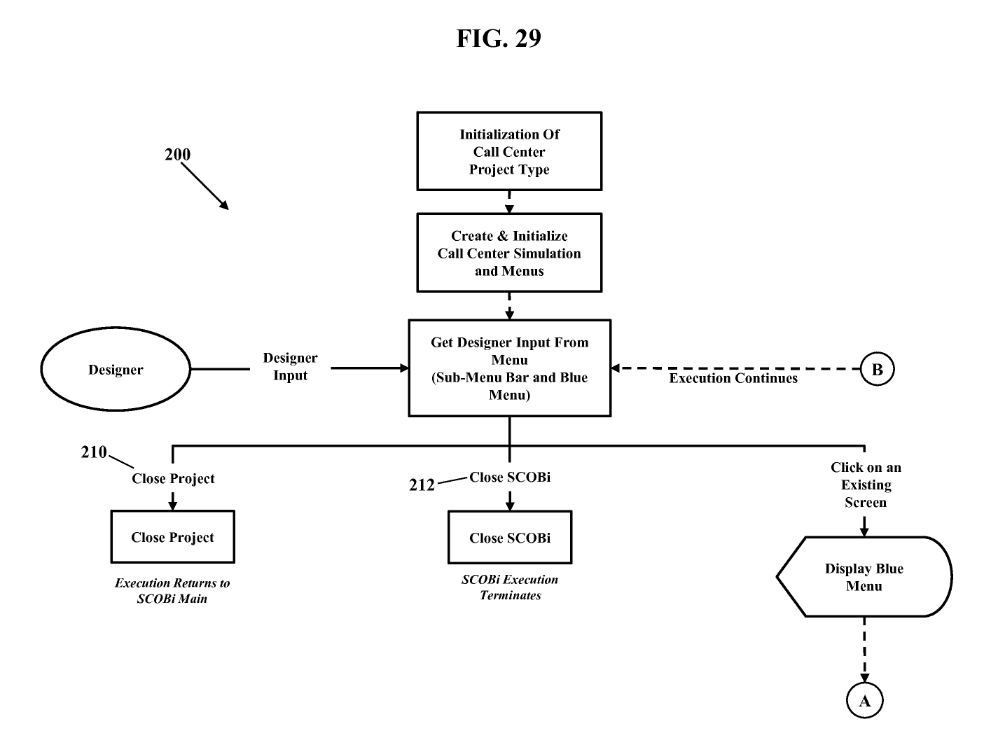

FIGS. 29-31 are schematics illustrating a call center subsystem 200, according to exemplary embodiments. This process will take designer inputs at runtime to the requisite text files that collectively represent an SCO project. The SCOBi application 24 can then be used to package (export) the SCO in the SCOBi SCO format. This project type provides the designer to choose from two Menus.

Blue Menu Bar

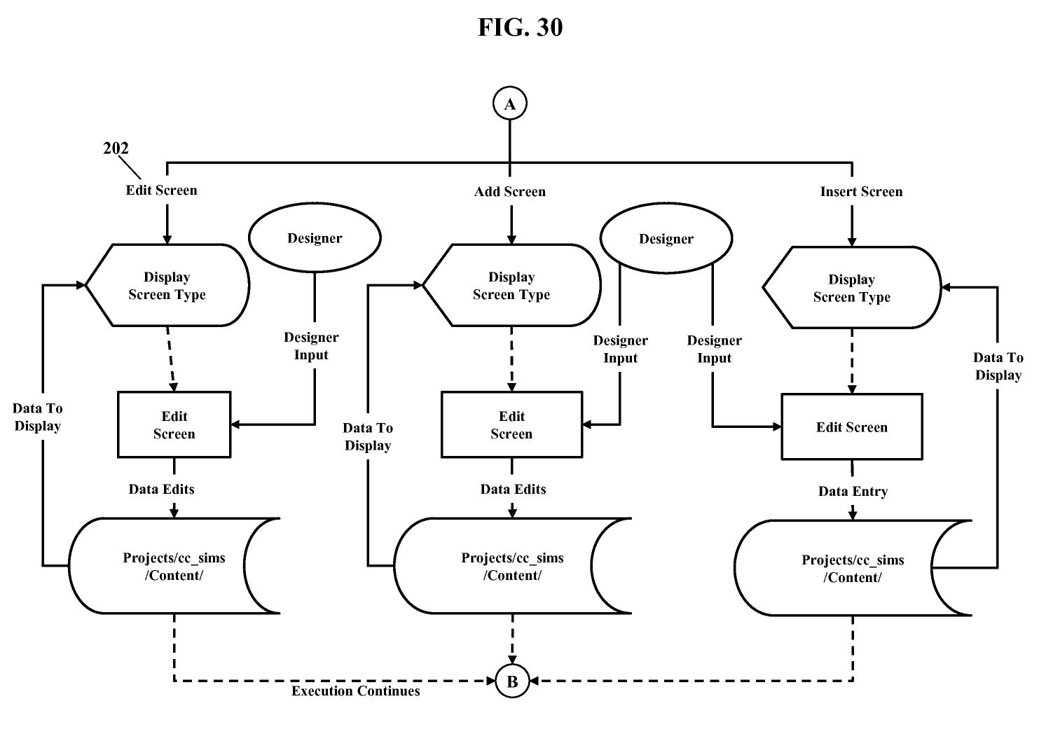

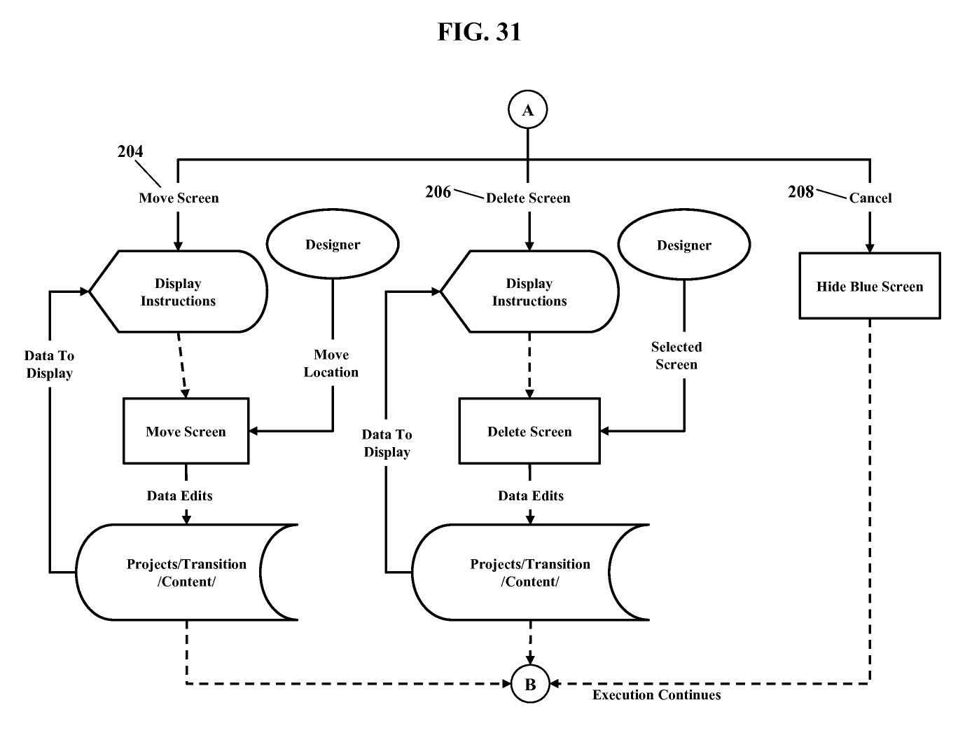

Using the Blue Bar Menu the designer can “Edit/Add/Insert/Move/Delete” the following nine (9) different screen types that can be included in a Transition SCO.
Single Step Simulation Graphic
Single Step Simulation SWF
Multiple Choice Single Answer
Multiple Choice Multiple Choice Multiple Answers
Classification Array Single Answers
Classification Array Multiple Answers
Create Results Screen
Begin Object Reinforcement
End Object Reinforcement
   Edit Screen (Block 202 of FIG. 30) displays current screen data to the Designer. When the Designer saves the screen, the screen data will be saved in an .sco text file at sco_builder_full/projects/cc_sims/xxxxxx/content. Move Screen (Block 204 of FIG. 31) displays instructions to the designer which allows the designer to move the screen. The SCOBi application 24 moves the corresponding .sco text file to appropriate location and the remaining .sco text files will be rearranged by the SCOBi application 24. Delete Screen (Block 206) displays a popup box to the designer in order to delete a screen. The SCOBi application 24 deletes the corresponding .sco text file from sco_builder_full/projects/cc_sims/xxxxxx/content and the remaining .sco text files will be rearranged by the SCOBi application 24. The Cancel process (Block 208) hides the Blue Menu bar.

Menu Bar

Returning to FIG. 29, using Menu Bar the designer can “close Project /close SCOBi.” Close Project (Block 210) allows the designer to close the current project type and the execution returns to the SCOBi application 24. Close SCOBi (Block 212) allows the designer to terminate the execution of the SCOBi application 24.

The call center subsystem 200 also has inputs and outputs. The inputs are designer commands during runtime. The output is the packaged SCO (in both zipped and unzipped forms). The packaged SCO may again be a series of text files that represent an entire SCO Project (SCO) to the SCOBi core application 70. These text files have an extension of .sco, and are stored at sco_builder_full/projects/cc_sims/xxxx-xxxxxx/content/. Text files that are stored at sco_builder_full/projects/cc_sims/xxxxxx/content/ may contain anywhere from 1 to n content files, depending on the number and type of screens chosen by the designer, with n being an integer value. Each output text file corresponds to a screen chosen by the designer, and contains the screen type and the data to populate the screen. The data contents of these files are marked up with SCOBi markup. These files are named with the proper SCOBi naming convention and the .sco file extension. The filename screen023.sco, for example, indicates that “screen230” is screen 23. The call center subsystem 200 may interface with the designer, the SCOBi core application 70, and WINZIP® Software.

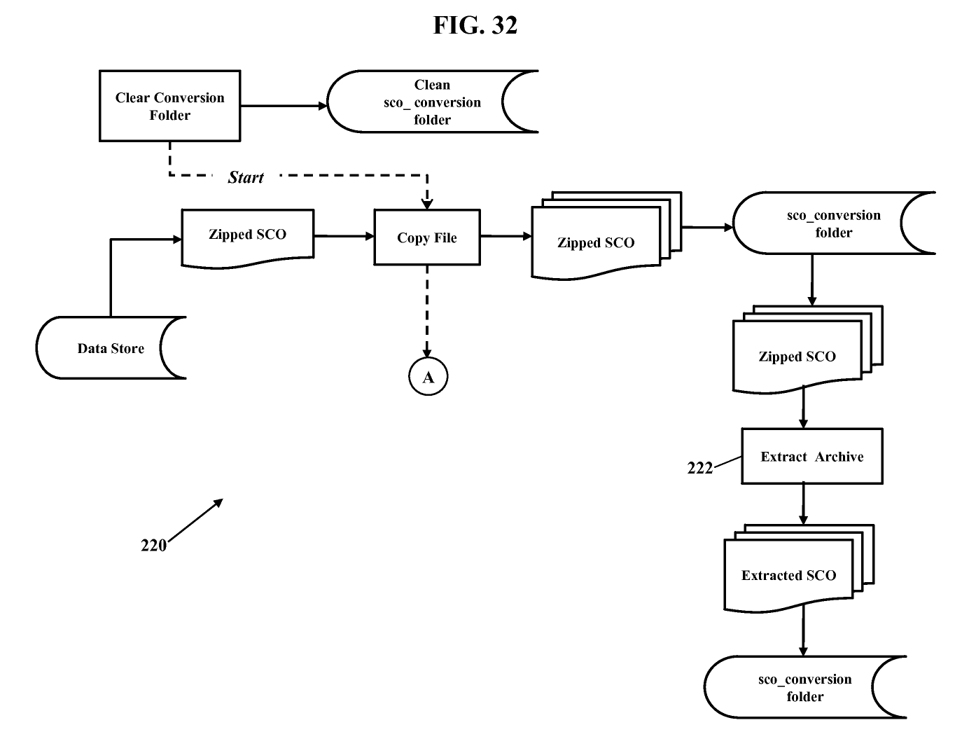

FIGS. 32-36 are schematics illustrating the SCO converter subsystem 220, according to exemplary embodiments. The SCO converter subsystem 220 converts a zipped SCO in the SWRI format to the requisite text files that collectively represent a SCO project to the SCOBi application 24. The SCOBi application 24 can then be used to package (export) the SCO in the SCOBi SCO format. The SCOBi SCO format is a standardized format utilized by AT&T and many other entities. Thus, the original SCO is converted from one format to another. This process generates the SCOBi SCO project text files. The sco_content.xml file defines the number and type of the screens, and the data these screens are populated with, for the SCO being converted. All of the sco_conversion folder's contents may be deleted, except for the scobiProjectFileStructure and its contents. This results in an empty or “clean” conversion folder.

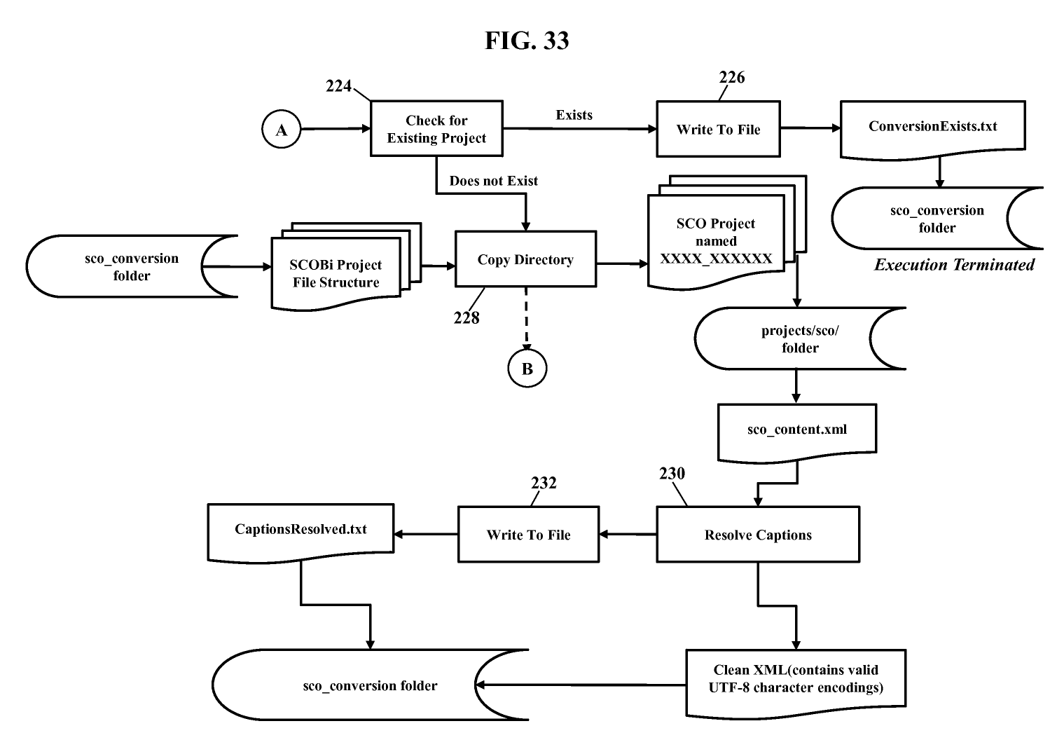

The SCO converter subsystem 220 may perform any of the following. The zipped SCO, selected by the designer, is copied from whatever location it resides in to the sco_conversion folder. Extract Archive (Block 222) extracts the zipped SCO to the sco_conversion folder. Check for Existing Project (Block 224 of FIG. 33) checks to see if a project with the same name as the zipped SCO exists in the projects/sco/ folder. If the project already exists, then Write To File (Block 226) writes out a ConversionExists.txt file to the sco_conversion folder. This text file contains a message indicating this situation, which the SCOBi core application 70 checks for and reads in to display this message to the designer. If the project does not exist, then execution continues onward to Copy Directory (Block 228). Copy Directory copies the scobiProjectFileStructure stored in the sco_conversion folder to the sco folder located at sco_builder_full/projects/. The file scobiProjectFileStructure is renamed, using the proper SCOBi naming convention, to sco_xxxx-xxxxxx (where the x's are numerical digits).

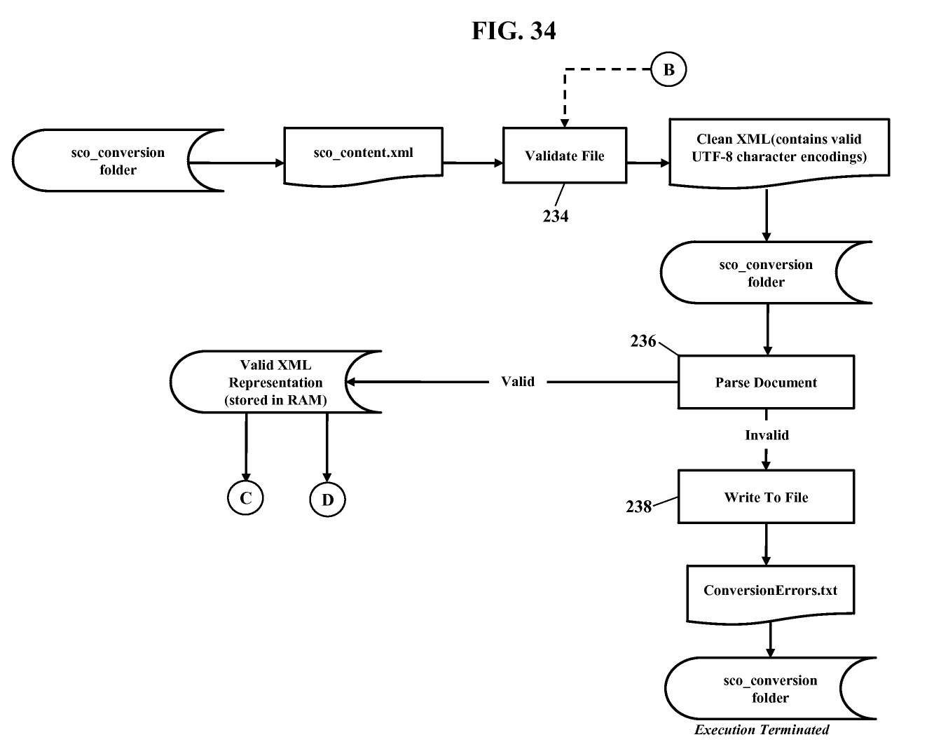

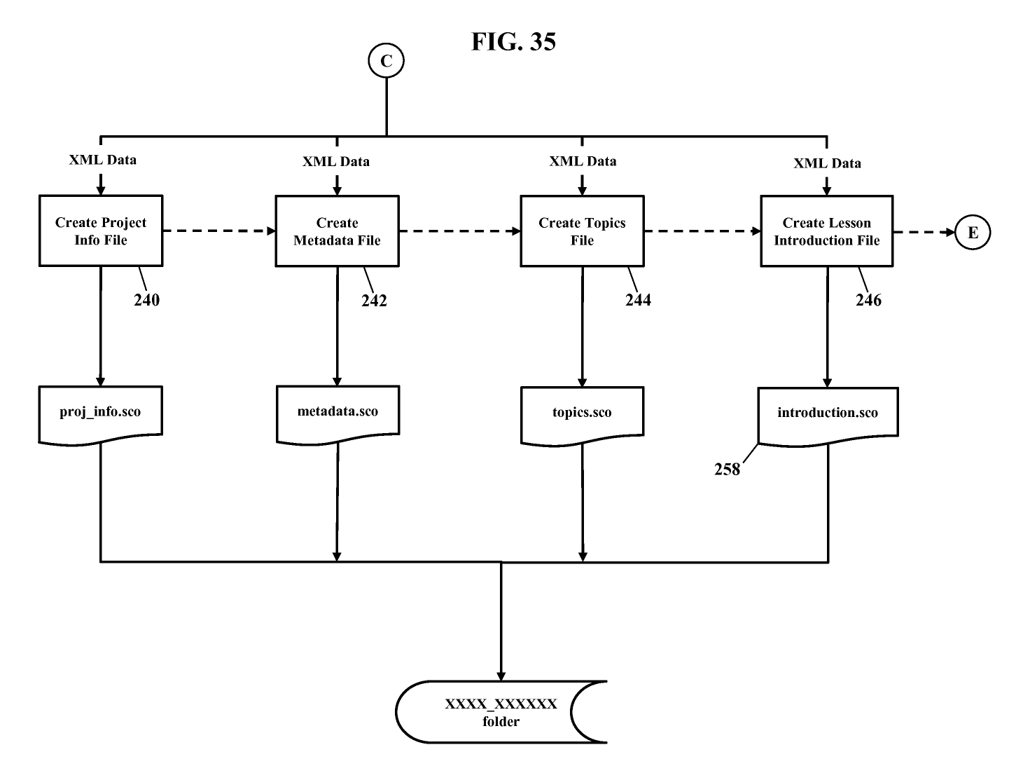

The SCO converter subsystem 220 may perform additional functions. Resolve Captions (Block 230) reads in sco_content.xml line by line and replaces any troublesome special characters in the media captions with the appropriate HTML character entity. This is done as a pre-check to ensure that the XML will not be rejected by the Java XML DOM parser. Resolve Captions outputs a new version of the sco_content.xml that has the special characters in the media captions removed (resolved captions). This new file replaces the copy of the original sco_content.xml in the sco_conversion folder. Write To File (Block 232) outputs CaptionsResolved.txt and stores it in the sco_conversion folder to indicate to the SCOBi core application 70 that the Captions Resolver (Block 230) has completed its work. Validate File (Block 234 of FIG. 34) reads in the sco_content.xml byte by byte. These bytes are examined for ANSI encoded characters, which may have been erroneously incorporated into the file when its contents were created or updated. Such characters should not be present in a UTF-8 encoded document. If an invalid encoding is encountered, it is resolved with the valid UTF-8 encoding that has the same visual representation as the ANSI character. Validate File outputs a clean sco_content.xml with any invalid UTF-8 characters corrected and/or removed. This new file replaces the copy of the original sco_content.xml in the sco_conversion folder. Parse XML Document (Block 236) takes in sco_content.xml and outputs a representation of the XML tree structure in the memory 26 if the parse is successful, otherwise Write To File (Block 238) writes out ConversionErrors.txt, stores it in the sco_conversion folder, and Execution of the SCO Converter process terminates. The SCOBi core application 70 checks for ConversionErrors.txt and uses it to display an error message to the designer to let them know that the SCO Conversion operation failed. Create Project Info File (Block 240 of FIG. 35) uses data from the SCO content XML tree structure in the memory 26 to generate the proj_info.sco file. This file is stored at projects/sco/xxxx-xxxxxx/.

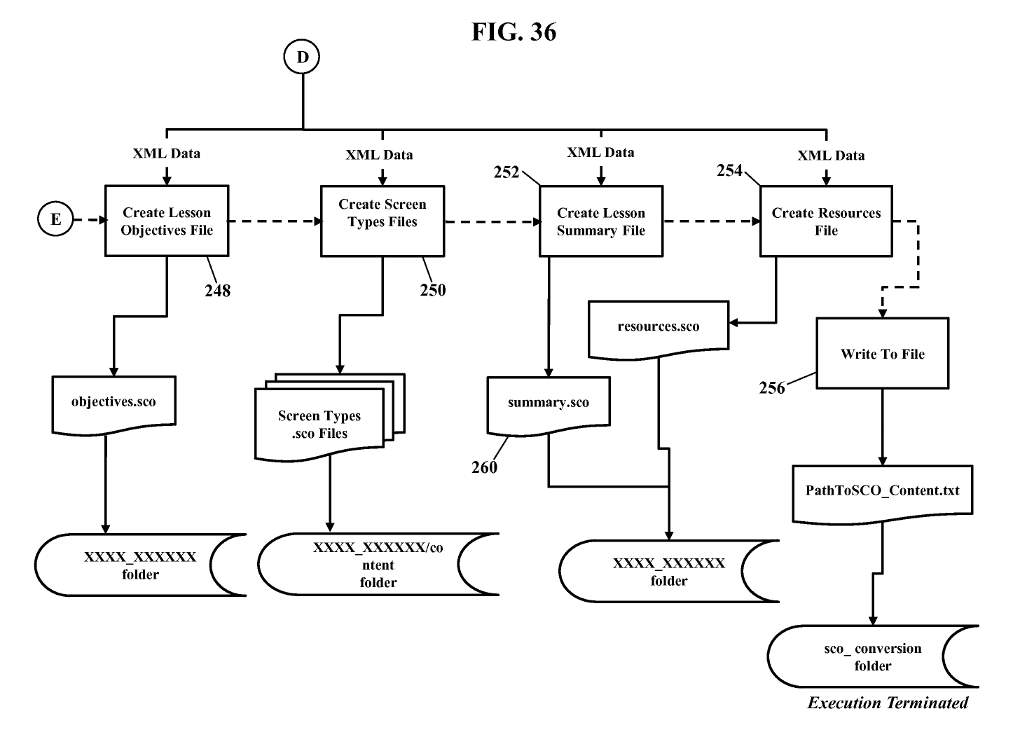

The SCO converter subsystem 220 may perform even more functions or steps. Create Metadata File (Block 242 of FIG. 35) uses data from the SCO content XML tree structure in the memory 26 to generate the metadata.sco file. This file is stored at projects/sco/xxxx-xxxxxx/. Create Topics File (Block 244) uses data from the SCO content XML tree structure to generate the topics.sco file. This file is stored at projects/sco/xxxx-xxxxxx/. Create Lesson Introduction File (Block 246) uses data from the SCO content XML tree structure to generate the introduction.sco file. This file is stored at projects/sco/xxxx-xxxxxx/. Create Lesson Objectives File (Block 248 of FIG. 36) uses data from the SCO content XML tree structure to generate the objectives.sco file. This file is stored at projects/sco/xxxx-xxxxxx/. Create Screen Types Files (Block 250) uses data from the SCO content XML tree structure to generate the necessary number and type of screen type text files from the data stored in the XML tree. All such files are named with the proper naming convention and have the .sco file extension. All of these files are stored at projects/sco/xxxx-xxxxxx/content/. Create Lesson Summary File (Block 252) uses data from the SCO content XML tree structure in the memory 26 to generate the summary.sco file. This file is stored at projects/sco/xxxx-xxxxxx/. Create Resources File (Block 254) uses data from the SCO content XML tree structure in the memory 26 to generate the resources.sco file. This file is stored at projects/sco/xxxx-xxxxxx/. Write To File (Block 256) writes out PathToSCO_Content.txt, which contains the path to the sco_content.xml file, and stores it in the sco_conversion folder. The SCOBi core application 70 uses the path contained in this file to perform its Lesson Introduction (Block 258 of FIG. 35) and Lesson Summary Coach Image operations (Block 260 of FIG. 36).

The SCO converter subsystem 220 also has inputs and outputs. The inputs to the SCO converter subsystem 220 include the zipped SCO that has a correct folder structure and is named with the proper naming convention, sco_xxxx_xxxxxx (where x denotes numerical digits). The output(s) include a series of text files that represent an entire SCO Project (SCO) to the SCOBi core application 70. These text files have an extension of .sco, and are stored at sco_builder_full/projects/sco/ and sco_builder_full/projects/sco/content/. The specific file names and storage locations may be at sco_builder_full/projects/sco/:
introduction.sco
metadata.sco
objectives.sco
proj_info.sco
resources.sco
topics.sco
summary.sco

Text files may also be stored at sco_builder_full/projects/sco/content/. This folder can contain anywhere from two to n content files, depending on the number and type of screens contained in the sco_content.xml file of the SCO being converted. Each output text file corresponds to a screen used in the SCO as defined by the sco_content.xml, and contains the screen type and the data to populate the screen. The data contents of these files are marked up with SCOBi markup, so that the SCOBi core application 70 can read them, parse the data, and generate a SCO Project representation for the designer to work with in the SCOBi application 24. These files are named with the proper SCOBi naming convention and the .sco file extension. Examples of filenames include t010-screen230.sco, where “t010” indicates topic 1 of the SCO, and “screen230” indicates screen 23 of topic 1. Filename t020-screen040.sco indicates “t020” is topic 2 of the SCO, and “screen040” indicates screen 40 of topic 2.

The SCO converter subsystem 220 interfaces with the SCOBi core application 70 via the scoconverter.bat batch file and the series of text files that represent an entire SCO Project (SCO) to the SCOBi core application 70. The SCO converter subsystem 220 may depend the SCOBi core application 70 to launch when needed via the scoconverter.bat batch file.

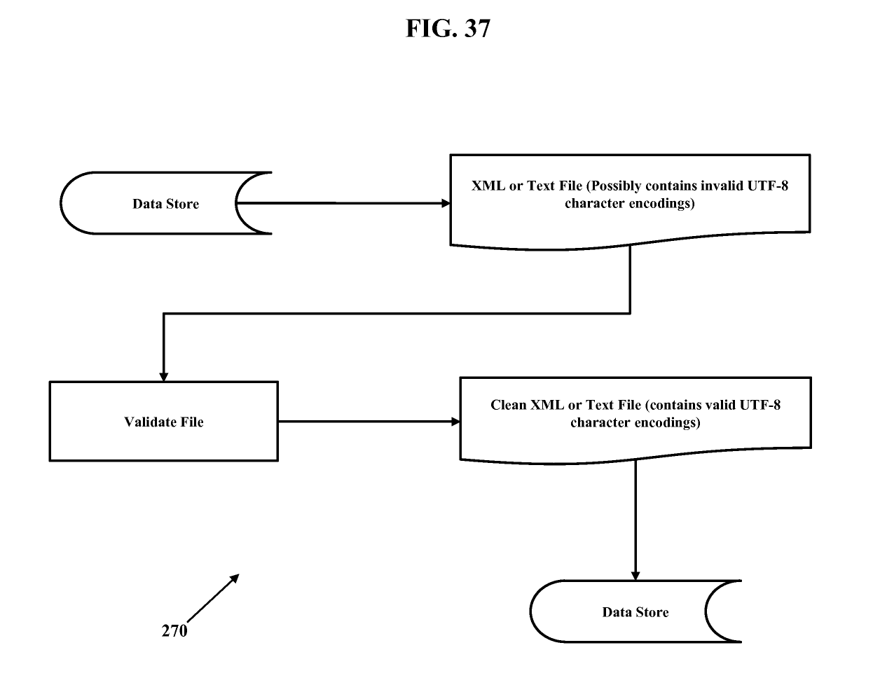

FIG. 37 is a schematic illustrating the special character resolver subsystem 270, according to exemplary embodiments. This process reads in an XML or text file in the UTF-8 character encoding byte by byte. These bytes are examined for ANSI encoded characters, which may have been erroneously incorporated into the file when its contents were created or updated. Such characters should not be present in a UTF-8 encoded document. If an invalid encoding is encountered, it is resolved with the valid UTF-8 encoding that has the same visual representation as the ANSI character. The special character resolver subsystem 270 receives inputs as any XML or text file in UTF-8 character encoding. The special character resolver subsystem 270 outputs a version of the input document with all incorrectly coded UTF-8 characters coded correctly. The special character resolver subsystem 270 interfaces the with SCOBi core application 70 via chars_batch.bat. The special character resolver subsystem 270 depends on SCOBi core application 70 to launch when needed via the chars_batch.bat file.

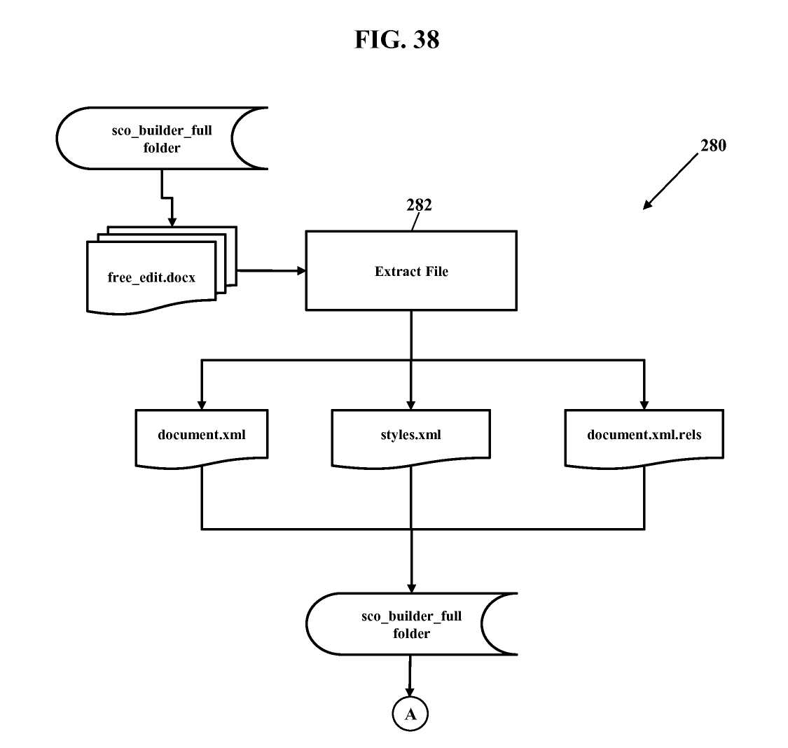

FIGS. 38-41 are schematics illustrating the WORD® document importer subsystem 280, according to exemplary embodiments. The WORD® document importer subsystem 280 accesses the free_edit.docx file stored at sco_builder_full/. Extract File (Block 282) extracts document.xml, styles.xml, and document.xml.rels from free_edit.docx and stores these files at sco_builder_full/. These XML files are then accessed by Parse Document (Block 284 of FIG. 9) and parsed into tree representations in the memory 26. The data in these XML trees are processed to yield the free_edit.txt text file. This text file contains the contents of the free_edit.docx WORD® document marked up with SCOBi Markup. This text file is stored at sco_builder_full/ in the ANSI text format. The SCOBi core application 70 may then read in the file and display. The WORD® document importer subsystem 280 thus receives the free_edit.docx WORD® document as an input and outputs the free_edit.txt text document. The WORD® document importer subsystem 280 interfaces with the SCOBi core application 70 via the editor.bat batch file and the following shared resources:
sco_builder_full\free_edit.docx, and
sco_builder_full\free edit. txt.
   The WORD document importer subsystem 280 may depend on the SCOBi core application 70 to launch when needed via the editor.bat batch file.

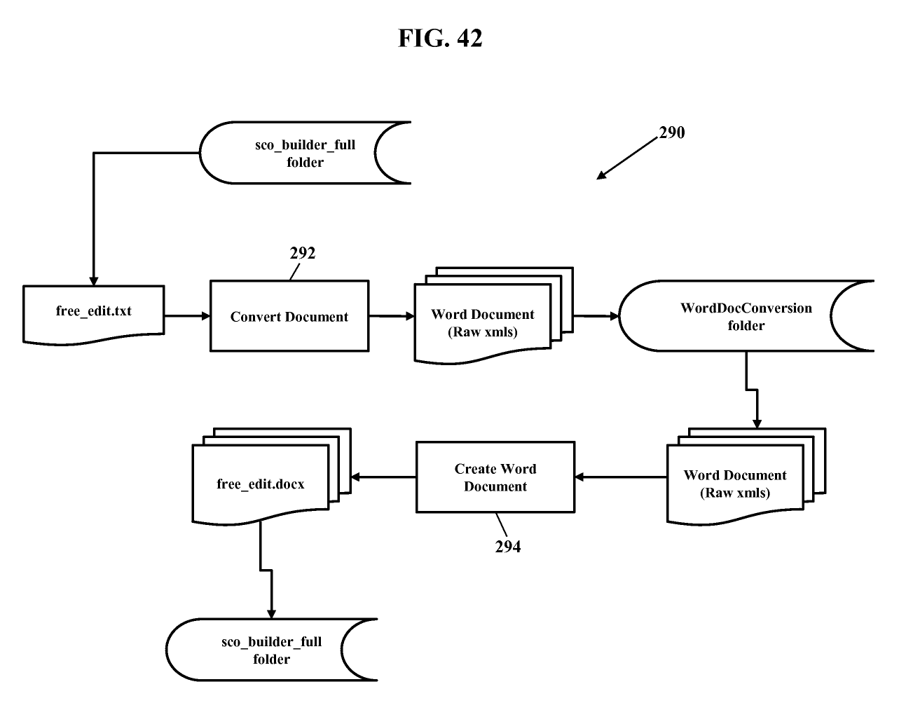

FIG. 42 is a schematic illustrating the WORD® document exporter subsystem 290, according to exemplary embodiments. The WORD® document exporter subsystem 290 accesses the free_edit.txt file stored at sco_builder_full/ . Convert Document (Block 292) converts the free_edit.txt file into document.xml and document.xml.rels and stores these files at wordDocConversion/. These XML files are then accessed by Create Word Document (Block 294) and zipped into a MICROSOFT® OFFICE® Open XML file (a specific type of .zip archive, with an extension of .docx instead of .zip) called free_edit.docx. This file is stored at sco_builder_full/ for the SCOBi core application to launch in WORD®. The WORD® document exporter subsystem 290 receives the free_edit.txt text document as an input and outputs the free_edit.docx as a MICROSOFT® WORD® file. The WORD® document exporter subsystem 290 interfaces with the SCOBi core application 70 via the editor.bat batch file and the following shared resources:
sco_builder_full\free_edit.txt
sco_builder_full\free_edit.docx
   The WORD® document exporter subsystem 290 thus utilizes MICROSOFT′S Open XML technology. This MICROSOFT® feature stores WORD® documents as a collection of XML documents in a zip archive, with the .docx file extension instead of .zip. The WORD® document exporter subsystem 290 depends on the SCOBi core application 70 to launch when needed via the editor.bat batch file.

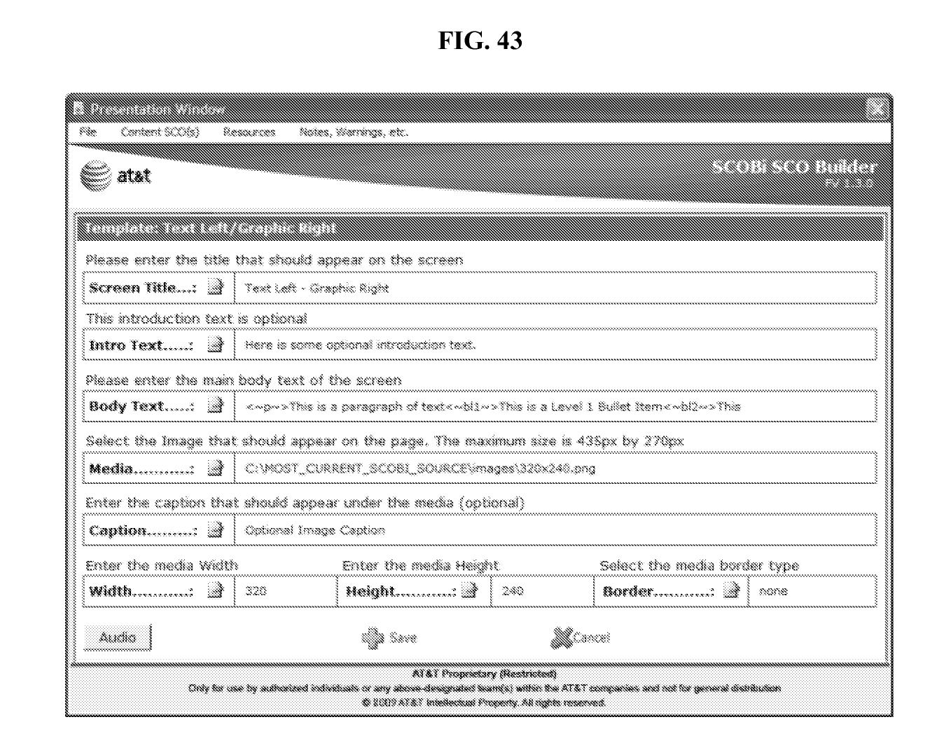

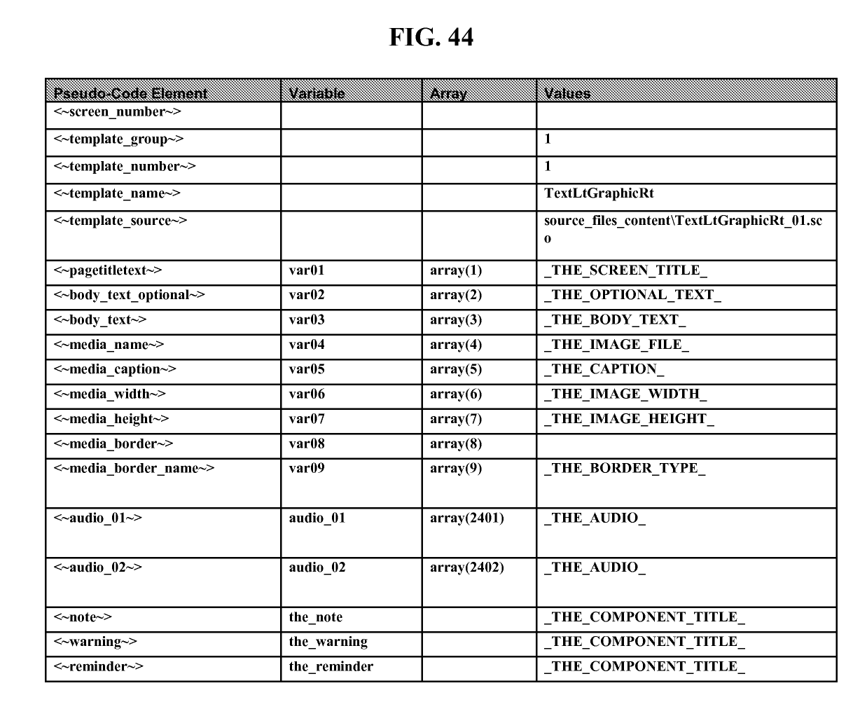

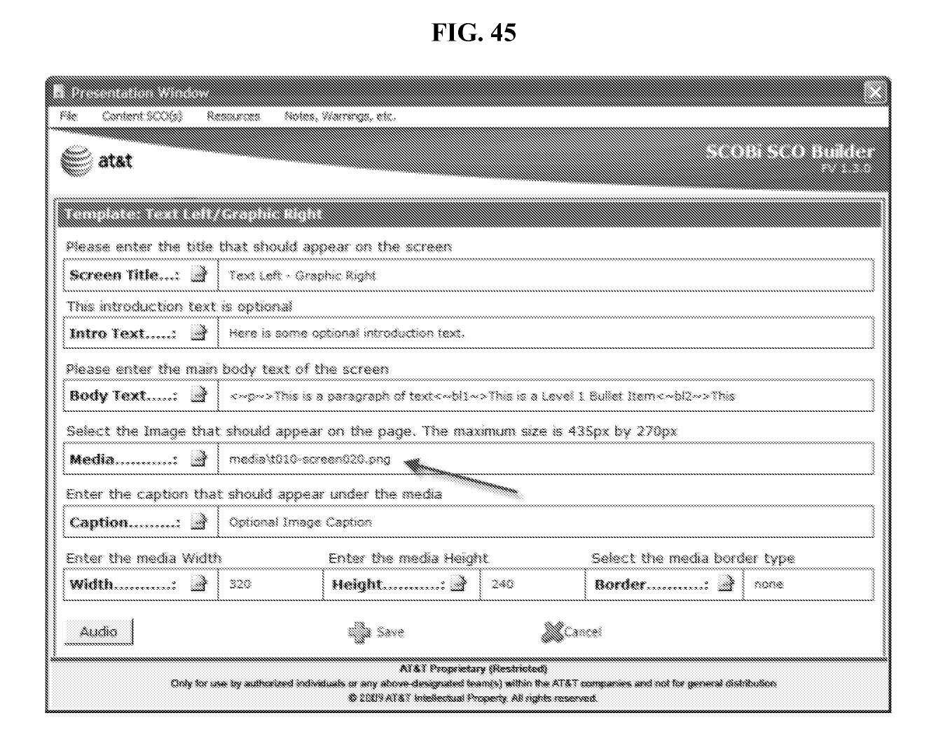

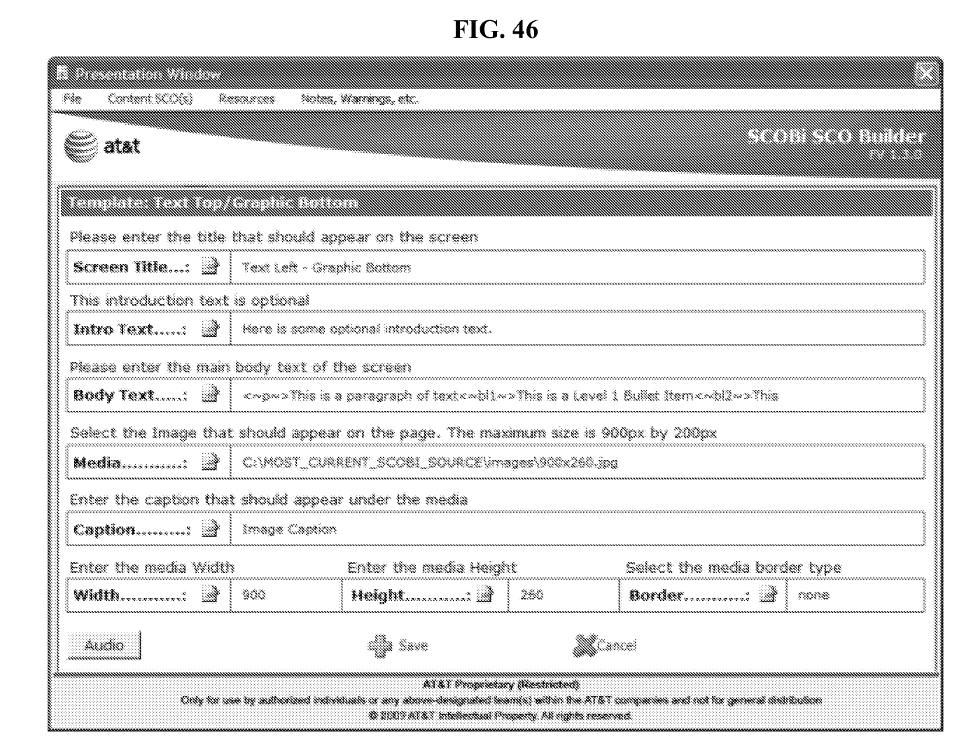

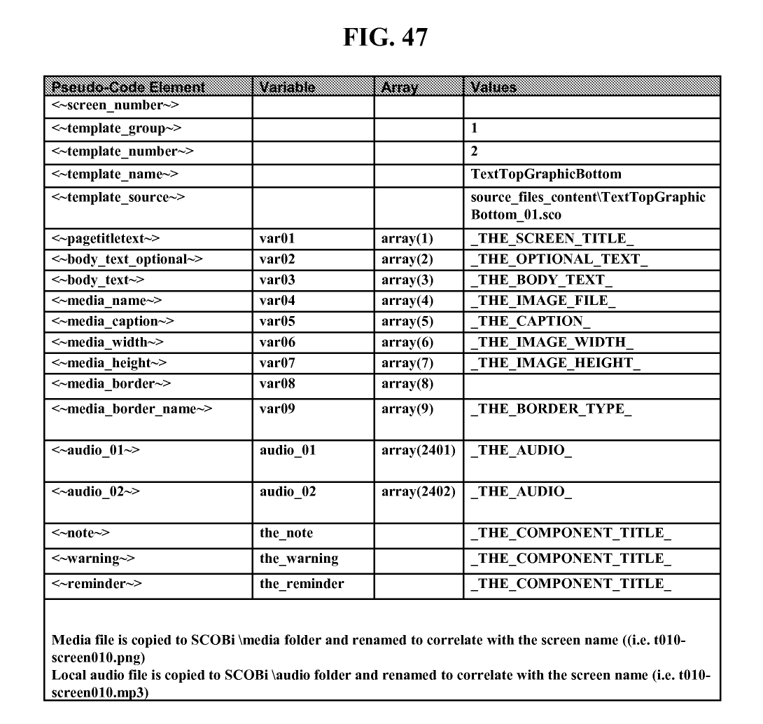

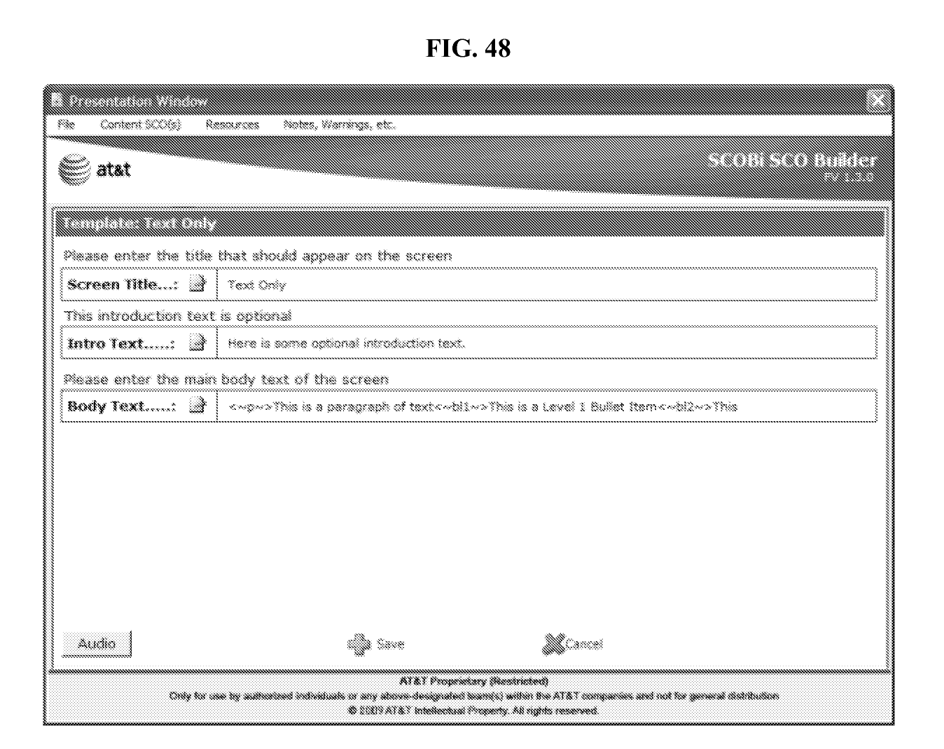

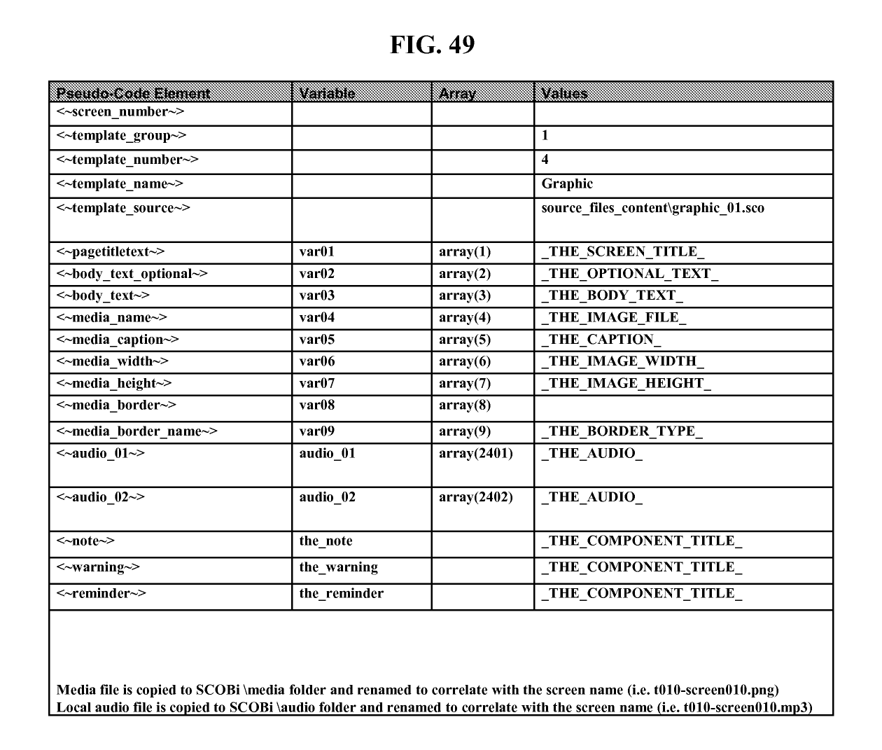

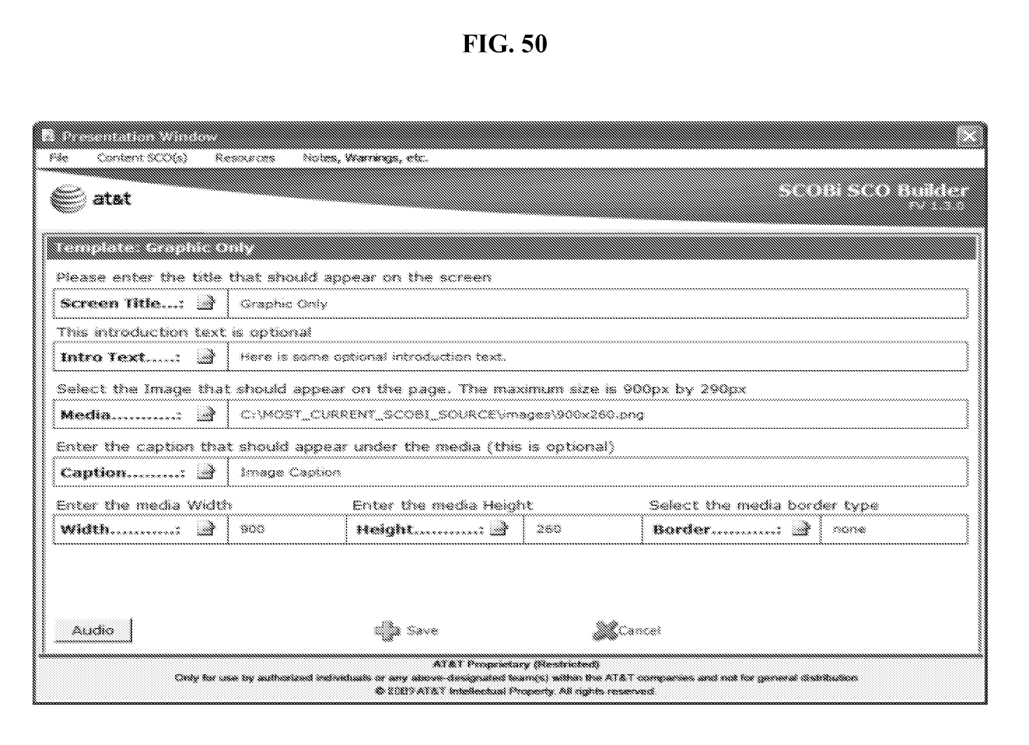

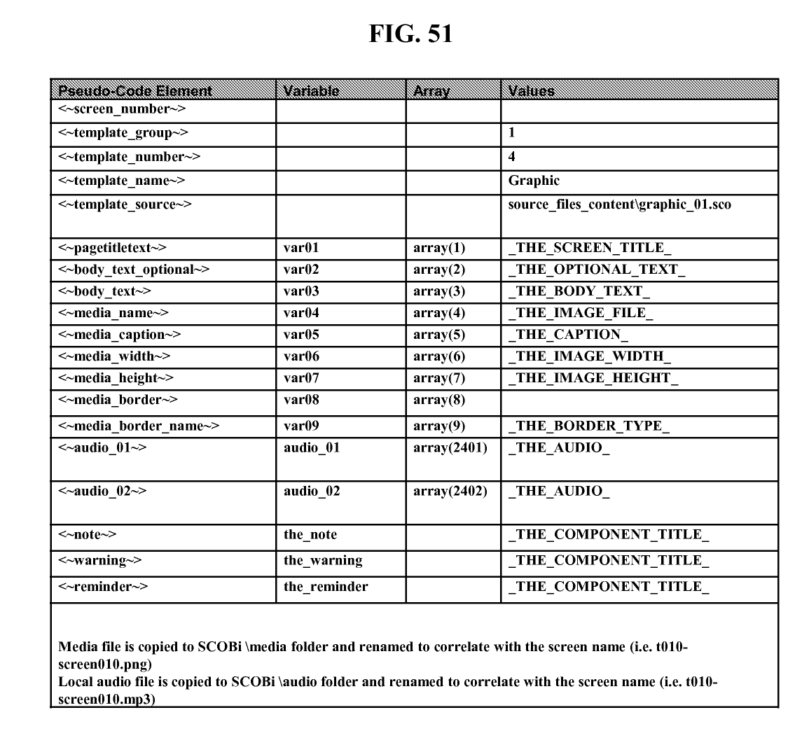

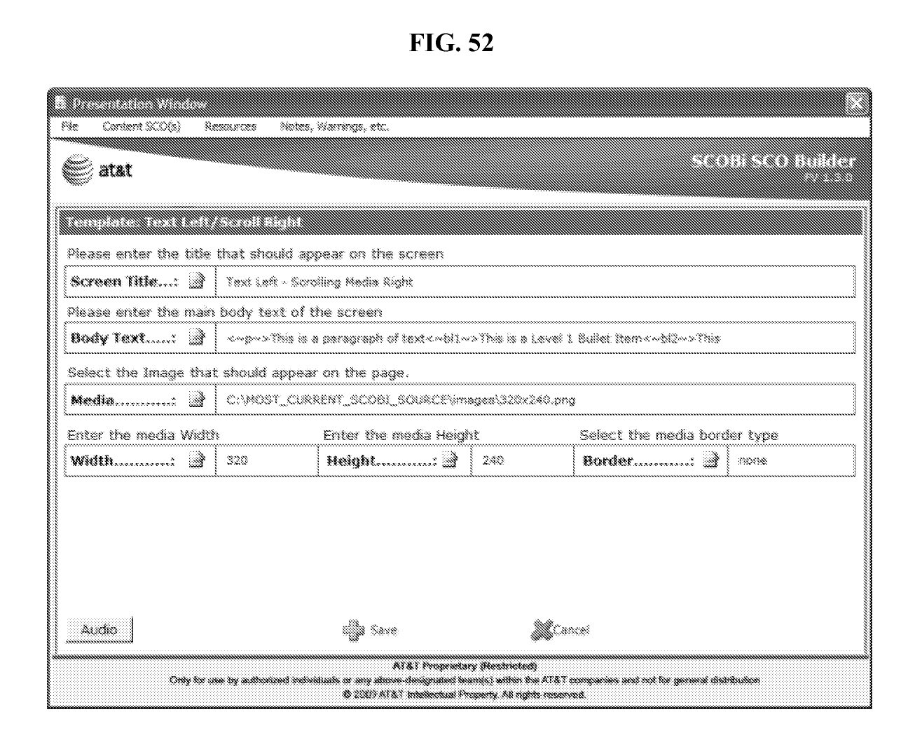

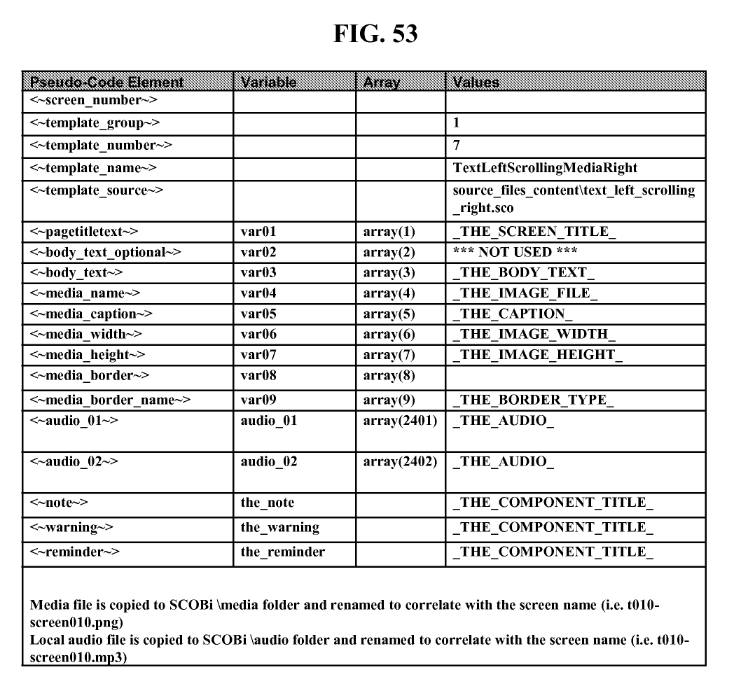

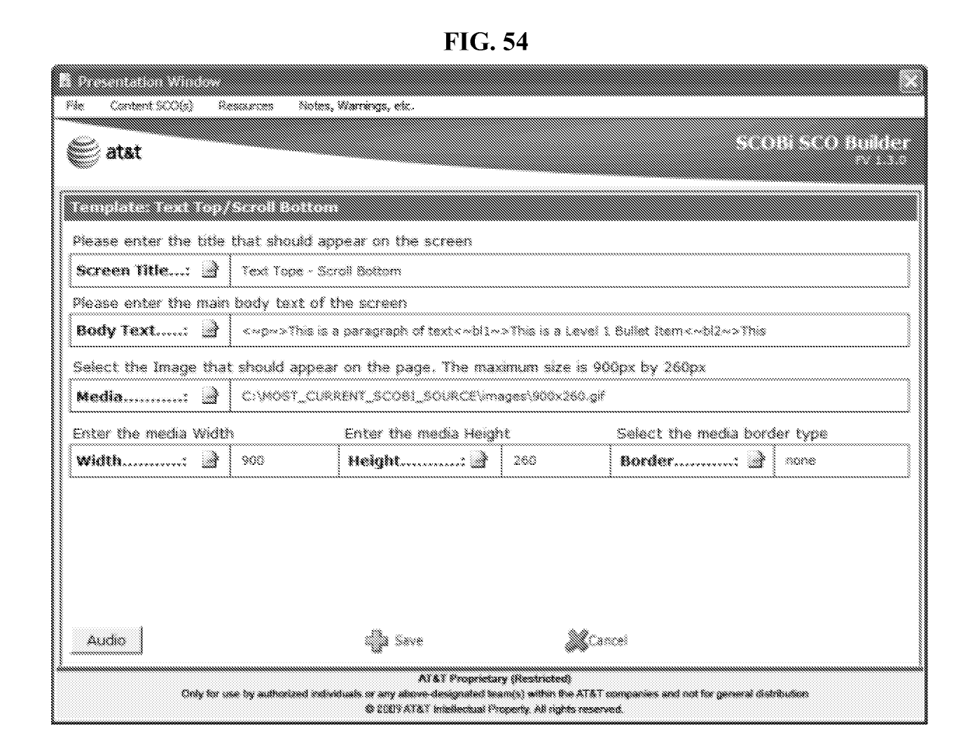

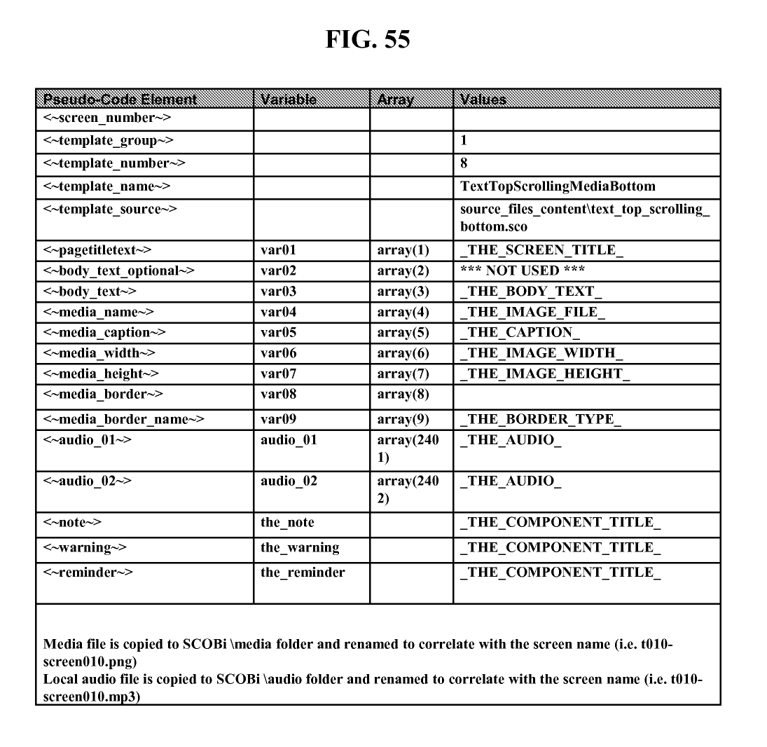

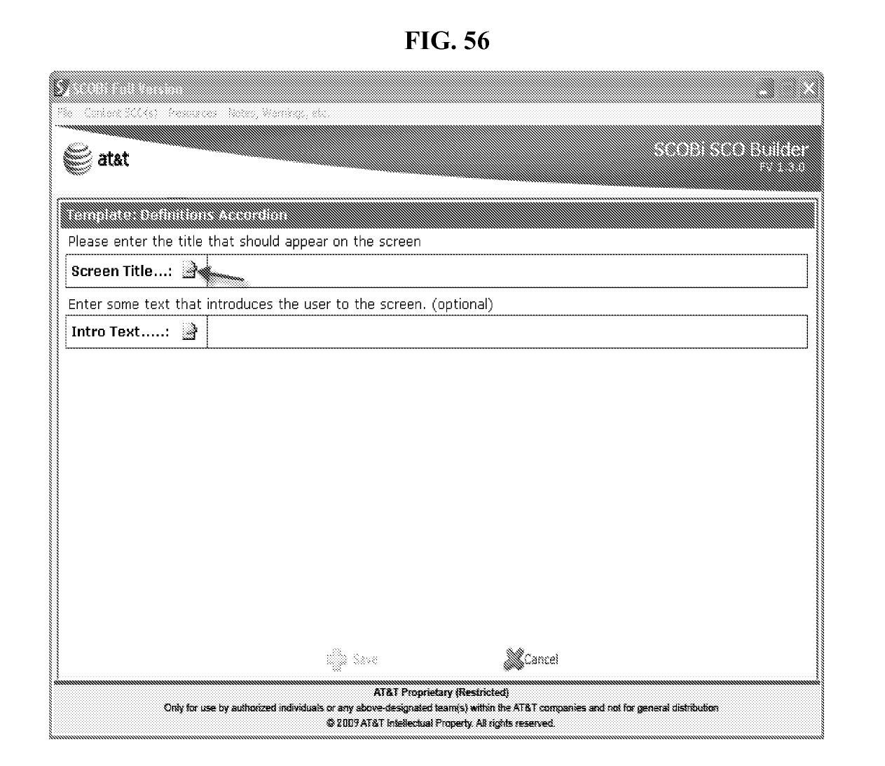

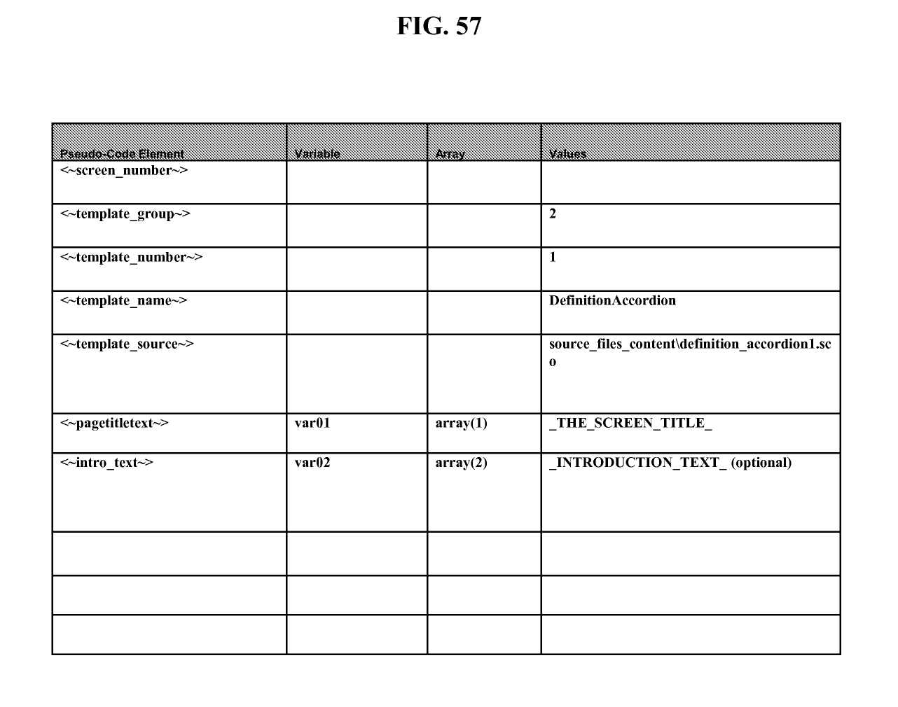

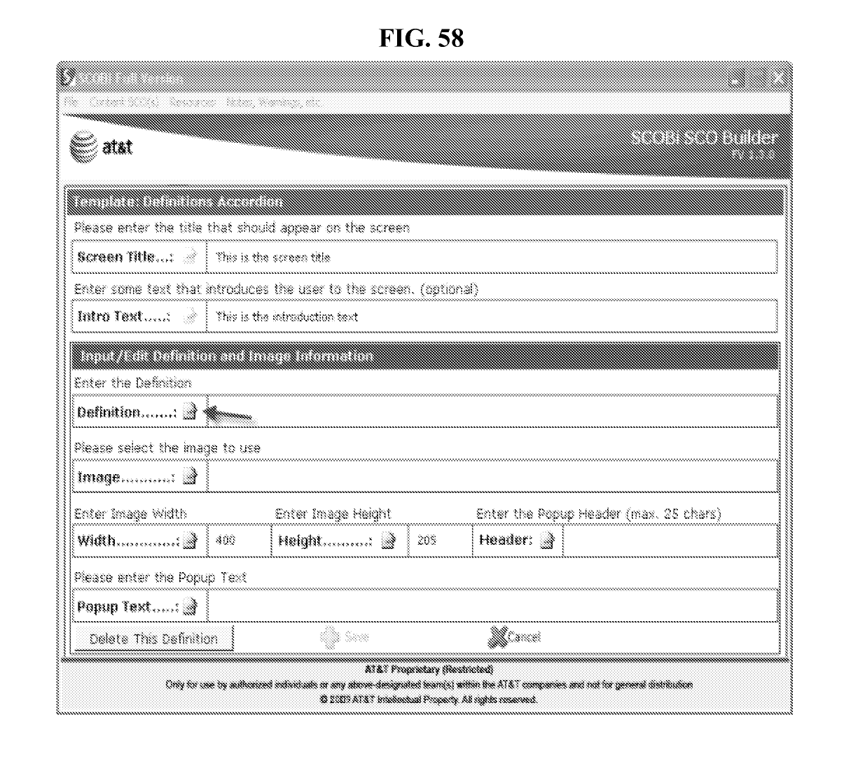

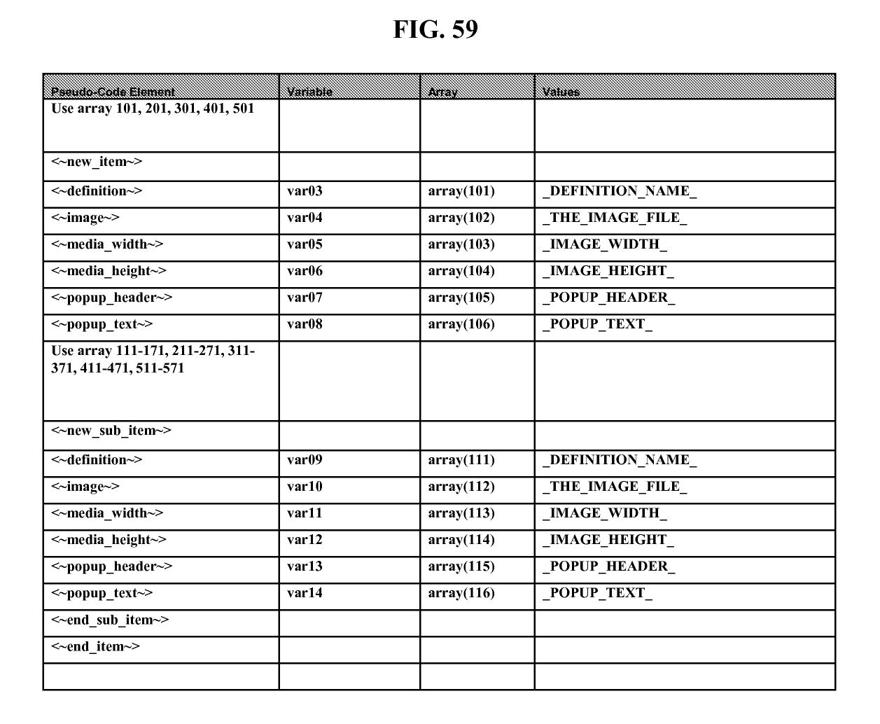

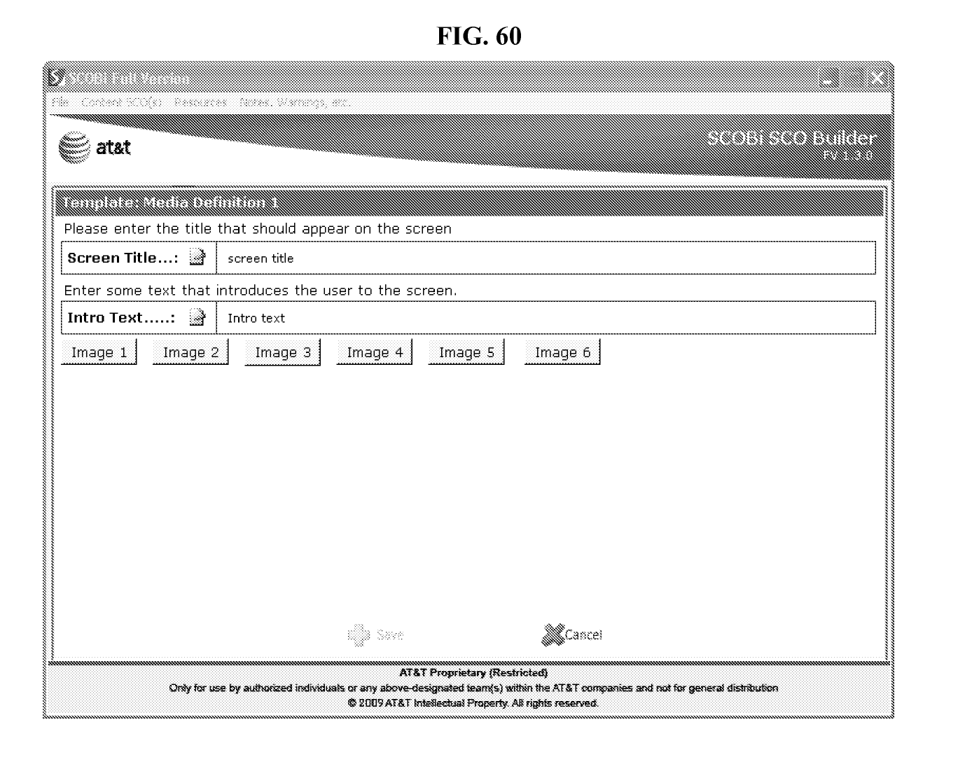

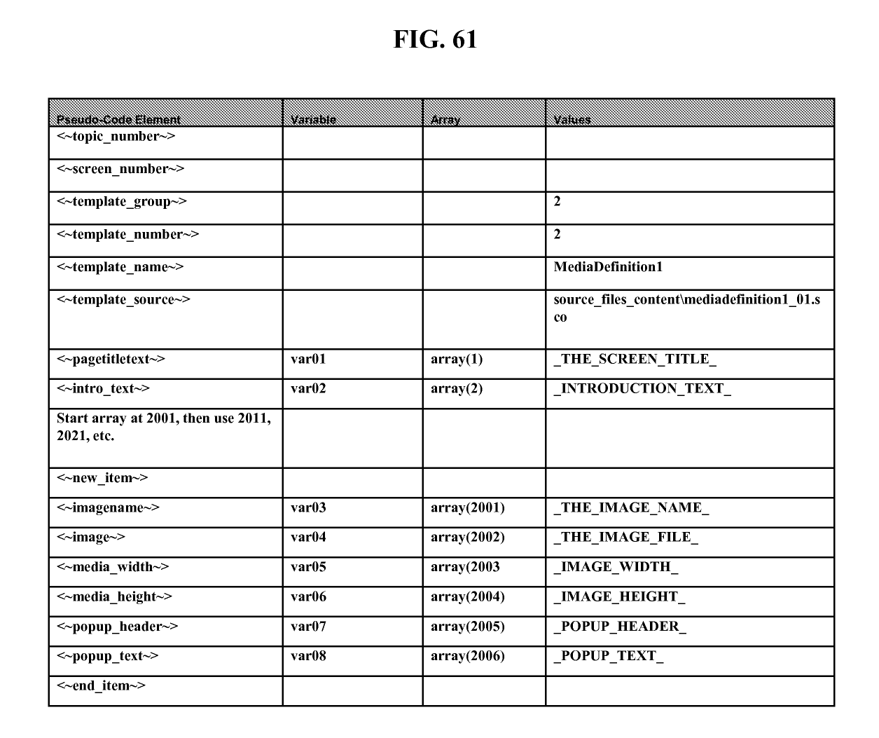

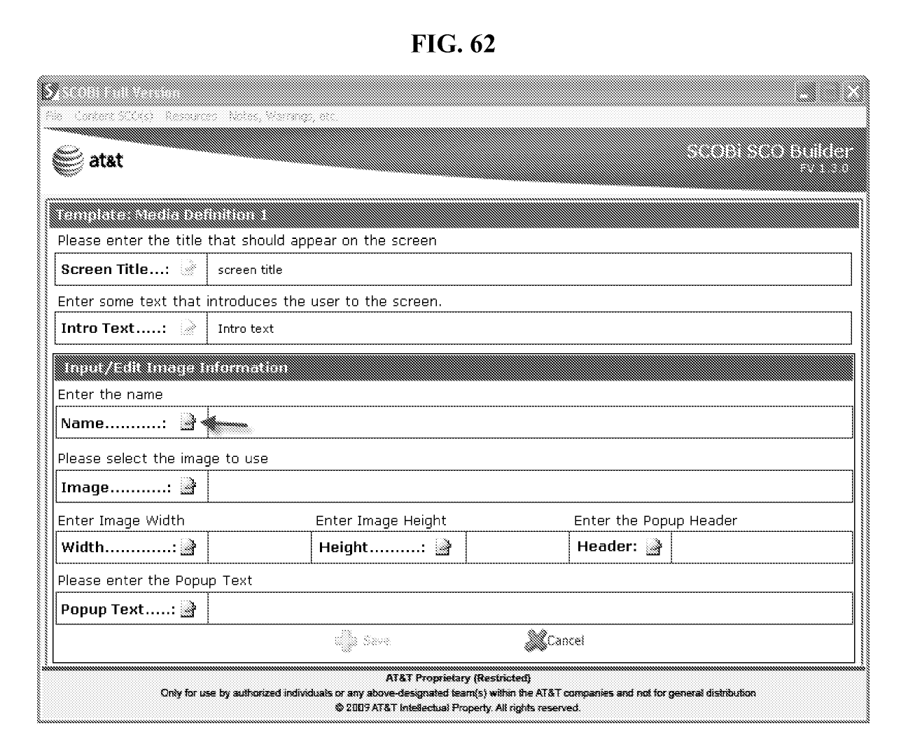

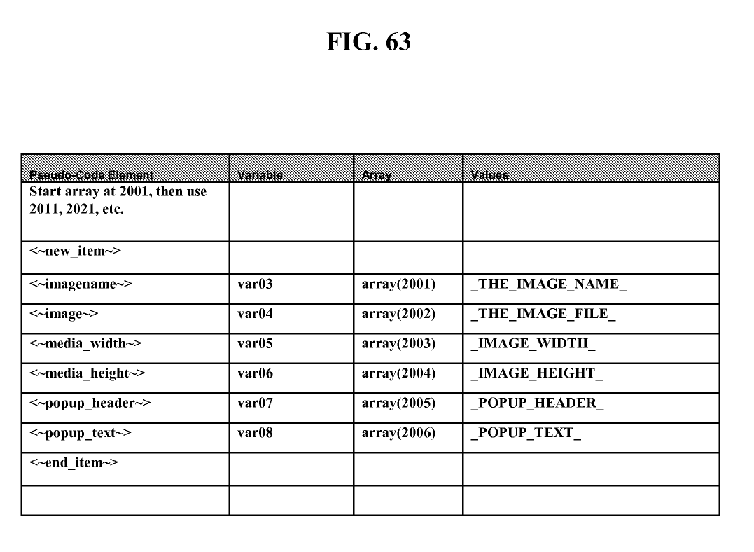

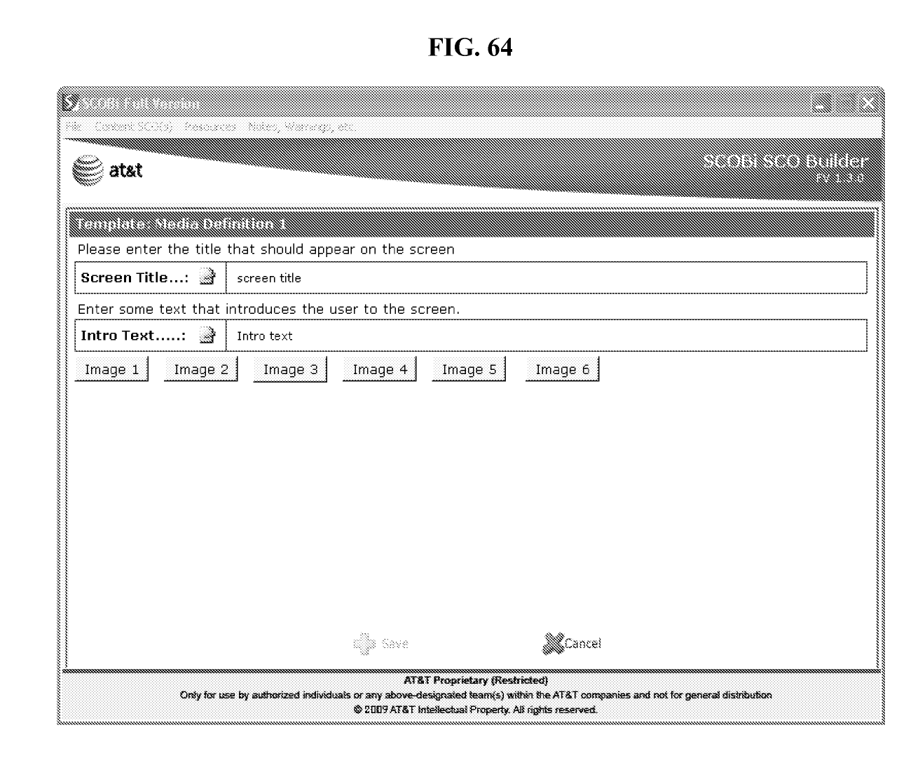

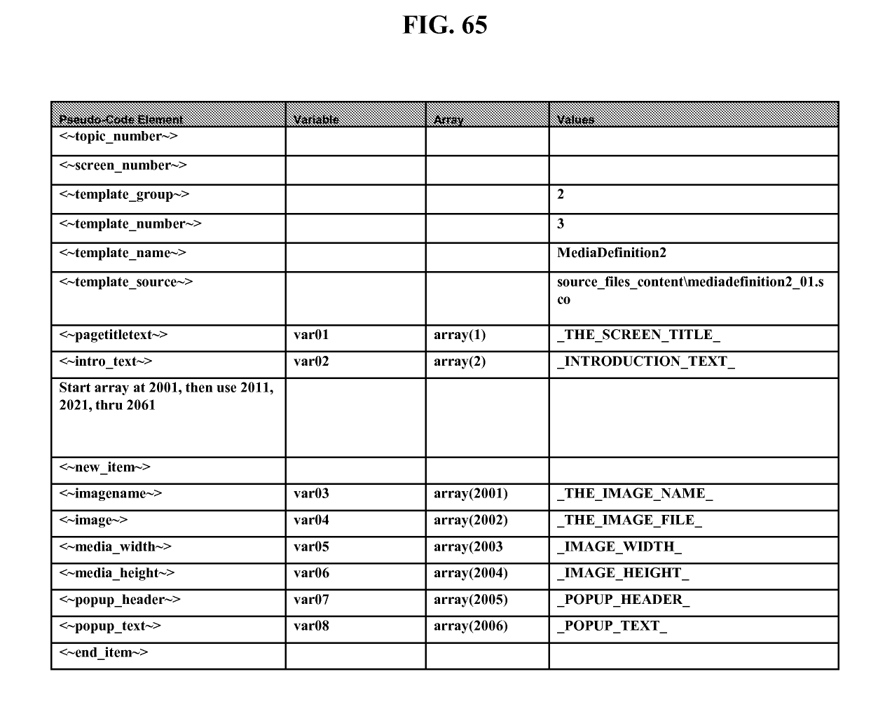

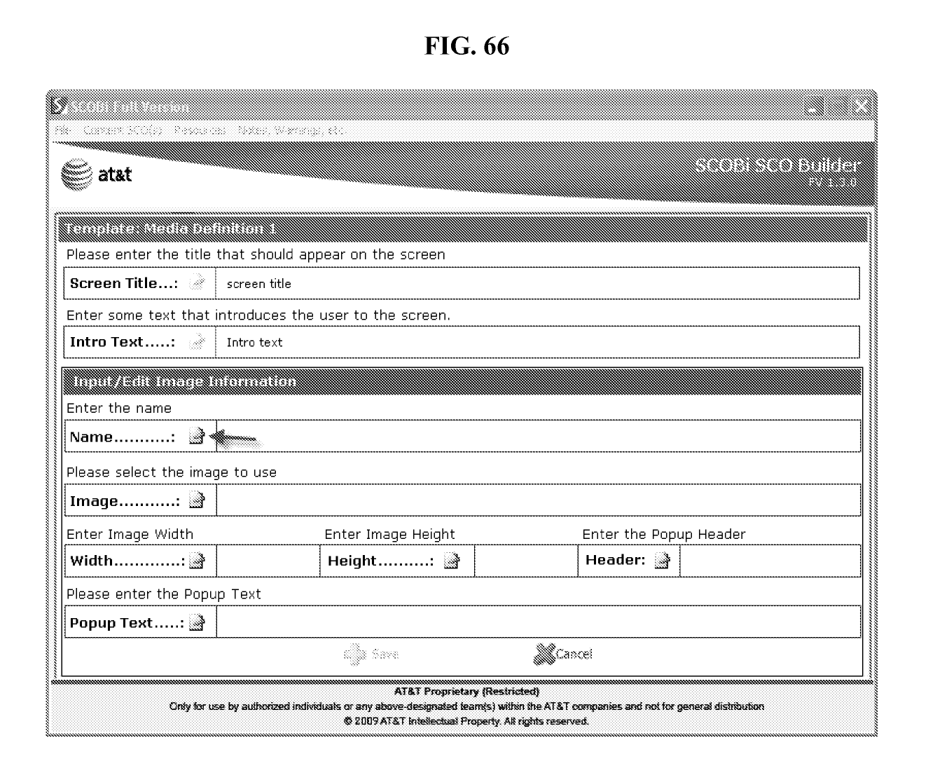

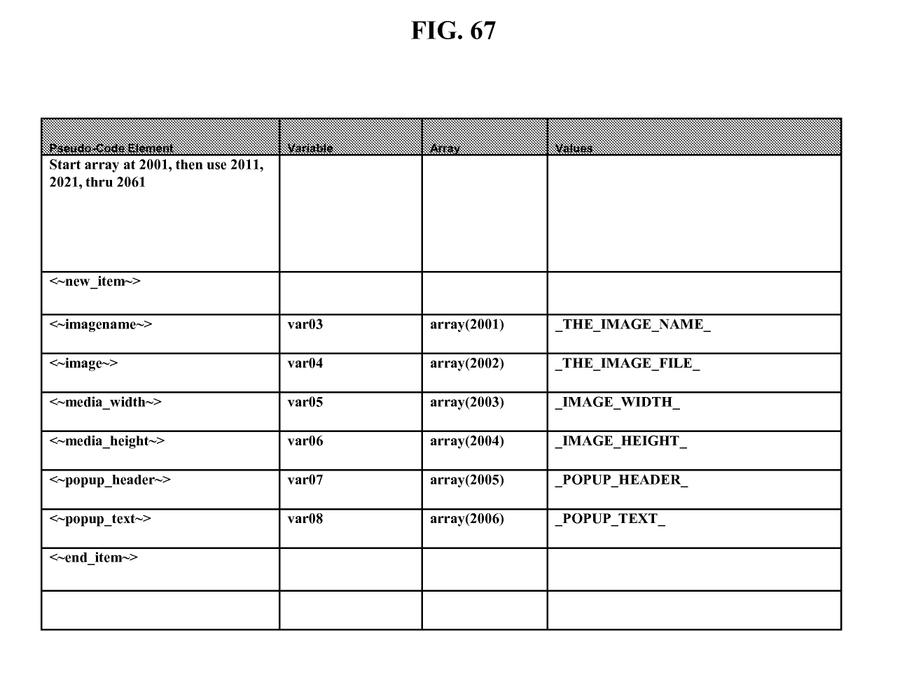

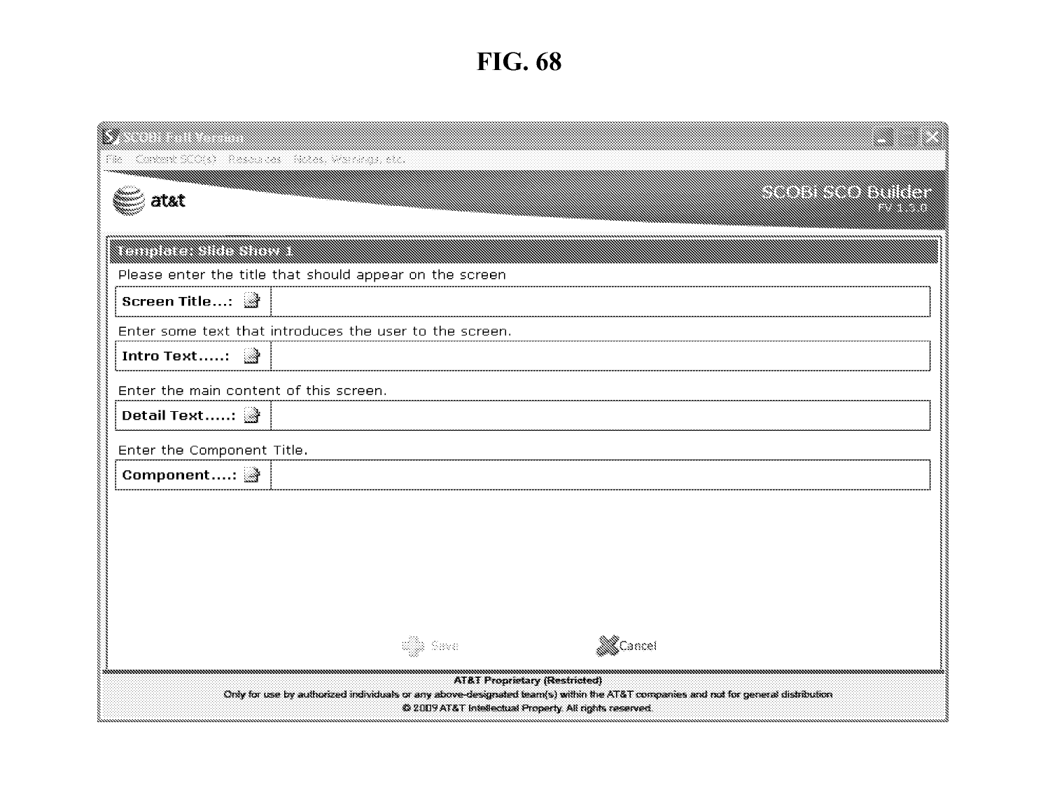

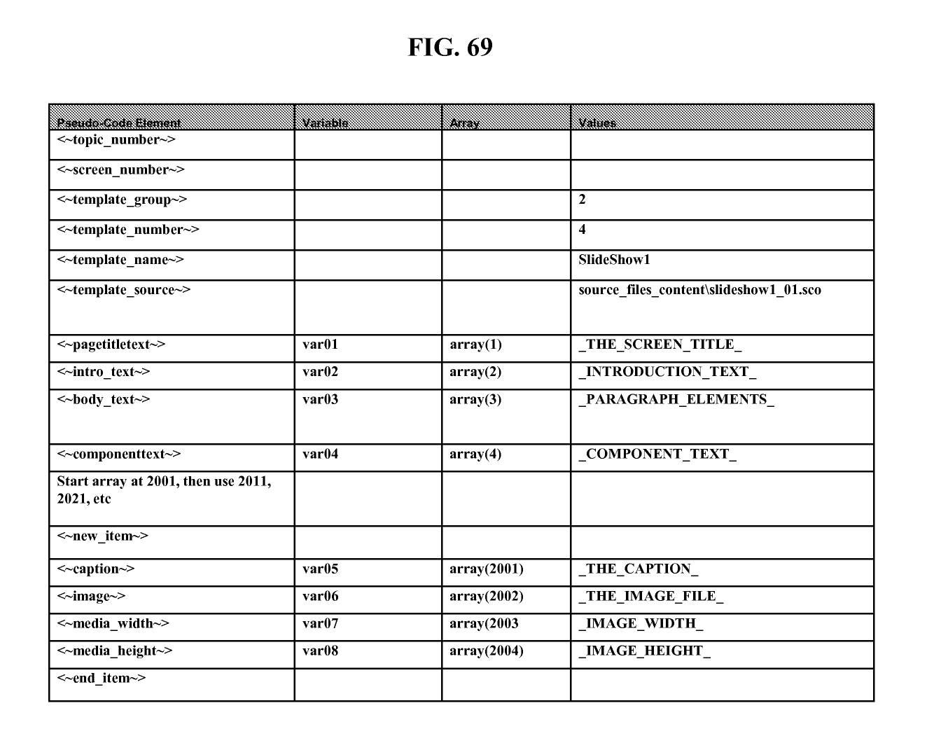

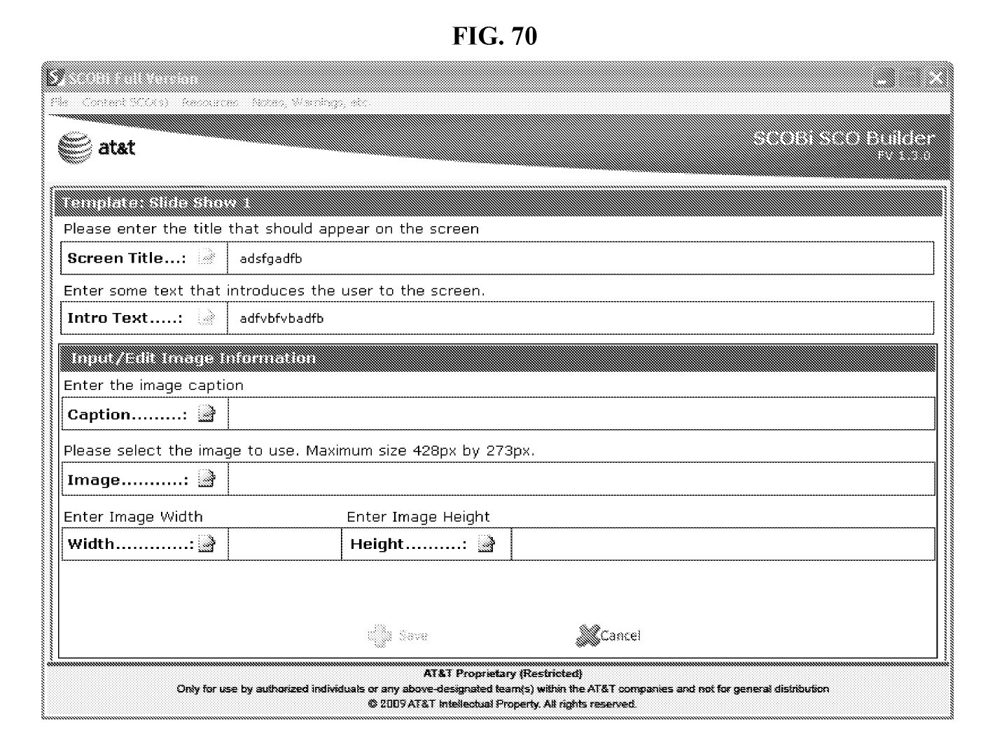

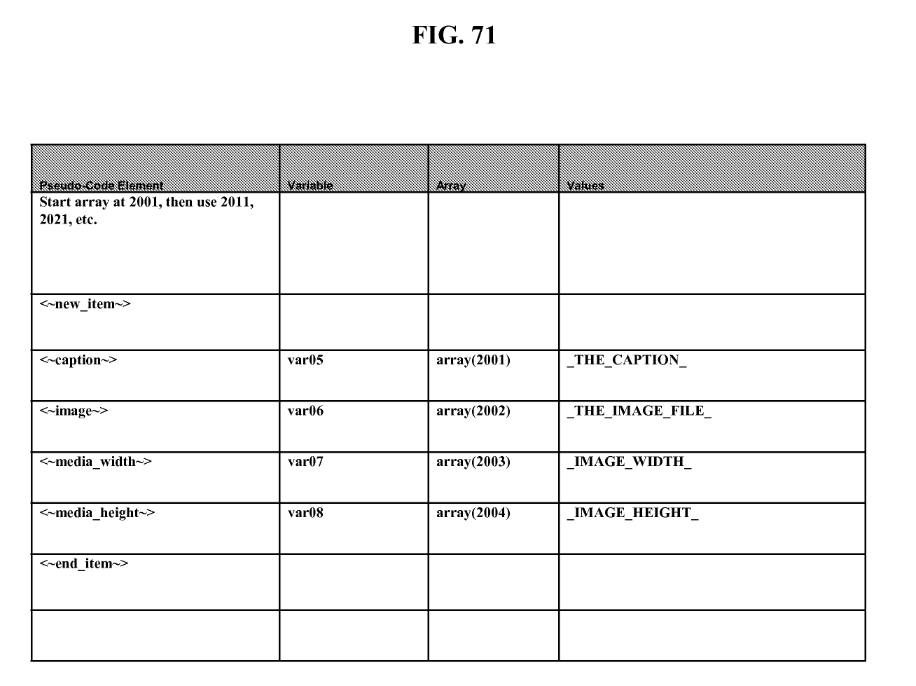

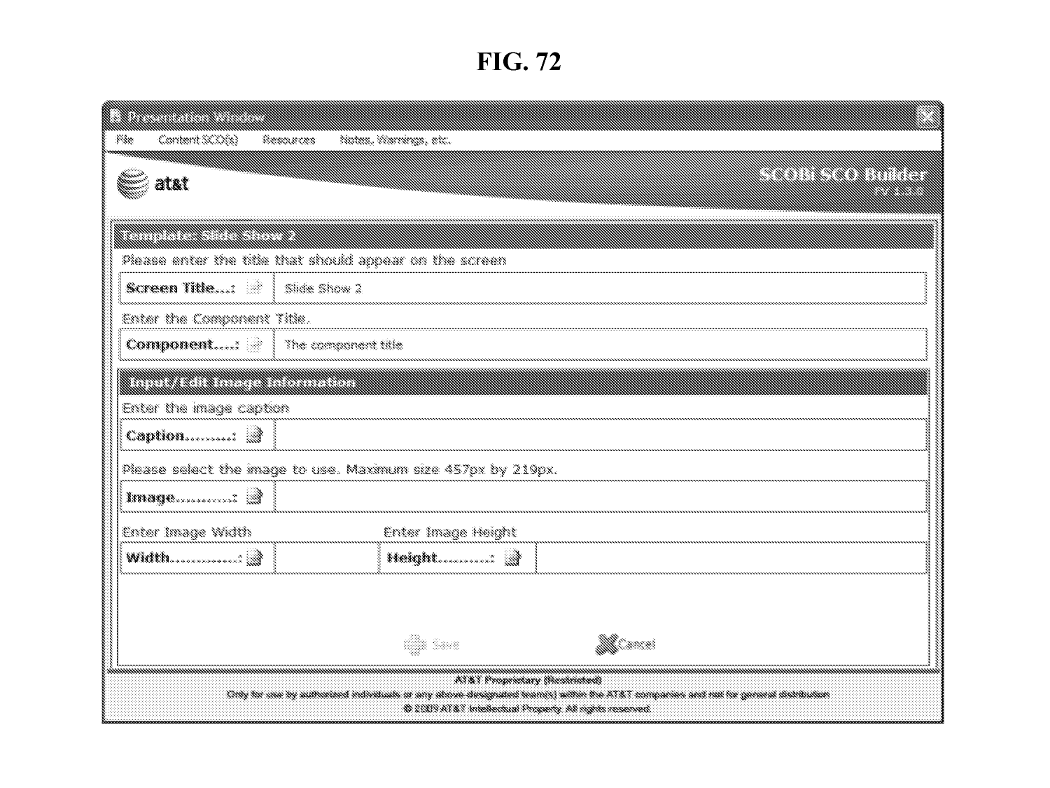

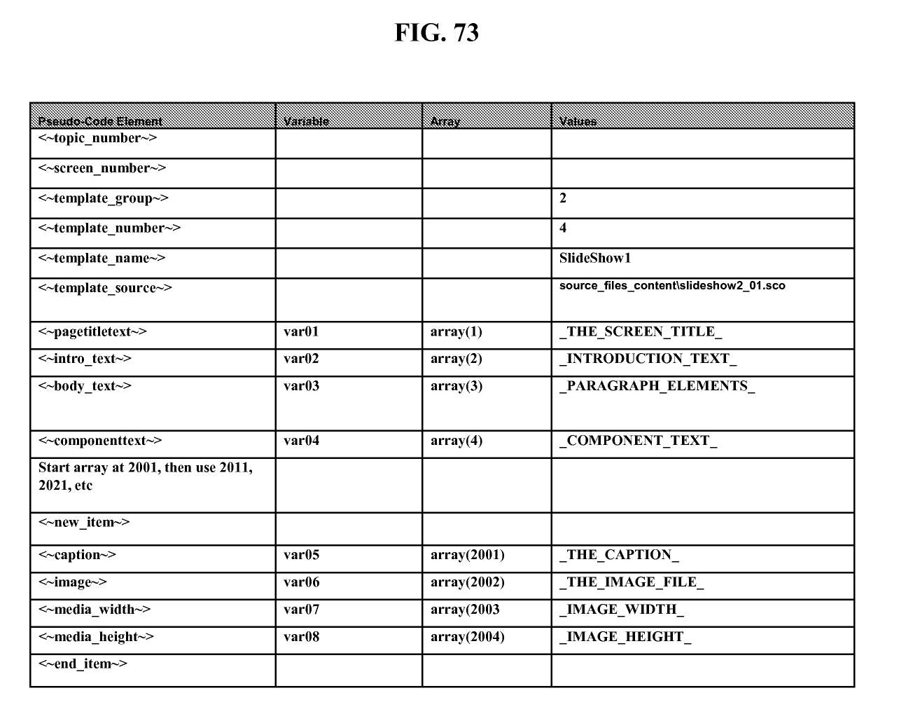

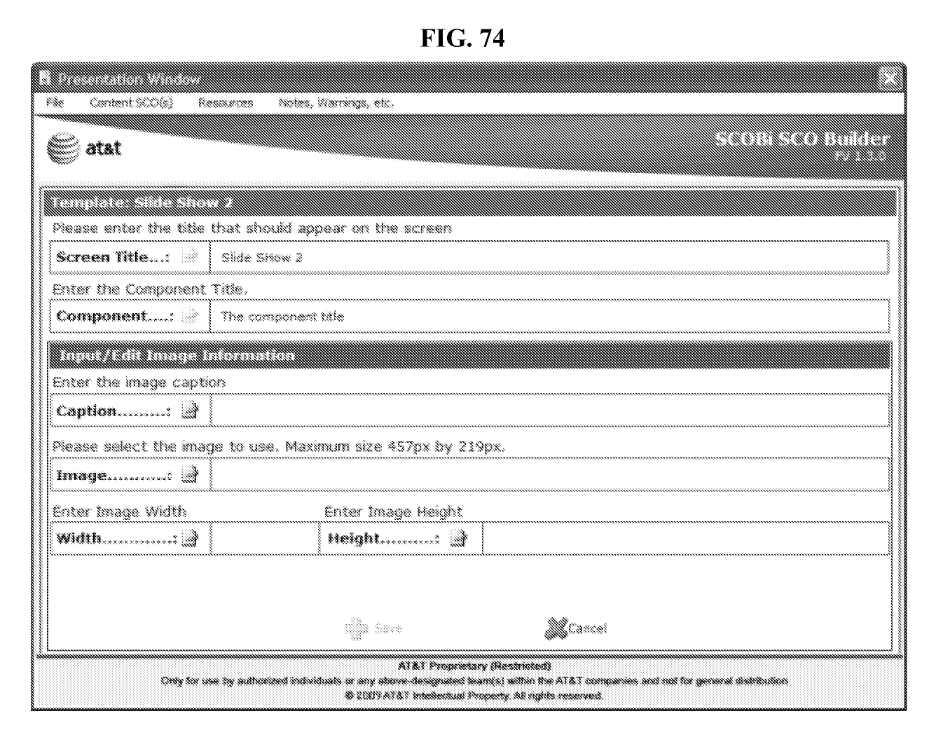

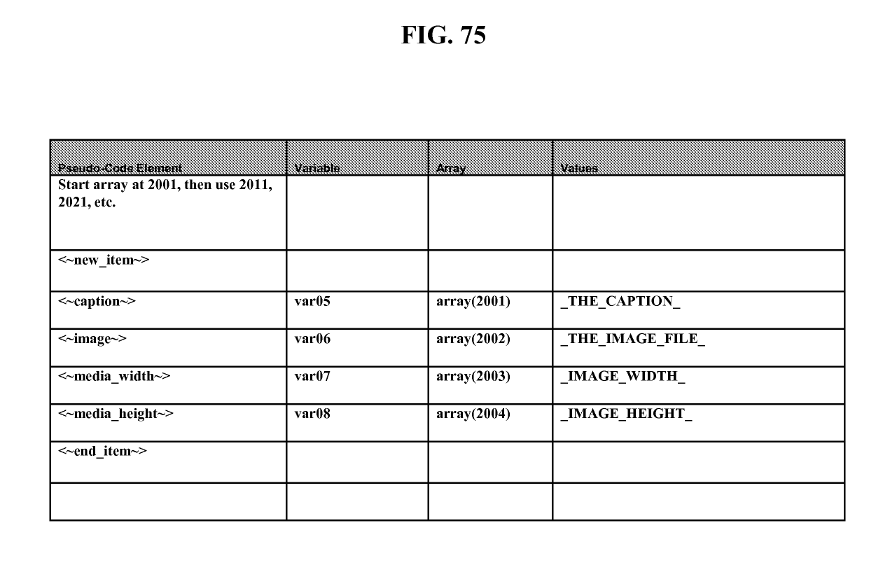

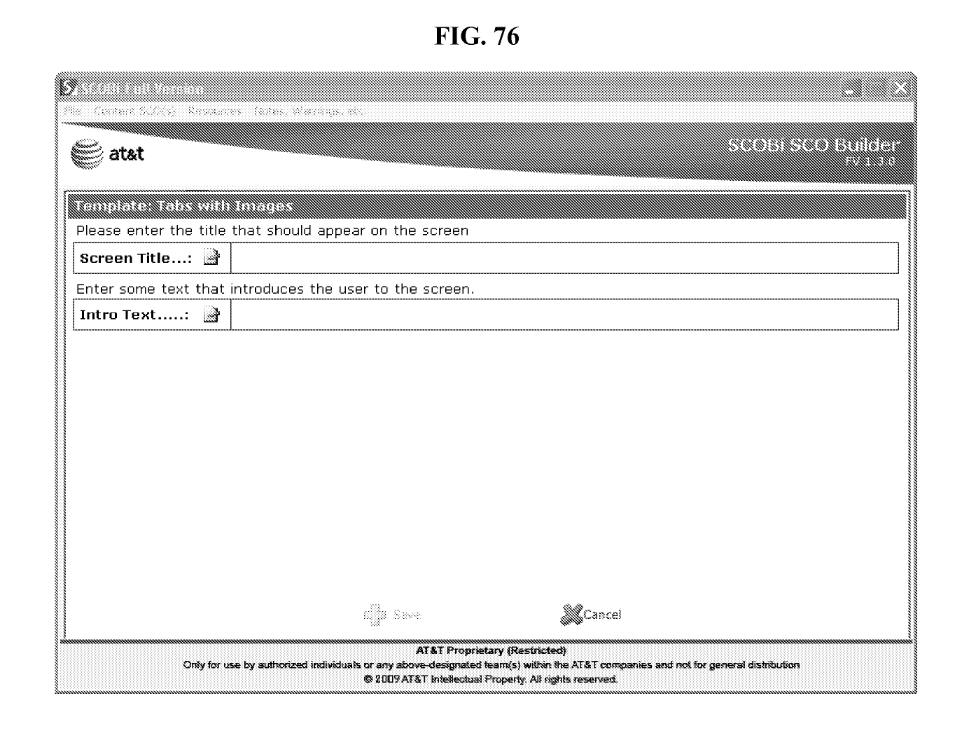

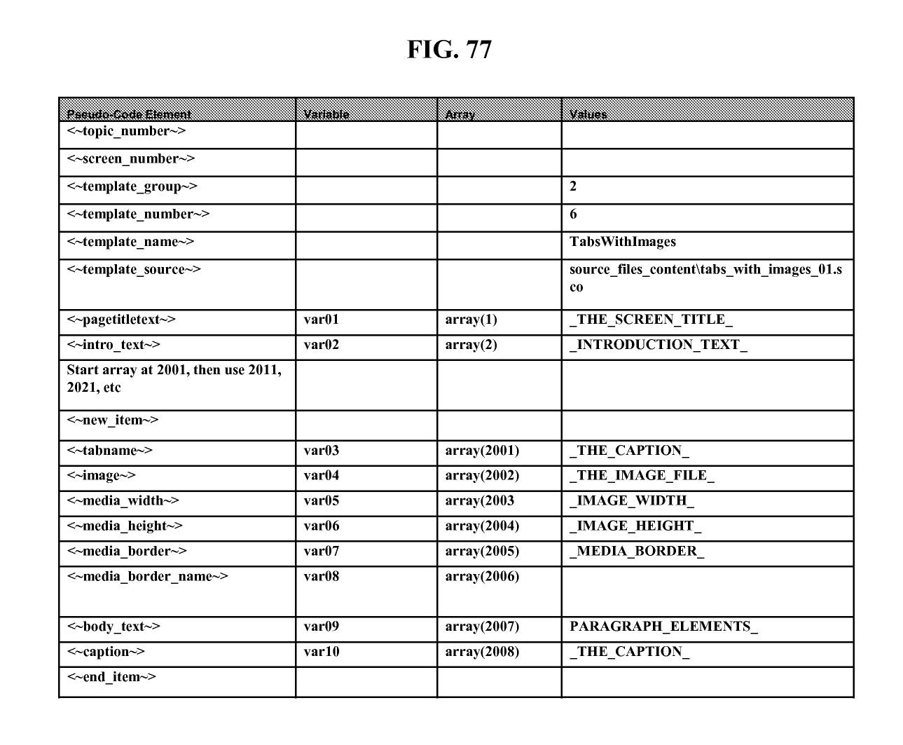

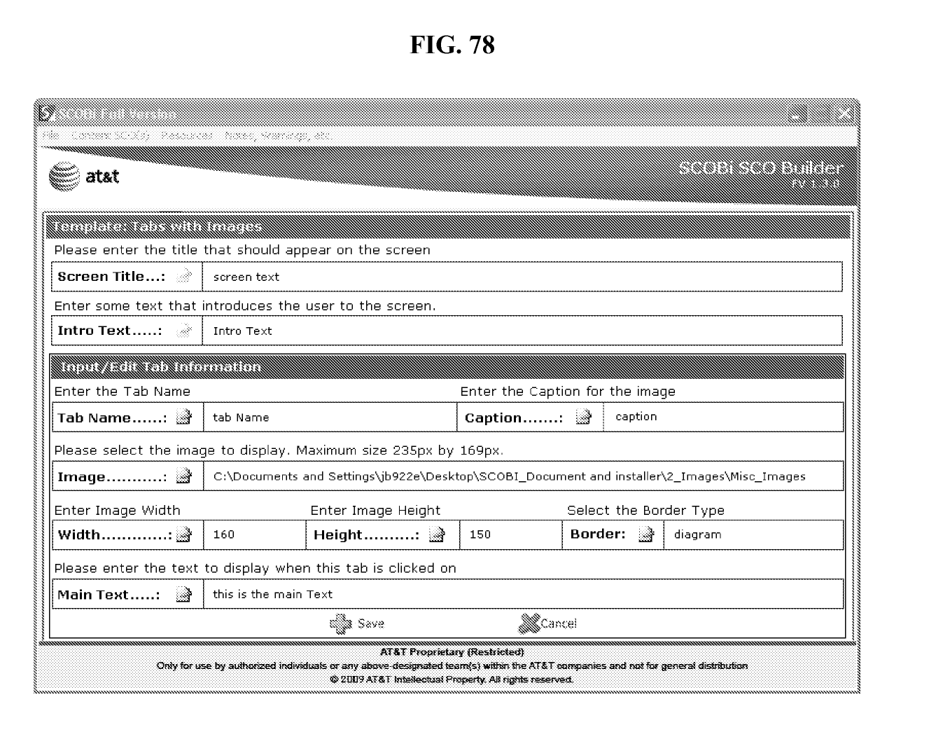

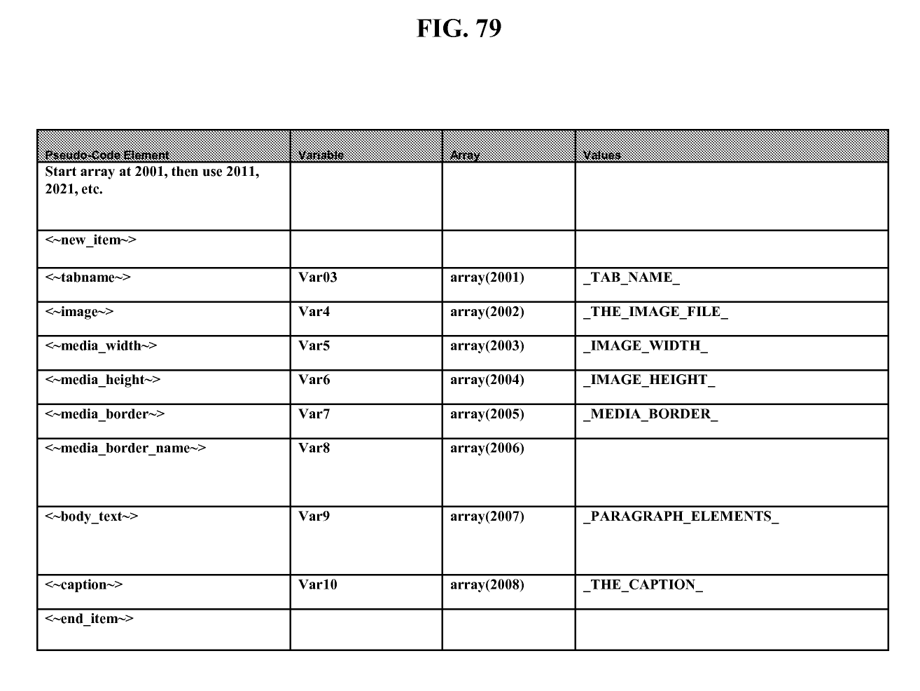

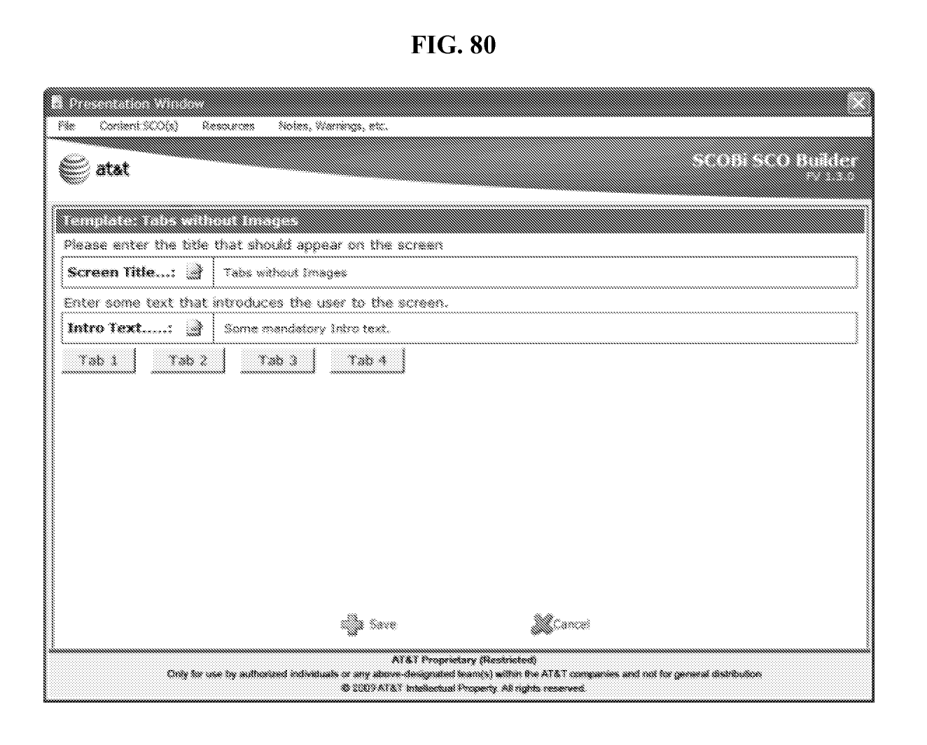

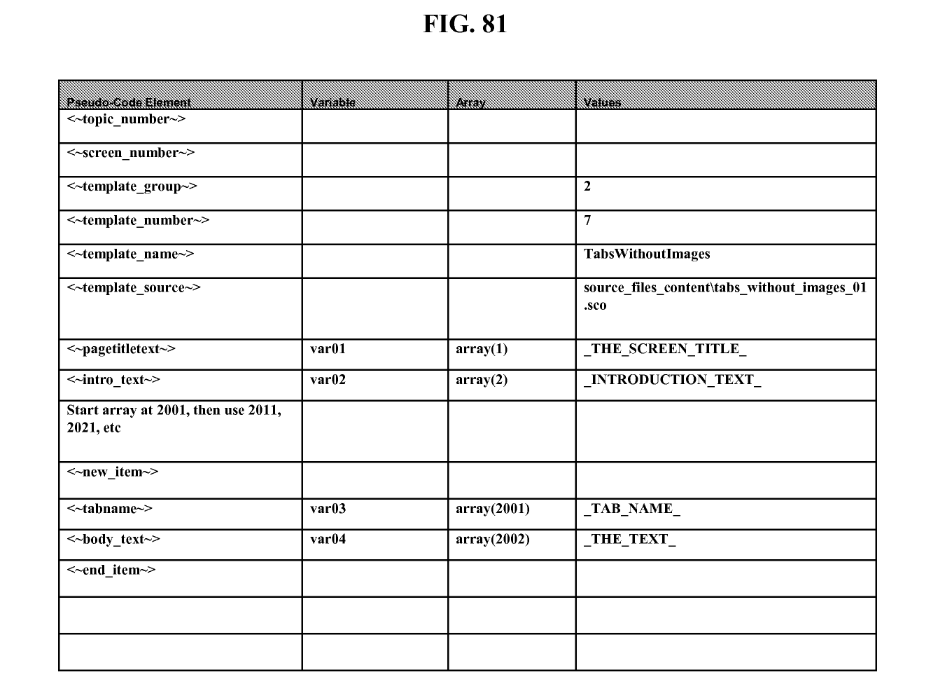

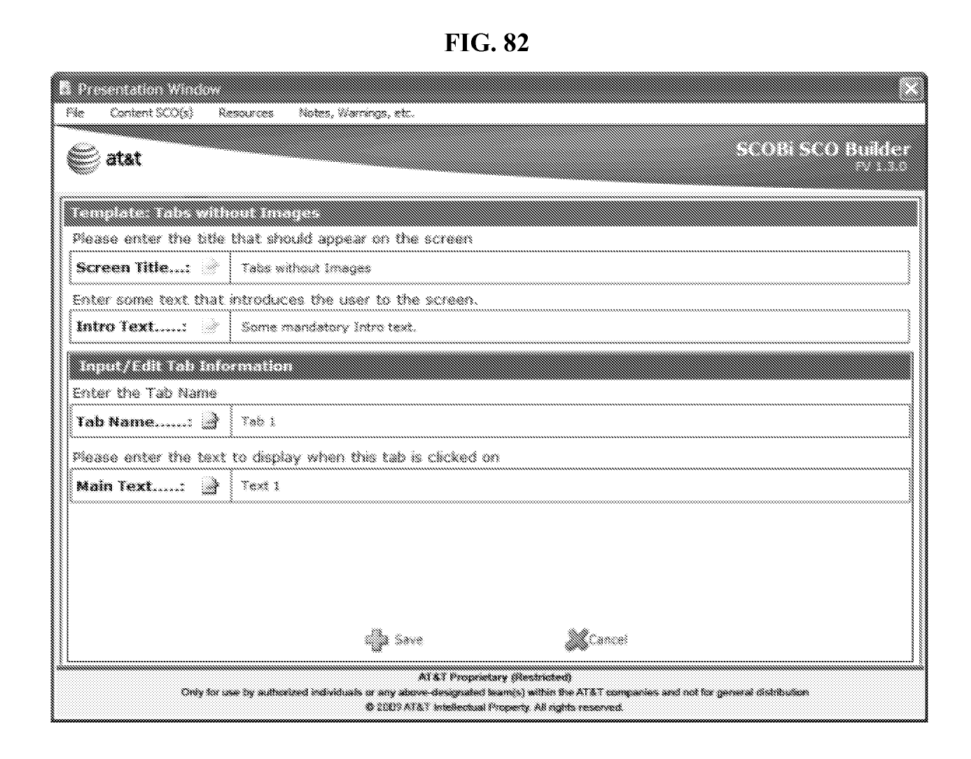

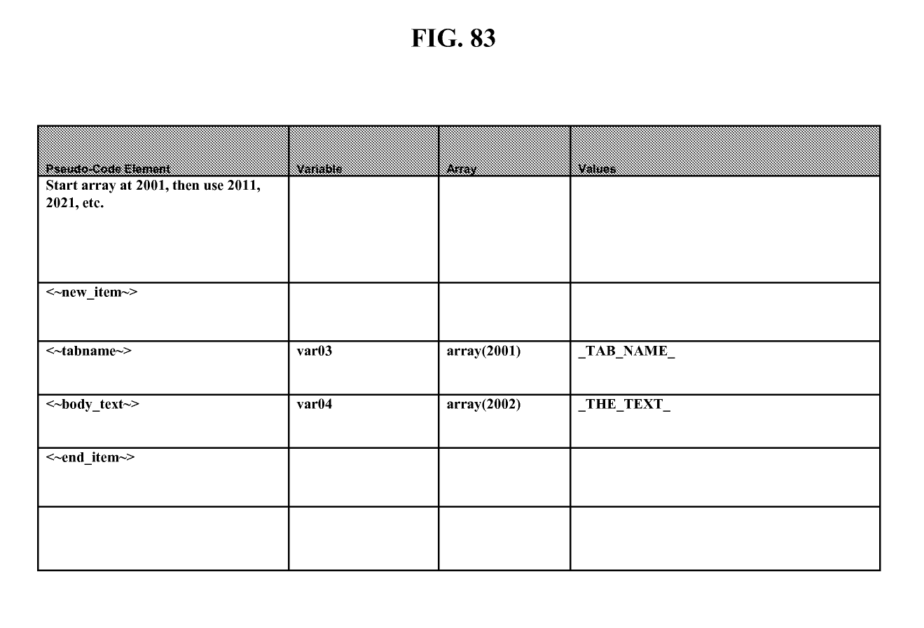

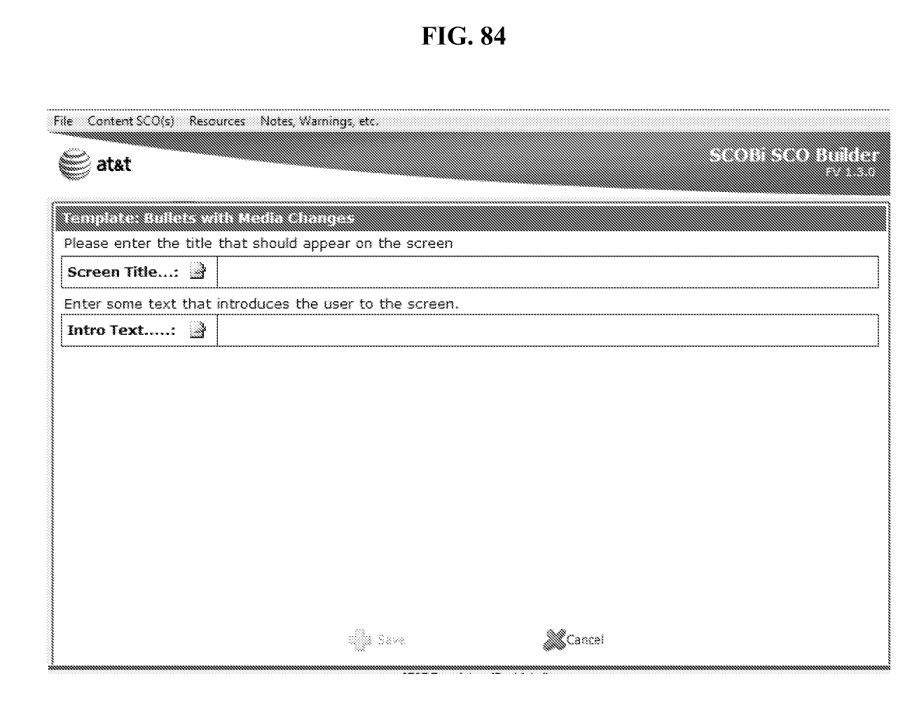

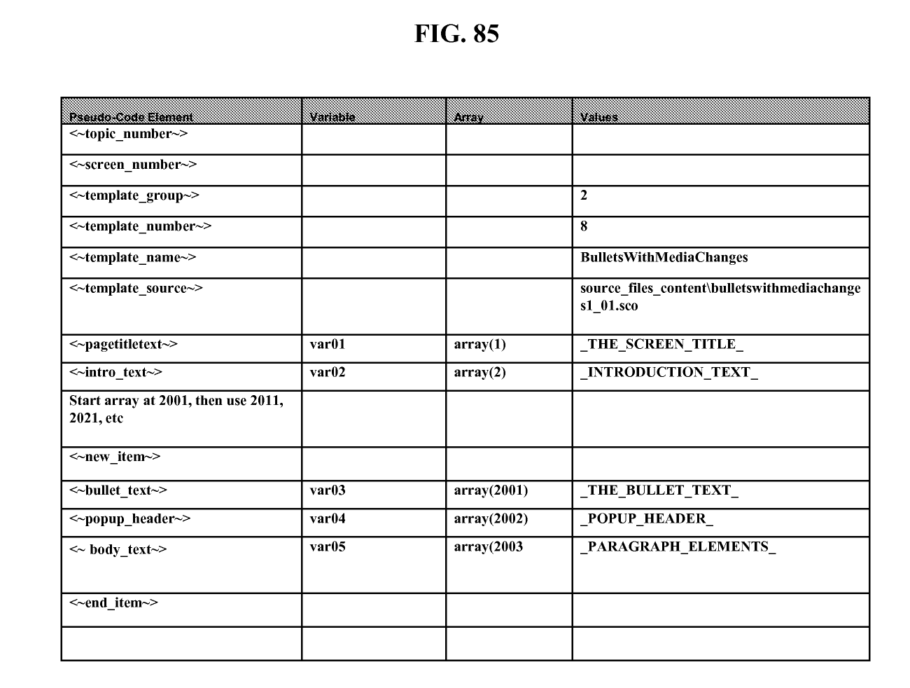

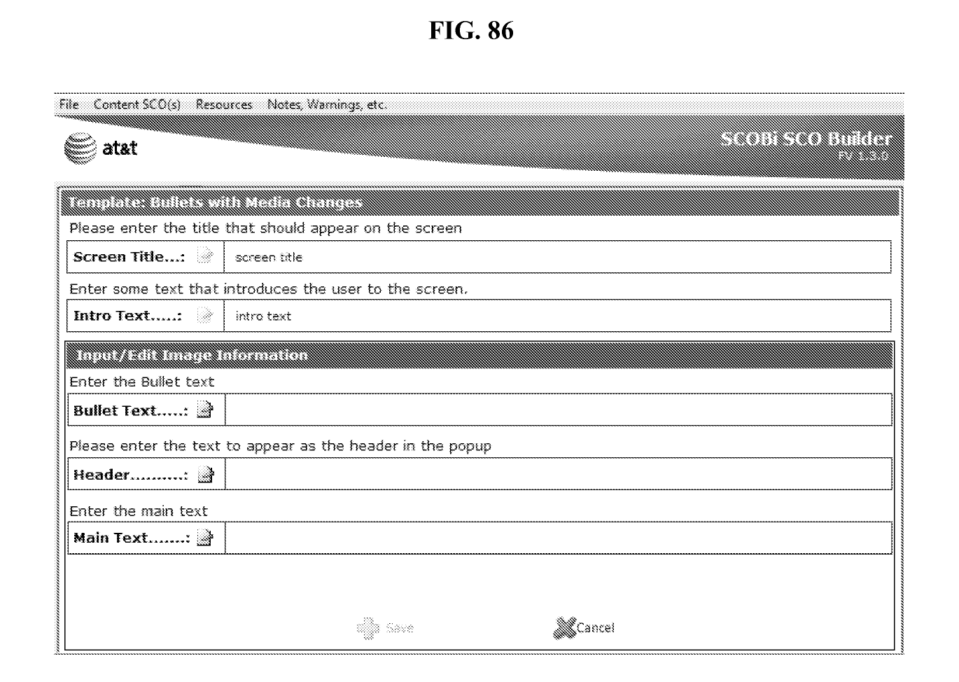

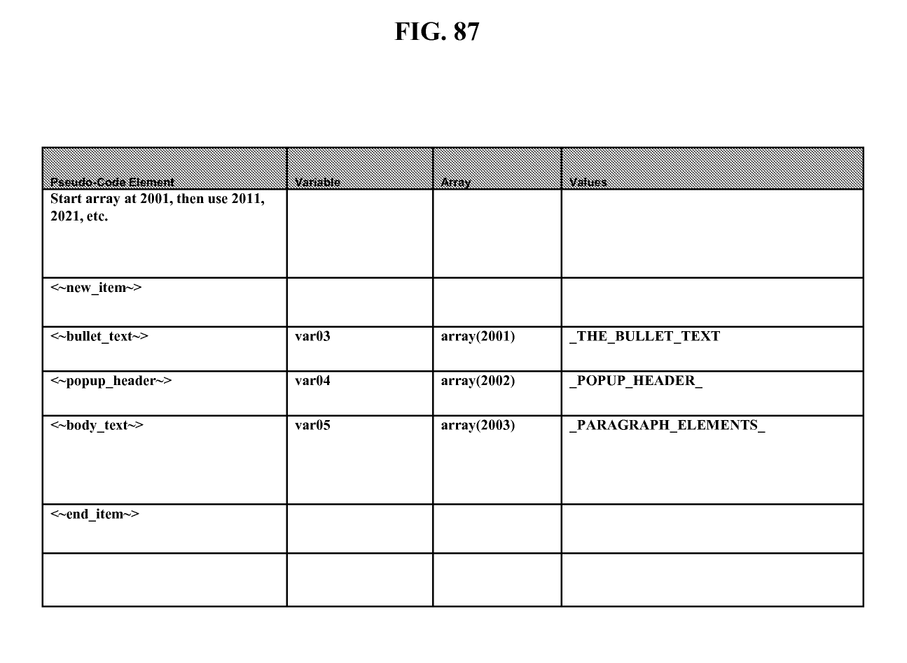

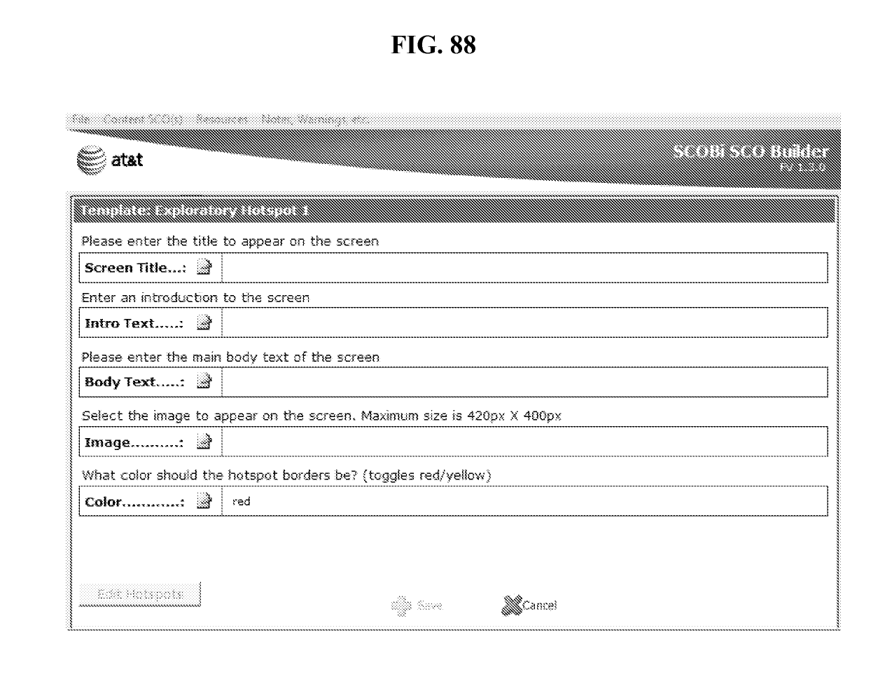

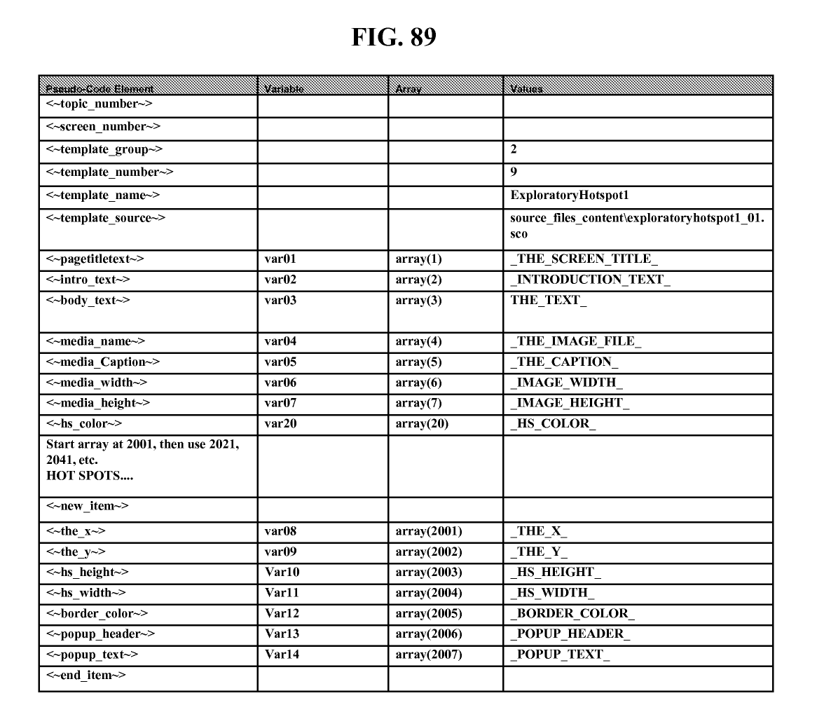

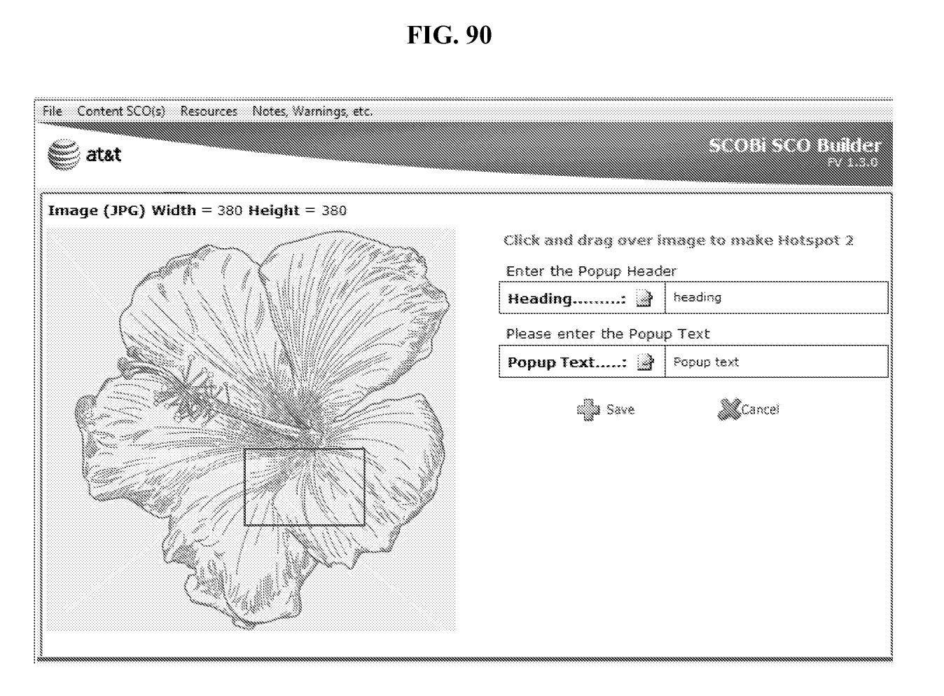

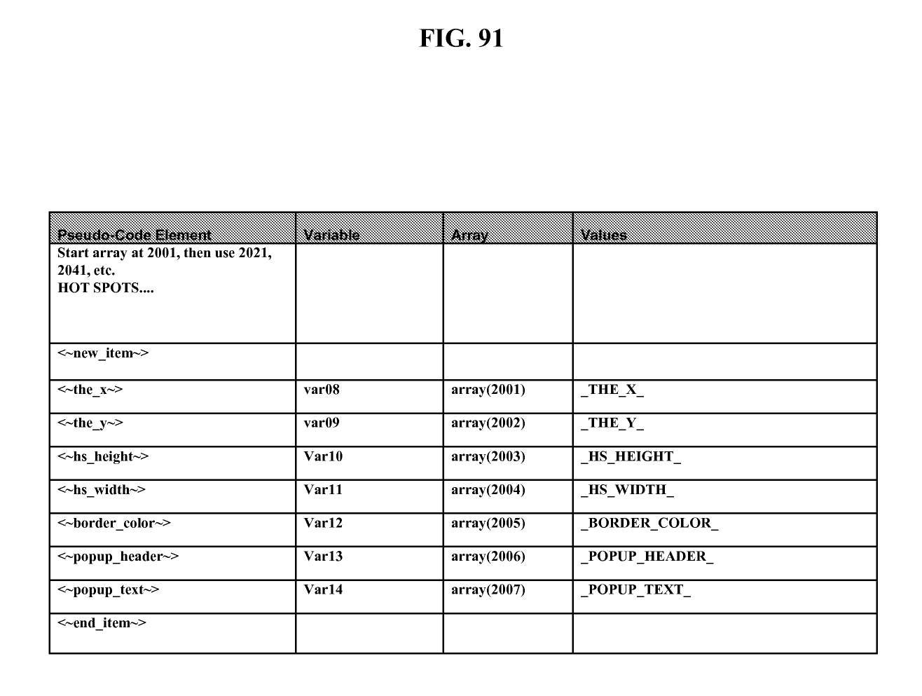

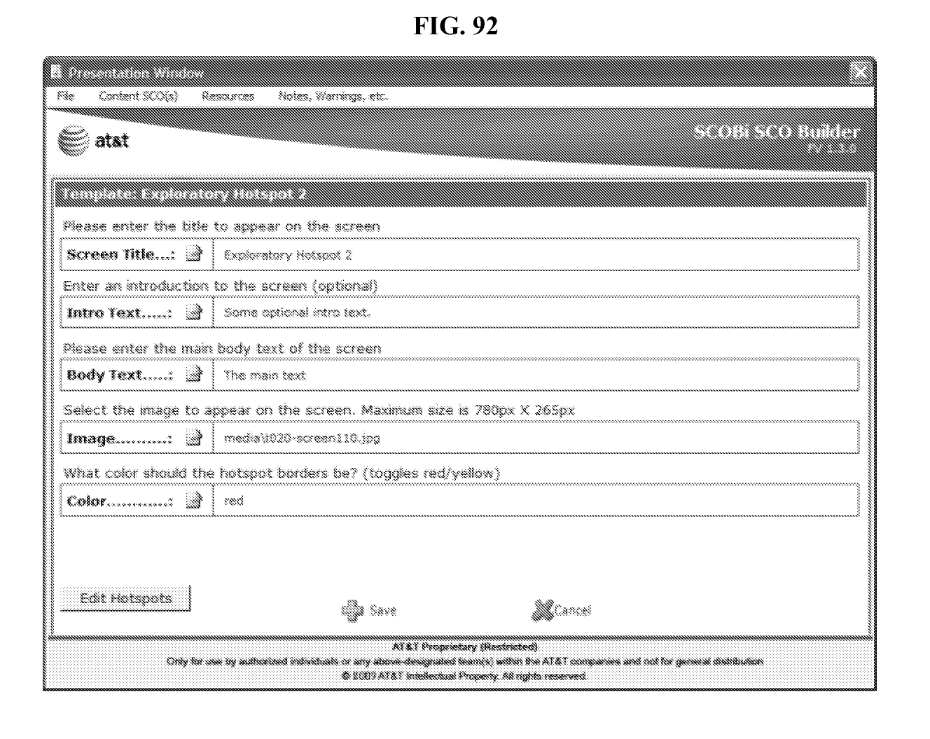

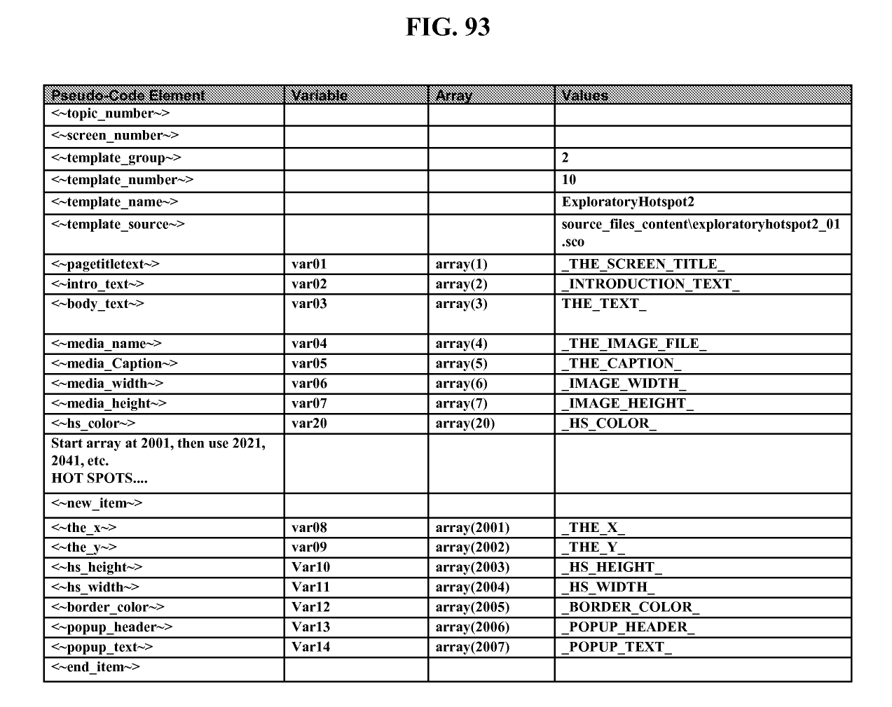

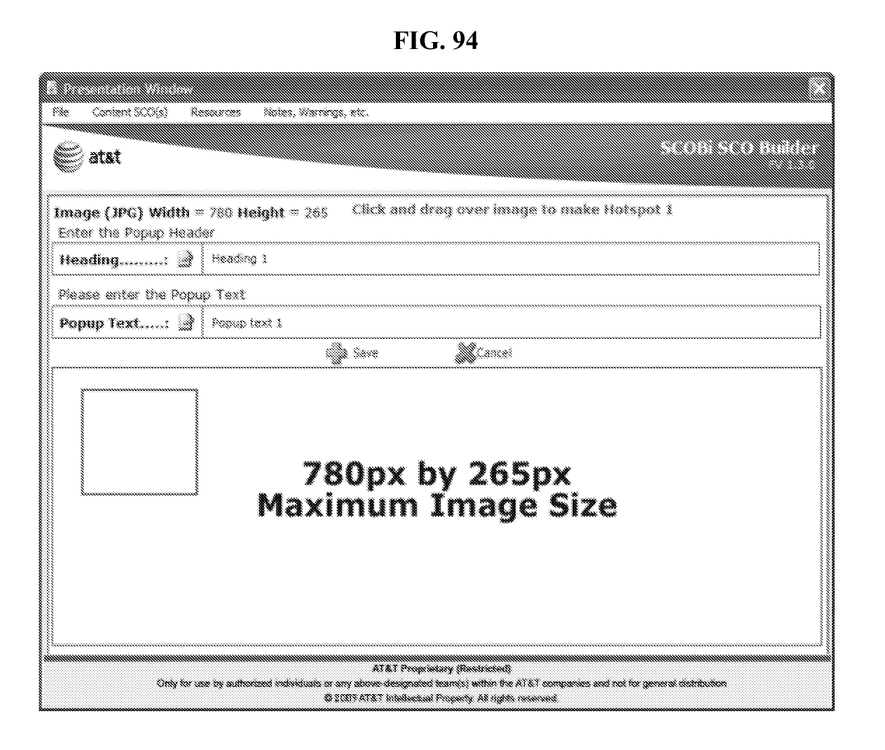

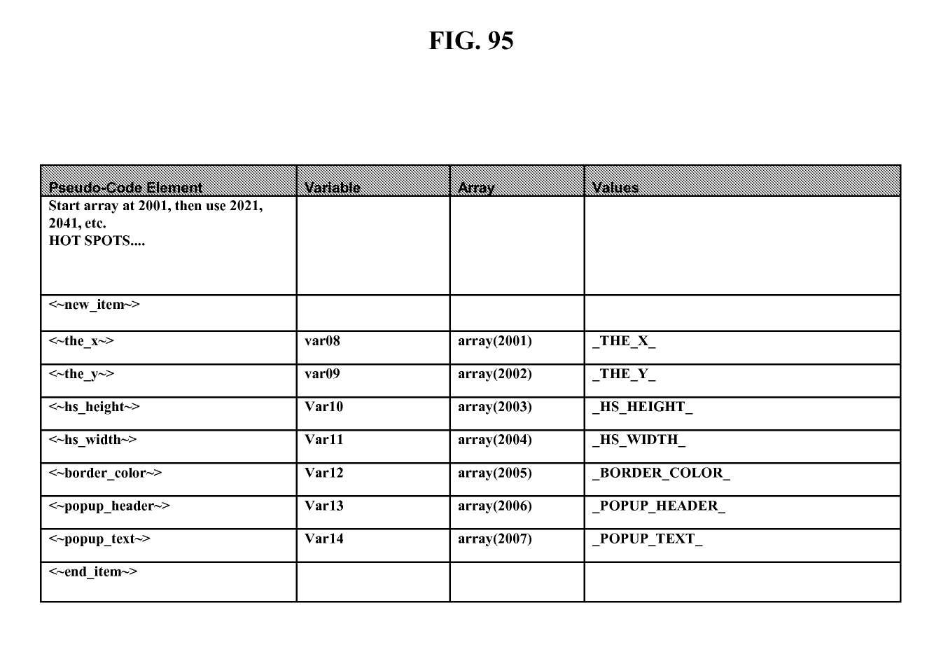

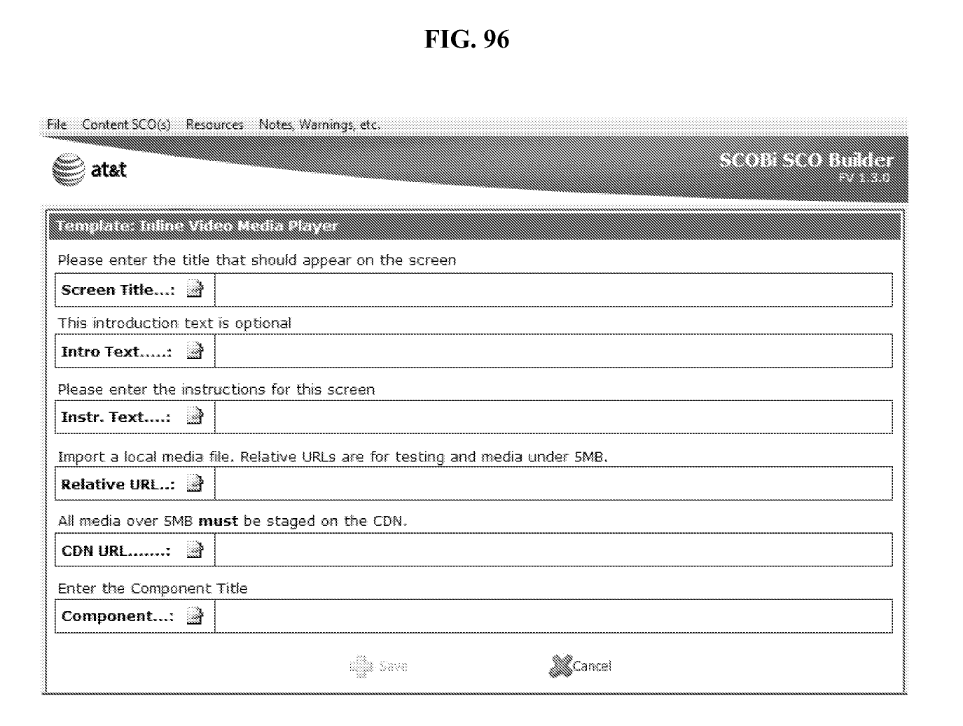

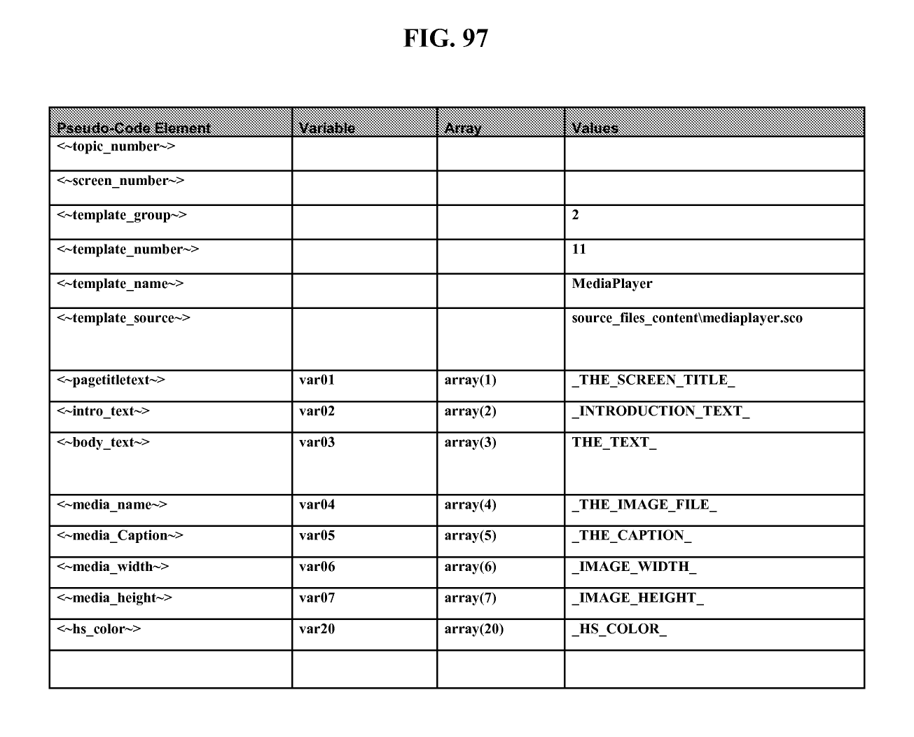

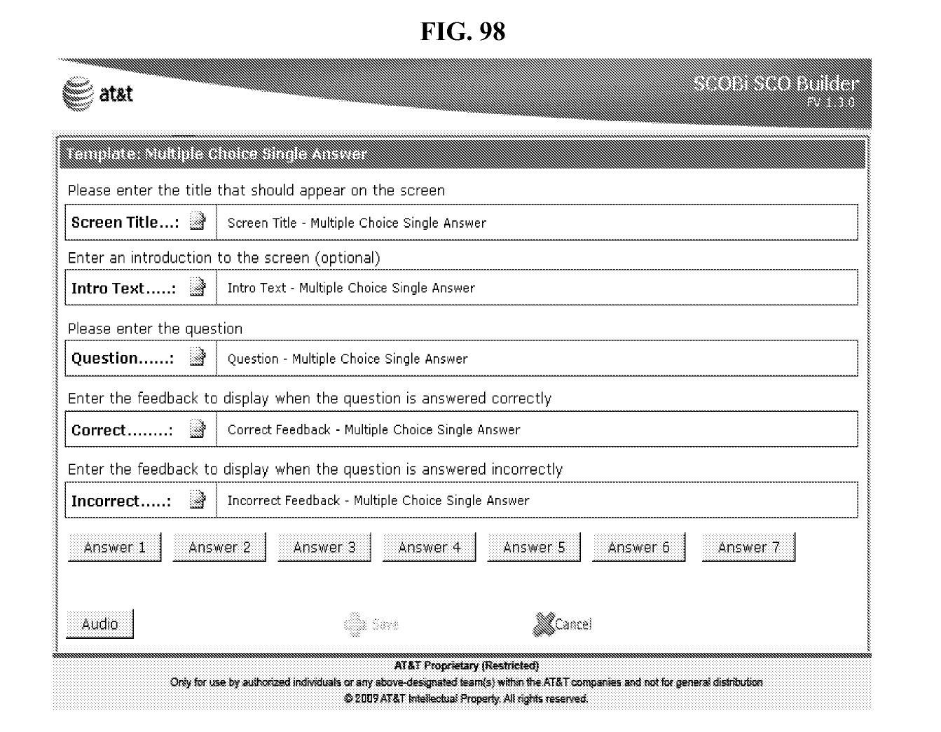

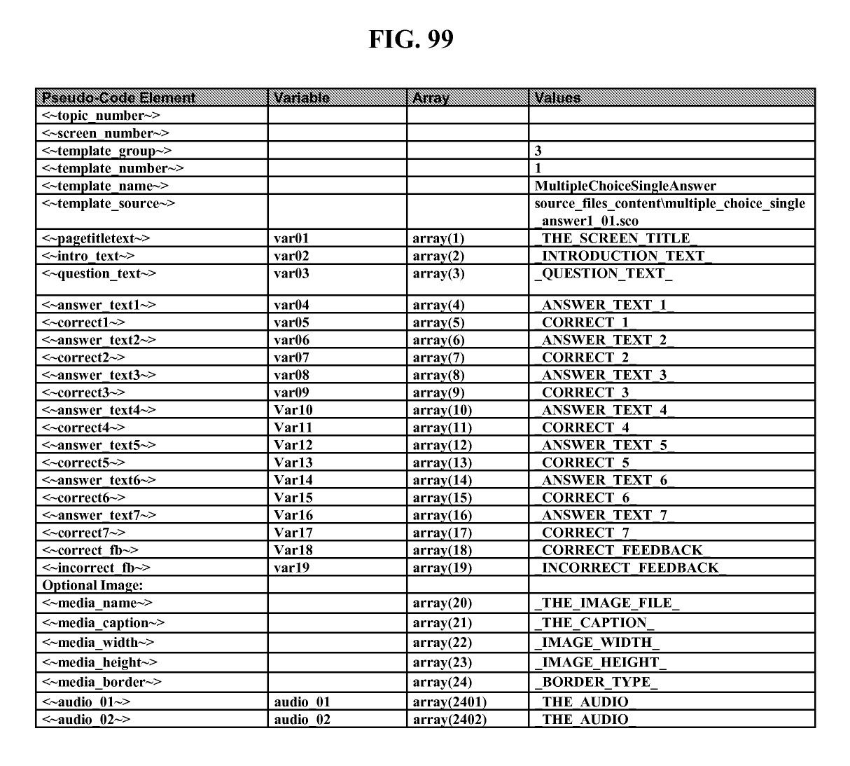

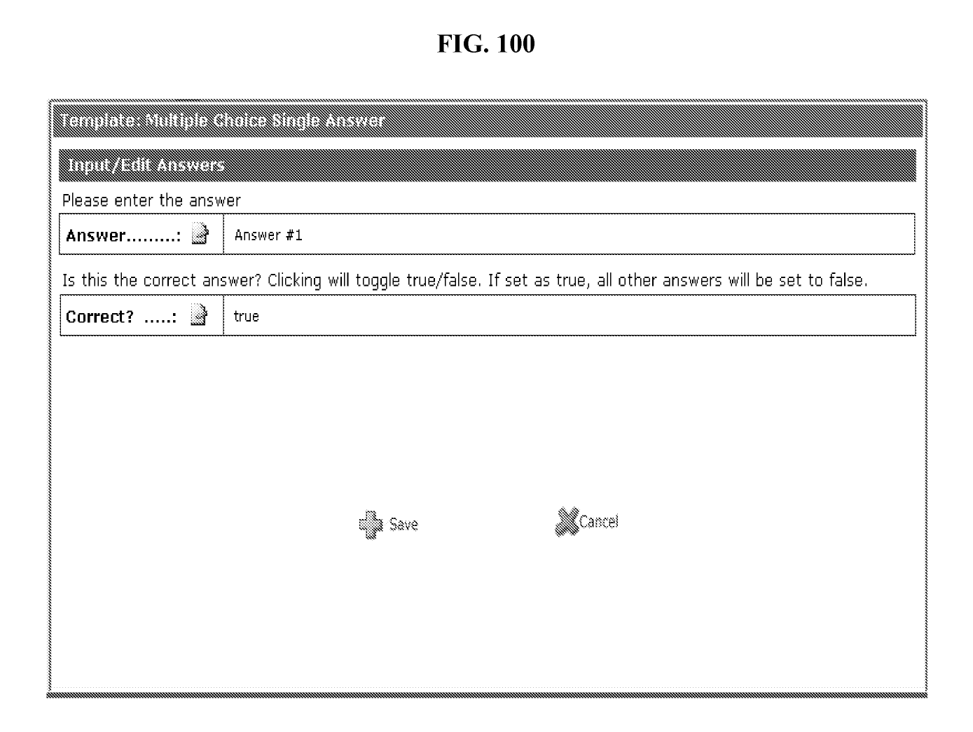

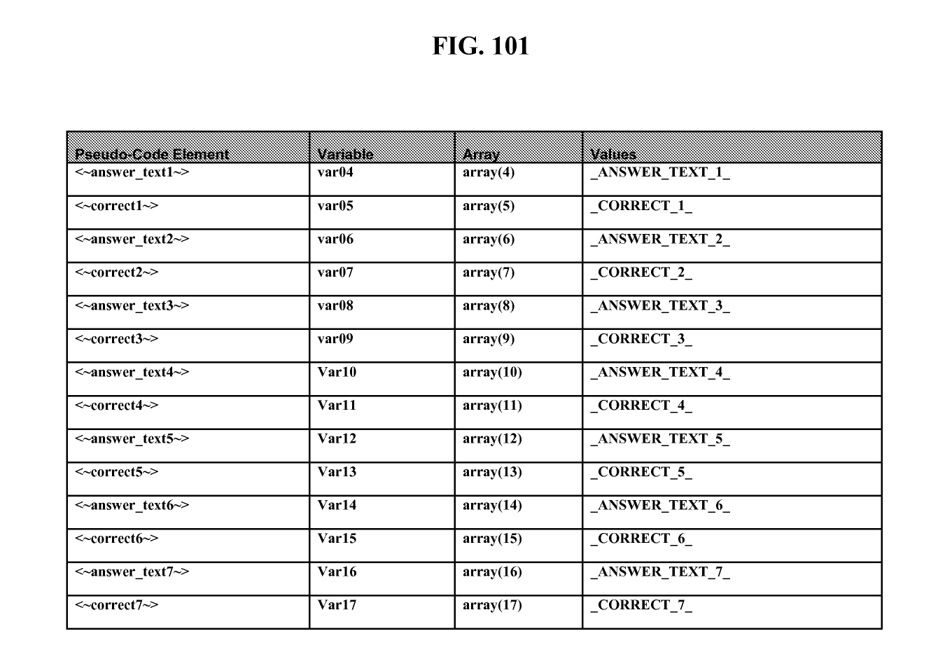

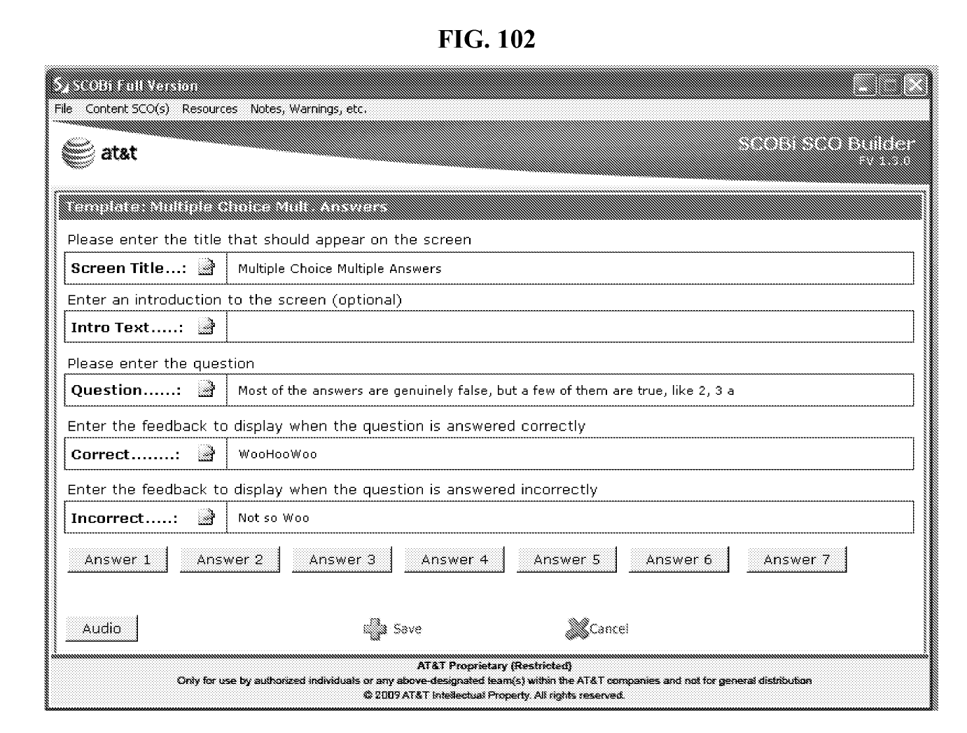

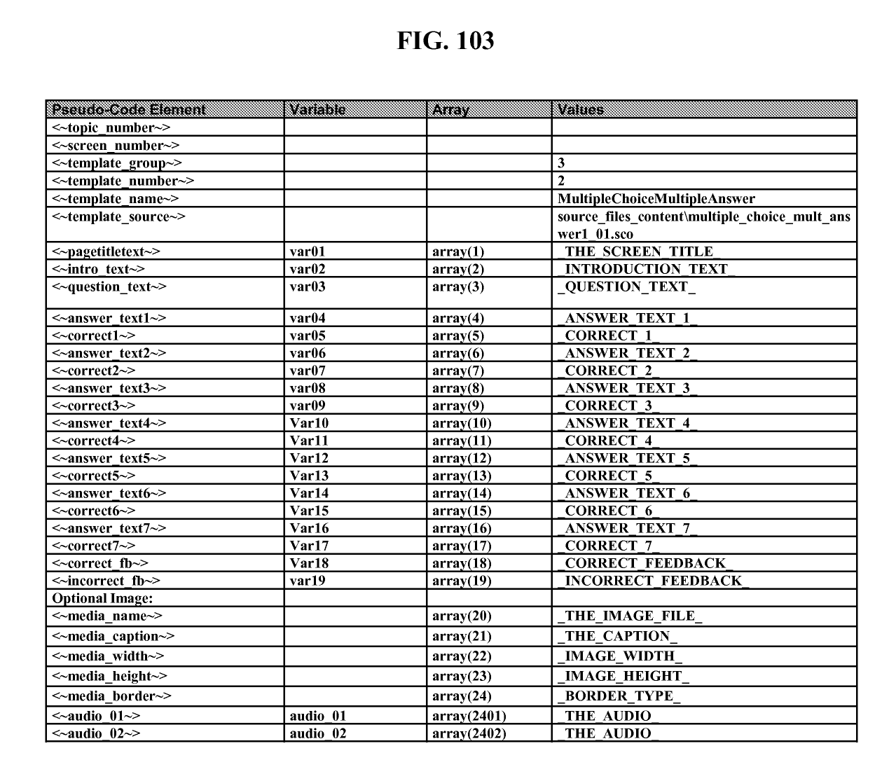

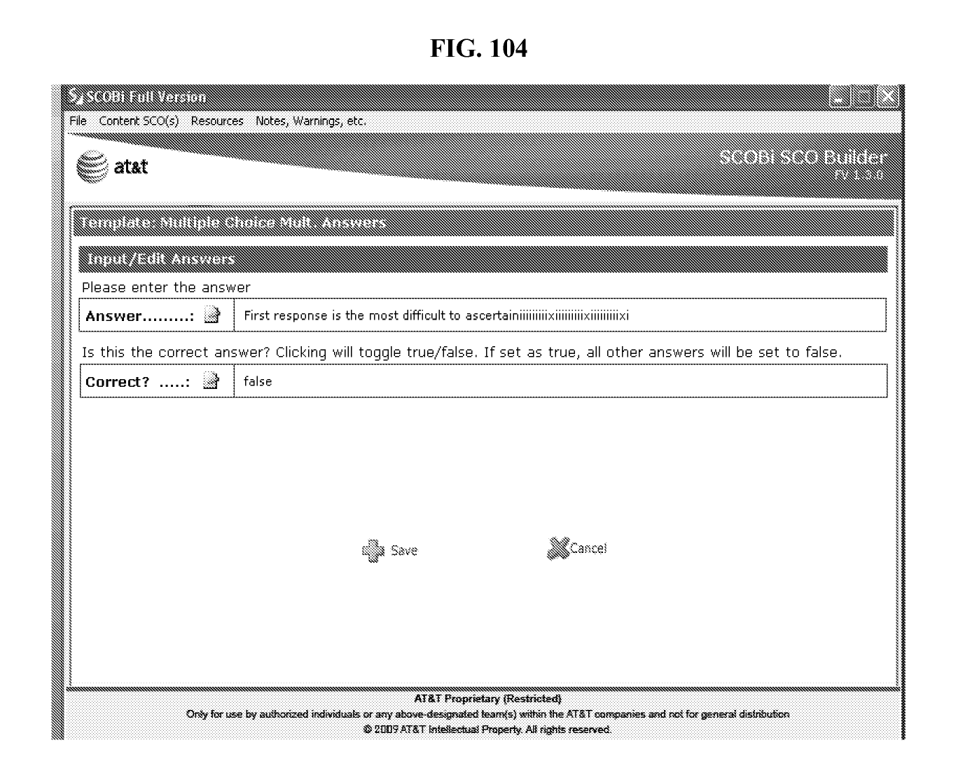

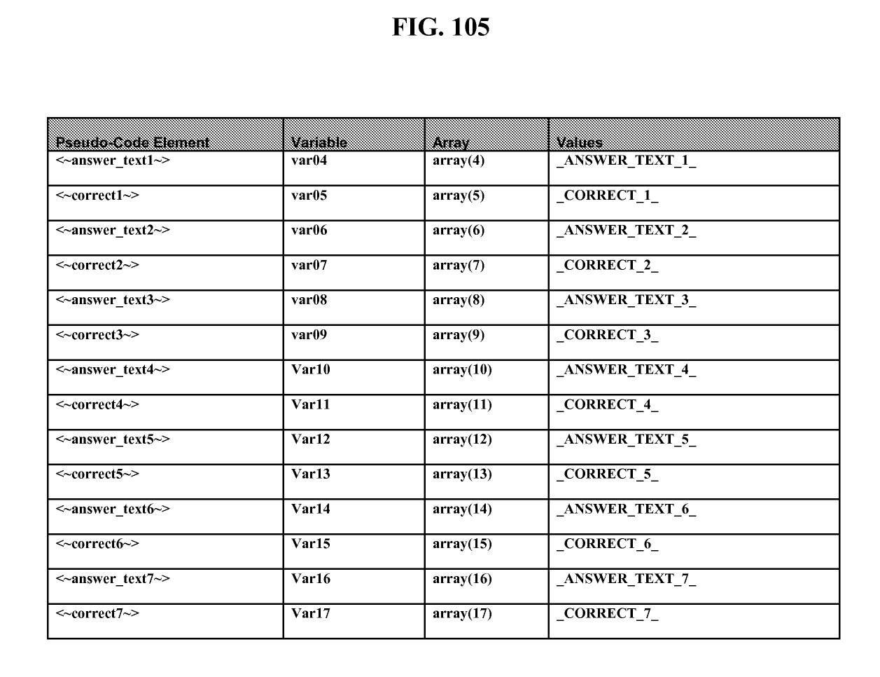

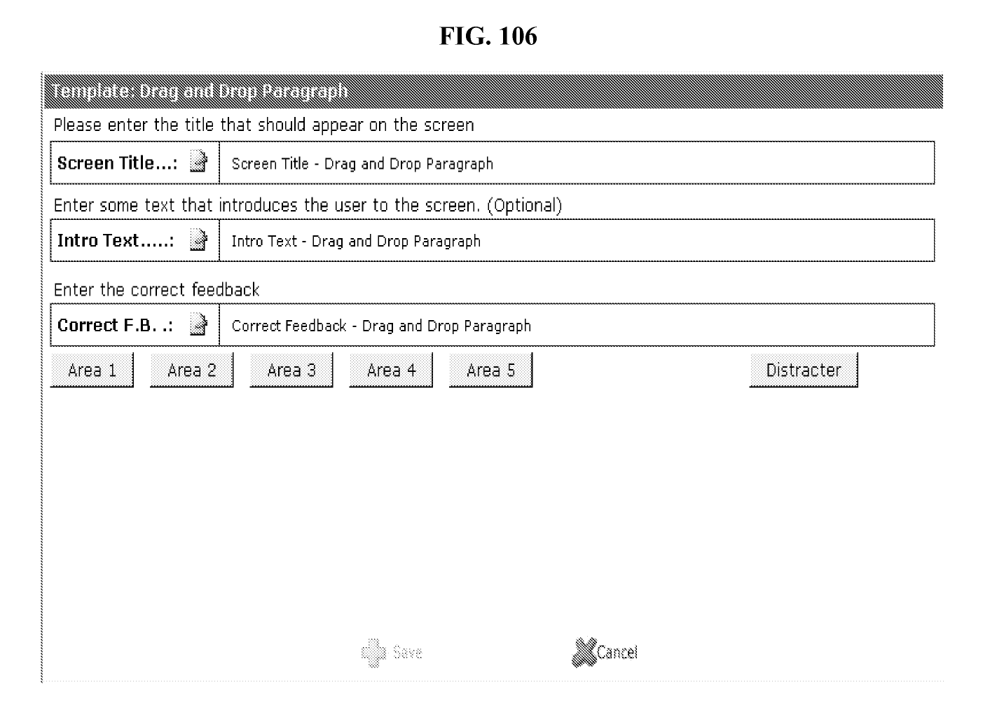

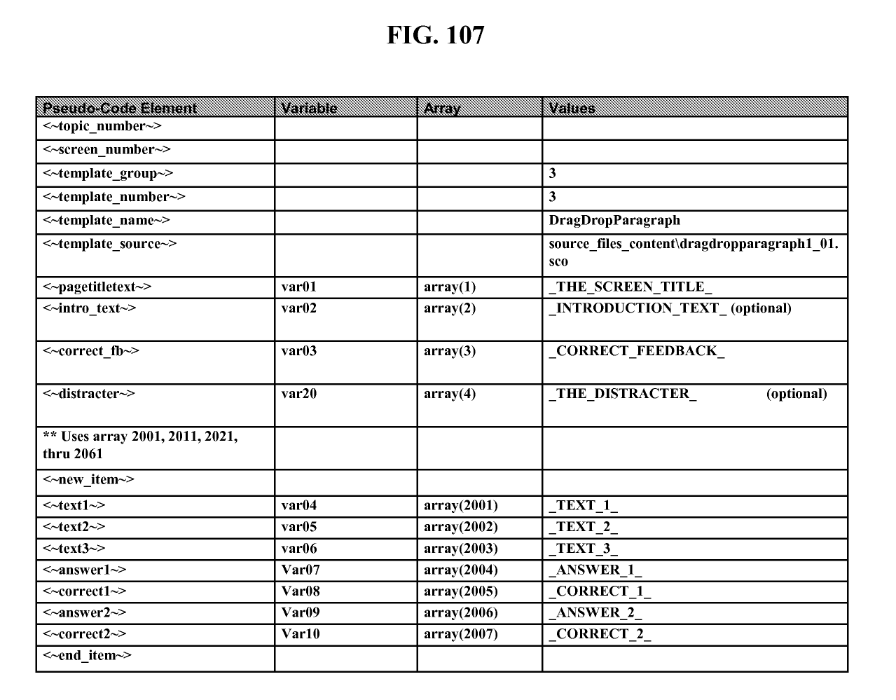

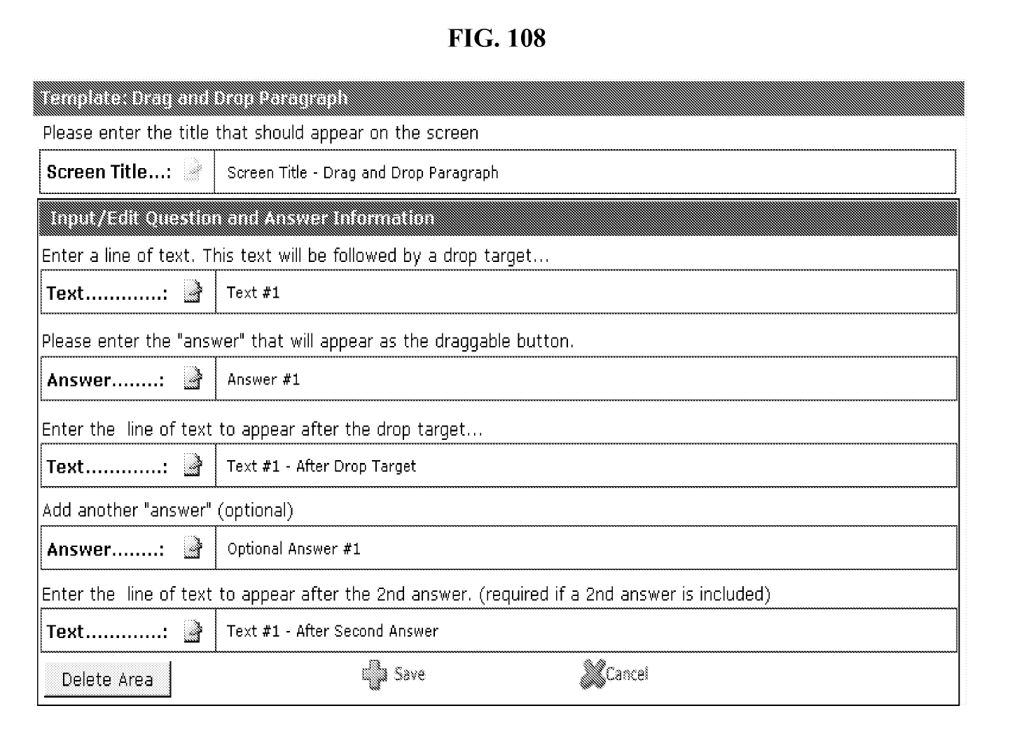

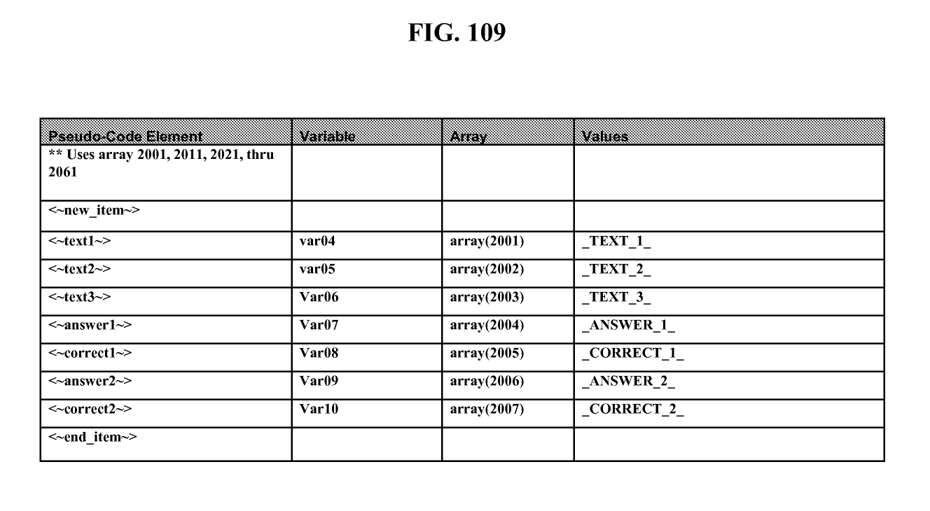

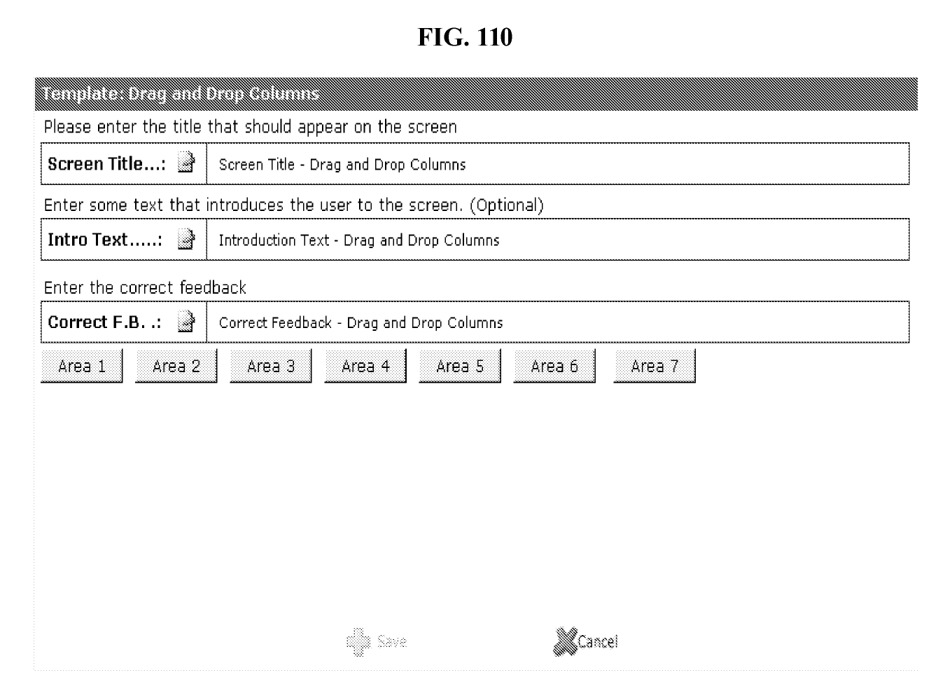

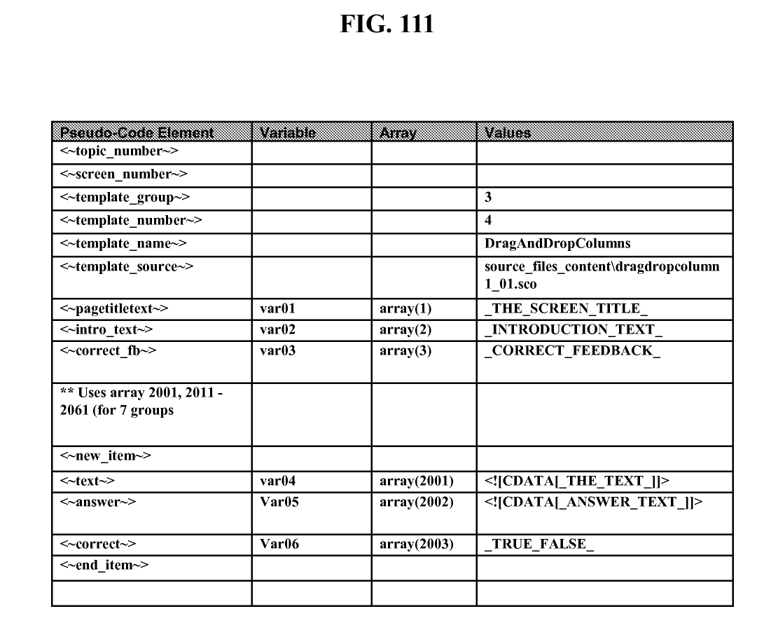

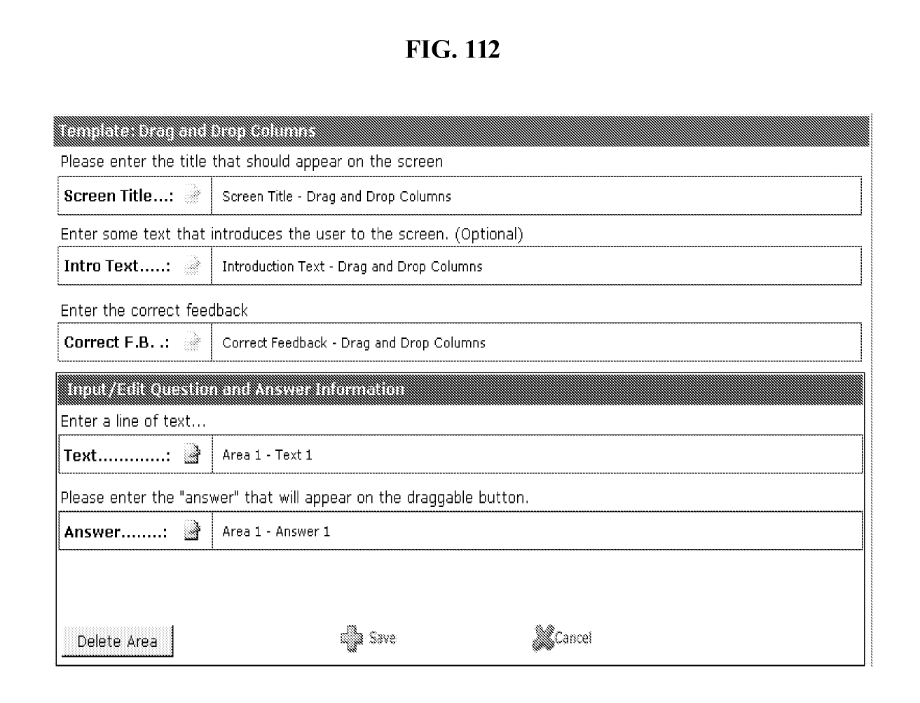

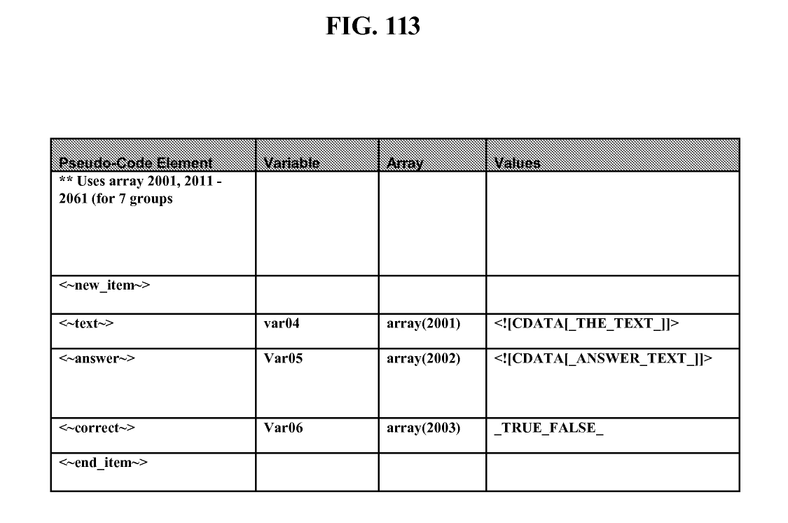

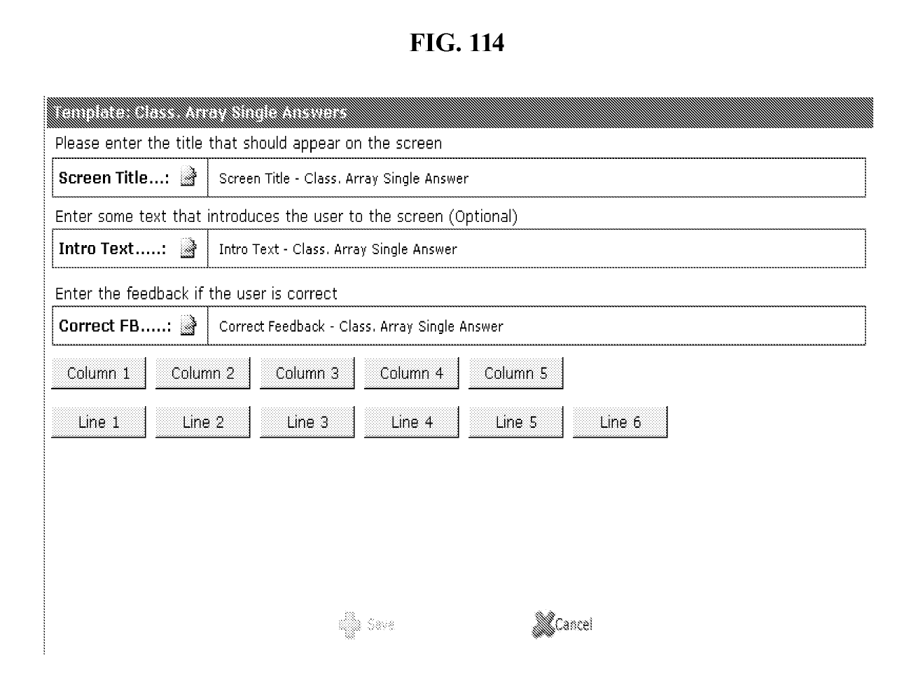

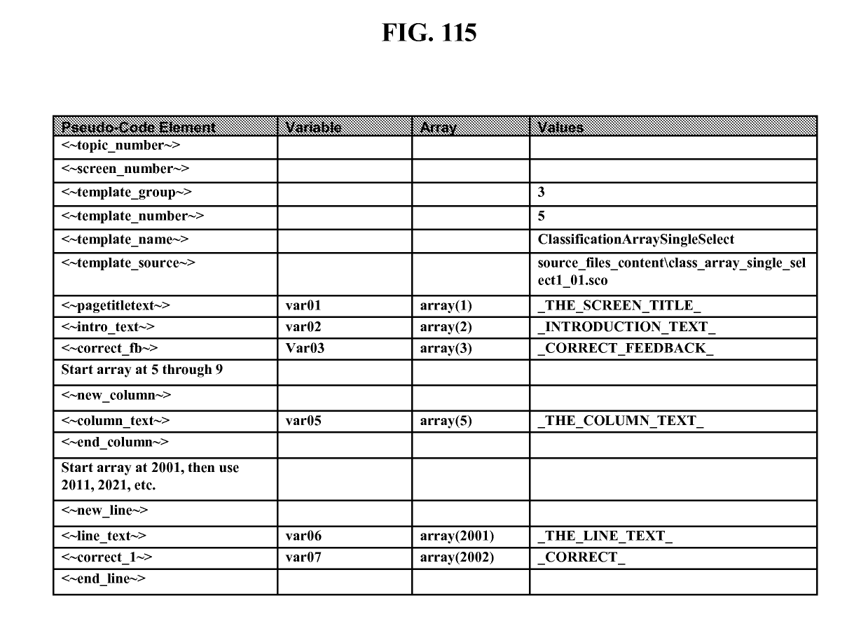

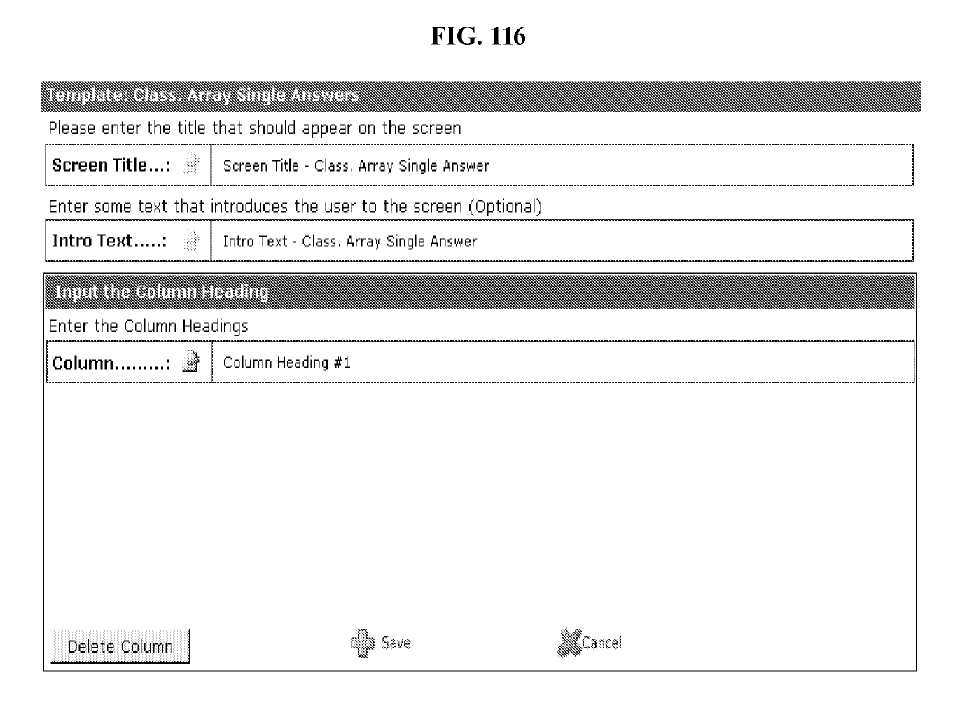

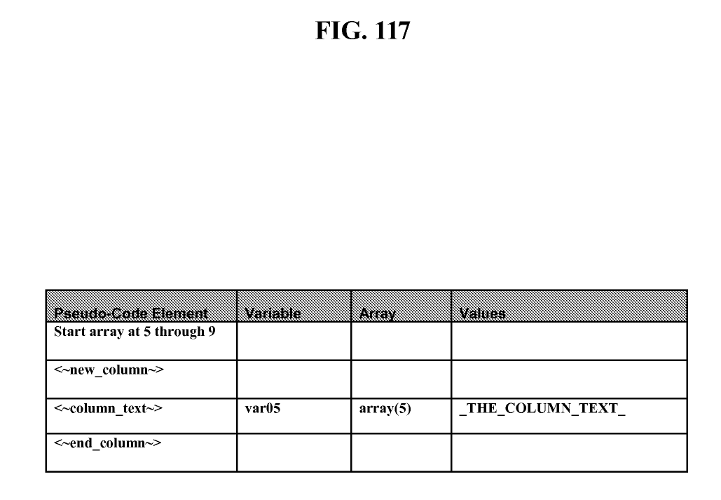

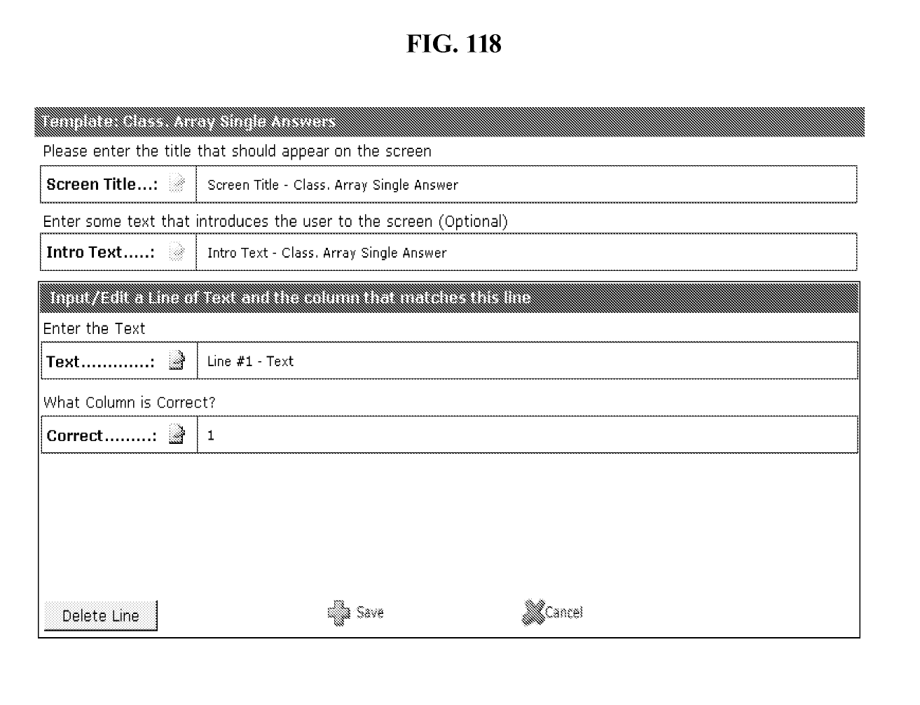

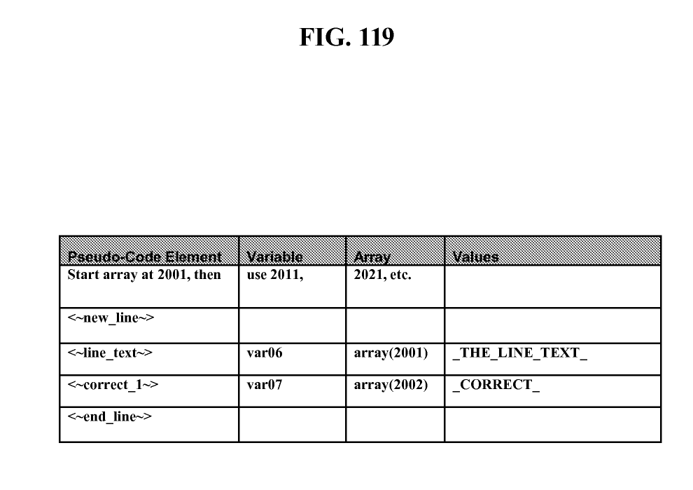

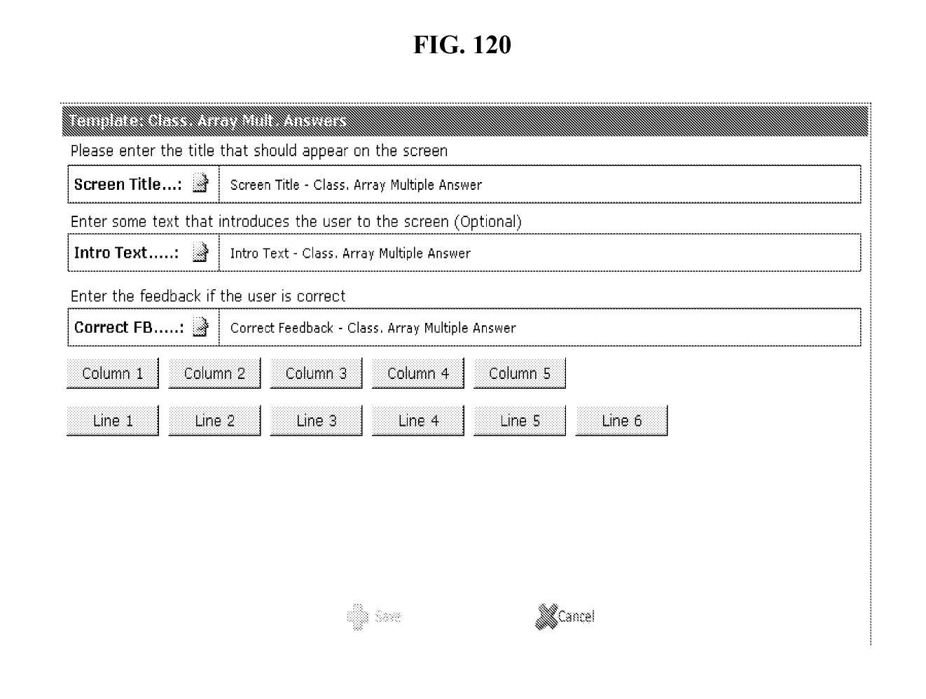

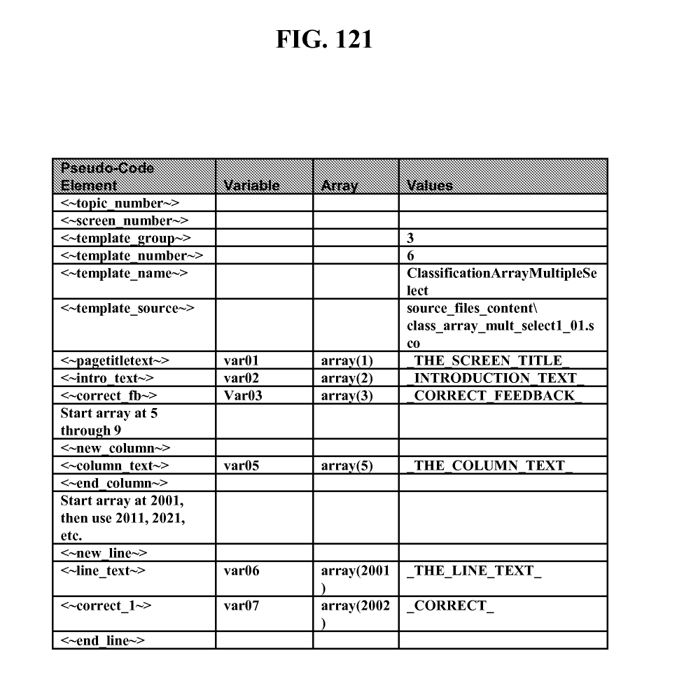

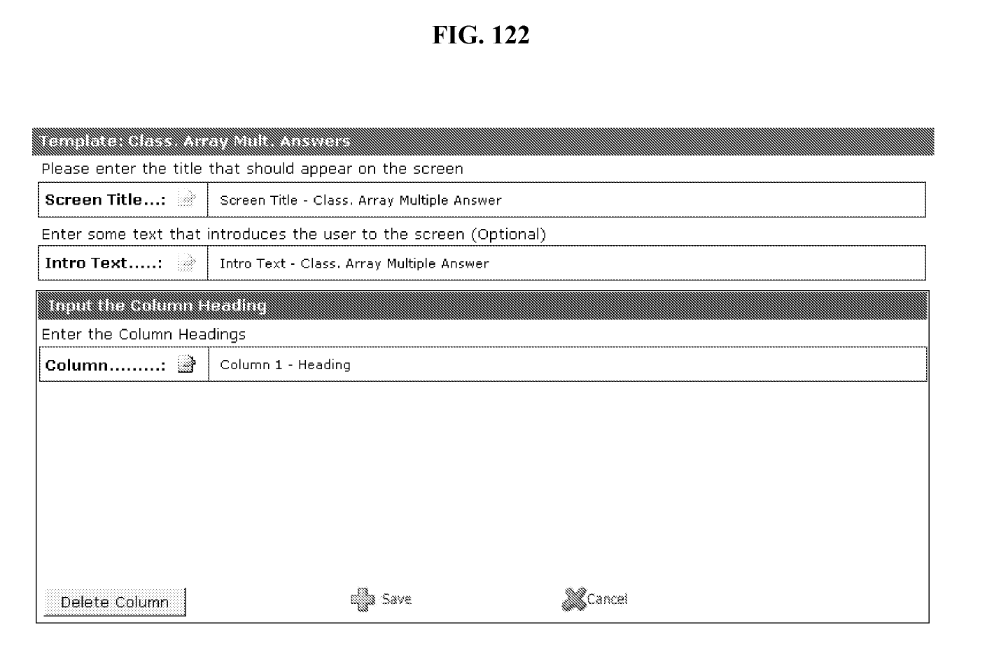

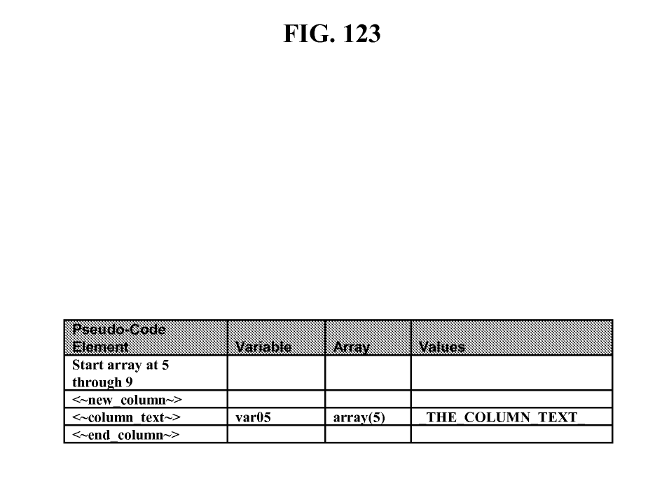

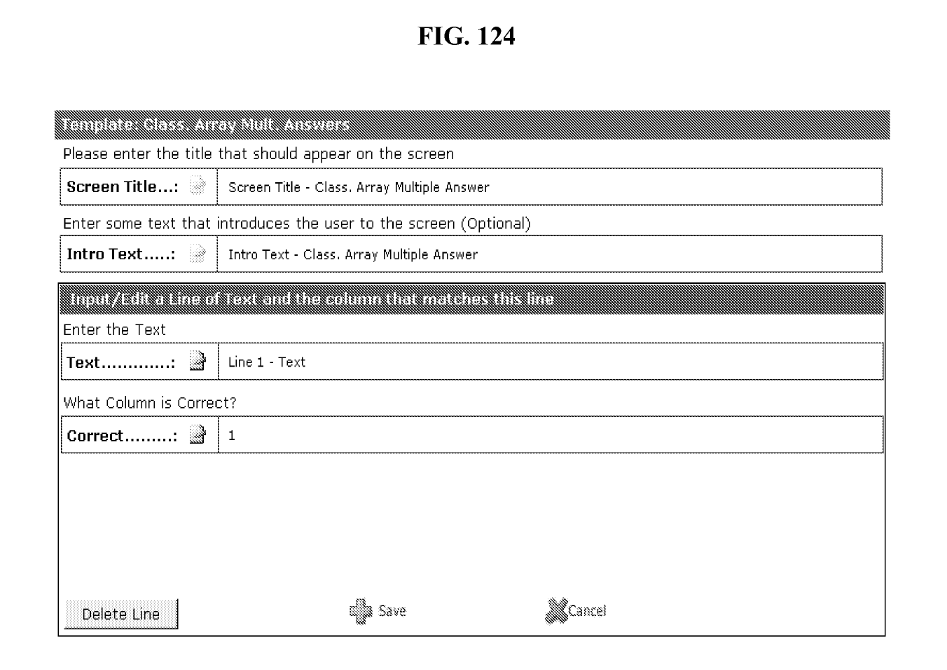

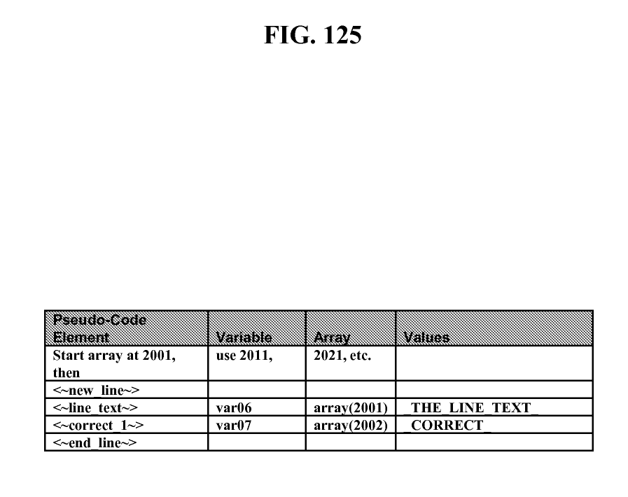

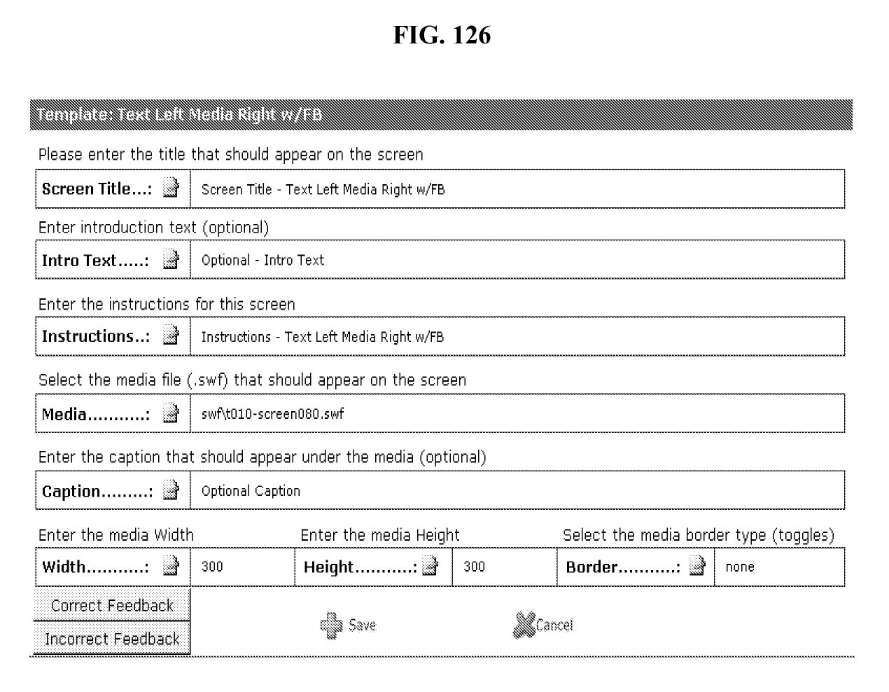

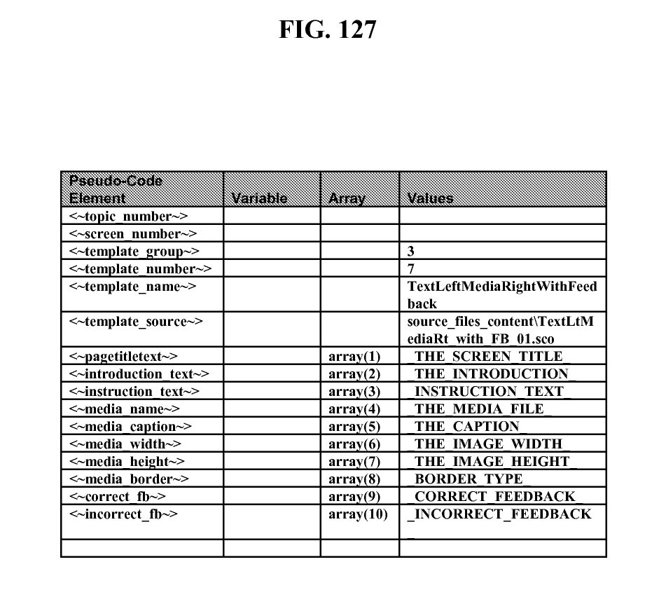

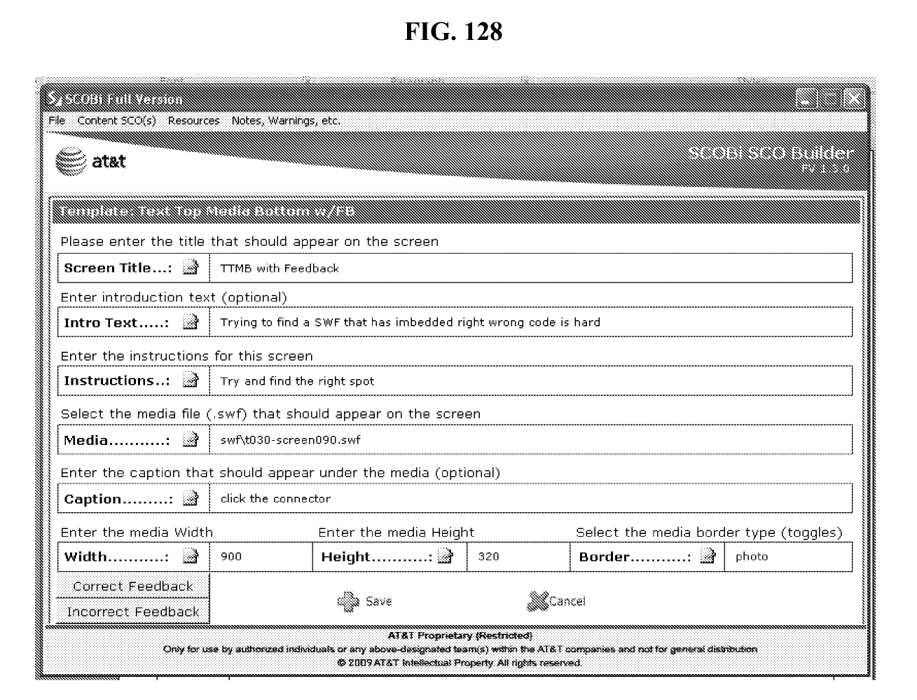

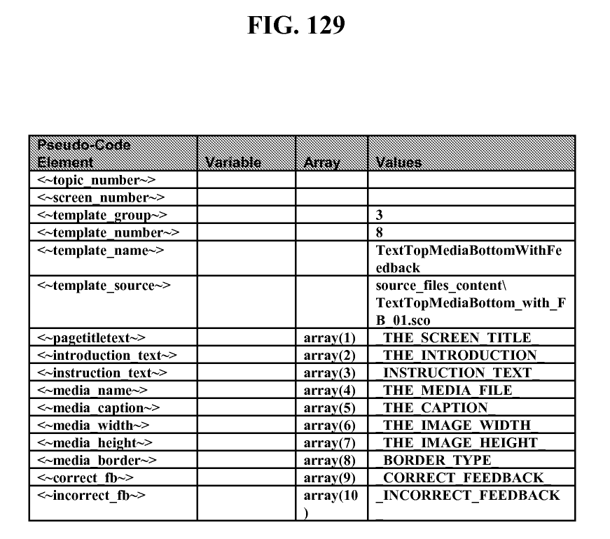

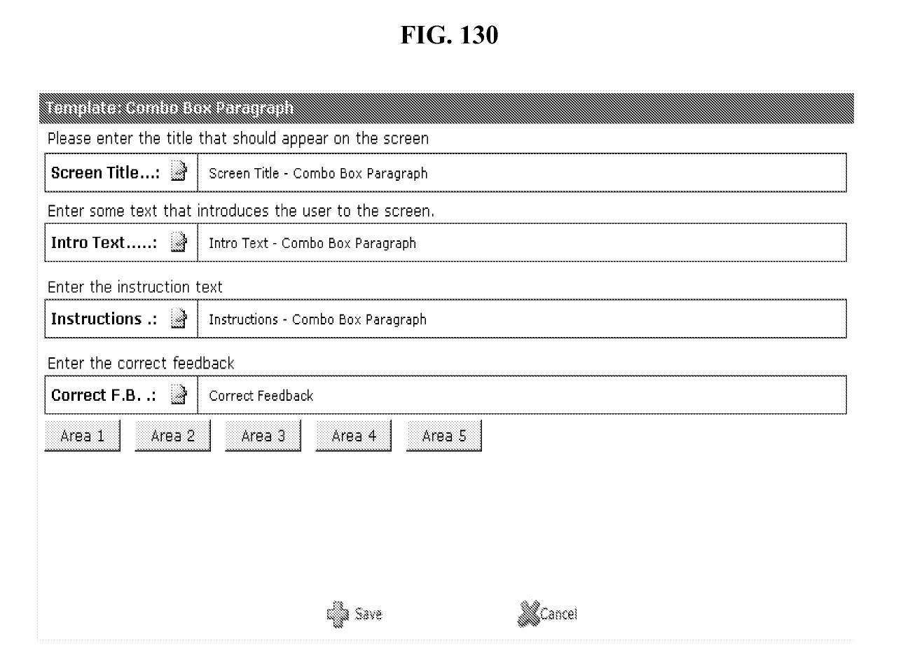

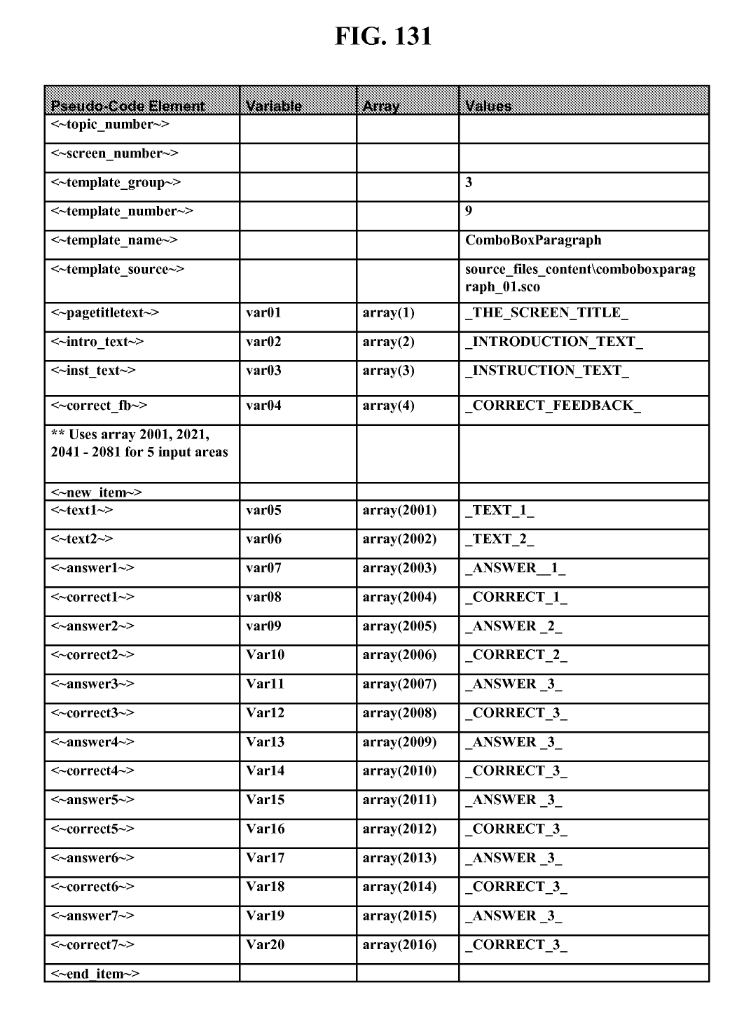

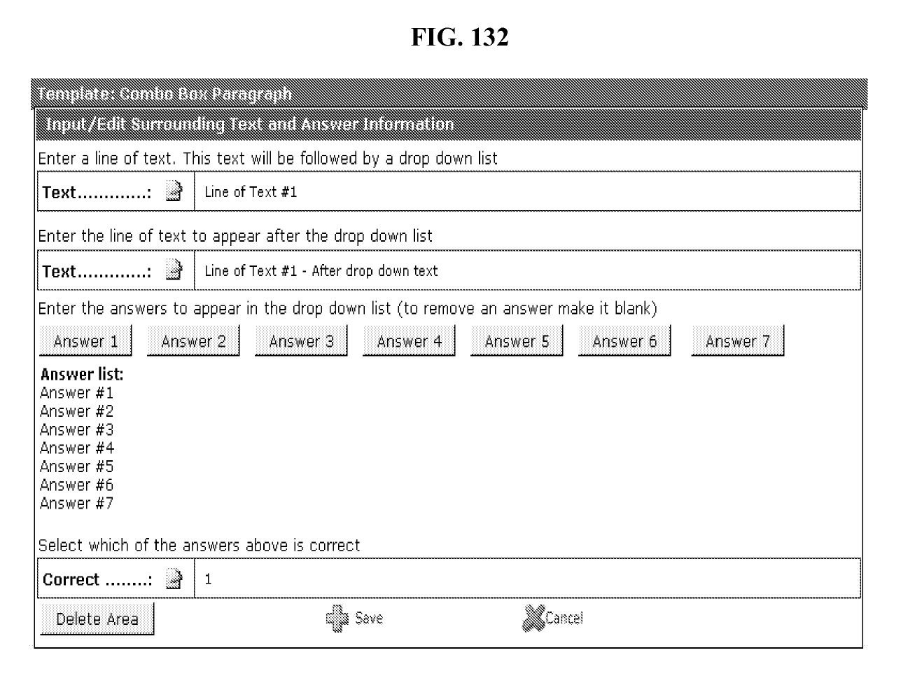

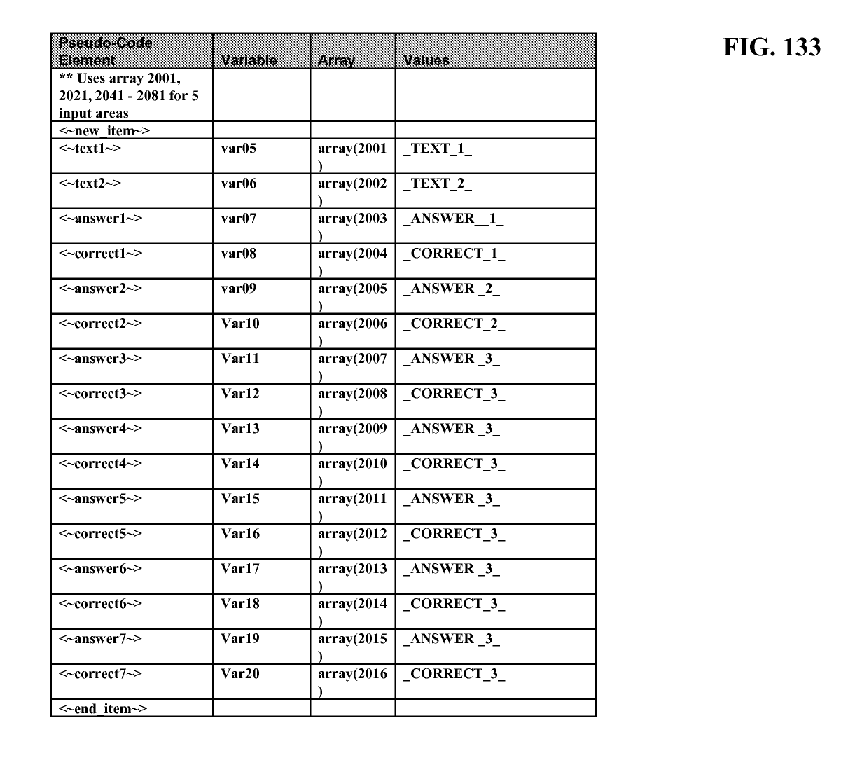

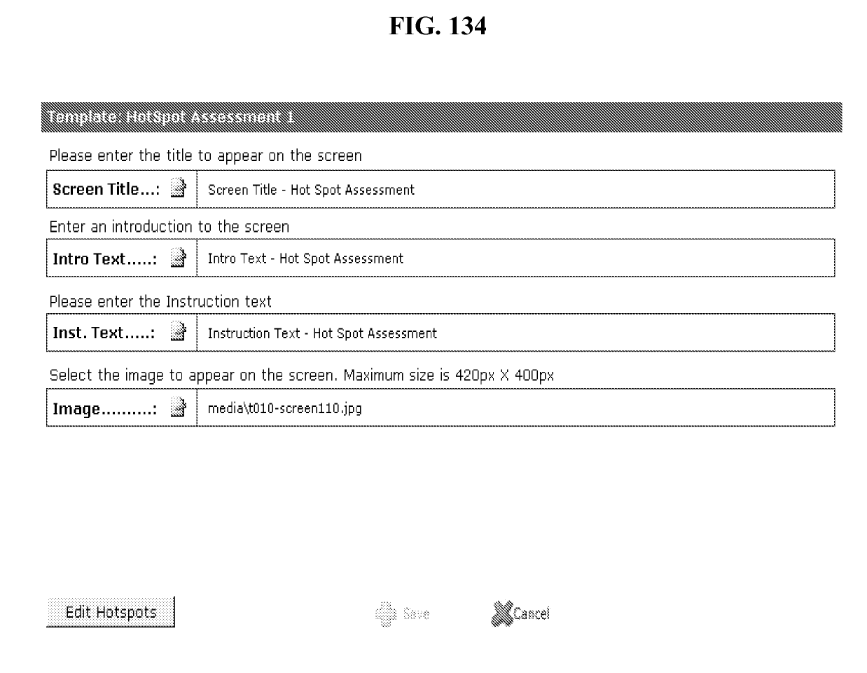

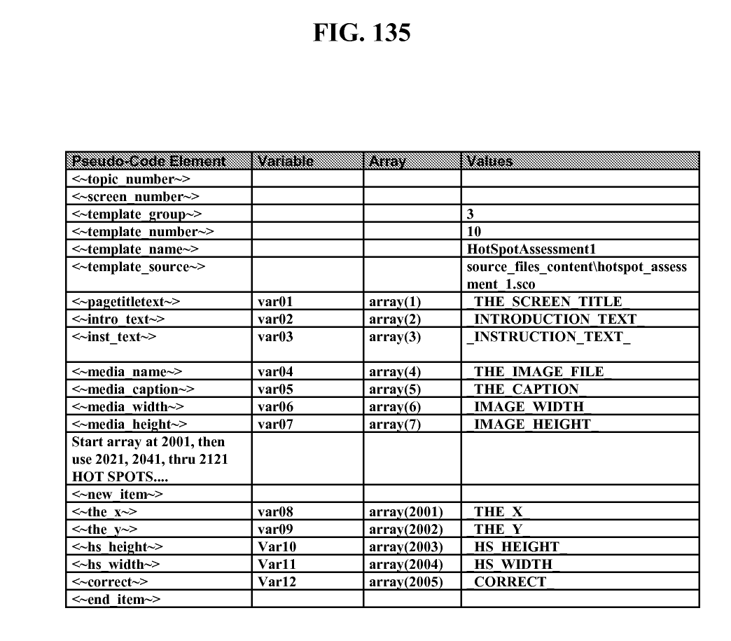

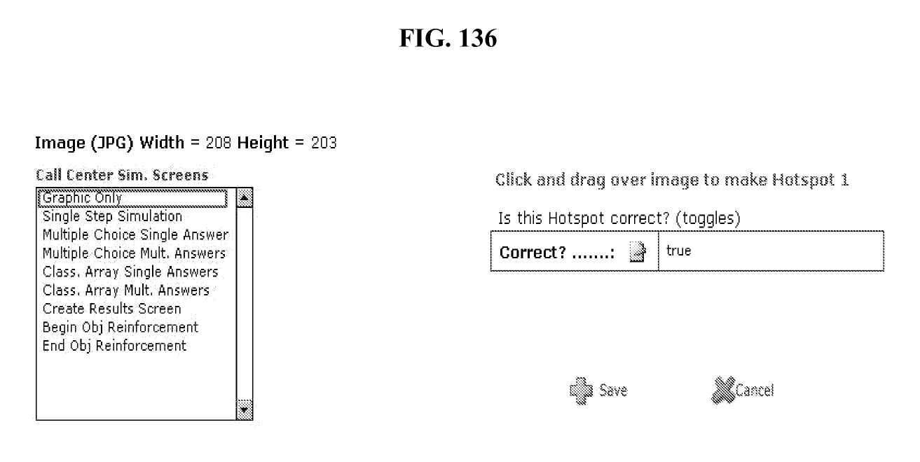

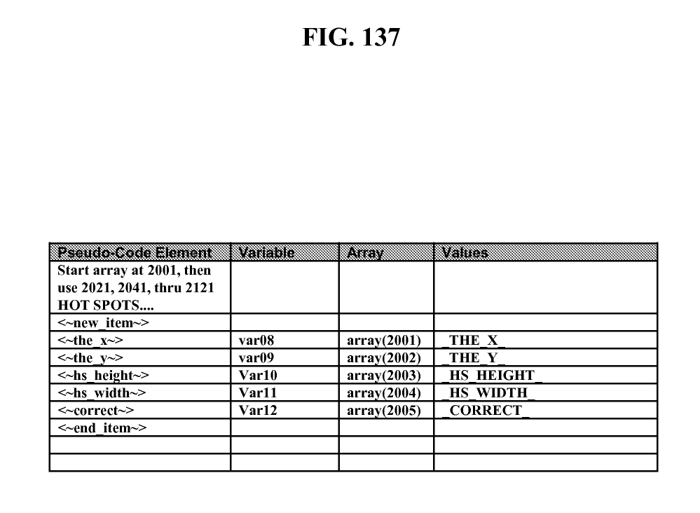

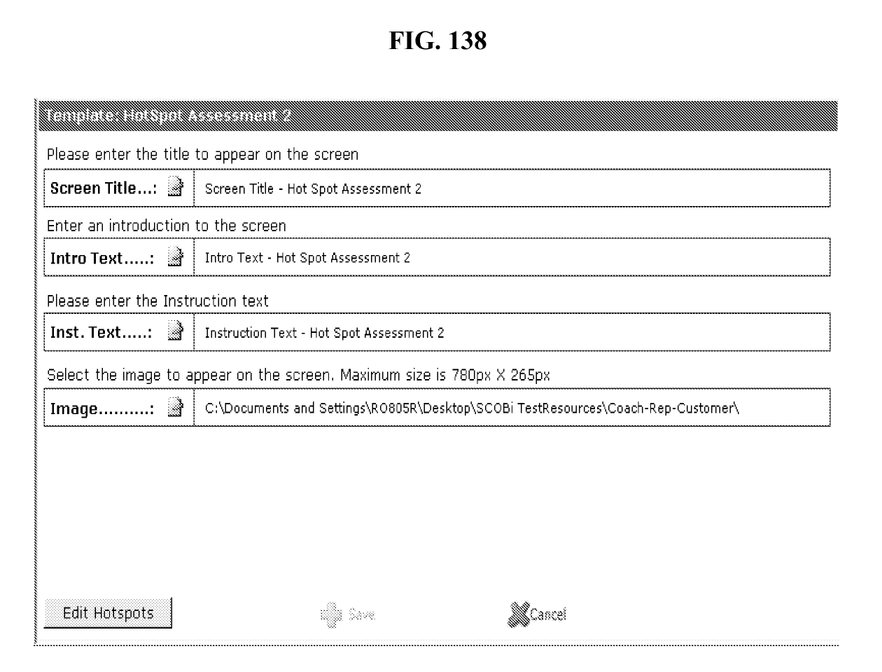

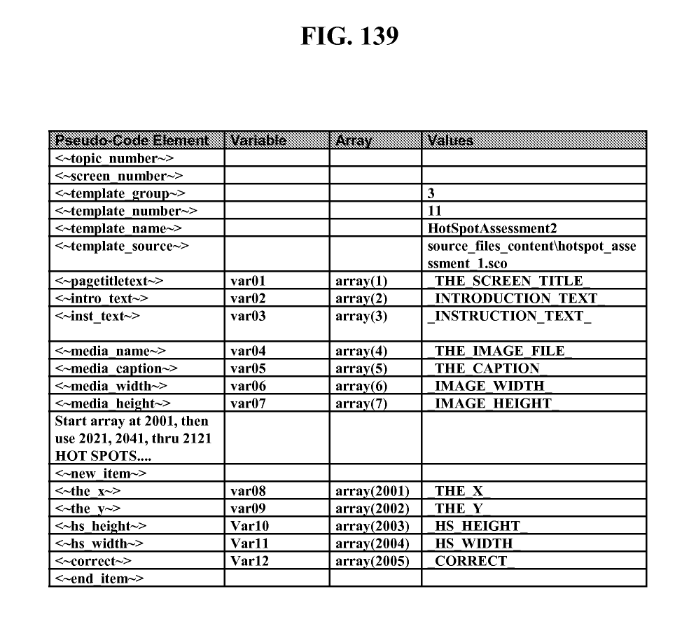

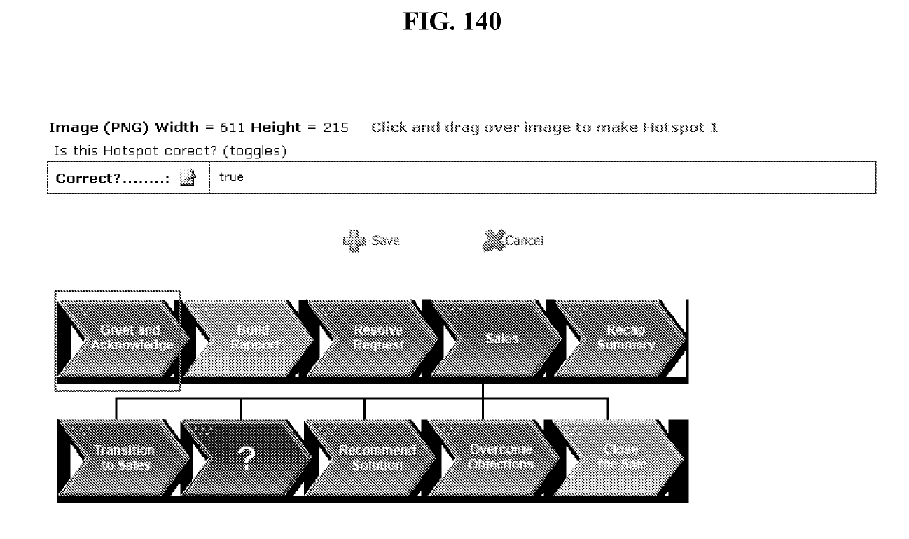

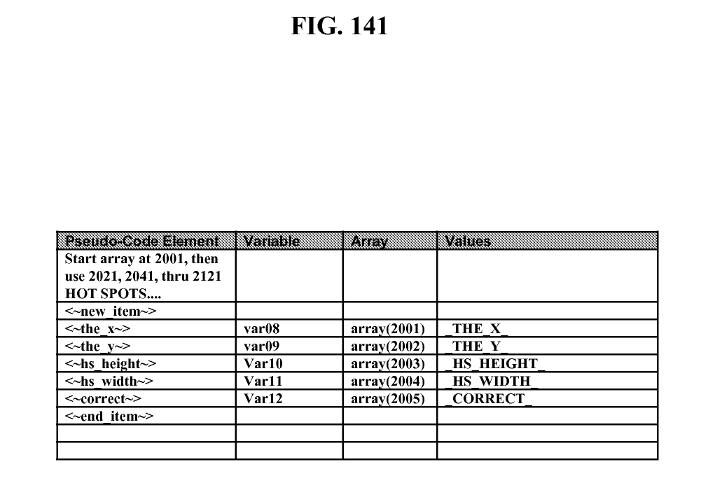

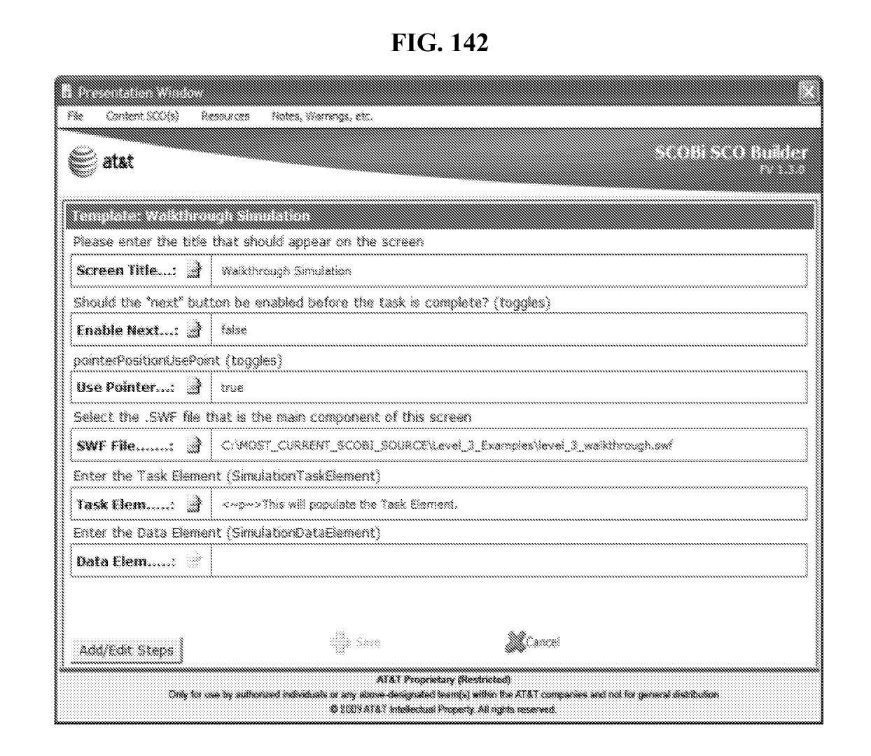

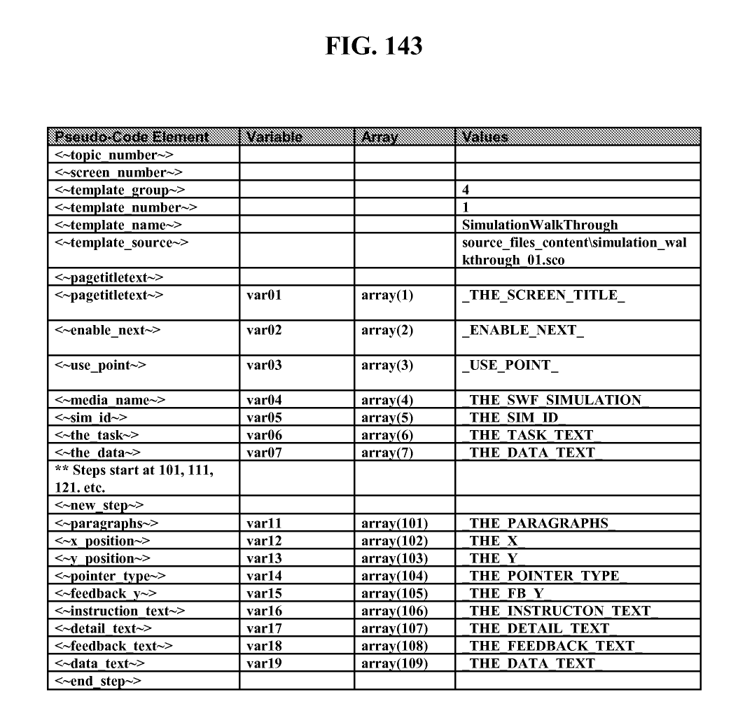

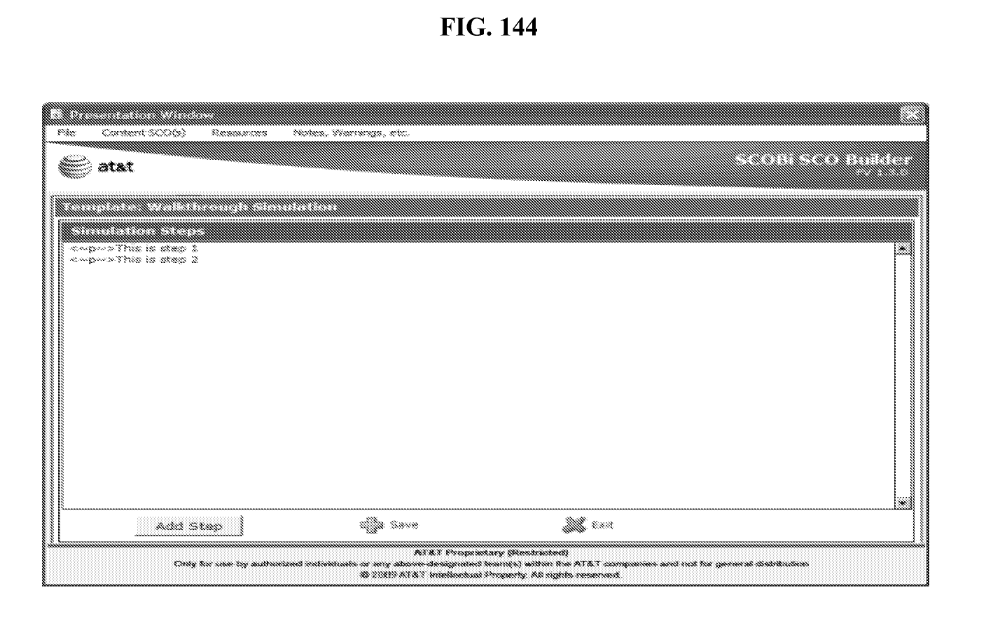

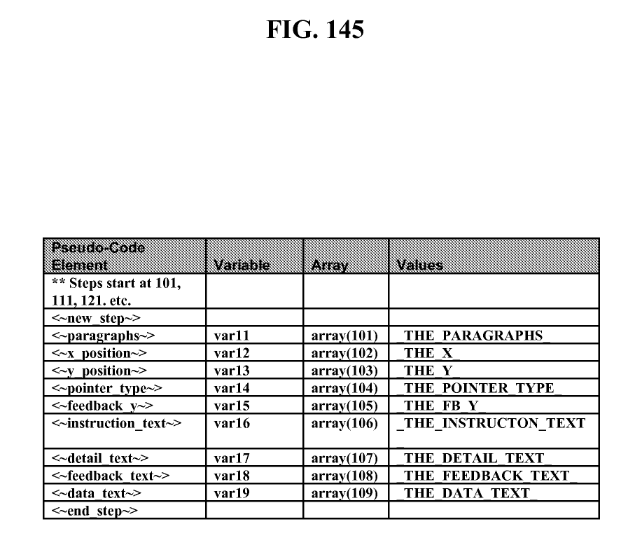

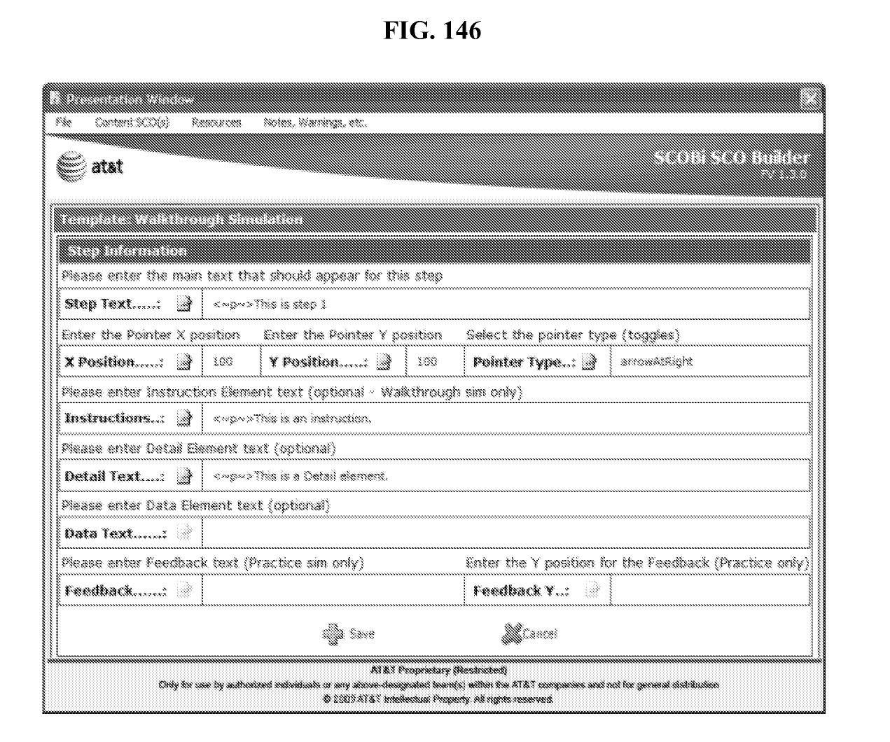

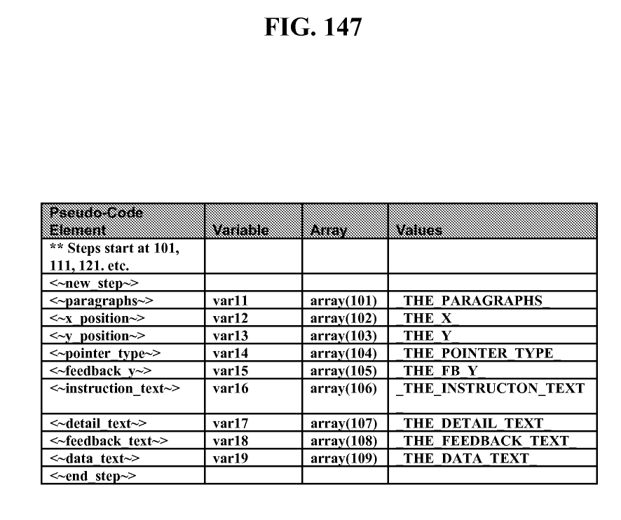

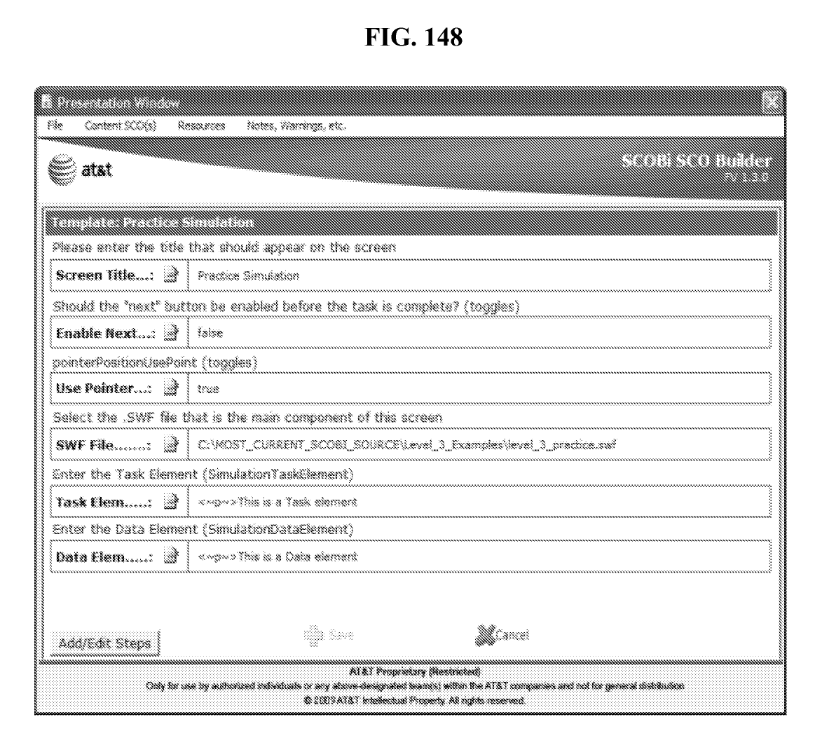

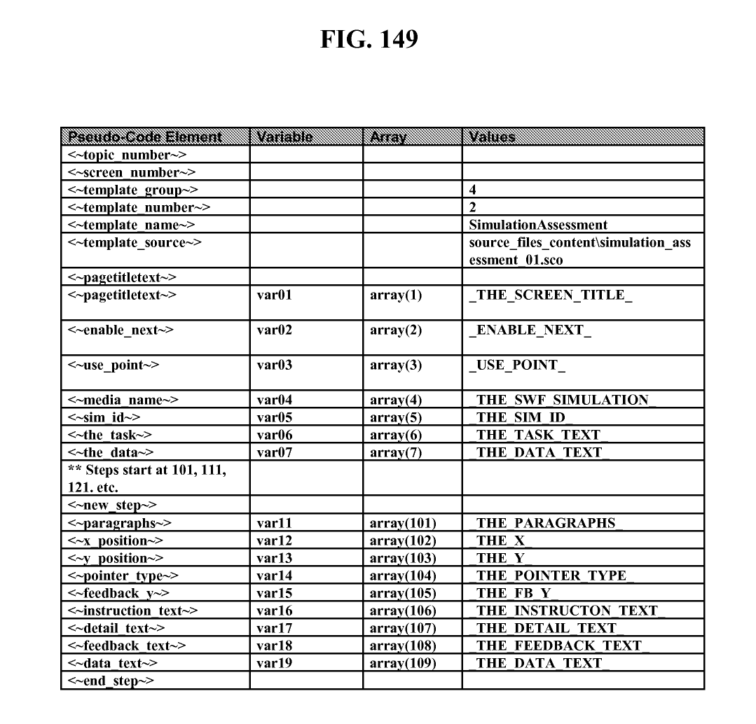

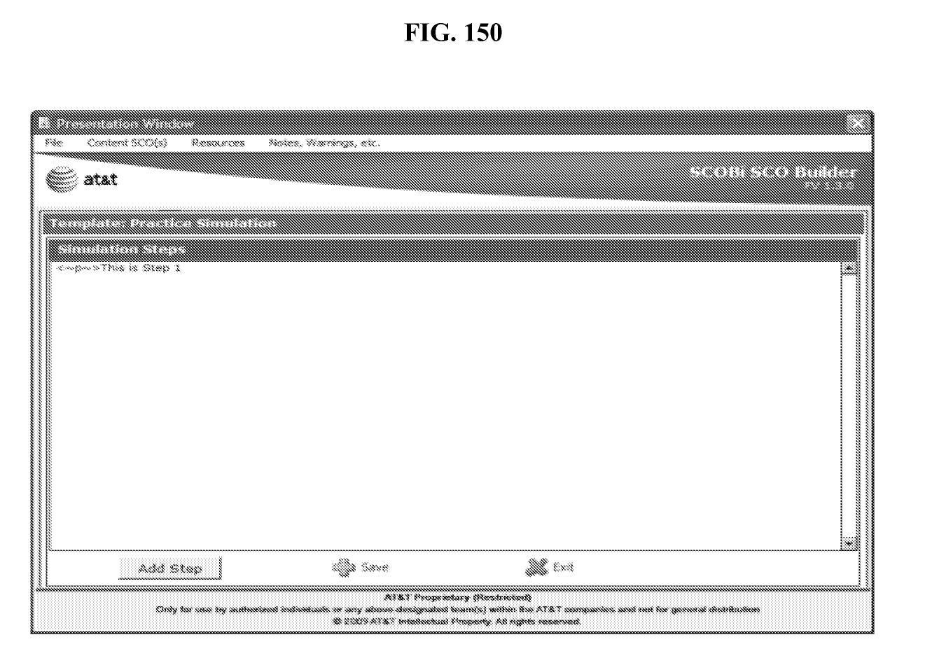

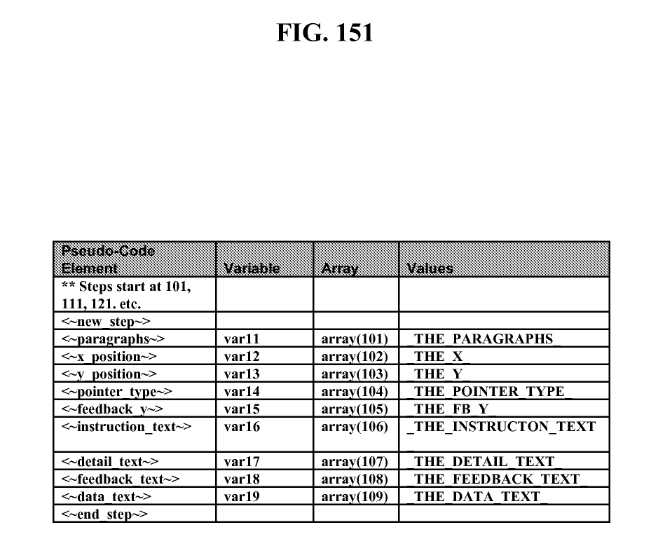

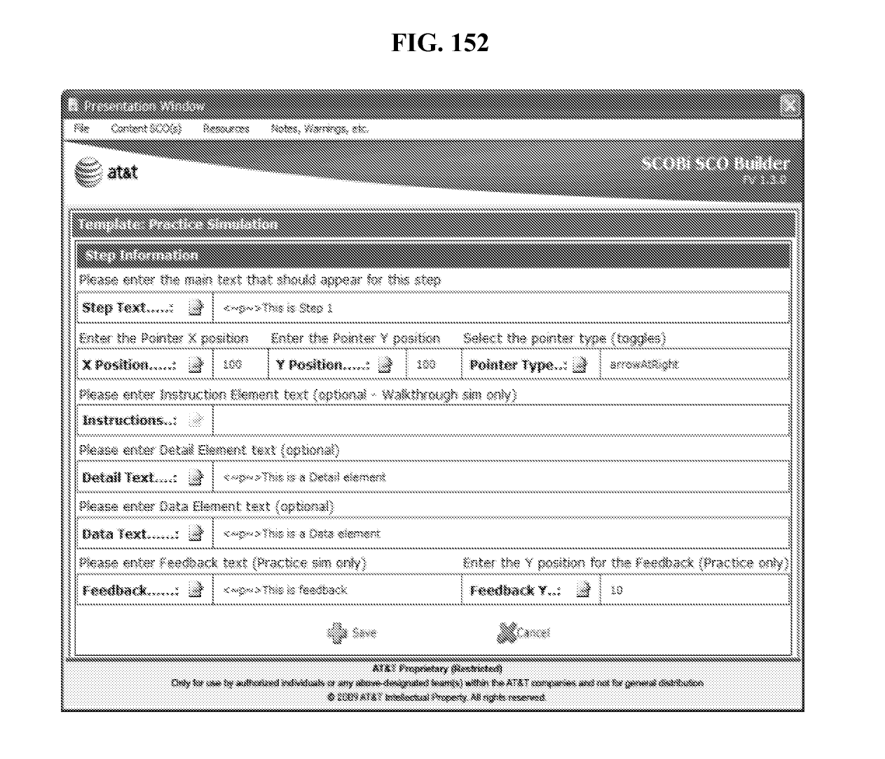

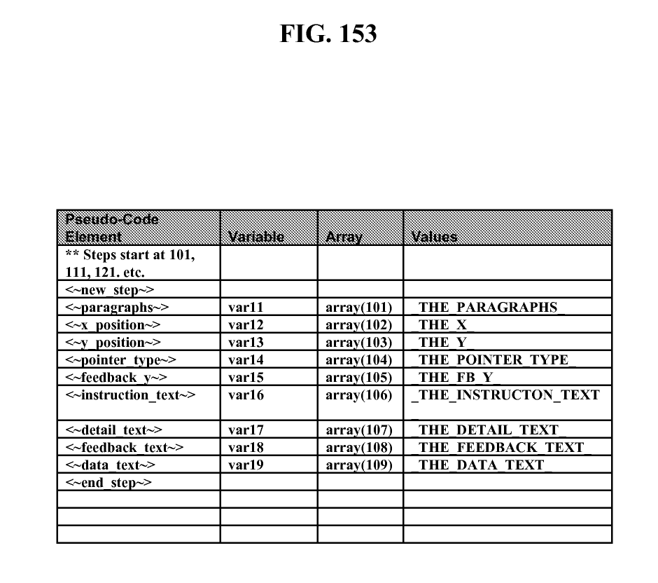

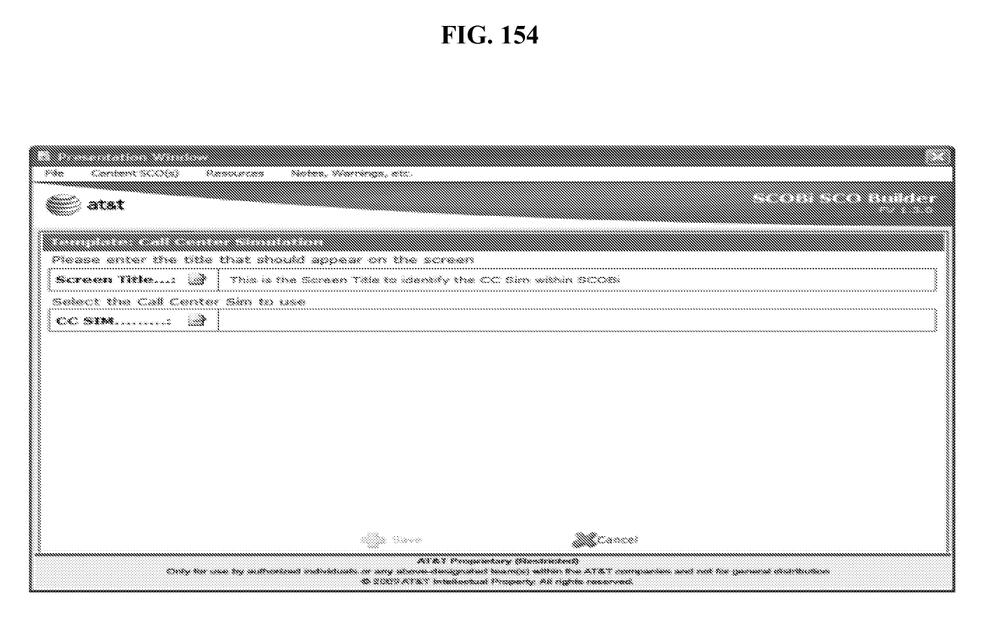

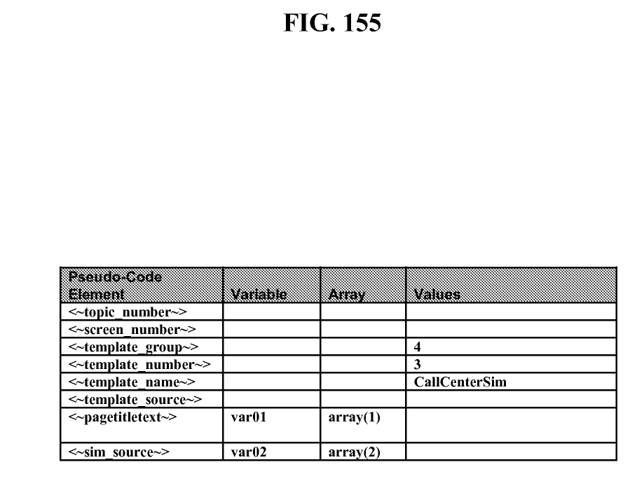

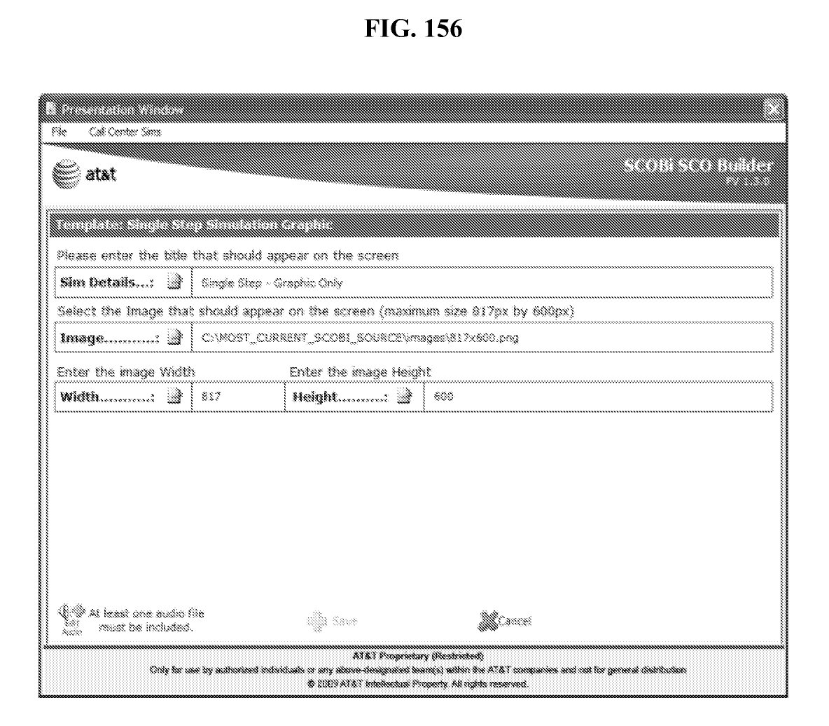

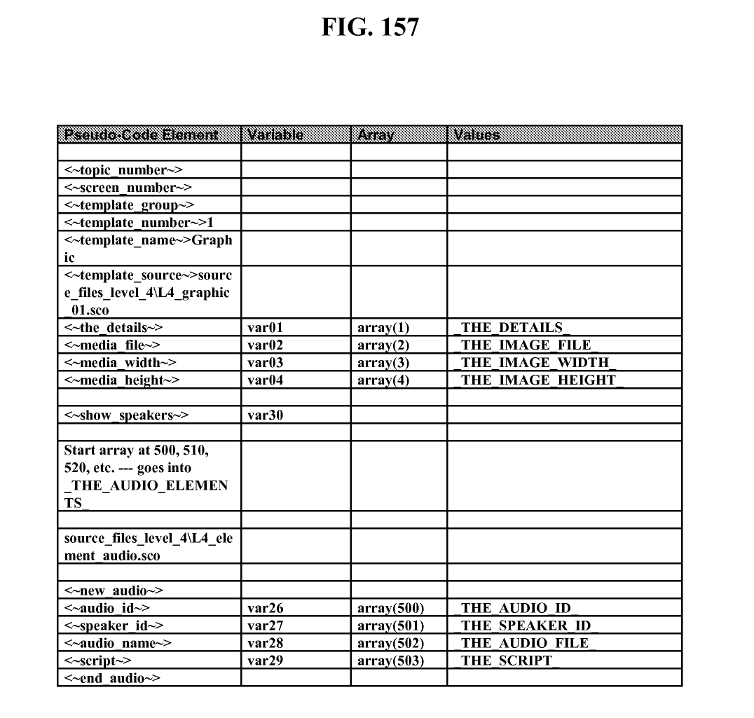

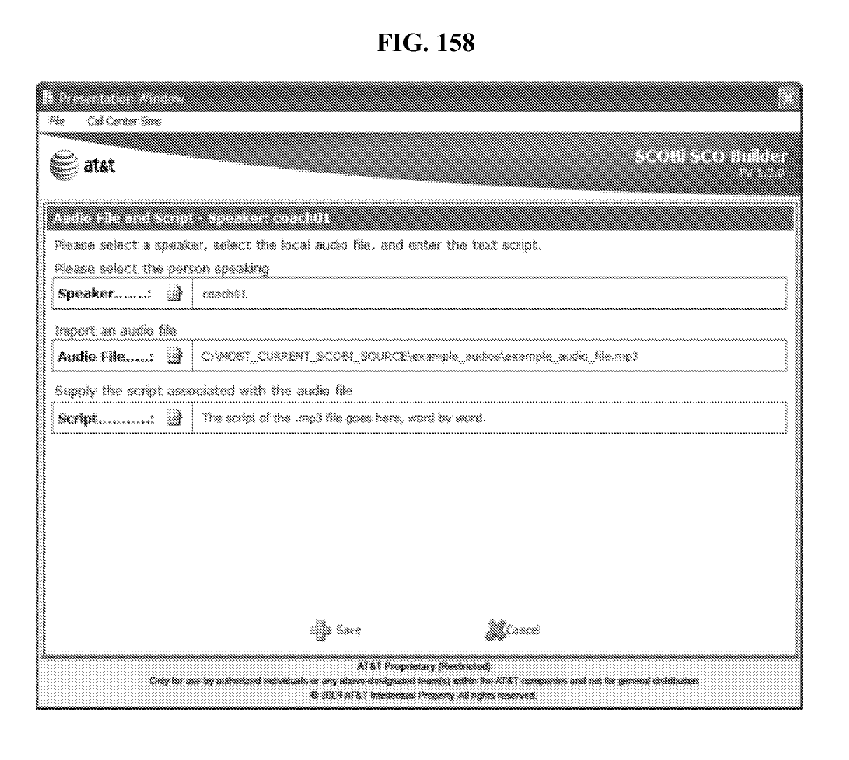

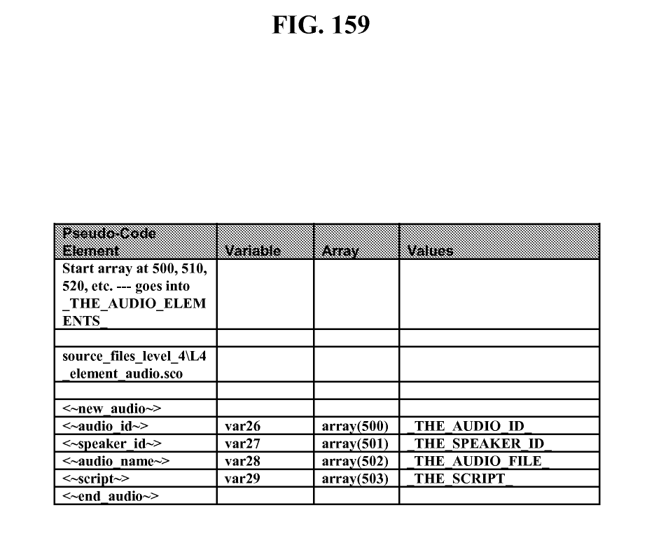

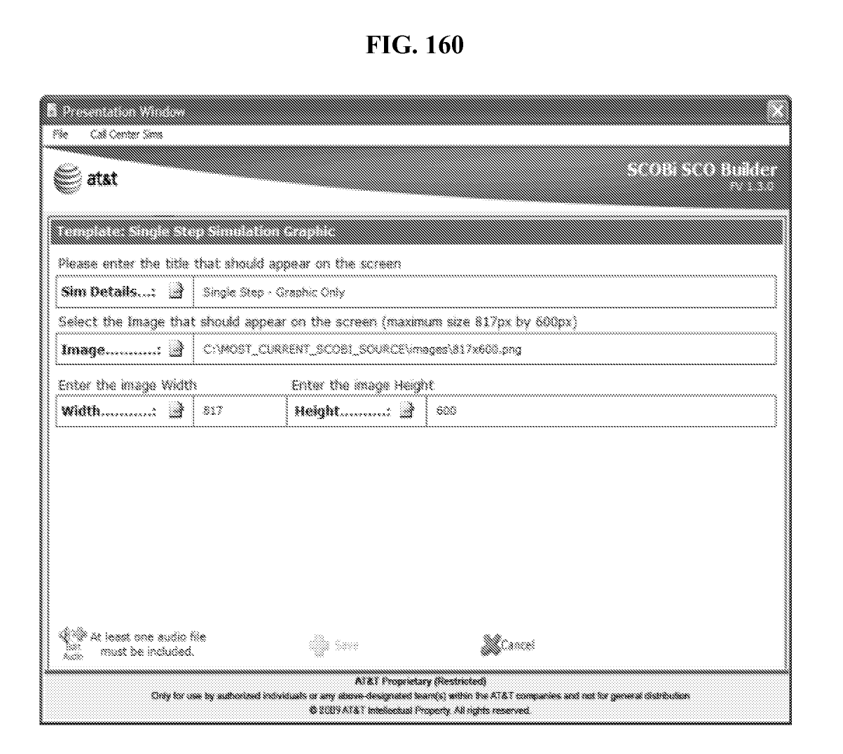

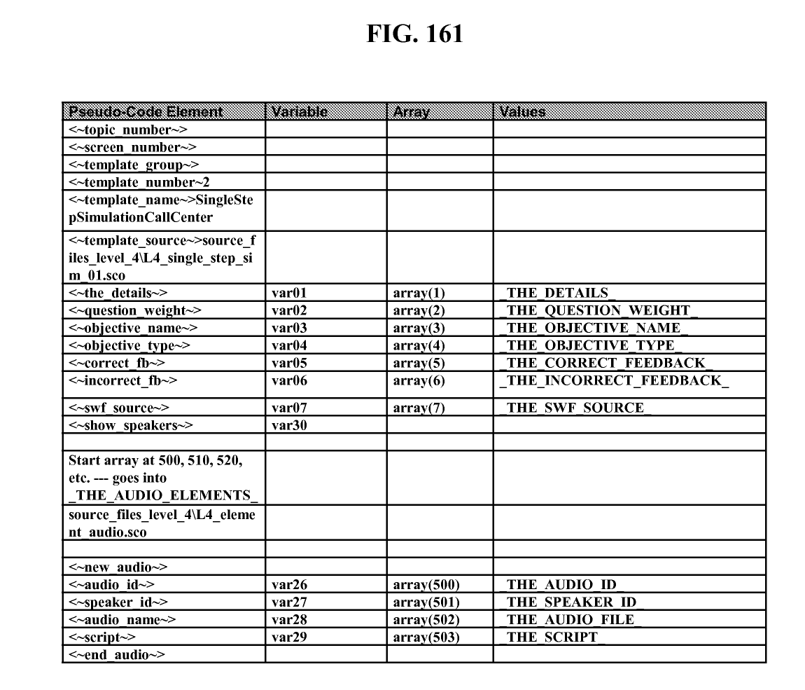

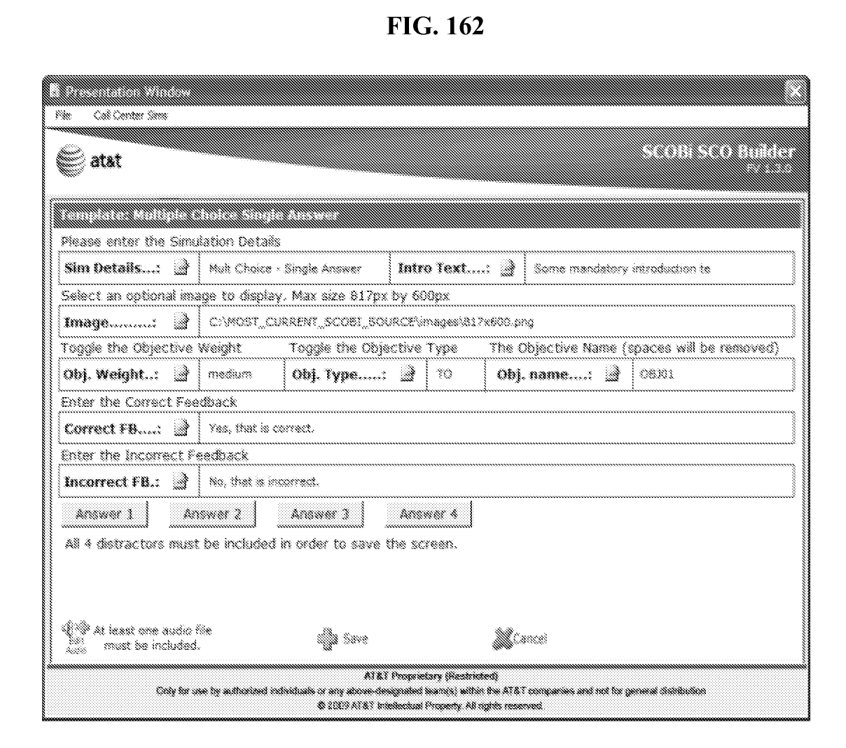

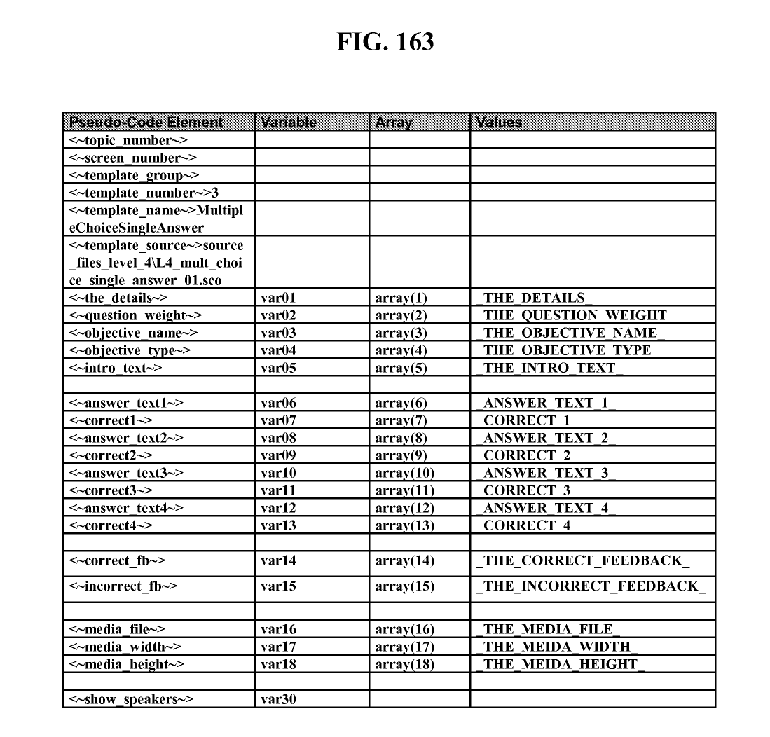

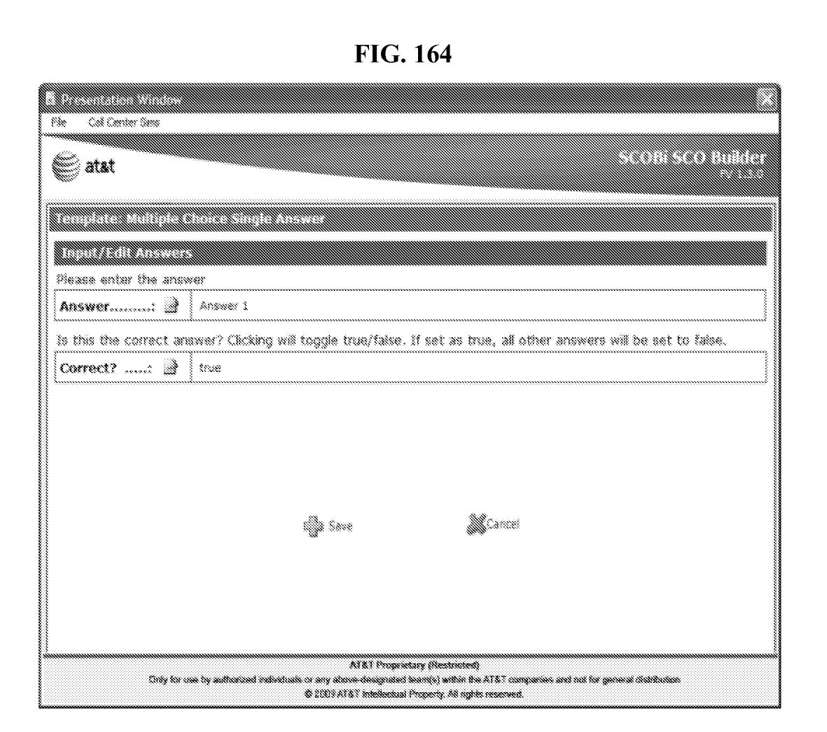

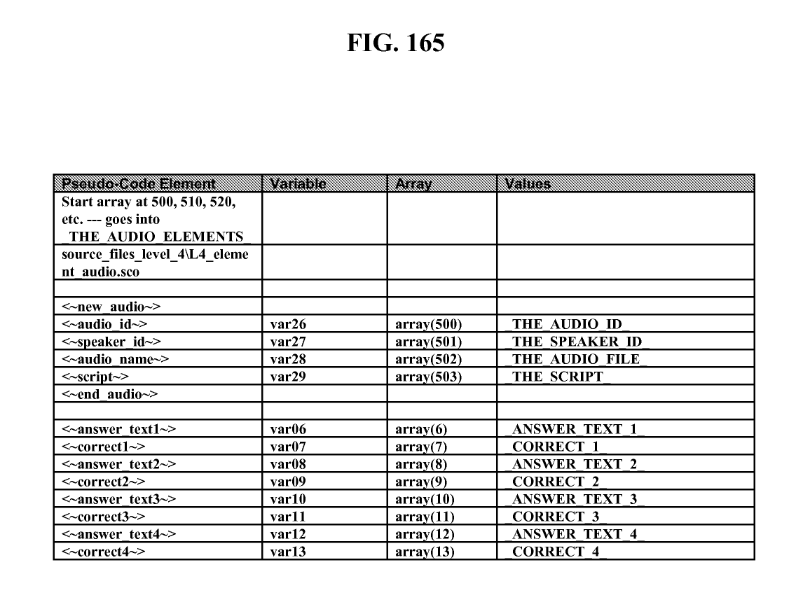

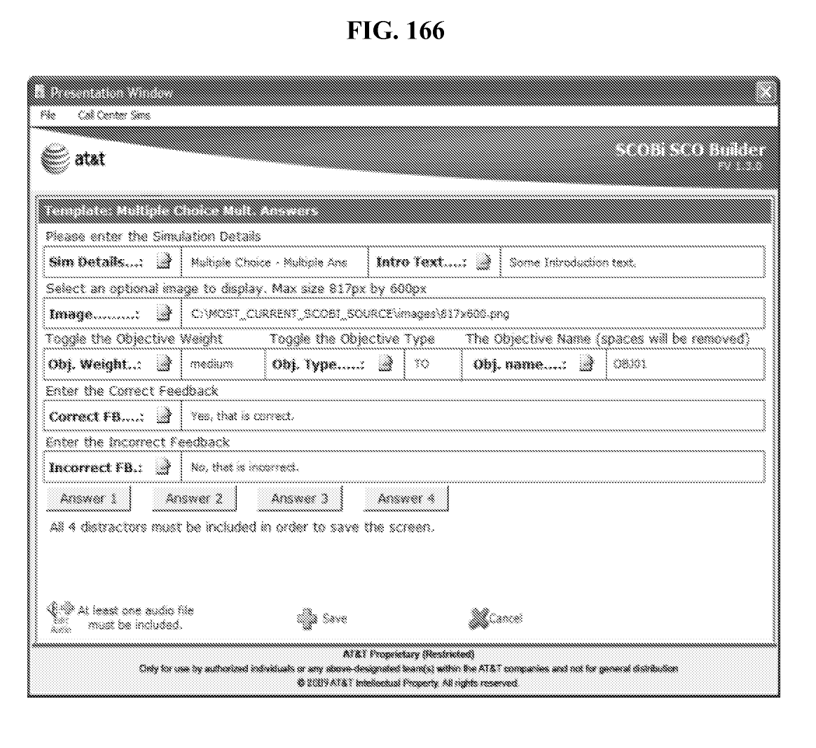

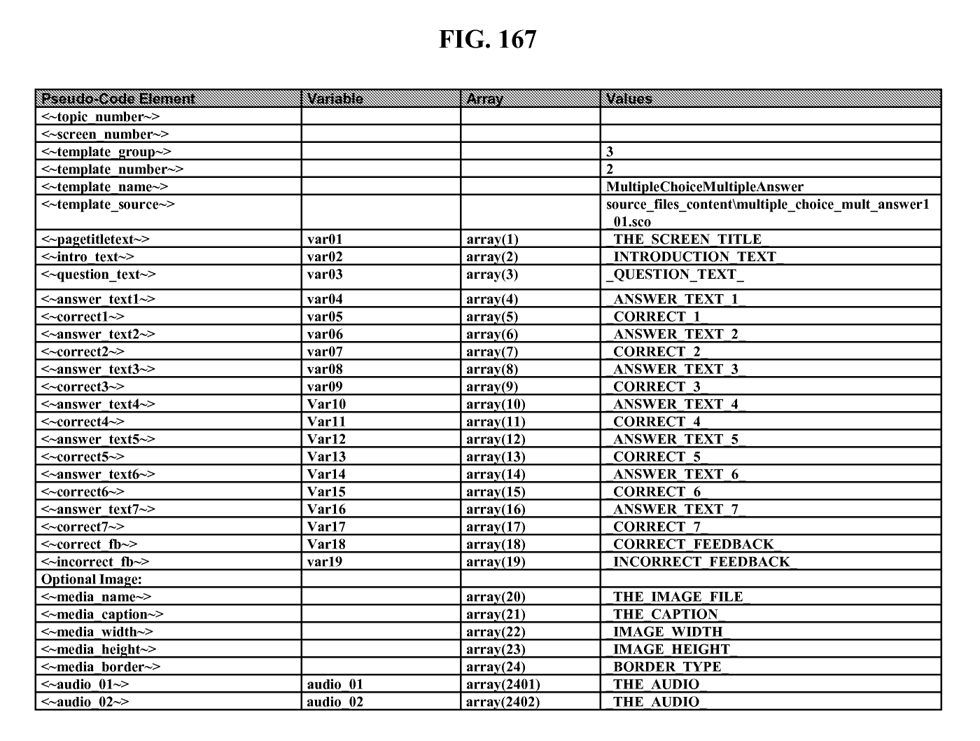

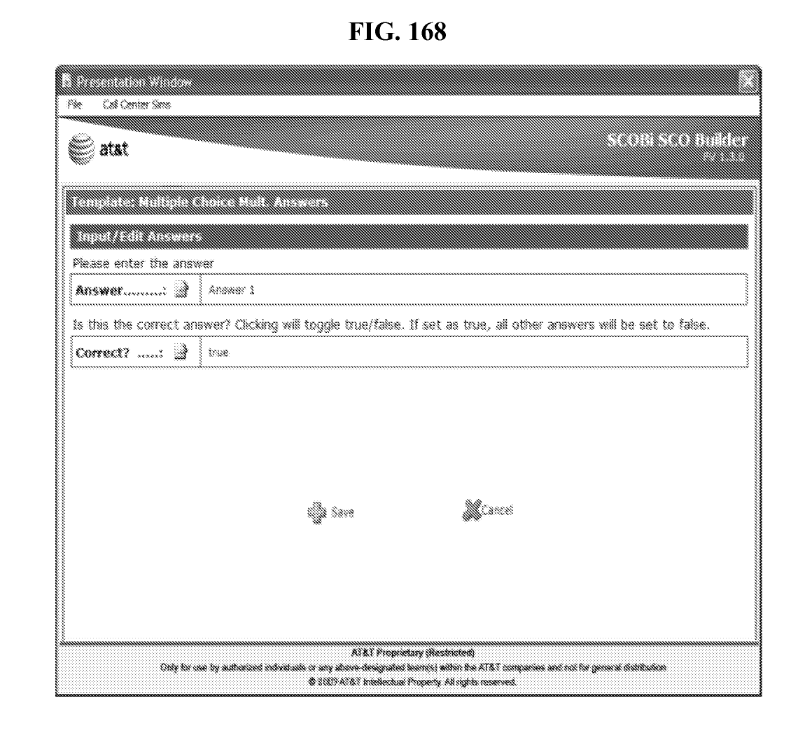

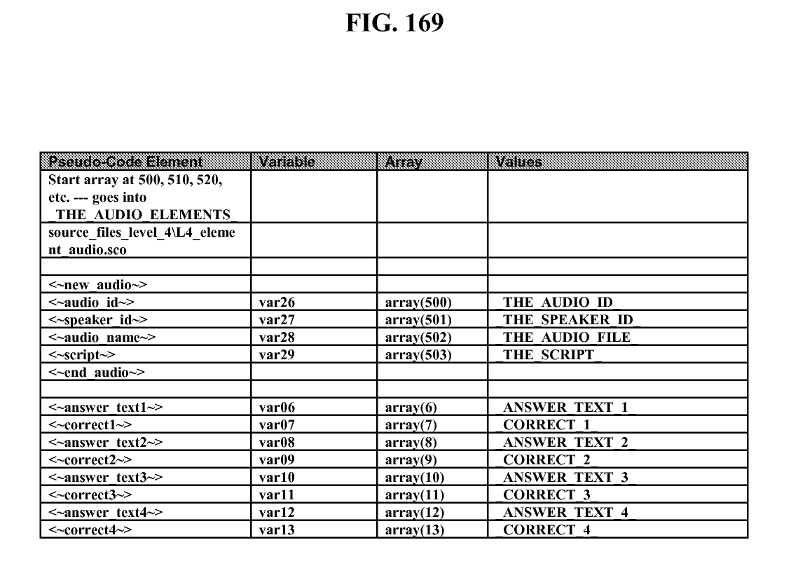

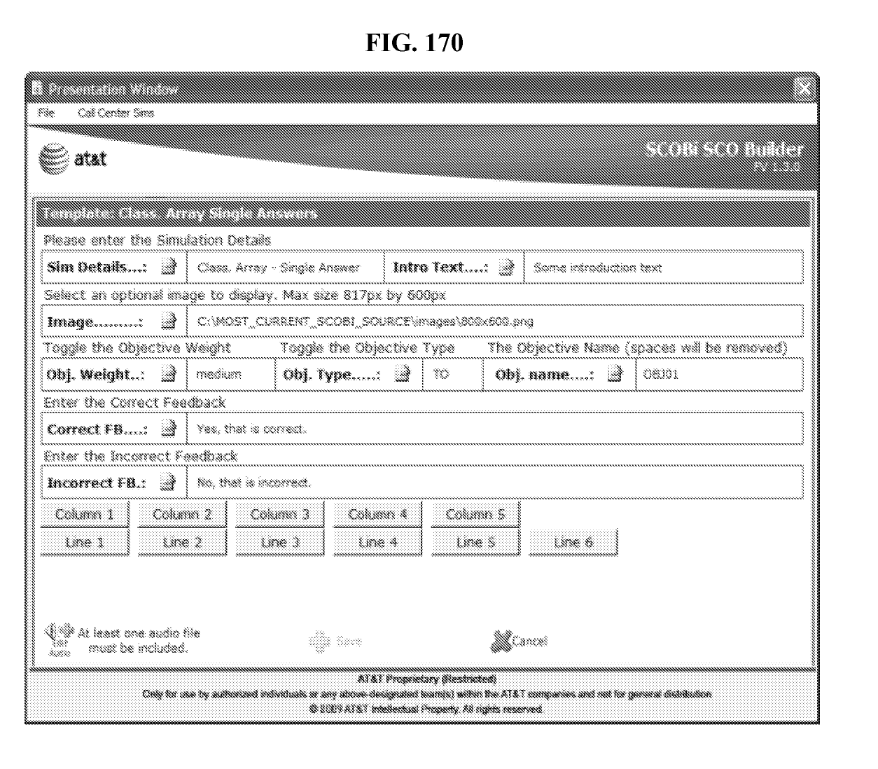

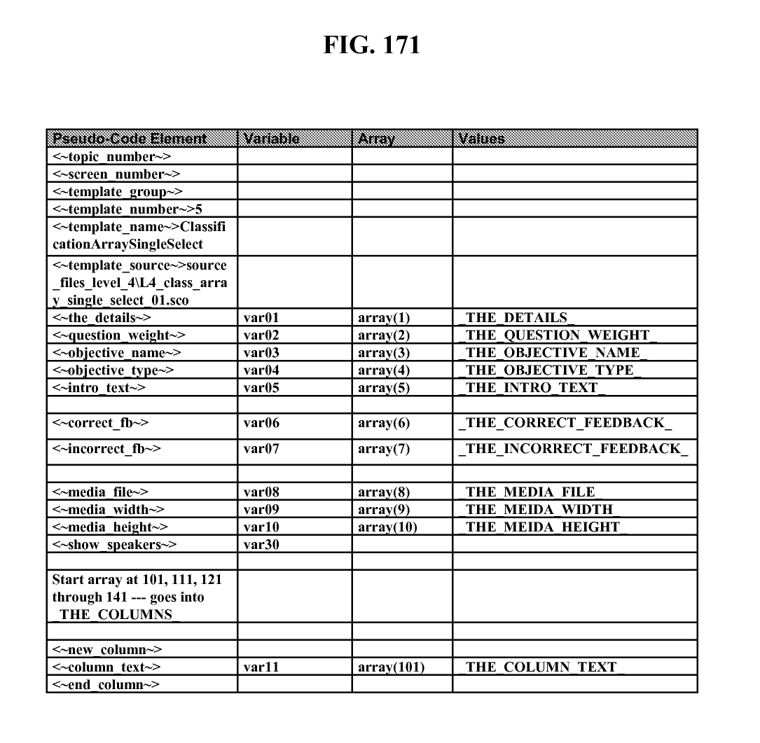

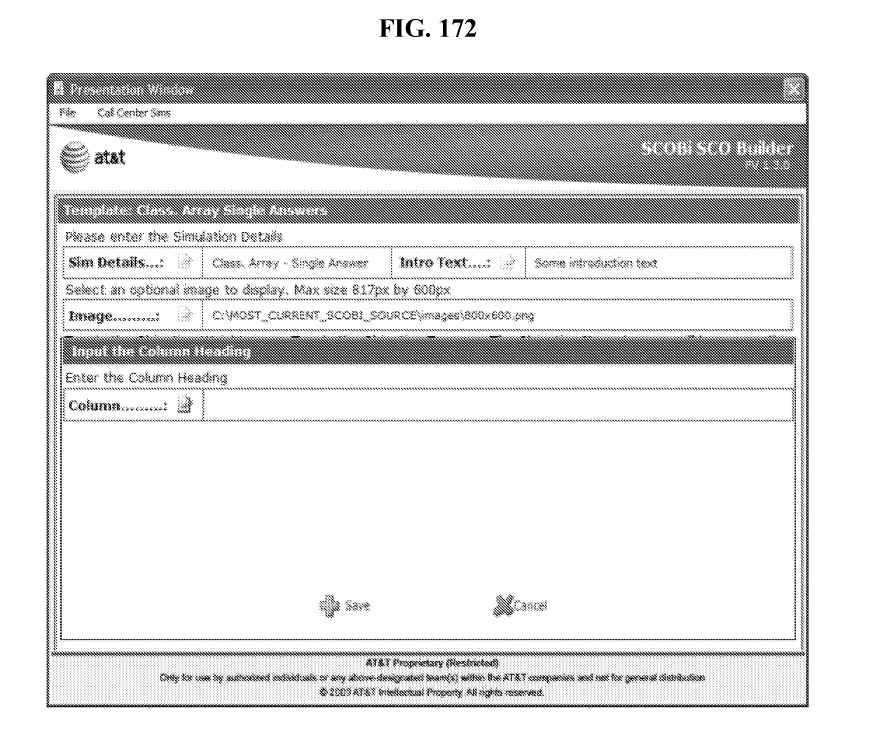

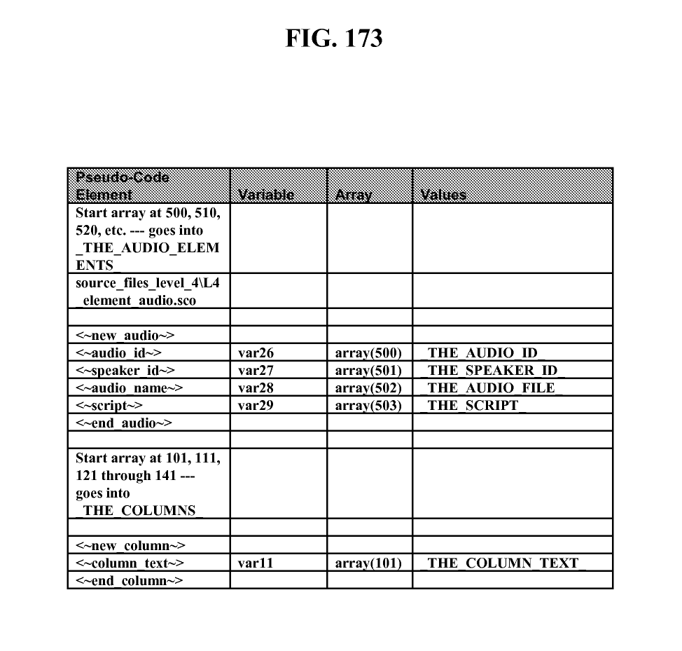

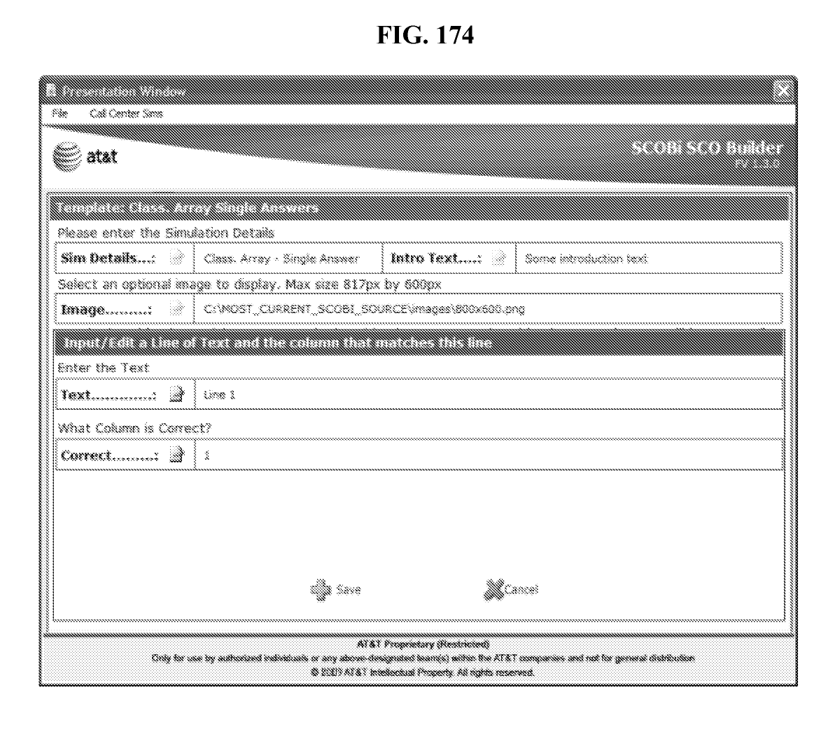

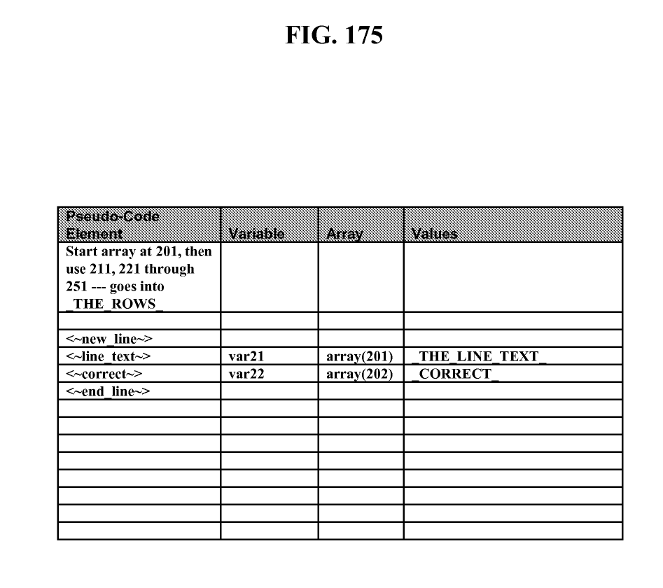

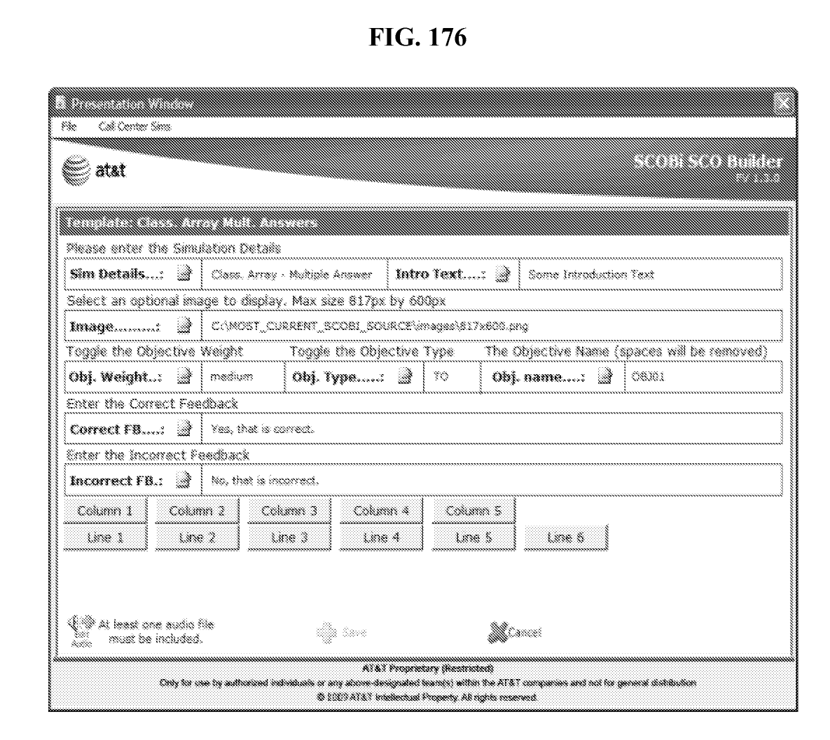

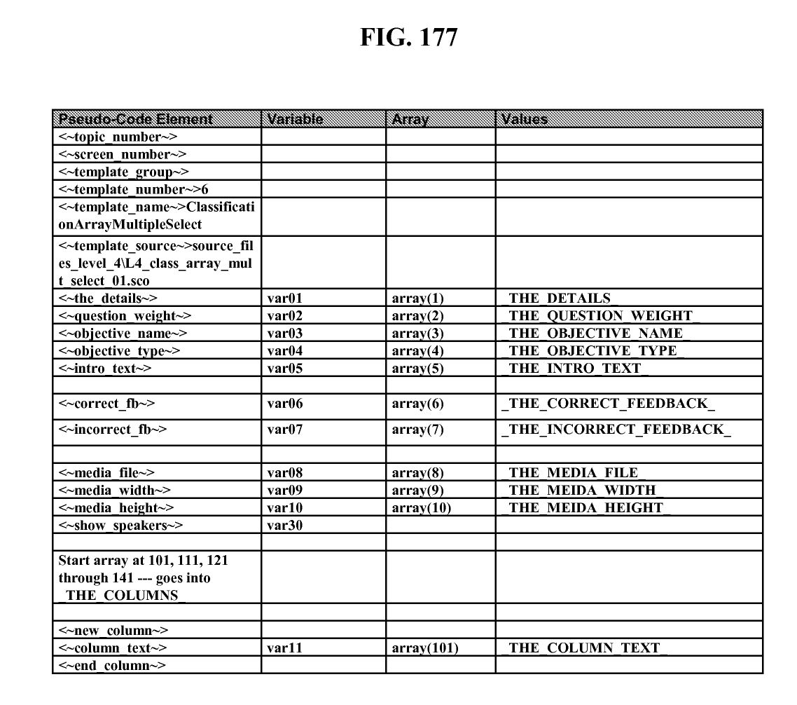

FIGS. 43-45 are schematics illustrating the Text Left Graphic Right component, according to exemplary embodiments. FIGS. 43 and 45 illustrate component element diagrams, with the following text explanations.
Screen Title: 70 characters—Mandatory
Intro Text: 200 characters—Optional
Body Text: Paragraphs, Bullet Lists 1,2,3—Mandatory
Media: Media File, user browses for .gif. .jpg, ,jpeg, .png, .swf—Mandatory
Caption: 50 characters—Optional
Width: Media Width, calculated for .gif, .jpg, .png—Editable by user
Height: Media Height, calculated for .gif, .jpg, .png—Editable by user
Border: Displays name of border. Correlates <˜media_border˜> and <˜media_border_name˜>
   Toggle Interaction: 1=none, 2=diagram, 3=photo
Audio: <˜audio01˜>=User browses to local .mp3 file
   <˜audio02˜>=User inputs http URL to .mp3 on CDN
      FIG. 44 illustrates the .sco storage table. The media file is copied to SCOBi\media folder and renamed to correlate with the screen name (i.e., t010-screen010.png). Any local audio file is copied to SCOBi\audio folder and renamed to correlate with the screen name (i.e., t010-screen010.mp3).

FIGS. 46-47 are schematics illustrating the Text Top Graphic Bottom component, according to exemplary embodiments. FIG. 46 illustrates the component element diagram, with the following text explanations.
Screen Title: 70 characters—Mandatory
Intro Text: 200 characters—Optional
Body Text: Paragraphs, Bullet Lists 1,2,3—Mandatory
Media: Media File, user browses for .gif. .jpg, ,jpeg, .png, .swf—Mandatory
Caption: 50 characters—Optional
Width: Media Width, calculated for .gif, .jpg, .png—Editable by user
Height: Media Height, calculated for .gif, .jpg, .png—Editable by user
Border: Displays name of border. Correlates <˜media_border˜> and <˜media_border_name˜>
   Toggle Interaction: 1=none, 2=diagram, 3=photo
Audio: <˜audio01˜>=User browses to local .mp3 file
   <˜audio02˜>=User inputs http URL to .mp3 on CDN
      FIG. 47 illustrates the .sco storage table. The Text Top Graphic Bottom component outputs the “Values” column of the .sco storage table, and information flows to \sco_builder_full\projects\sco\XXXX_XXXXXX\content.

FIGS. 48-49 are schematics illustrating the Text Only component, according to exemplary embodiments. FIG. 48 illustrates the component element diagram, with the following text explanations.
Screen Title: 70 characters—Mandatory
Intro Text: 200 characters—Optional
Body Text: Paragraphs, Bullet Lists 1,2,3—Mandatory
Audio: <˜audio01˜>=User browses to local .mp3 file
   <˜audio02˜>=User inputs http URL to mp3 on CDN
      FIG. 49 illustrates the .sco storage table. The Text Only component outputs the “Values” column of the .sco storage table, and information flows to \sco_builder_full\projects\sco\XXXX_XXXXXX\content.

FIGS. 50-51 are schematics illustrating the Graphic Only component, according to exemplary embodiments. FIG. 50 illustrates the component element diagram, and FIG. 51 illustrates the .sco storage table. The Graphic Only component outputs the “Values” column of the .sco storage table. Information flows to the file \sco_builder_full\projects_sco\XXXX_XXXXXX\content.
Screen Title: 70 characters—Mandatory
Intro Text: 200 characters—Optional
Media: Media File, user browses for .gif. .jpg, ,jpeg, .png, .swf—Mandatory
Caption: 50 characters—Optional
Width: Media Width, calculated for .gif, .jpg, .png—Editable by user
Height: Media Height, calculated for .gif, .jpg, .png—Editable by user
Border: Displays name of border. Correlates <˜media_border˜> and <˜media_border_name˜>
   Toggle Interaction: 1=none, 2=diagram, 3=photo
Audio: <˜audio01˜>=User browses to local .mp3 file
   <˜audio02˜>=User inputs http URL to mp3 on CDN

FIGS. 52-53 are schematics illustrating the Text Left Scroll Right component, according to exemplary embodiments. FIG. 52 illustrates the component element diagram, and FIG. 53 illustrates the .sco storage table. The Text Left Scroll Right component outputs the “Values” column of the . .sco storage table. Information flows to \sco_builder_full\projects_sco\XXXX_XXXXXX\content.
Screen Title: 70 characters—Mandatory
Intro Text: 200 characters—Optional
Media: Media File, user browses for .gif. .jpg, ,jpeg, .png, .swf—Mandatory
Caption: 50 characters—Optional
Width: Media Width, calculated for .gif, .jpg, .png—Editable by user
Height: Media Height, calculated for .gif, .jpg, .png—Editable by user
Border: Displays name of border. Correlates <˜media_border˜> and <˜media_border_name˜>
   Toggle Interaction: 1=none, 2=diagram, 3=photo
Audio: <˜audio01˜>=User browses to local .mp3 file
   <˜audio02˜>=User inputs http URL to mp3 on CDN

FIGS. 54-55 are schematics illustrating the Text Top Scroll Bottom component, according to exemplary embodiments. FIG. 54 illustrates the component element diagram, and FIG. 55 illustrates the .sco storage table. The Text Top Scroll Bottom component outputs the “Values” column of the .sco storage table. Information flows to \sco_builder_full\projects\sco\XXXX_XXXXXX\content.
Screen Title: 70 characters—Mandatory
Body Text: Paragraphs, Bullet Lists 1,2,3—Mandatory
Media: Media File, user browses for .gif. .jpg, ,jpeg, .png, .swf—Mandatory
Caption: 50 characters—Optional
Width: Media Width, calculated for .gif, .jpg, .png—Editable by user
Height: Media Height, calculated for .gif, .jpg, .png—Editable by user
Border: Displays name of border. Correlates <˜media_border˜> and <˜media_border_name˜>
   Toggle Interaction: 1=none, 2=diagram, 3=photo
Audio: <˜audio01˜>=User browses to local .mp3 file
   <˜audio02˜>=User inputs http URL to .mp3 on CDN

FIGS. 56-59 are schematics illustrating the Definitions Accordion component, according to exemplary embodiments. FIGS. 56 and 58 illustrate the component element diagrams, and FIGS. 57 and 59 illustrate the .sco storage tables. The Definitions Accordion component outputs the “Values” column of the .sco storage table. Information flows to \sco_builder_full\projects\sco\XXXX_XXXXXX\content.
Screen Title: 70 characters—Mandatory
Intro Text: 250 characters—Optional
Definition: 50 characters—Mandatory
Image: Media File, user browses for .gif. .jpg, ,jpeg, .png, .swf—Mandatory
Width: Media Width, calculated for .gif, .jpg, .png—Editable by user
Height: Media Height, calculated for .gif, .jpg, .png—Editable by user
Heading: 25 characters—Mandatory
Popup Text: 300 characters—Mandatory

FIGS. 60-63 are schematics illustrating the Media Definition 1 component, according to exemplary embodiments. FIGS. 60 and 62 illustrate the component element diagrams, and FIGS. 61 and 63 illustrate the .sco storage tables. The Media Definition 1 component outputs the “Values” column of the .sco storage table. Information flows to \sco_builder_full\projects\sco\XXXX_XXXXXX\content.
Screen Title: 70 characters—Mandatory
Intro Text: 250 characters—Optional
Name: 25 characters—Mandatory
Image: Media File, user browses for .gif. .jpg, ,jpeg, .png, .swf—Mandatory
Width: Media Width, calculated for .gif, .jpg, .png—Editable by user
Height: Media Height, calculated for .gif, .jpg, .png—Editable by user
Heading: 25 characters—Mandatory
Popup Text: 300 characters—Mandatory

FIGS. 64-67 are schematics illustrating the Media Definition 2 component, according to exemplary embodiments. FIGS. 64 and 66 illustrate the component element diagrams, and FIGS. 65 and 67 illustrate the .sco storage tables. The Media Definition 2 component outputs the “Values” column of the .sco storage table. Information flows to \sco_builder_full\projects\sco\XXXX_XXXXXX\content.
Screen Title: 70 characters—Mandatory
Intro Text: 250 characters—Optional
Name: 25 characters—Mandatory
Image: Media File, user browses for .gif. .jpg, ,jpeg, .png, .swf—Mandatory
Width: Media Width, calculated for .gif, .jpg, .png—Editable by user
Height: Media Height, calculated for .gif, .jpg, .png—Editable by user
Heading: 25 characters—Mandatory
Popup Text: 300 characters—Mandatory

FIGS. 68-71 are schematics illustrating the Slideshow 1 component, according to exemplary embodiments. FIGS. 68 and 70 illustrate the component element diagrams, and FIGS. 69 and 71 illustrate the .sco storage tables. The Slideshow 1 component outputs the “Values” column of the .sco storage table. Information flows to \sco_builder_full\projects\sco\XXXX_XXXXXX\content.
Screen Title: 70 characters—Mandatory
Intro Text: 250 characters—Mandatory
Detail Text: Paragraphs, Bullet Lists 1,2,3—Mandatory
Component: 100 characters—Mandatory
Caption: 50 characters—Optional
Image: Media File, user browses for .gif. .jpg, ,jpeg, .png, .swf—Mandatory
Width: Media Width, calculated for .gif, .jpg, .png—Editable by user
Height: Media Height, calculated for .gif, .jpg, .png—Editable by user

FIGS. 72-75 are schematics illustrating the Slideshow 2 component, according to exemplary embodiments. FIGS. 72 and 74 illustrate the component element diagrams, and FIGS. 73 and 75 illustrate the .sco storage tables. The Slideshow 2 component outputs the “Values” column of the .sco storage table. Information flows to \sco_builder_full\projects\sco\XXXX_XXXXXX\content.
Screen Title: 70 characters—Mandatory
Component: 100 characters—Mandatory
Caption: 50 characters—Optional
Image: Media File, user browses for .gif. .jpg, ,jpeg, .png, .swf—Mandatory
Width: Media Width, calculated for .gif, .jpg, .png—Editable by user
Height: Media Height, calculated for .gif, .jpg, .png—Editable by user

FIGS. 76-79 are schematics illustrating the Tabs With Images component, according to exemplary embodiments. FIGS. 76 and 78 illustrate the component element diagrams, and FIGS. 77 and 79 illustrate the .sco storage tables. The Tabs With Images component outputs the “Values” column of the .sco storage table. Information flows to \sco_builder_full\projects\sco\XXXX_XXXXXX\content.
Screen Title: 70 characters—Mandatory
Component: 250 characters—Mandatory
Tab Name: 25 characters—Mandatory
Caption: 30 characters—Mandatory
Image: Media File, user browses for .gif. .jpg, ,jpeg, .png, .swf—Mandatory
Width: Media Width, calculated for .gif, .jpg, .png—Editable by user
Height: Media Height, calculated for .gif, .jpg, .png—Editable by user
Border: Displays name of border. Correlates <˜media_border˜> and <˜media_border_name˜>
   Toggle Interaction: 1=none, 2=diagram, 3=photo
Main Text: 500 characters—Mandatory

FIGS. 80-83 are schematics illustrating the Tabs Without Images component, according to exemplary embodiments. FIGS. 80 and 82 illustrate the component element diagrams, and FIGS. 81 and 83 illustrate the .sco storage tables. The Tabs Without Images component outputs the “Values” column of the .sco storage table. Information flows to \sco_builder_full\projects\sco\XXXX_XXXXXX\content.
Screen Title: 70 characters—Mandatory
Component: 250 characters—Mandatory
Tab Name: 25 characters—Mandatory
Main Text: 500 characters—Mandatory

FIGS. 84-87 are schematics illustrating the Bullets With Media Changes component, according to exemplary embodiments. FIGS. 84 and 86 illustrate the component element diagrams, and FIGS. 85 and 87 illustrate the .sco storage tables. The Bullets With Media Changes component outputs the “Values” column of the .sco storage table. Information flows to \sco_builder_full\projects\sco\XXXX_XXXXXX\content.
Screen Title: 70 characters—Mandatory
Component: 250 characters—Mandatory
Bullet Text: 100 characters—Mandatory
Header: 25 characters—Mandatory
Main Text: Paragraphs, Bullet Lists 1,2,3—Mandatory

FIGS. 88-91 are schematics illustrating the Exploratory HotSpot 1 component, according to exemplary embodiments. FIGS. 88 and 90 illustrate the component element diagrams, and FIGS. 88 and 91 illustrate the .sco storage tables. The Exploratory HotSpot 1 component outputs the “Values” column of the .sco storage table. Information flows to \sco_builder_full\projects\sco\XXXX_XXXXXX\content.
Screen Title: 70 characters—Mandatory
Intro Text: 200 characters—Mandatory
Body Text: 400 characters—Mandatory
Image: Media File, user browses for .gif. jpg, ,jpeg, .png—Mandatory
Color: Toggles, red or yellow
Caption: 25 characters—Mandatory
Popup Text: 250 characters—Mandatory
   The _x is the x coordinate of where the user clicks to start creating the hotspot. The _y is the y coordinate of where the user clicks to start creating the hotspot. The hs_height is the difference between the y coordinate where the user released the button and _y. The hs_width is the difference between the x coordinate where the user released the button and _x.

FIGS. 92-95 are schematics illustrating the Exploratory HotSpot 2 component, according to exemplary embodiments. FIGS. 92 and 94 illustrate the component element diagrams, and FIGS. 93 and 95 illustrate the .sco storage tables. The Exploratory HotSpot 2 component outputs the “Values” column of the .sco storage table. Information flows to \sco_builder_full\projects\sco\XXXX_XXXXXX\content.
Screen Title: 70 characters—Mandatory
Intro Text: 200 characters—Optional
Body Text: 400 characters—Mandatory
Image: Media File, user browses for .gif. jpg, ,jpeg, .png—Mandatory
Color: Toggles, red or yellow
Caption: 25 characters—Mandatory
Popup Text: 350 characters—Mandatory
   The _x is the x coordinate of where the user clicks to start creating the hotspot. The _y is the y coordinate of where the user clicks to start creating the hotspot. The hs_height is the difference between the y coordinate where the user released the button and the _y. The hs_width is the difference between the x coordinate where the user released the button and _x.

FIGS. 96-97 are schematics illustrating the Inline Video Media Player component, according to exemplary embodiments. FIG. 96 illustrates the component element diagram, and FIG. 97 illustrates the .sco storage table. The Inline Video Media Player component outputs the “Values” column of the .sco storage table. Information flows to \sco_builder_full\projects\sco\XXXX_XXXXXX\content.
Screen Title: 70 characters—Mandatory
Intro Text: 200 characters—Optional
Instr Text: 200 characters—Mandatory
Relative URL: Media File, user browses for .flv—Mandatory if no CDN path
CDN URN: the http: path to a .flv—Mandatory if no relative media

FIGS. 98-101 are schematics illustrating the Multiple Choice Single Answer component, according to exemplary embodiments. FIGS. 98 and 100 illustrate the component element diagrams, and FIGS. 99 and 101 illustrate the .sco storage tables. The Multiple Choice Single Answer component outputs the “Values” column of the .sco storage table. Information flows to \sco_builder_full\projects\sco\XXXX_XXXXXX\content.
Screen Title: 70 characters—Mandatory
Intro Text: 200 characters—Optional
Question: 400 characters—Mandatory
Correct: 150 characters—Mandatory
Incorrect: 150 characters—Mandatory
Audio: <˜audio01˜>=User browses to local .mp3 file
   <˜audio02˜>=User inputs http URL to .mp3 on CDN
Answer: 100 characters—Mandatory
Correct?: Toggles true, false

FIGS. 102-105 are schematics illustrating the Multiple Choice Multiple Answer component, according to exemplary embodiments. FIGS. 102 and 104 illustrate the component element diagrams, and FIGS. 103 and 105 illustrate the .sco storage tables. The Multiple Choice Multiple Answer component outputs the “Values” column of the .sco storage table. Information flows to \sco_builder_full\projects\sco\XXXX_XXXXXX\content.
Screen Title: 70 characters—Mandatory
Intro Text: 200 characters—Optional
Question: 400 characters—Mandatory
Correct: 150 characters—Mandatory
Incorrect: 150 characters—Mandatory
Audio: <˜audio01˜>=User browses to local .mp3 file
   <˜audio02˜>=User inputs http URL to .mp3 on CDN
Answer: 100 characters—Mandatory
Correct?: Toggles true, false

FIGS. 106-109 are schematics illustrating the Drag and Drop Paragraph component, according to exemplary embodiments. FIGS. 106 and 108 illustrate the component element diagrams, and FIGS. 107 and 109 illustrate the .sco storage tables. The Drag and Drop Paragraph component outputs the “Values” column of the .sco storage table. Information flows to \sco_builder_full\projects\sco\XXXX_XXXXXX\content.
Screen Title: 70 characters—Mandatory
Intro Text: 200 characters—Optional
Correct F.B.: 250 characters—Mandatory
Distracter: 20 characters—Optional
Text: 100 characters—Mandatory
Answer: 20 characters—Mandatory
Text: 100 characters—Mandatory
Answer: 20 characters—Optional
Text: 100 characters—Mandatory if 2nd answer provided

FIGS. 110-113 are schematics illustrating the Drag and Drop Columns component, according to exemplary embodiments. FIGS. 110 and 112 illustrate the component element diagrams, and FIGS. 111 and 113 illustrate the .sco storage tables. The Drag and Drop Columns component outputs the “Values” column of the .sco storage table. Information flows to \sco_builder_full\projects\sco\XXXX_XXXXXX\content.
Screen Title: 70 characters—Mandatory
Intro Text: 250 characters—Optional
Correct F.B.: 250 characters—Mandatory
Text: 100 characters—Mandatory
Answer: 30 characters—Mandatory
<˜correct˜> below is always true

FIGS. 114-119 are schematics illustrating the Classification Array Single Answer component, according to exemplary embodiments. FIGS. 114, 116, and 118 illustrate the component element diagrams, and FIGS. 115, 117, and 119 illustrate the .sco storage tables. The Classification Array Single Answer component outputs the “Values” column of the .sco storage table. Information flows to \sco_builder_full\projects\sco\XXXX_XXXXXX\content.
Screen Title: 70 characters—Mandatory
Intro Text: 200 characters—Optional
Correct FB: 100 characters—Mandatory
Column: 10 characters
Text: 70 characters—Mandatory
Correct: 1 character (numeral)—Mandatory

FIGS. 120-125 are schematics illustrating the Classification Array Multiple Answer component, according to exemplary embodiments. FIGS. 120, 122, and 124 illustrate the component element diagrams, and FIGS. 121, 123, and 125 illustrate the .sco storage tables. The Classification Array Multiple Answer component outputs the “Values” column of the .sco storage table. Information flows to \sco_builder_full\projects\sco\XXXX_XXXXXX\content.
Screen Title: 70 characters—Mandatory
Intro Text: 200 characters—Optional
Correct FB: 100 characters—Mandatory
Column: 10 characters
Text: 70 characters—Mandatory
Correct: 1 character (numeral)—Mandatory

FIGS. 126-127 are schematics illustrating the Text Left Graphic Right With Feedback component, according to exemplary embodiments. FIG. 126 illustrates the component element diagram, and FIG. 127 illustrates the .sco storage table. The Text Left Graphic Right With Feedback component outputs the “Values” column of the .sco storage table. Information flows to \sco_builder_full\projects\sco\XXXX_XXXXXX\content.
Screen Title: 70 characters—Mandatory
Intro Text: 200 characters—Optional
Instructions: 200 characters—Mandatory
Media: Media File, user browses for .swf—Mandatory
Caption: 50 characters—Optional
Width: Media Width, .swf width
Height: Media Height, .swf height
Border: Displays name of border. Correlates <˜media_border˜> and <˜media_border_name˜>
   Toggle Interaction: 1=none, 2=diagram, 3=photo
Correct FB: 300 characters—Mandatory
Incorrect FB: 300 characters—Mandatory

FIGS. 128-129 are schematics illustrating the Text Top Media Bottom With Feedback component, according to exemplary embodiments. FIG. 128 illustrates the component element diagram, and FIG. 129 illustrates the .sco storage table. The Text Top Media Bottom With Feedback component outputs the “Values” column of the .sco storage table. Information flows to \sco_builder_full\projects\sco\XXXX_XXXXXX\content.
Screen Title: 70 characters—Mandatory
Intro Text: 200 characters—Optional
Instructions: 200 characters—Mandatory
Media: Media File, user browses for .swf—Mandatory
Caption: 50 characters—Optional
Width: Media Width, .swf width
Height: Media Height, .swf height
Border: Displays name of border. Correlates <˜media_border˜> and <˜media_border_name˜>
   Toggle Interaction: 1=none, 2=diagram, 3=photo
Correct FB: 300 characters—Mandatory
Incorrect FB: 300 characters—Mandatory

FIGS. 130-133 are schematics illustrating the Combo Box Paragraph component, according to exemplary embodiments. FIGS. 130 and 132 illustrate the component element diagrams, and FIGS. 131 and 133 illustrate the .sco storage tables. The Combo Box Paragraph component outputs the “Values” column of the .sco storage table. Information flows to \sco_builder_full\projects\sco\XXXX_XXXXXX\content.
Screen Title: 70 characters—Mandatory
Intro Text: 250 characters—Optional
Instructions: 250 characters—Mandatory
Correct F.B.: 250 characters—Mandatory
Text: 100 characters—Mandatory
Text: 100 characters—Mandatory
Answers: 50 characters—Mandatory (at least 2)
Correct: Toggles from 1 thru the total number of answers provided

FIGS. 134-137 are schematics illustrating the HotSpot Assessment 1 component, according to exemplary embodiments. FIGS. 134 and 136 illustrate the component element diagrams, and FIGS. 135 and 137 illustrate the .sco storage tables. The HotSpot Assessment 1 component outputs the “Values” column of the .sco storage table. Information flows to \sco_builder_full\projects\sco\XXXX_XXXXXX\content.
Screen Title: 70 characters—Mandatory
Intro Text: 200 characters—Optional
Inst Text: 400 characters—Mandatory
Image: Media File, user browses for .gif. jpg, ,jpeg, .png—Mandatory
Correct?: Toggles true, false
   The _x is the x coordinate of where the user clicks to start creating the hotspot. The _y is the y coordinate of where the user clicks to start creating the hotspot. The hs_height is the difference between the y coordinate where the user released the button and the _y. The hs_width is the difference between the x coordinate where the user released the button and the _x.

FIGS. 138-141 are schematics illustrating the HotSpot Assessment 2 component, according to exemplary embodiments. FIGS. 138 and 140 illustrate the component element diagrams, and FIGS. 139 and 141 illustrate the .sco storage tables. The HotSpot Assessment 2 component outputs the “Values” column of the .sco storage table. Information flows to \sco_builder_full\projects\sco\XXXX_XXXXXX\content.
Screen Title: 70 characters—Mandatory
Intro Text: 200 characters—Optional
Inst Text: 400 characters—Mandatory
Image: Media File, user browses for .gif. jpg, ,jpeg, .png—Mandatory
Correct?: Toggles true, false
   The _x is the x coordinate of where the user clicks to start creating the hotspot. The _y is the y coordinate of where the user clicks to start creating the hotspot. The hs_height is the difference between the y coordinate where the user released the button and the _y. The hs_width is the difference between the x coordinate where the user released the button and the _x.

FIGS. 142-147 are schematics illustrating the Walkthrough Simulation component, according to exemplary embodiments. FIGS. 142, 144, and 146 illustrate the component element diagrams, and FIGS. 143, 145, and 147 illustrate the .sco storage tables. The Walkthrough Simulation component outputs the “Values” column of the .sco storage table. Information flows to \sco_builder_full\projects\sco\XXXX_XXXXXX\content.
Screen Title: 70 characters—Mandatory
Enable Next: Toggles true, false
Use Pointer: Toggles true, false
SWF File: Media File, user browses for .swf—Mandatory
Task Elem: Only Paragraph elements
Step Text: Only Paragraph elements—Mandatory
X Position: The x coordinate of where the text balloon should appear
Y Position: The y coordinate of where the text balloon should appear
Pointer Type: Toggles through arrowAtRight, arrowAtLeft, arrowAtTop, arrowAtBottom
Instructions: Only Paragraph elements—Optional
Detail Text: Only Paragraph elements—Optional

FIGS. 148-153 are schematics illustrating the Practice Simulation component, according to exemplary embodiments. FIGS. 148, 150, and 152 illustrate the component element diagrams, and FIGS. 149, 151, and 153 illustrate the .sco storage tables. The Practice Simulation component outputs the “Values” column of the .sco storage table. Information flows to \sco_builder_full\projects\sco\XXXX_XXXXXX\content.
Screen Title: 70 characters—Mandatory
Enable Next: Toggles true, false
Use Pointer: Toggles true, false
SWF File: Media File, user browses for .swf—Mandatory
Task Elem: Only Paragraph elements
Data Elem: Only Paragraph elements
Step Text: Only Paragraph elements—Mandatory
X Position: The x coordinate of where the text balloon should appear
Y Position: The y coordinate of where the text balloon should appear
Pointer Type: Toggles through arrowAtRight, arrowAtLeft, arrowAtTop, arrowAtBottom
Detail Text: Only Paragraph elements—Optional
Data Text: Only Paragraph elements—Optional
Feedback: Only Paragraph elements—Mandatory
Feedback Y: The y coordinate of where the feedback should appear—Mandatory

FIGS. 154-155 are schematics illustrating the Call Center Simulation component, according to exemplary embodiments. FIG. 154 illustrates the component element diagram, and FIG. 155 illustrates the .sco storage table. The Call Center Simulation component outputs the “Values” column of the .sco storage table. Information flows to \sco_builder_full\projects\sco\XXXX_XXXXXX\cc_sims.
Screen Title: 70 characters—Mandatory
CC SIM: User browses to select the CC Sim folder the existing sim resides in (projects\cc_sims\FOLDER)

FIGS. 156-159 are schematics illustrating the Call Center Simulation—Single Step Simulation Graphic component, according to exemplary embodiments. FIGS. 156 and 158 illustrate the component element diagrams, and FIGS. 157 and 159 illustrate the .sco storage tables. The Call Center Simulation—Single Step Simulation Graphic component outputs the “Values” column of the .sco storage table. Information flows to \sco_builder_full\projects\sco\XXXX_XXXXXX\cc_sims.
Sim Details: 70 characters—Mandatory
Image: Media File, user browses for .gif. .jpg, ,jpeg, .png—Mandatory
Width: Media Width, calculated for .gif, .jpg, .png—Editable by user
Height: Media Height, calculated for .gif, .jpg, .png—Editable by user
Speaker: User selects the person speaking from a visual list (next item)—Mandatory
Audio File: User browses for .mp3 file—Mandatory
Script: 800 characters—Mandatory

FIGS. 160-161 are schematics illustrating the Call Center Simulation—Single Step Simulation component, according to exemplary embodiments. FIG. 160 illustrates the component element diagram, and FIG. 161 illustrates the .sco storage table. The Call Center Simulation—Single Step Simulation component outputs the “Values” column of the .sco storage table. Information flows to \sco_builder_full\projects\sco\XXXX_XXXXXX\cc_sims.
Sim Details: 70 characters—Mandatory
SWF Source: Media File, user browses for .swf—Mandatory
Obj. Weight: Toggles—low, medium, high, N/A
Obj. Type: Toggles—TO, EO (inactive if Obj. Weight is N/A)
Obj. name: 20 characters (inactive if Obj. Weight is N/A)
Correct FB: 300 characters—Mandatory
Incorrect FB: 300 characters—Mandatory

FIGS. 162-165 are schematics illustrating the Call Center Simulation—Multiple Choice Single Answer component, according to exemplary embodiments. FIGS. 162 and 164 illustrate the component element diagrams, and FIGS. 163 and 165 illustrate the .sco storage tables. The Call Center Simulation—Multiple Choice Single Answer component outputs the “Values” column of the .sco storage table. Information flows to \sco_builder_full\projects\sco\XXXX_XXXXXX\cc_sims.
Sim Details: 70 characters—Mandatory
Image: Media File, user browses for .gif. jpg, ,jpeg, .png—Optional
Obj. Weight: Toggles—low, medium, high, N/A
Obj. Type: Toggles—TO, EO (inactive if Obj. Weight is N/A)
Obj. name: 20 characters (inactive if Obj. Weight is N/A)
Correct FB: 300 characters—Mandatory
Incorrect FB: 300 characters—Mandatory
Answer: 100 characters—Mandatory
Correct?: Toggles—true, false

FIGS. 166-169 are schematics illustrating the Call Center Simulation—Multiple Choice Multiple Answer component, according to exemplary embodiments. FIGS. 166 and 168 illustrate the component element diagrams, and FIGS. 167 and 169 illustrate the .sco storage tables. The Call Center Simulation—Multiple Choice Multiple Answer component outputs the “Values” column of the .sco storage table. Information flows to \sco_builder_full\projects\sco\XXXX_XXXXXX\cc_sims.
Sim Details: 70 characters—Mandatory
Image: Media File, user browses for .gif. jpg, ,jpeg, .png—Optional
Obj. Weight: Toggles—low, medium, high, N/A
Obj. Type: Toggles—TO, EO (inactive if Obj. Weight is N/A)
Obj. name: 20 characters (inactive if Obj. Weight is N/A)
Correct FB: 300 characters—Mandatory
Incorrect FB: 300 characters—Mandatory
Answer: 100 characters—Mandatory
Correct?: Toggles—true, false

FIGS. 170-175 are schematics illustrating the Call Center Simulation—Classification Array Single Answer component, according to exemplary embodiments. FIGS. 170, 172, and 174 illustrate the component element diagrams, and FIGS. 171, 173, and 175 illustrate the .sco storage tables. The Call Center Simulation—Classification Array Single Answer component outputs the “Values” column of the .sco storage table. Information flows to \sco_builder_full\projects\sco\XXXX_XXXXXX\cc_sims.
Sim Details: 70 characters—Mandatory
Image: Media File, user browses for .gif. jpg, ,jpeg, .png—Optional
Obj. Weight: Toggles—low, medium, high, N/A
Obj. Type: Toggles—TO, EO (inactive if Obj. Weight is N/A)
Obj. name: 20 characters (inactive if Obj. Weight is N/A)
Correct FB: 300 characters—Mandatory
Incorrect FB: 300 characters—Mandatory
Column: 10 characters—Mandatory
Text: 100 characters—Mandatory
Correct: 1 character (numeral)—Mandatory

FIGS. 176-181 are schematics illustrating the Call Center Simulation—Classification Array Multiple Answer component, according to exemplary embodiments. FIGS. 176, 178, and 180 illustrate the component element diagrams, and FIGS. 177, 179, and 181 illustrate the .sco storage tables. The Call Center Simulation—Classification Array Multiple Answer component outputs the “Values” column of the .sco storage table. Information flows to \sco_builder_full\projects\sco\XXXX_XXXXXX\cc_sims.
Sim Details: 70 characters—Mandatory
Image: Media File, user browses for .gif. jpg, ,jpeg, .png—Optional
Obj. Weight: Toggles—low, medium, high, N/A
Obj. Type: Toggles—TO, EO (inactive if Obj. Weight is N/A)
Obj. name: 20 characters (inactive if Obj. Weight is N/A)
Correct FB: 300 characters—Mandatory
Incorrect FB: 300 characters—Mandatory
Column: 10 characters—Mandatory
Text: 100 characters—Mandatory
Correct: 5 character (numeral)—Mandatory

FIGS. 182-183 are schematics illustrating the Call Center Simulation—Create Results Screen component, according to exemplary embodiments. FIG. 182 illustrates the component element diagram, and FIG. 183 illustrates the .sco storage table. The Call Center Simulation—Create Results Screen component outputs the “Values” column of the .sco storage table. Information flows to \sco_builder_full\projects\sco\XXXX_XXXXXX\cc_sims.
Text: 800 characters—Mandatory

FIGS. 184-185 are schematics illustrating the Call Center Simulation—Begin Object Reinforcement component, according to exemplary embodiments. FIG. 184 illustrates the component element diagram, and FIG. 185 illustrates the .sco storage table. The Call Center Simulation—Begin Object Reinforcement component outputs the “Values” column of the .sco storage table. Information flows to \sco_builder_full\projects\sco\XXXX_XXXXXX\cc_sims.
Obj. name: 20 characters—Mandatory
Obj. Type: Toggles—TO, EO
Min Score 1: 3 characters (numerals, range from 0 to 100)—Mandatory
Max Score 1: 3 characters (numerals, range from 0 to 100)—Mandatory
Min Score 2: 3 characters (numerals, range from 0 to 100)—Mandatory
Max Score 2: 3 characters (numerals, range from 0 to 100)—Mandatory

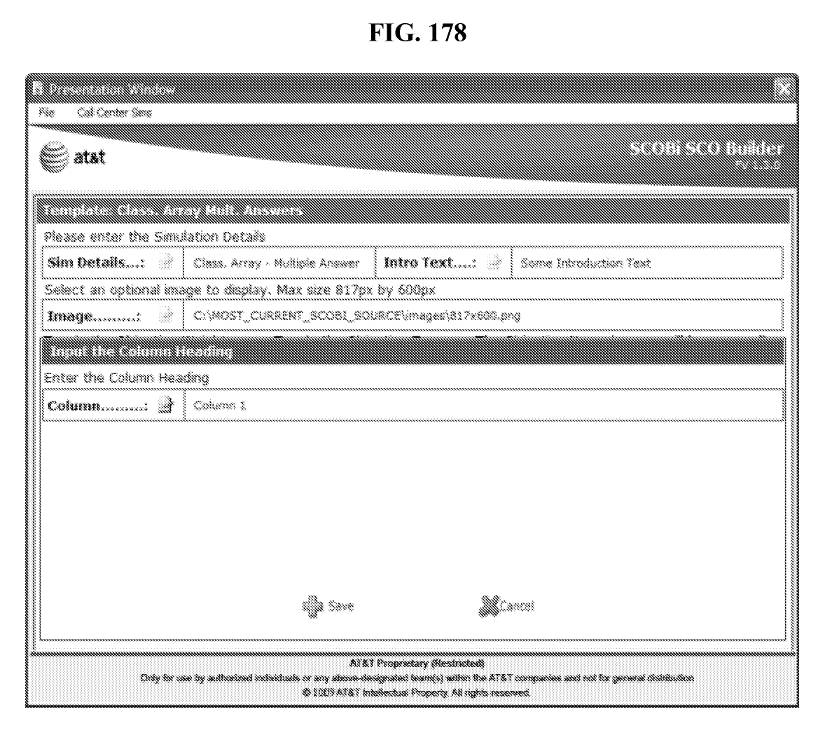

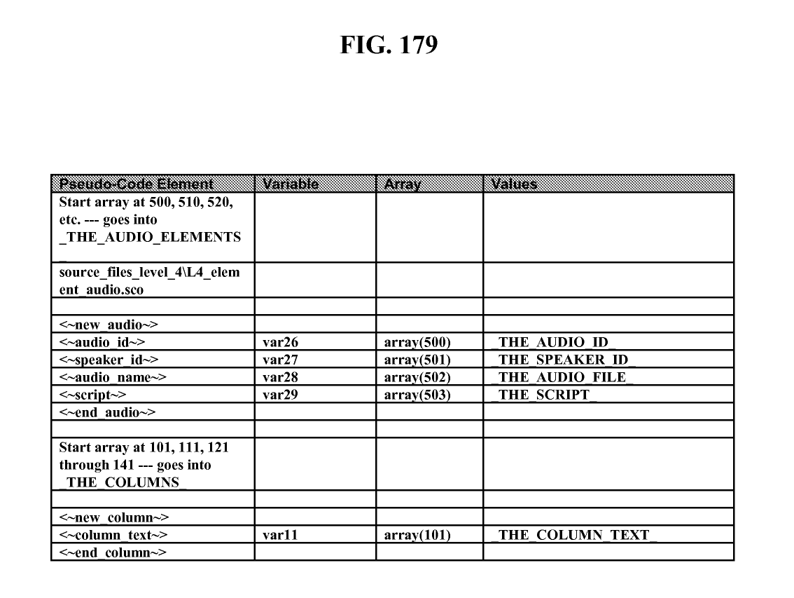

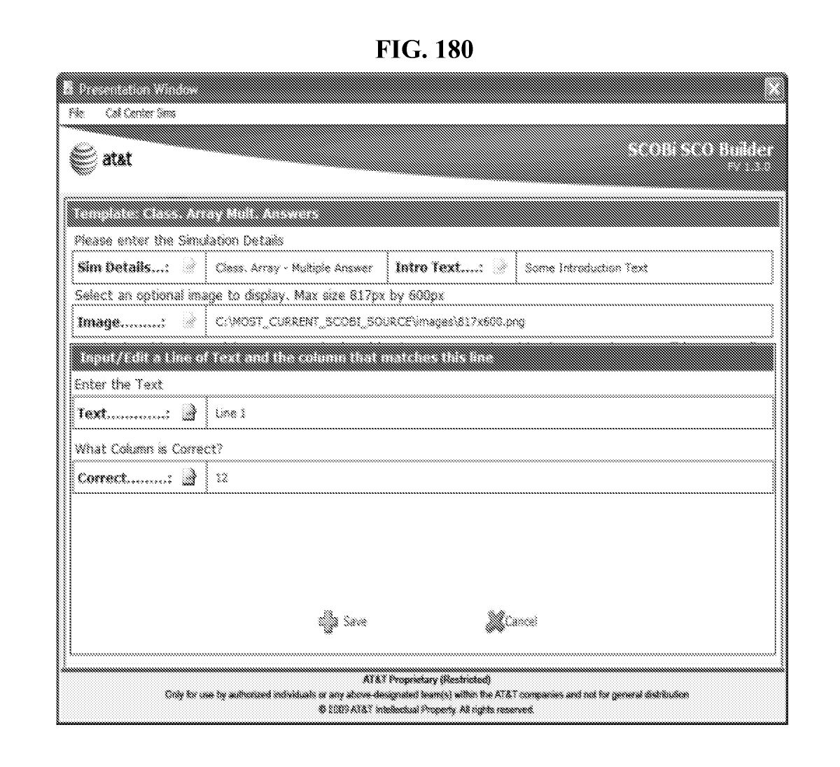

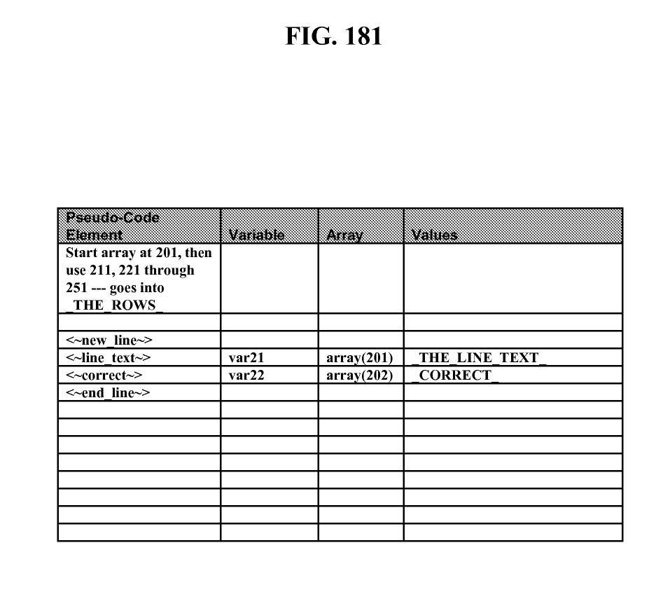

FIGS. 186-187 are schematics illustrating the Call Center Simulation—End Object Reinforcement component, according to exemplary embodiments. FIG. 186 illustrates the component element diagram, and FIG. 187 illustrates the .sco storage table. The Call Center Simulation—End Object Reinforcement component outputs the “Values” column of the .sco storage table. Information flows to \sco_builder_full\projects\sco\XXXX_XXXXXX\cc_sims. There must be at least one (1) interaction between the beginning of an Objective Reinforcement and the end of one.

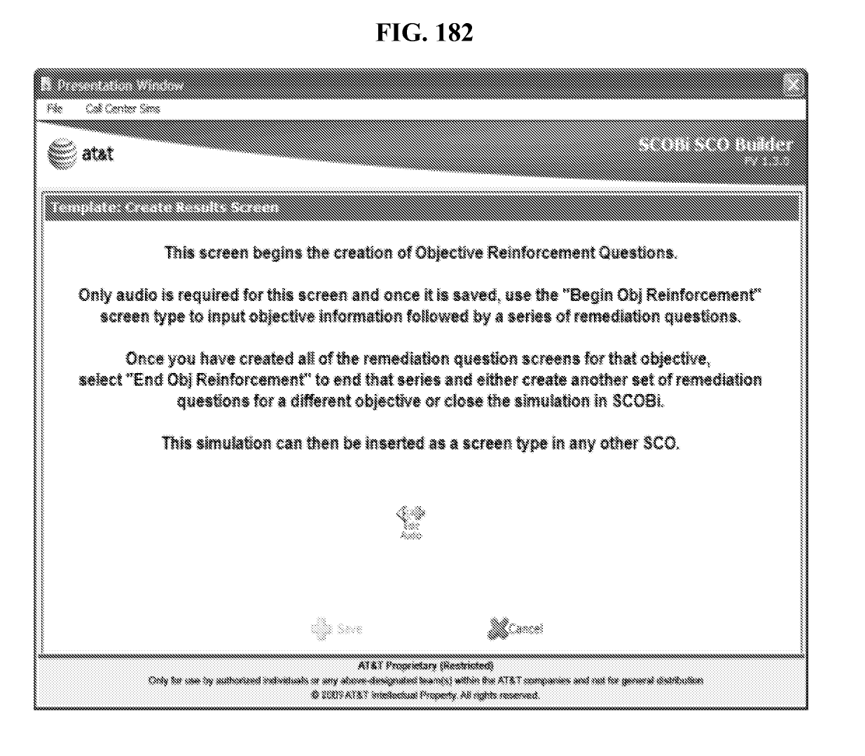

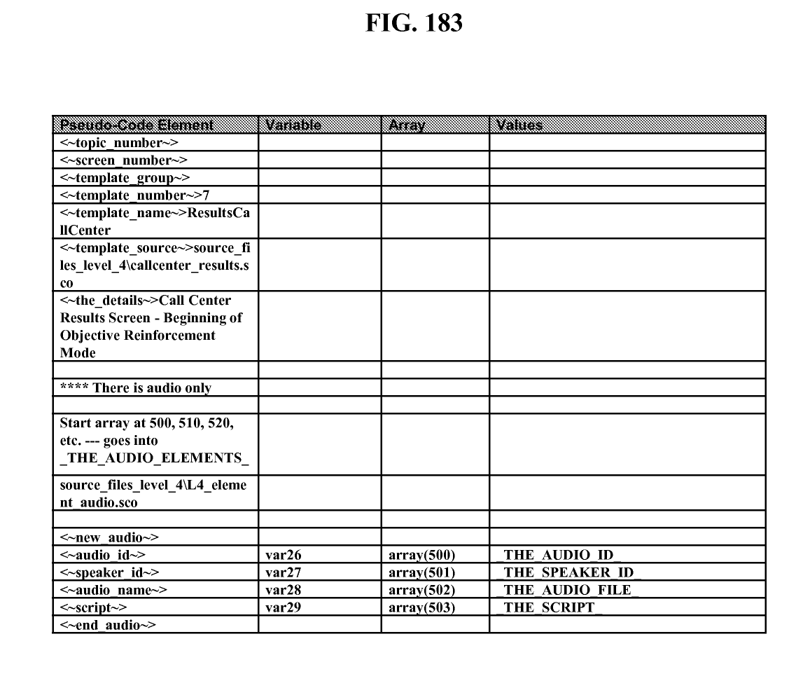

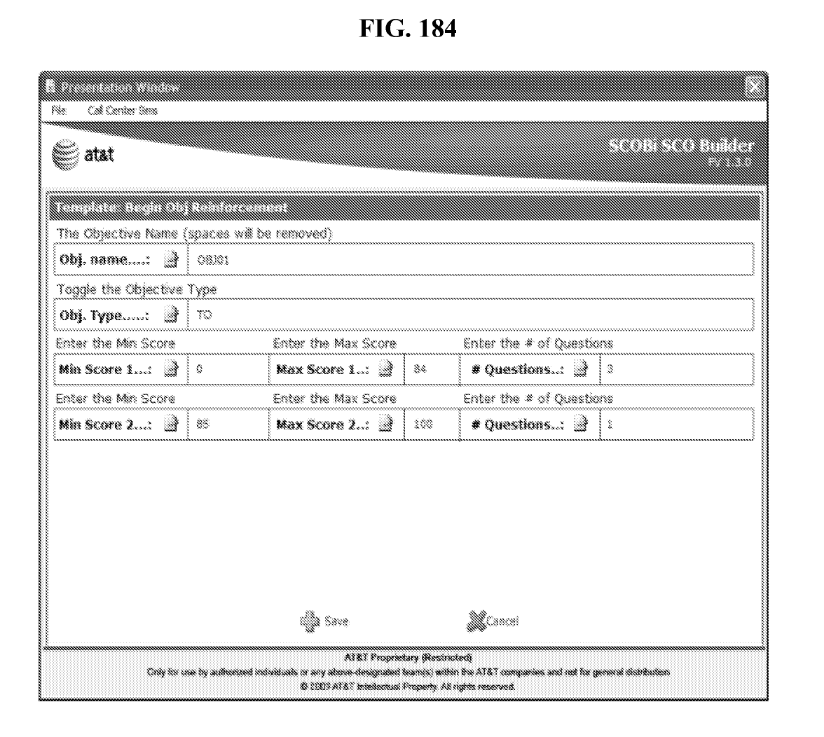

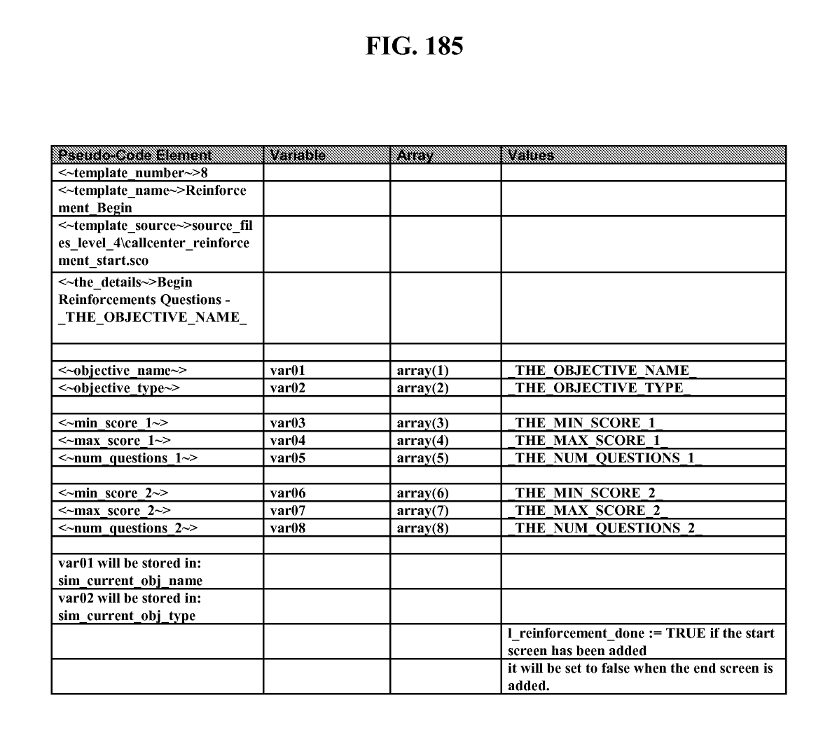

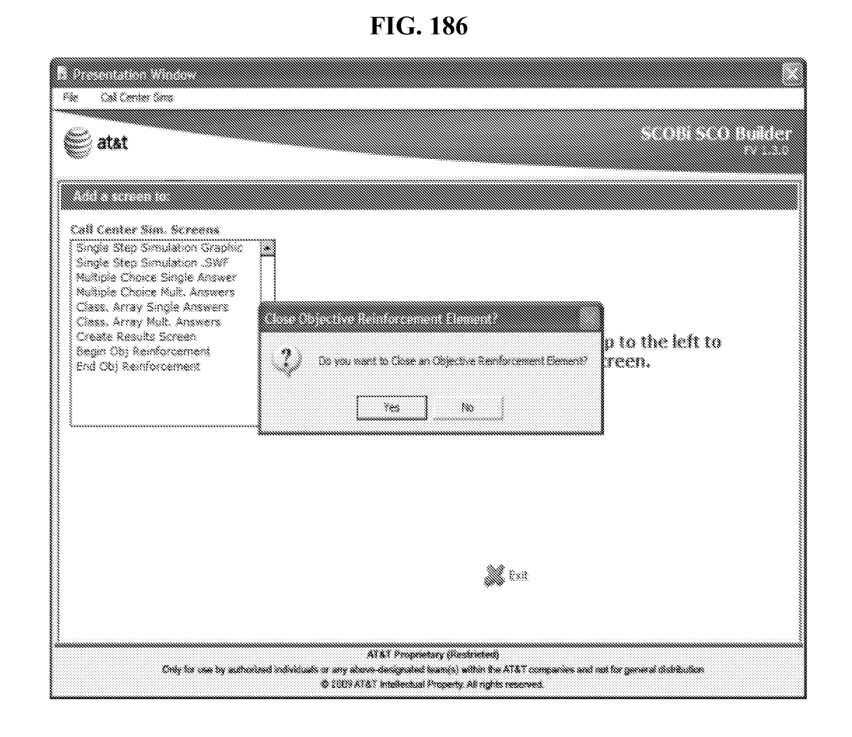

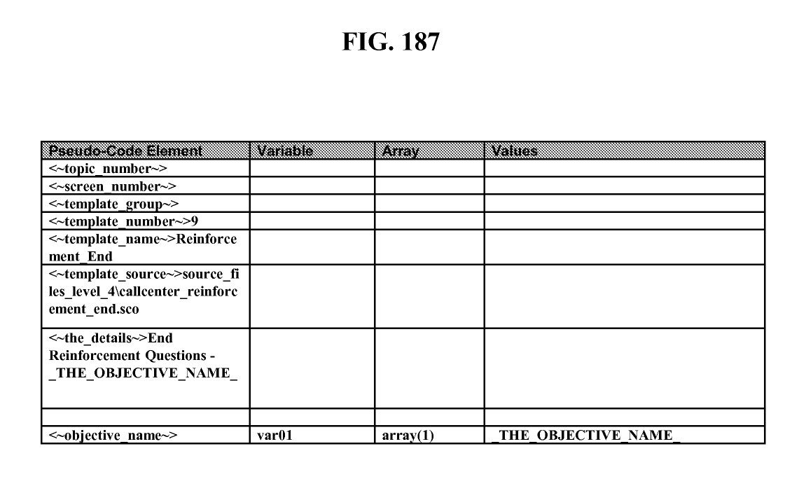

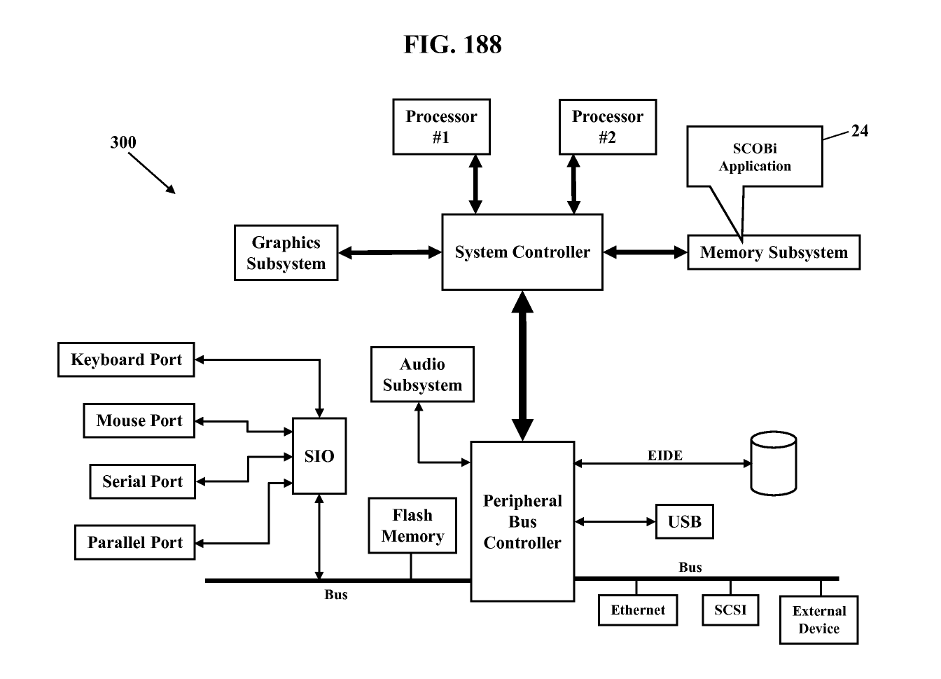

FIG. 188 is a schematic illustrating still more exemplary embodiments. FIG. 188 is a generic block diagram illustrating the SCOBi application 24 may operate within a processor-controlled device 300. The SCOBi application 24 may be stored in a memory subsystem of the processor-controlled device 300. One or more processors communicate with the memory subsystem and execute the SCOBi application 24. Because the processor-controlled device 300 illustrated in FIG. 188 is well-known to those of ordinary skill in the art, no detailed explanation is needed.

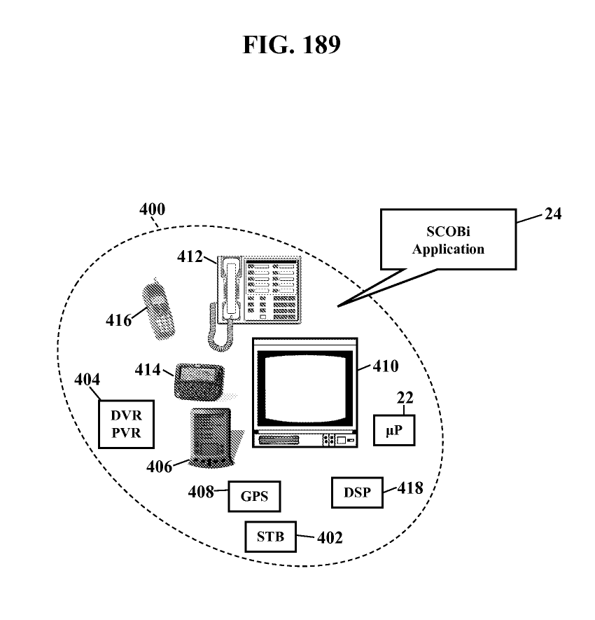

FIG. 189 depicts other possible operating environments for additional aspects of the exemplary embodiments. FIG. 189 illustrates that the exemplary embodiments may alternatively or additionally operate within various other devices 400. FIG. 189, for example, illustrates that the SCOBi application 24 may entirely or partially operate within a set-top box (“STB”) (402), a personal/digital video recorder (PVR/DVR) 404, personal digital assistant (PDA) 406, a Global Positioning System (GPS) device 408, an interactive television 410, an Internet Protocol (IP) phone 412, a pager 414, a cellular/satellite phone 416, or any computer system, communications device, or processor-controlled device utilizing the processor 22 and/or a digital signal processor (DP/DSP) 418. The device 400 may also include watches, radios, vehicle electronics, clocks, printers, gateways, mobile/implantable medical devices, and other apparatuses and systems. Because the architecture and operating principles of the various devices 400 are well known, the hardware and software componentry of the various devices 400 are not further shown and described. If, however, the reader desires more details, the reader is invited to consult the following sources: LAWRENCE HARTE et al., GSM SUPERPHONES (1999); SIEGMUND REDL et al., GSM AND PERSONAL COMMUNICATIONS HANDBOOK (1998); and JOACHIM TISAL, GSM CELLULAR RADIO TELEPHONY (1997); the GSM Standard 2.17, formally known Subscriber Identity Modules, Functional Characteristics (GSM 02.17 V3.2.0 (1995-01))”; the GSM Standard 11.11, formally known as Specification of the Subscriber Identity Module—Mobile Equipment (Subscriber Identity Module—ME) interface (GSM 11.11 V5.3.0 (1996-07))”; MICHEAL ROBIN & MICHEL POULIN, DIGITAL TELEVISION FUNDAMENTALS (2000); JERRY WHITAKER AND BLAIR BENSON, VIDEO AND TELEVISION ENGINEERING (2003); JERRY WHITAKER, DTV HANDBOOK (2001); JERRY WHITAKER, DTV: THE REVOLUTION IN ELECTRONIC IMAGING (1998); and EDWARD M. SCHWALB, ITV HANDBOOK: TECHNOLOGIES AND STANDARDS (2004).

Exemplary embodiments may be physically embodied on or in a computer-readable storage medium. This computer-readable medium may include CD-ROM, DVD, tape, cassette, floppy disk, memory card, and large-capacity disks. This computer-readable medium, or media, could be distributed to end-subscribers, licensees, and assignees. These types of computer-readable media, and other types not mention here but considered within the scope of the exemplary embodiments. A computer program product comprises processor-executable instructions for generating SCORM-conformant content.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method of producing content sharable objects, comprising:
retrieving a set of data from memory;
creating a sharable content object from the set of data;
conforming the sharable content object to a Sharable Content Object Reference Model specification; and
outputting the conformed sharable content object as multiple text files.

2. The method according to claim 1, further comprising outputting the conformed sharable content object as a structure in an extensible markup language.

3. The method according to claim 1, further comprising outputting the conformed sharable content object as a listing of files and a path structure to each file.

4. The method according to claim 1, further comprising outputting the conformed sharable content object as a metadata file comprising metadata information associated with the conformed sharable content object.

5. The method according to claim 1, further comprising creating multiple sharable content objects from the set of data with each sharable content object conformed to the Sharable Content Object Reference Model specification.

6. The method according to claim 1, further comprising storing a portal web page 62 that provides access to the conformed sharable content object.

7. The method according to claim 1, further comprising naming the conformed sharable content object with an .sco extension.

8. The method according to claim 1, further comprising naming the conformed sharable content object with a filename associated with a topic and a screen.

9. A system, comprising:
a processor executing code stored in memory, the code causing the processor to:
retrieve a set of data from the memory;
create a sharable content object from the set of data;
conform the sharable content object to a Sharable Content Object Reference Model specification; and
output the conformed sharable content object as multiple text files.

10. The system according to claim 9, further comprising code that causes the processor to output the conformed sharable content object as a structure in an extensible markup language.

11. The system according to claim 9, further comprising code that causes the processor to output the conformed sharable content object as a listing of files and a path structure to each file.

12. The system according to claim 9, further comprising code that causes the processor to output the conformed sharable content object as a metadata file comprising metadata information associated with the conformed sharable content object.

13. The system according to claim 9, further comprising code that causes the processor to create multiple sharable content objects from the set of data with each sharable content object conformed to the Sharable Content Object Reference Model specification.

14. The system according to claim 9, further comprising code that causes the processor to store a portal web page 62 that provides access to the conformed sharable content object.

15. The system according to claim 9, further comprising code that causes the processor to name the conformed sharable content object with an .sco extension.

16. The system according to claim 9, further comprising code that causes the processor to name the conformed sharable content object with a filename associated with a topic and a screen.

17. A computer readable medium storing processor executable instructions for performing a method, the method comprising:
retrieving a set of data from the memory;
creating a sharable content object from the set of data;
conforming the sharable content object to a Sharable Content Object Reference Model specification; and
outputting the conformed sharable content object as multiple text files.

18. The computer readable medium according to claim 17, further comprising instructions for outputting the conformed sharable content object as a structure in an extensible markup language.

19. The computer readable medium according to claim 17, further comprising instructions for outputting the conformed sharable content object as a listing of files and a path structure to each file.

20. The computer readable medium according to claim 17, further comprising instructions for naming the conformed sharable content object with a filename associated with a topic and a screen.
